(19) United States
(12) Patent Application Publication
(10) Pub. No.: US 2025/0348193 A1
(43) Pub. Date: Nov. 13, 2025

(54) Devices, Methods, and Graphical User Interfaces for Interacting with Controls

(71) Applicant: Apple Inc., Cupertino, CA (US)

(72) Inventors: Nathan de Vries, San Francisco, CA (US); Arian Behzadi, San Francisco, CA (US); Seyit Yilmaz, Santa Clara, CA (US); Christopher P. Foss, San Francisco, CA (US); Caelan G. Stack, Belmont, CA (US)

(21) Appl. No.: 19/187,822

(22) Filed: Apr. 23, 2025

Related U.S. Application Data
(60) Provisional application No. 63/646,114, filed on May 13, 2024.
(60) Provisional application No. 63/656,049, filed on Jun. 4, 2024.

(51) Int. Cl. G06F 3/0484

(52) U.S. Cl. CPC G06F 3/0484

(57) ABSTRACT

A computer system detects a first input that includes first movement relative to a first user interface, and in response, displays a control user interface, including: in accordance with a determination that the first movement meets first criteria, wherein the first criteria require that the first movement meets a first input threshold, displaying, after detecting an end of the first input, the first set of two or more controls that corresponds to the first set of two or more control functions of the computer system; and in accordance with a determination that the first movement meets the second criteria, wherein the second criteria require that the first movement meets a second input threshold that is greater than the first input threshold, displaying, after detecting the end of the first input, the second set of two or more controls that corresponds to a second set of two or more control functions.

### RELATED APPLICATIONS

This application claims the benefit of and priority to U.S. Provisional Patent Application No. 63/656,049, filed Jun. 4, 2024, and to U.S. Provisional Patent Application No. 63/646,114, filed May 13, 2024, each of which is hereby incorporated by reference in its entirety.

### TECHNICAL FIELD

This relates generally to electronic devices with input devices, such as touch-sensitive surfaces, cameras, and/or other sensors for detecting user inputs and contextual conditions, and/or output devices, such as display generation components and audio output devices, including but not limited to electronic devices in communication with touch-sensitive surfaces, displays, and/or audio output devices.

### BACKGROUND

Mobile devices such as smartphones, head-mounted displays, vehicle head units, and smartwatches are used by users throughout the day. Such devices often include many applications, each application providing various functionality of the device.

Current methods for quickly accessing controls that cause the mobile devices to perform respective operations are inefficient. For example, a limited number of controls are presented to the user. This often results in users needing to expend additional effort to effectively access functionality that is available via various applications on the device. This may further result in wasted time, increased cognitive burden on the user, and unneeded power consumption of the device (e.g., performing operations that can be avoided with more efficient and effective content delivery).

### SUMMARY

Accordingly, there is a need for electronic devices with faster, more efficient methods and interfaces for accessing controls on the electronic devices. Such methods and interfaces optionally complement or replace conventional methods for accessing controls on the electronic devices. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has (e.g., includes or is in communication with) a display generation component (e.g., a display device such as a head-mounted device (HM D), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the device is a head-mounted display device that provides three-dimensional virtual and/or augmented reality experiences. In some embodiments, the device has a touchpad. In some embodiments, the device has a touch-sensitive display (also known as a “touch screen” or “touch-screen display”). In some embodiments, the device has one or more cameras that detect air gestures performed using a user's hand, and, optionally, the gaze of the user. In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with one or more display generation components and one or more input devices. The method includes displaying, via the one or more display generation components, a first user interface; and while displaying the first user interface, detecting, via the one or more input devices, a first input that includes first movement relative to the first user interface. The method further includes, in response to detecting the first input, displaying a control user interface, including: in accordance with a determination that the first movement meets first criteria that correspond to display of a first set of two or more controls that corresponds to a first set of two or more control functions of the computer system, without meeting second criteria that correspond to display of a second set of two or more controls that is different from the first set of two or more controls, wherein the first criteria require that the first movement meets a first input threshold in order for the first criteria to be met by the first movement, displaying, via the one or more display generation components, after detecting an end of the first input, the first set of two or more controls that corresponds to the first set of two or more control functions of the computer system; and in accordance with a determination that the first movement meets the second criteria, wherein the second criteria require that the first movement meets a second input threshold that is greater than the first input threshold, in order for the second criteria to be met by the first movement, displaying, via the one or more display generation components, after detecting the end of the first input, the second set of two or more controls that corresponds to a second set of two or more control functions of the computer system, wherein the second set of two or more control functions are different from the first set of two or more control functions.

In accordance with some embodiments, a method is performed at a computer system that is in communication with one or more display generation components and one or more input devices for detecting user inputs. The method includes displaying, via the one or more display generation components, a control user interface that provides access to a plurality of controls corresponding to different control functions of the computer system, wherein the control user interface includes a first representation of a first group of controls, wherein the first group of controls includes one or more controls that are added to the first group of controls by a user, and wherein displaying the first representation of the first group of controls includes: displaying two or more controls from the first group of controls in the first representation of the first group of controls, wherein the two or more controls include: a first control for performing a first function when selected based on input detected via the one or more input devices; and a second control for performing a second function different from the first function when selected based on input detected via the one or more input devices. The method includes, in accordance with a determination that the first group of controls includes more than a first threshold number of controls, displaying, concurrently with the two or more controls, a first user interface object that, when selected based on input detected via the one or more input devices, causes the computer system to display one or more additional controls from the first group of controls that have not been displayed in the first representation prior to the selection of the first user interface object.

In accordance with some embodiments, a method is performed at a computer system that is in communication with one or more display generation components and one or more sensors for detecting user inputs. The method includes detecting the occurrence of a condition that corresponds to display of a respective wake screen of the computer system that corresponds to a restricted state of the computer system wherein the respective wake screen includes: a notification region for displaying notifications from a plurality of different applications associated with the computer system; and an action region that includes a respective user-configurable control that, when activated, causes the computer system to perform a corresponding action associated with the respective user-configurable control. The method further includes, in response to detecting the occurrence of the condition that corresponds to display of the respective wake screen that corresponds to the restricted state of the computer system: in accordance with a determination that a first wake screen is a currently selected wake screen for the computer system, displaying the first wake screen, wherein displaying the first wake screen includes concurrently displaying: one or more first notifications in the notification region; and a first control in the action region. The method includes, in accordance with a determination that a second wake screen is the currently selected wake screen for the computer system, displaying the second wake screen that is different from the first wake screen, wherein displaying the second wake screen includes concurrently displaying: one or more second notifications in the notification region; and a second control in the action region, wherein the second control is different from the first control.

In accordance with some embodiments, a method is performed at a computer system that is in communication with one or more display generation components and one or more input devices. The method includes displaying, via the one or more display generation components, a control user interface, wherein the control user interface includes a plurality of controls corresponding to a plurality of control functions of the computer system and wherein one or more configuration options of a respective control of the plurality of controls are adjustable in accordance with user inputs. The method further includes, while displaying the control user interface, detecting, via the one or more input devices, a first user input that is directed to a first control of the plurality of controls in the first control user interface. The method includes, in response to detecting the first user input that is directed to the first control: in accordance with a determination that the first user input meets resize criteria, wherein the resize criteria require that the first user input is directed to the first control and includes more than a first threshold amount of movement in order for the first user input to meet the resize criteria with respect to the first control, displaying, via the one or more display generation components, the first control with a second size different from the first size in accordance with the first user input, while maintaining display of the control user interface; and in accordance with a determination that the first user input does not meet the resize criteria, maintaining display, via the one or more display generation components, of the first control with the first size.

In accordance with some embodiments, an electronic device (or computer system more generally) includes a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device that includes a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), cause the device to perform or cause performance of the operations of any of the methods described herein. In accordance with some embodiments, a graphical user interface on an electronic device with a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators); and means for performing or causing performance of the operations of any of the methods described herein. In accordance with some embodiments, an information processing apparatus, for use in an electronic device with a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), includes means for performing or causing performance of the operations of any of the methods described herein.

Thus, electronic devices and other computer systems with display generation components (e.g., displays, touch-screen displays, and/or head-mounted displays), input device (e.g., touch-sensitive surfaces, touch screen displays, optionally one or more sensors to detect intensities of contacts with the touch-sensitive surface or touch-screen display, one or more cameras, and/or one or more controllers), and one or more output devices (e.g., audio output devices, and optionally, one or more tactile output generators) are provided with improved methods and interfaces for accessing controls, thereby increasing the effectiveness, efficiency, and user satisfaction with such devices. Such methods and interfaces may complement or replace conventional methods for accessing controls.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C1-4C2 illustrate an example state diagram of navigation between various user interfaces of the multifunction devices in accordance with some embodiments.

FIGS. 5A-5CX illustrate example user interfaces for interacting with controls in various user interfaces in accordance with some embodiments.

FIGS. 6A-6J are flow diagrams of a process for interacting with a control user interface in accordance with some embodiments.

FIGS. 7A-7I are flow diagrams of a process for configuring a control user interface in accordance with some embodiments.

FIGS. 8A-8H are flow diagrams of a process for providing quick actions in a user interface in accordance with some embodiments.

FIGS. 9A-9J are flow diagrams of a process for resizing controls in an editing control user interface in accordance with some embodiments.

### DESCRIPTION OF EMBODIMENTS

Many devices provide a plurality of controls for interacting with various functions of the device. Typically, the level of customization for the various controls is limited. Improved methods of accessing, organizing and customizing controls are provided. For example, a system that displays a first set of controls or a second set of controls in a control user interface based on a type and/or characteristics of user input that is detected is provided. In some embodiments, a system is provided for creating groups of controls within a control user interface. In some embodiments, a system for providing and customizing a set of controls on a wake screen user interface, and/or another system user interface, is provided. In some embodiments, a system for configuring one or more properties of controls in a control user interface is provided. As such, a user is provided with improved access to controls corresponding to various control functions on the electronic device and/or other devices controlled by the electronic device.

The methods, devices, and GUIs described make it easier to for users to quickly locate, view, and/or interact with relevant content (e.g., controls and/or application content), by providing control user interfaces and/or allowing the user to customize control user interfaces.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

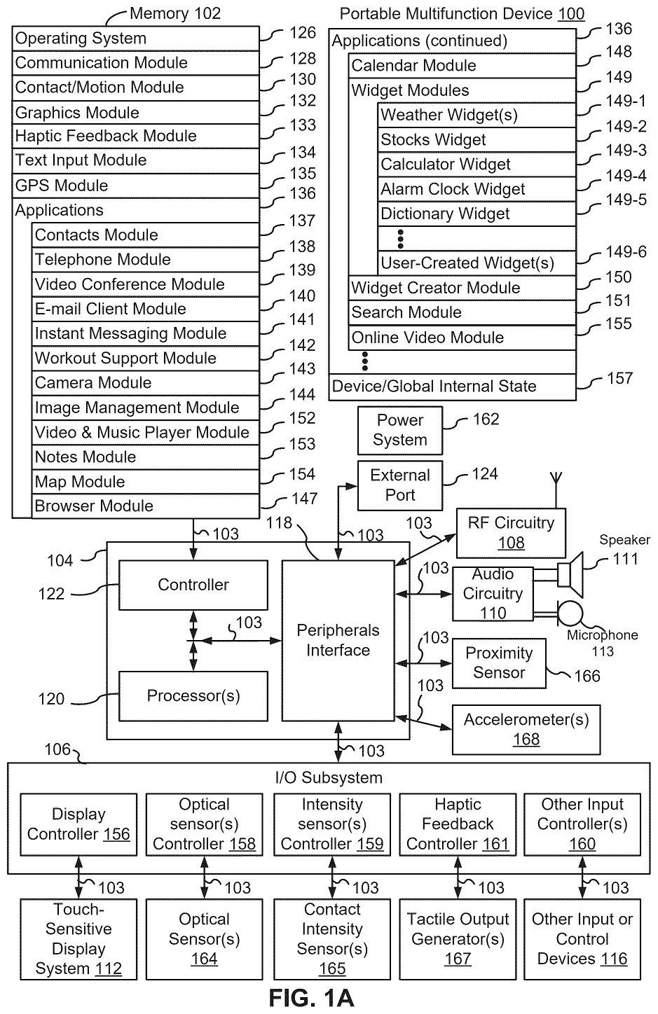

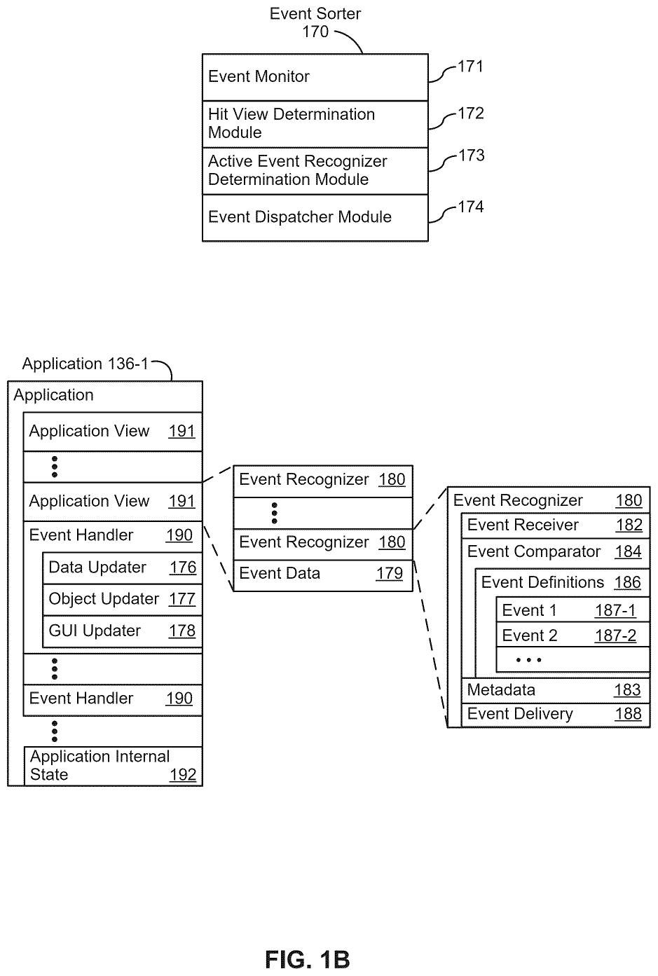

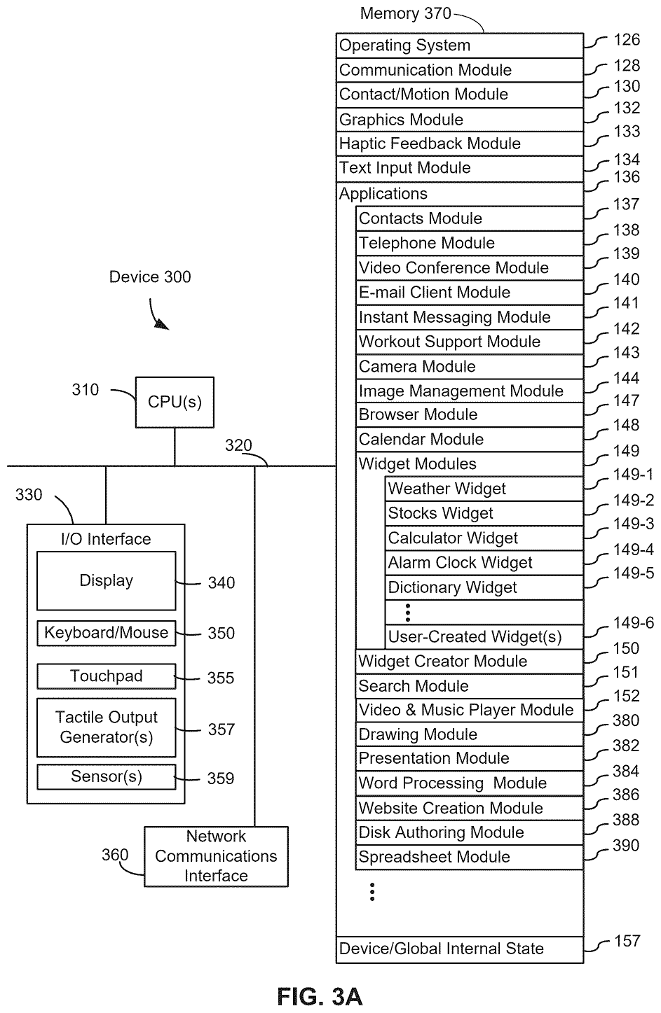

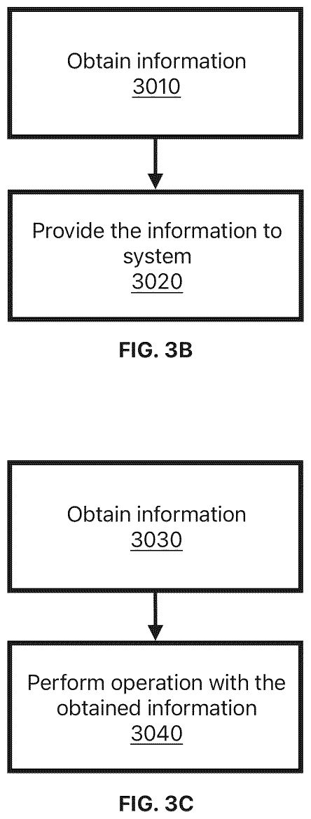

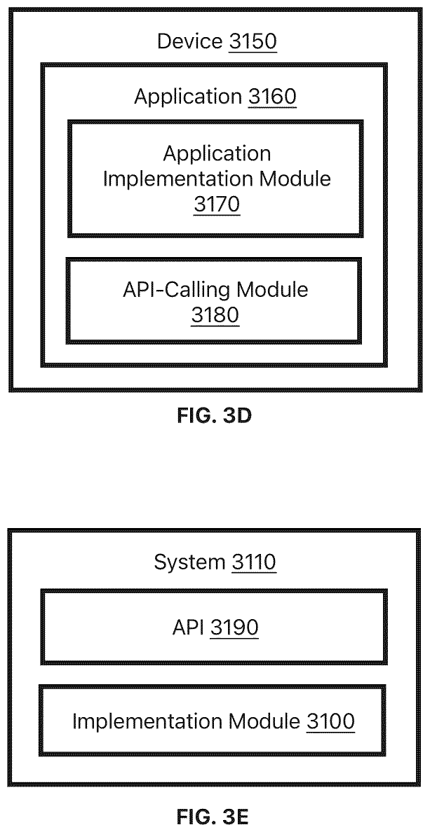

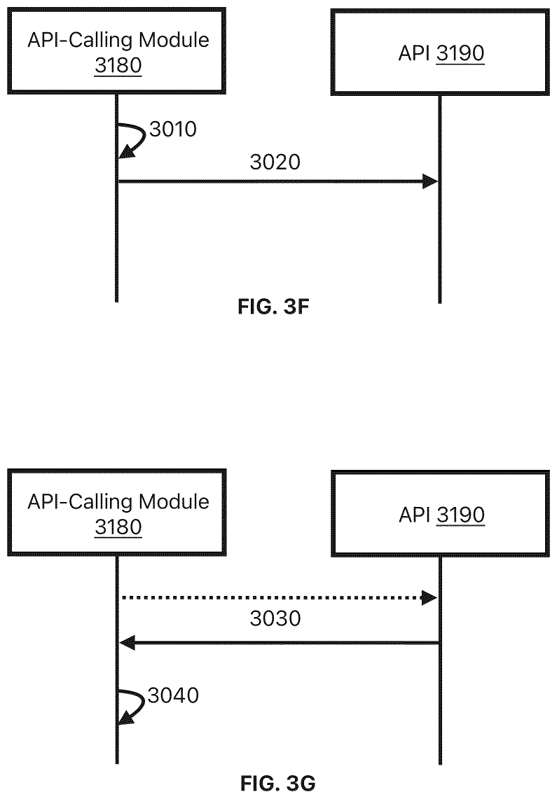

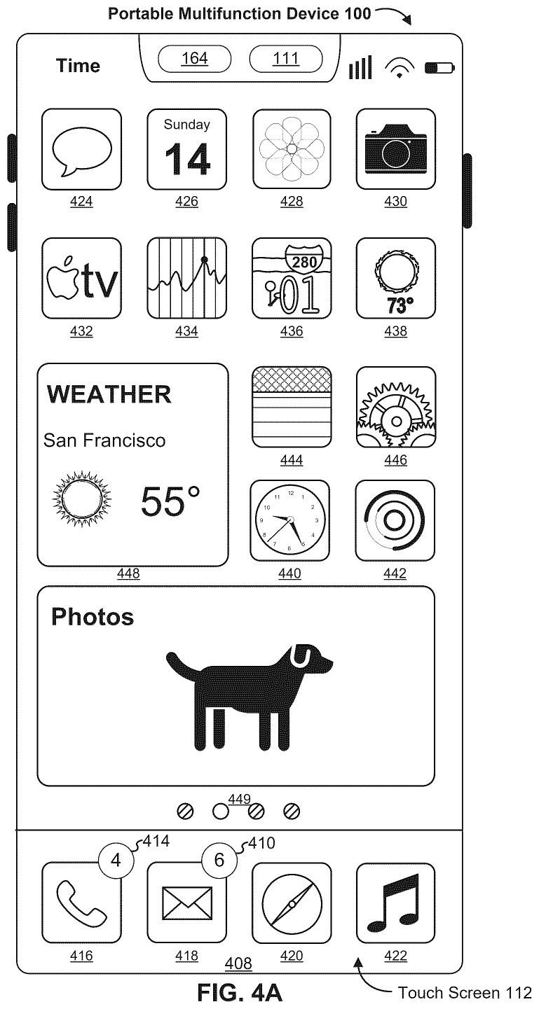

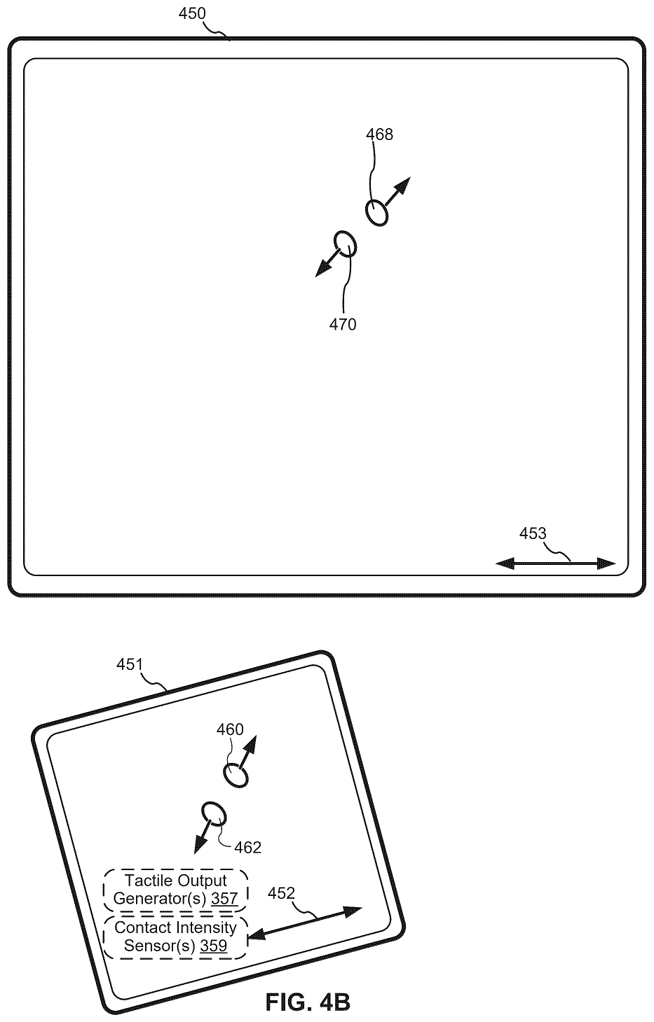

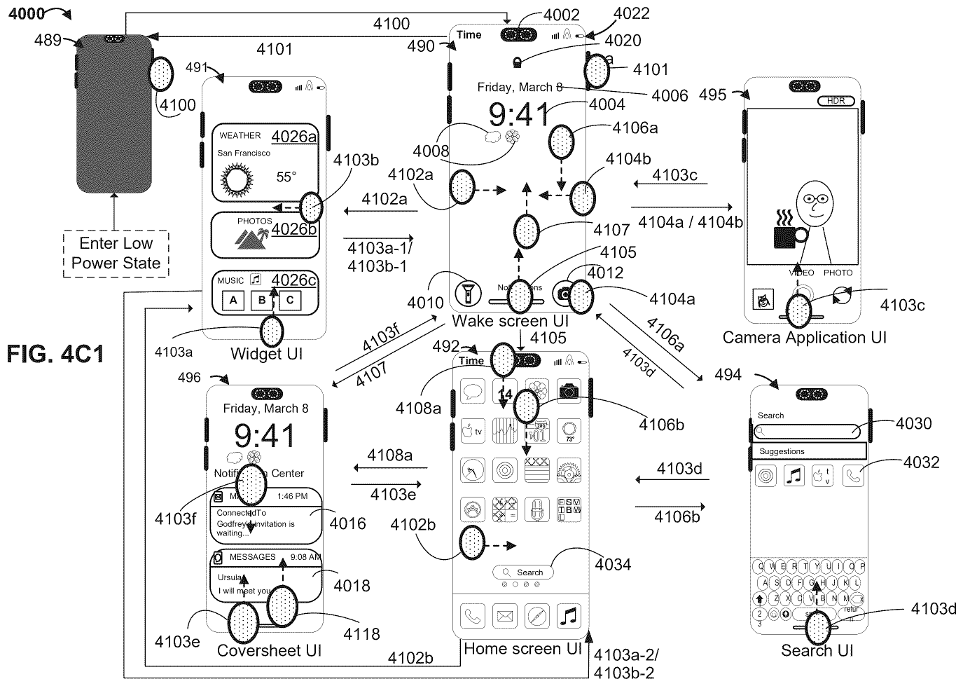

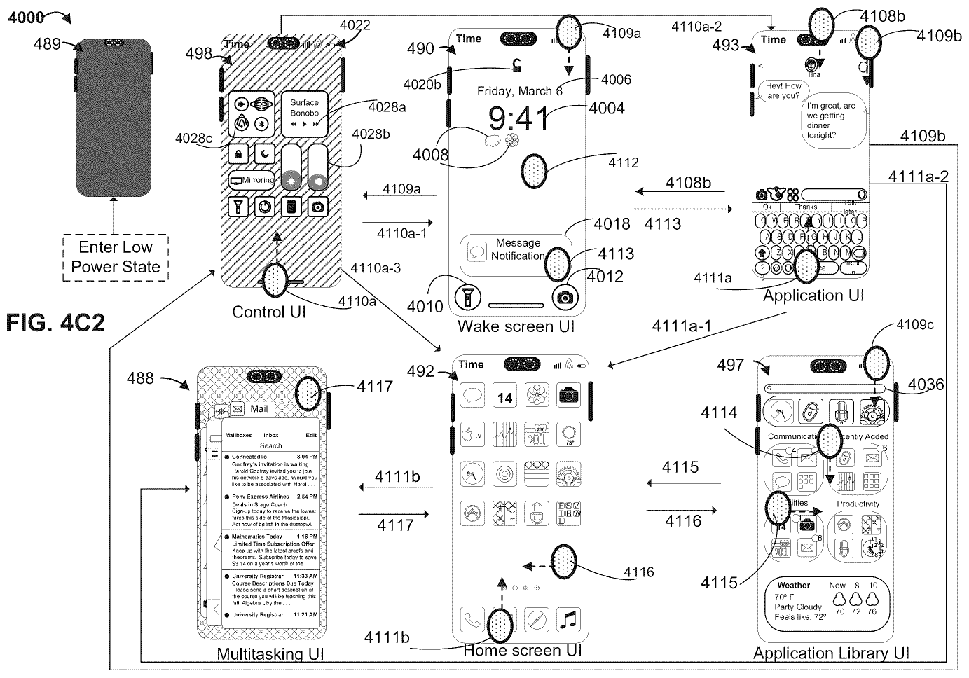

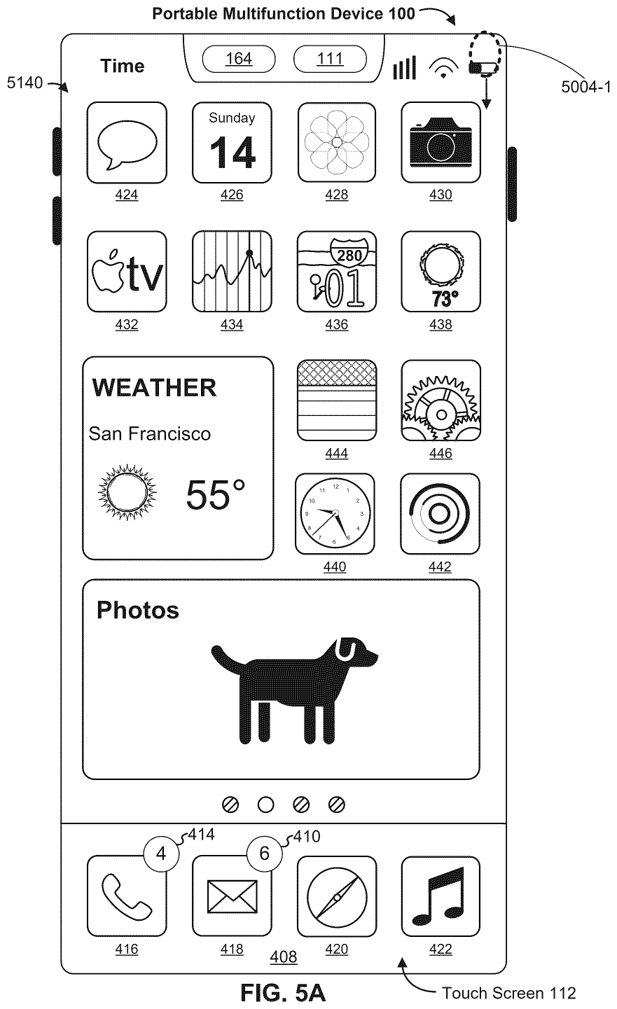

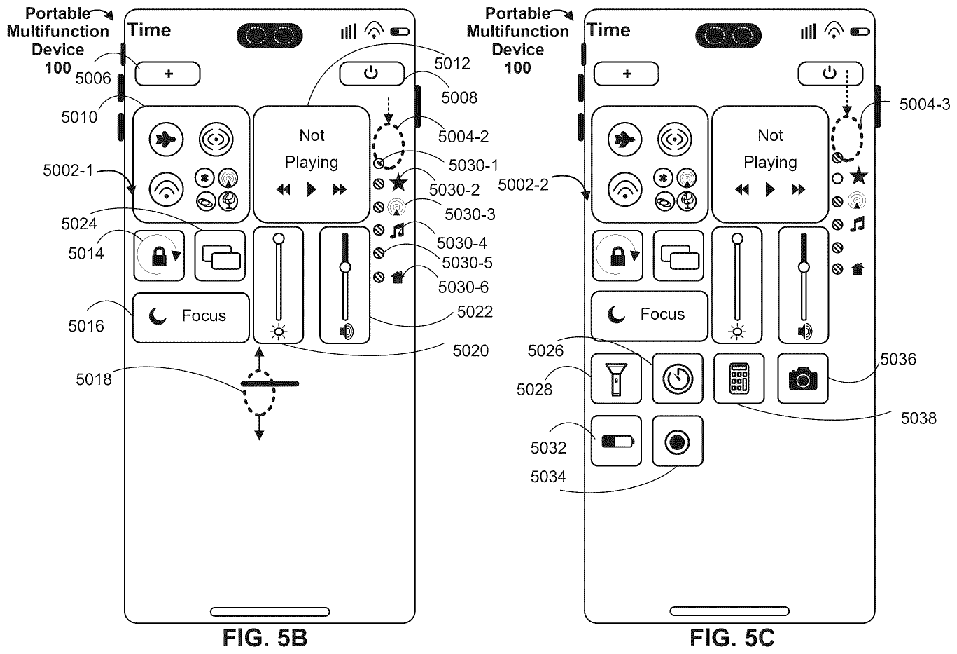

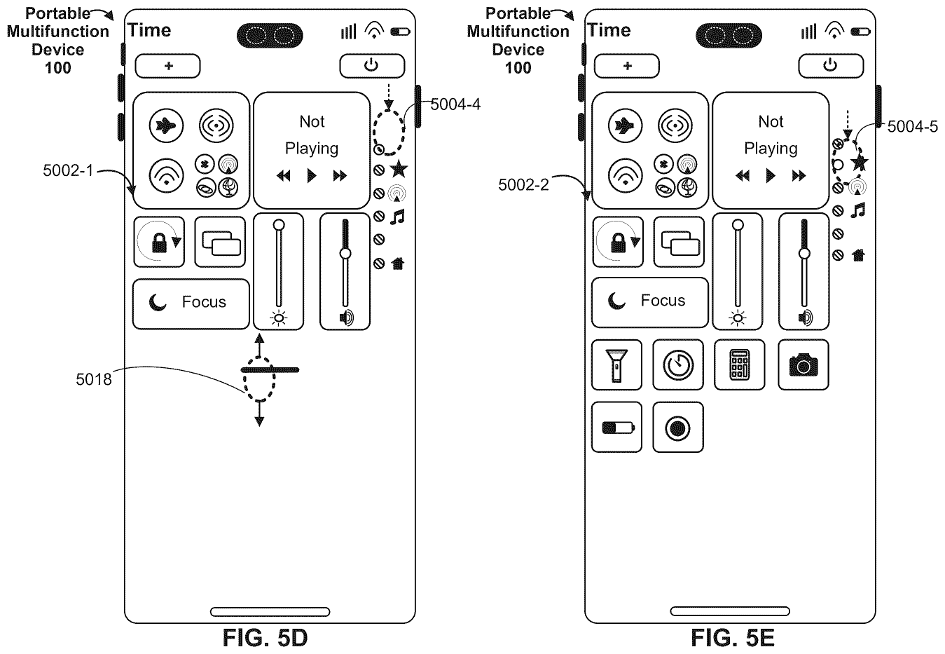

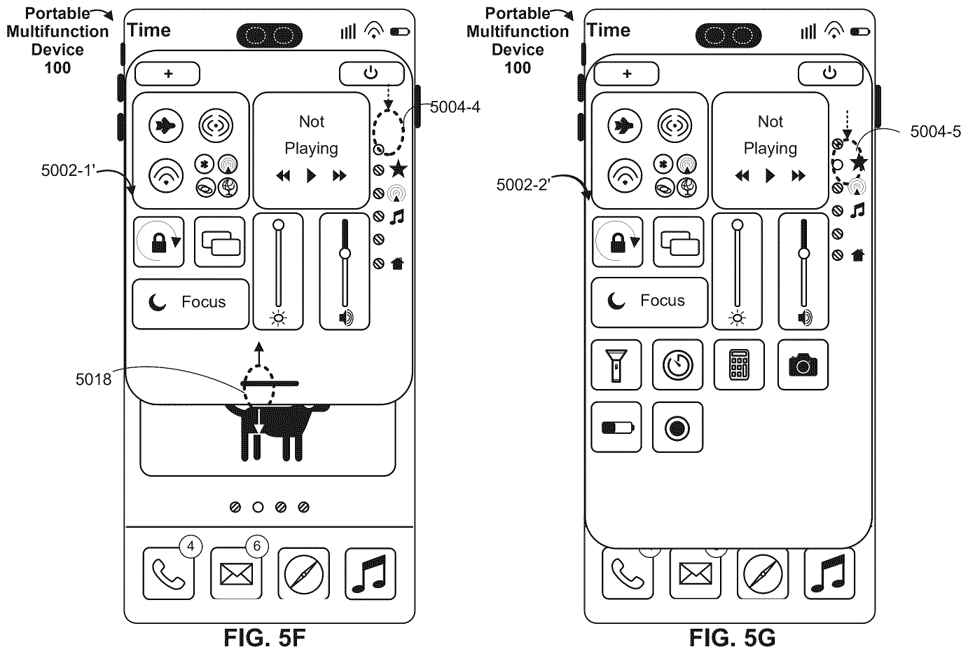

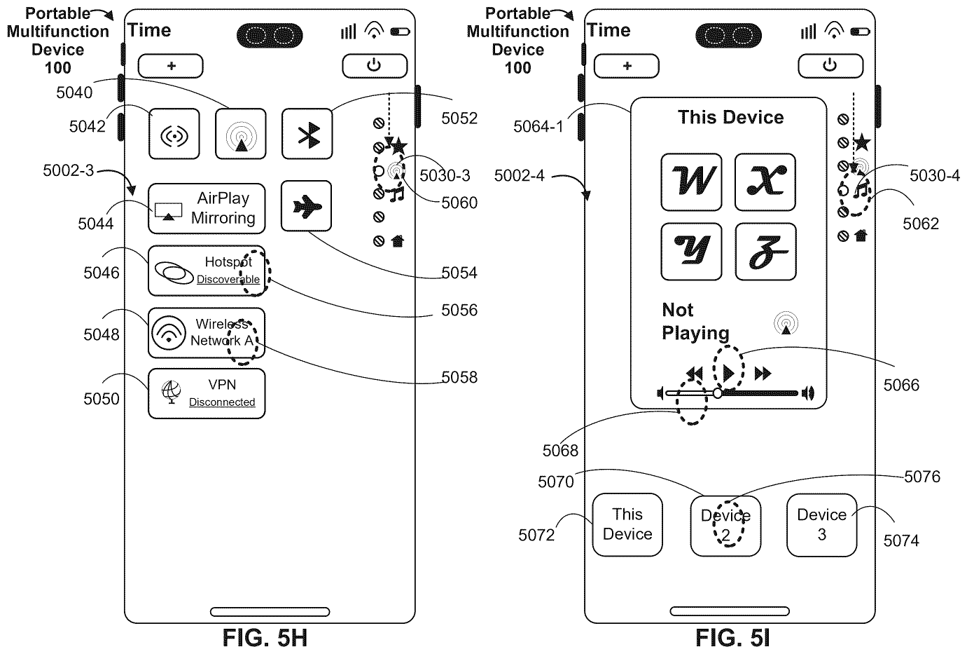

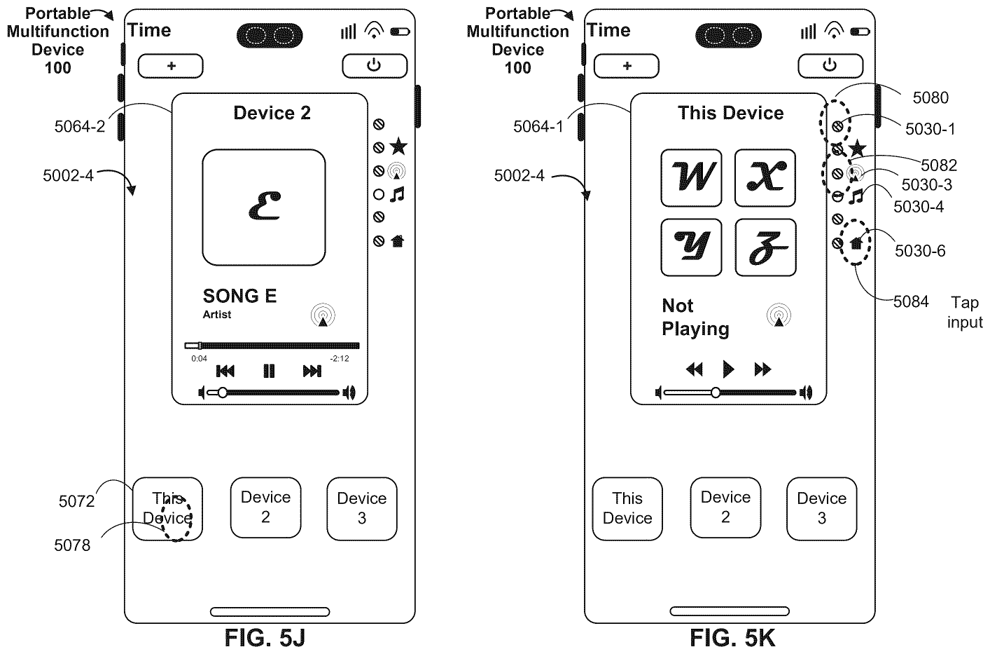

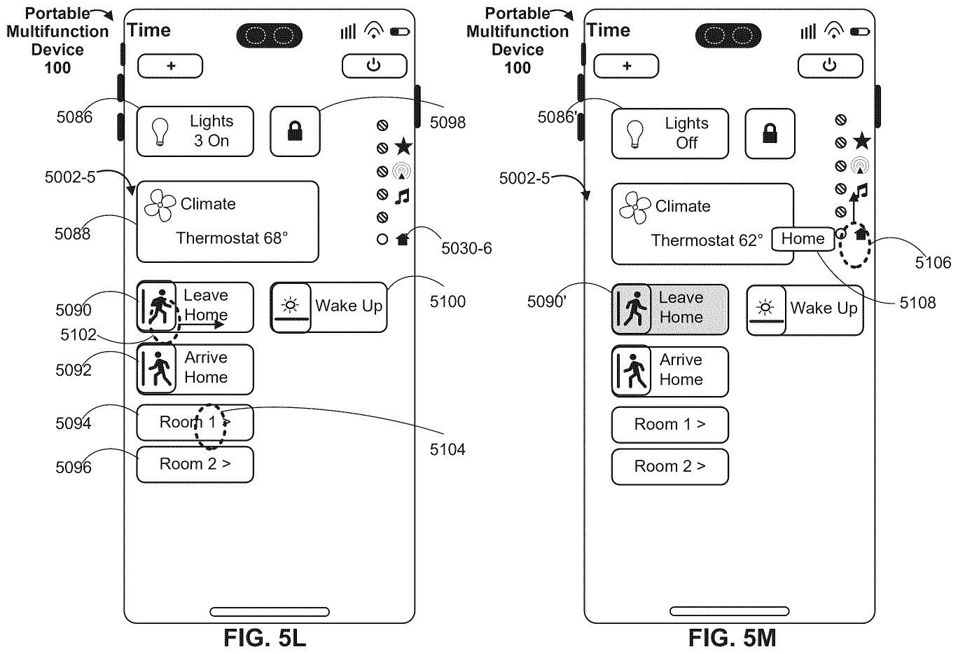

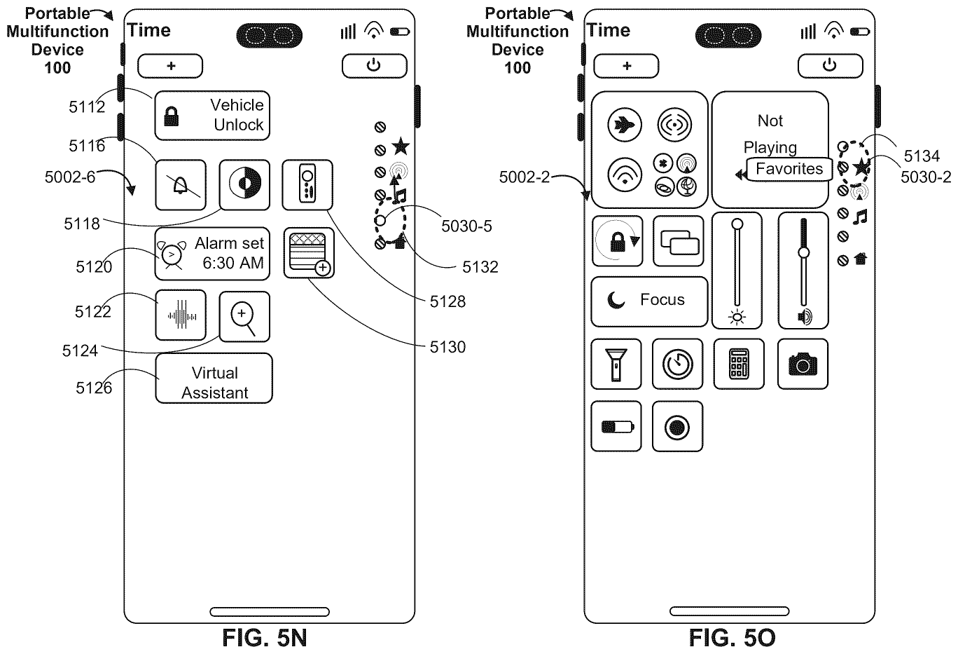

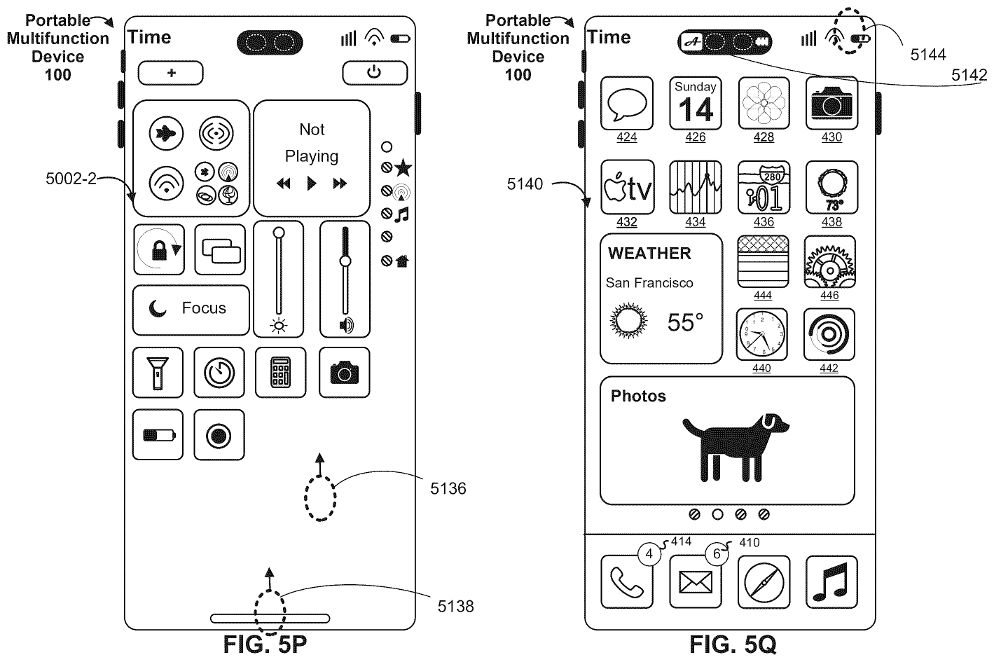

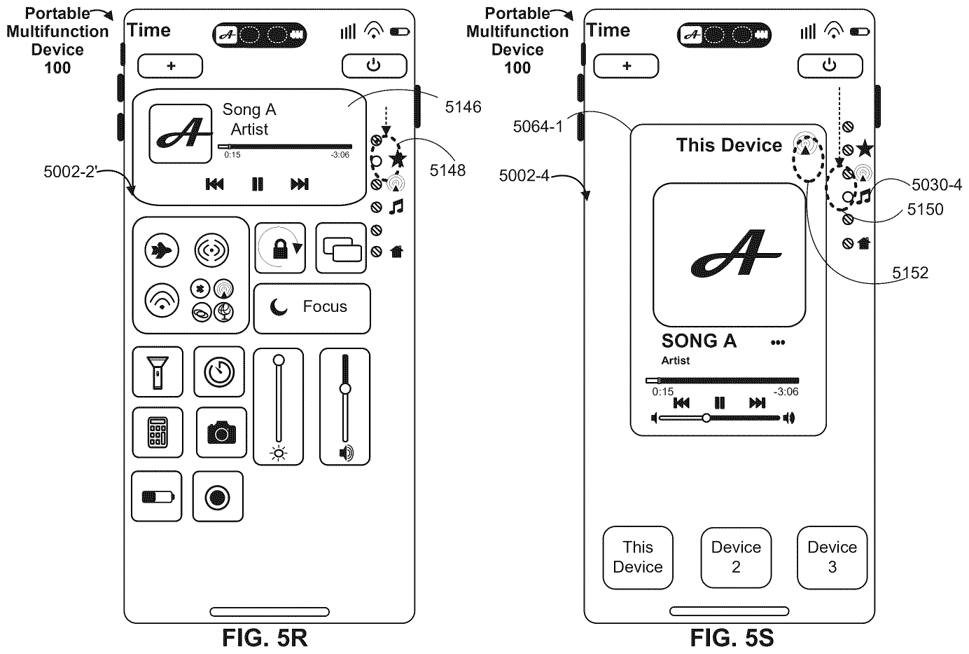

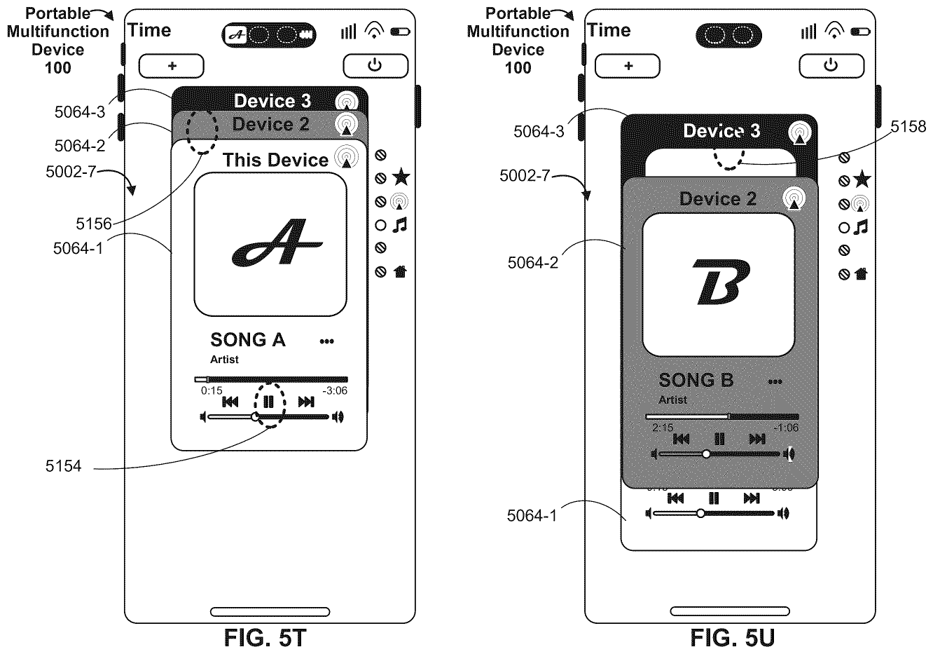

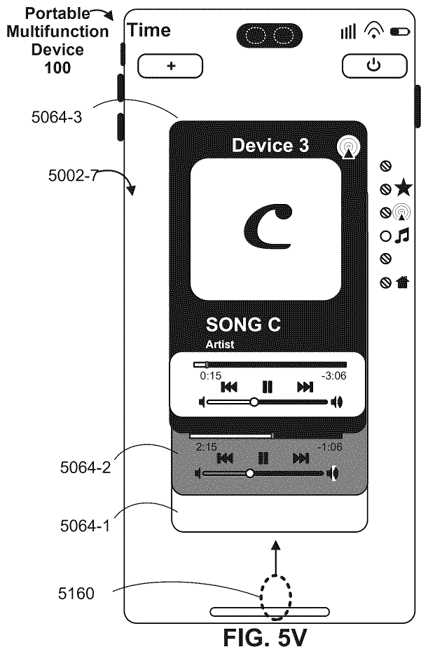

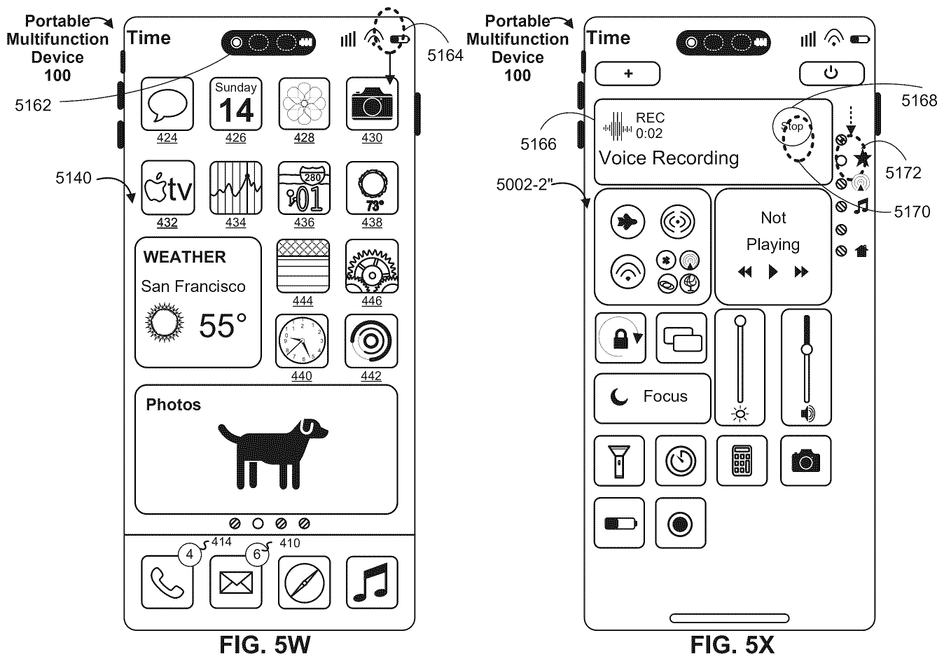

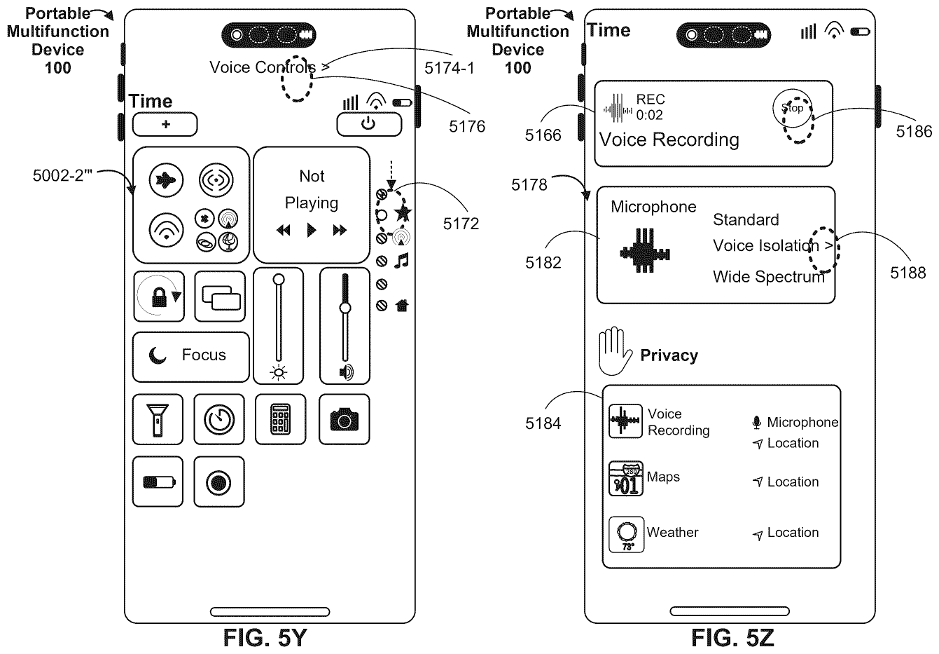

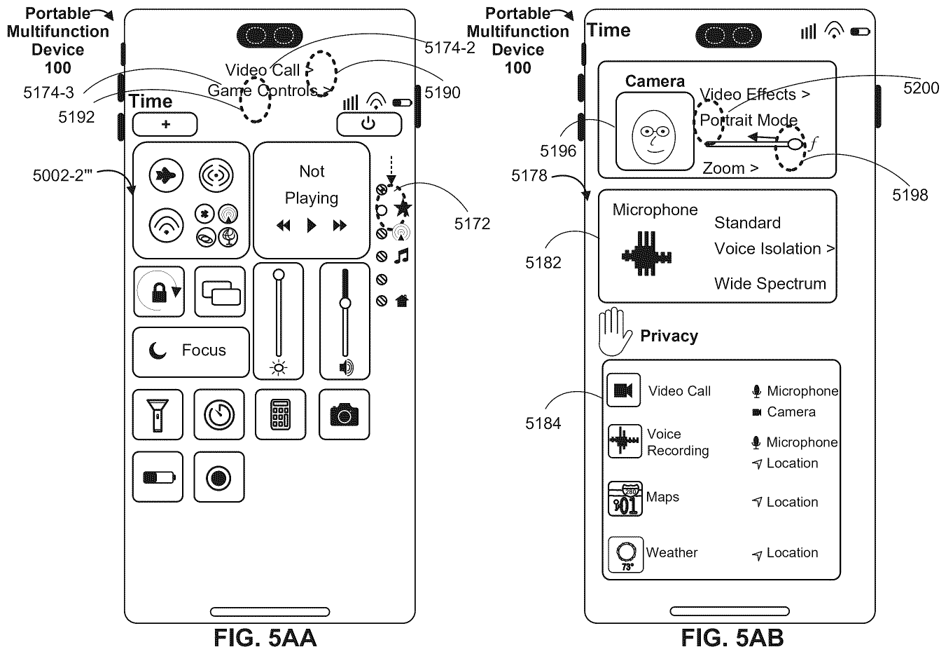

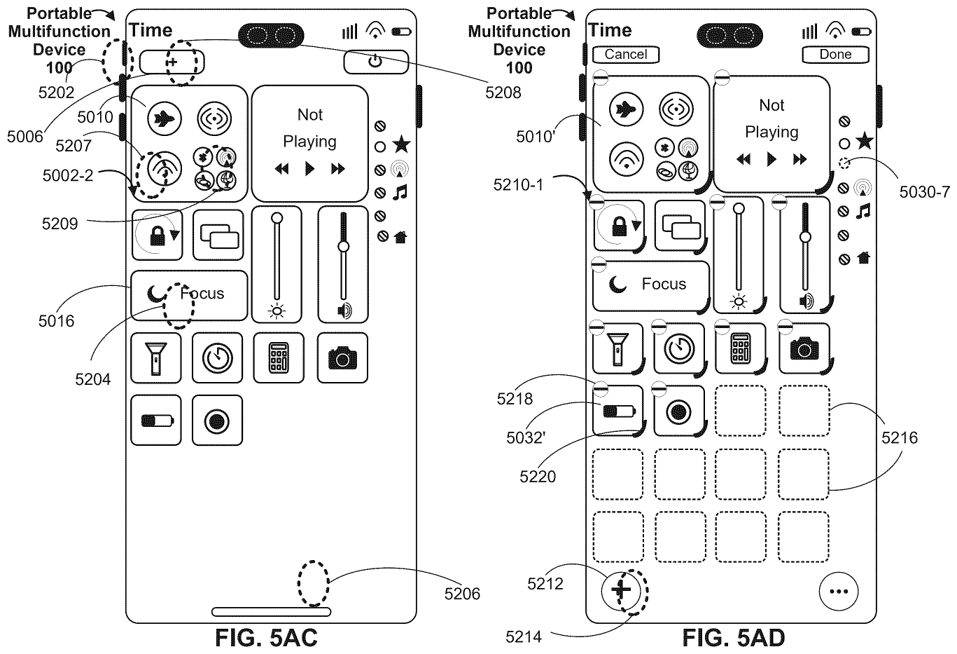

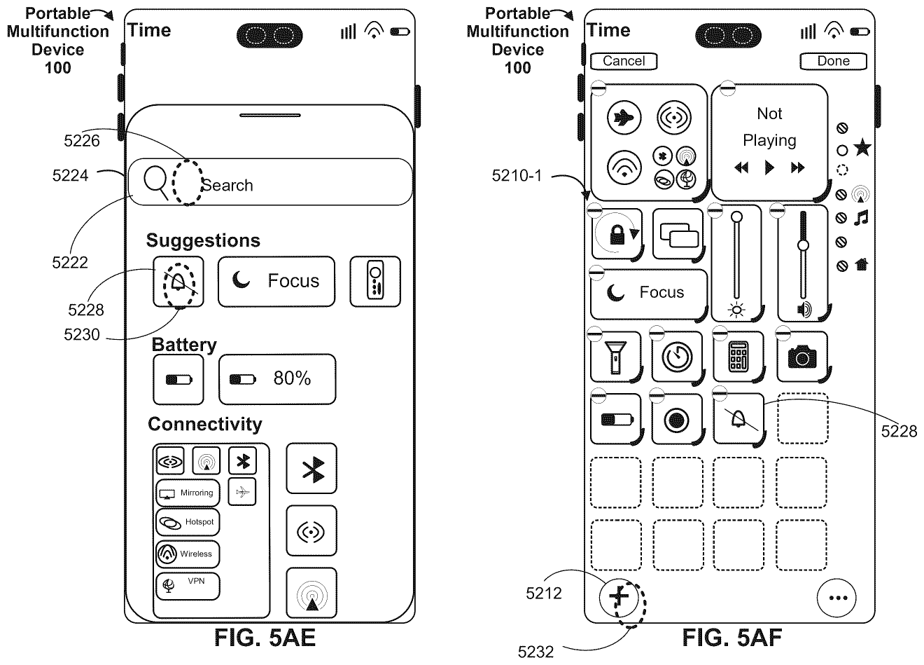

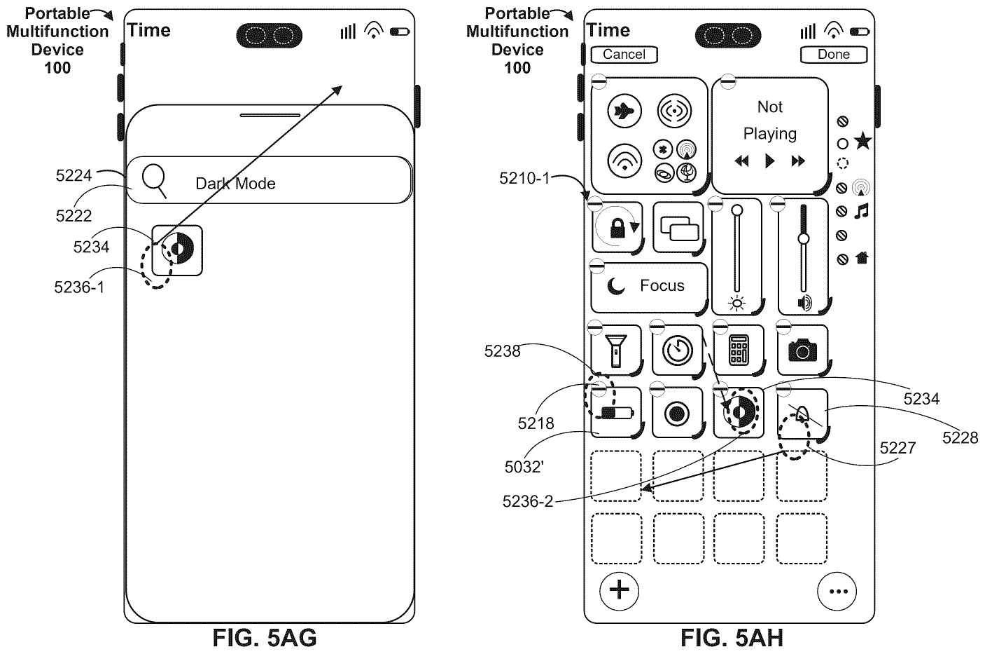

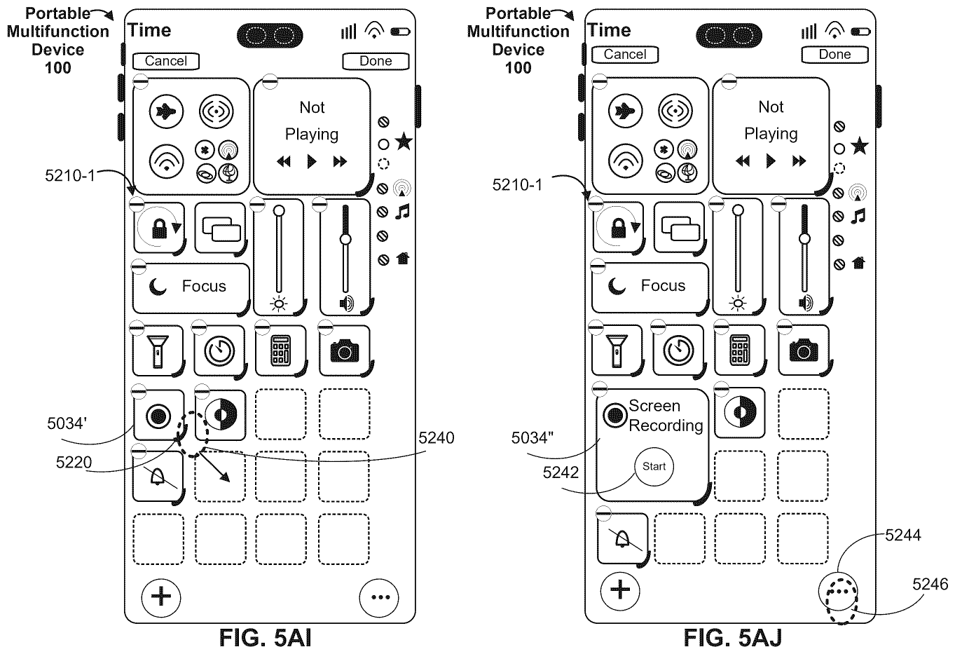

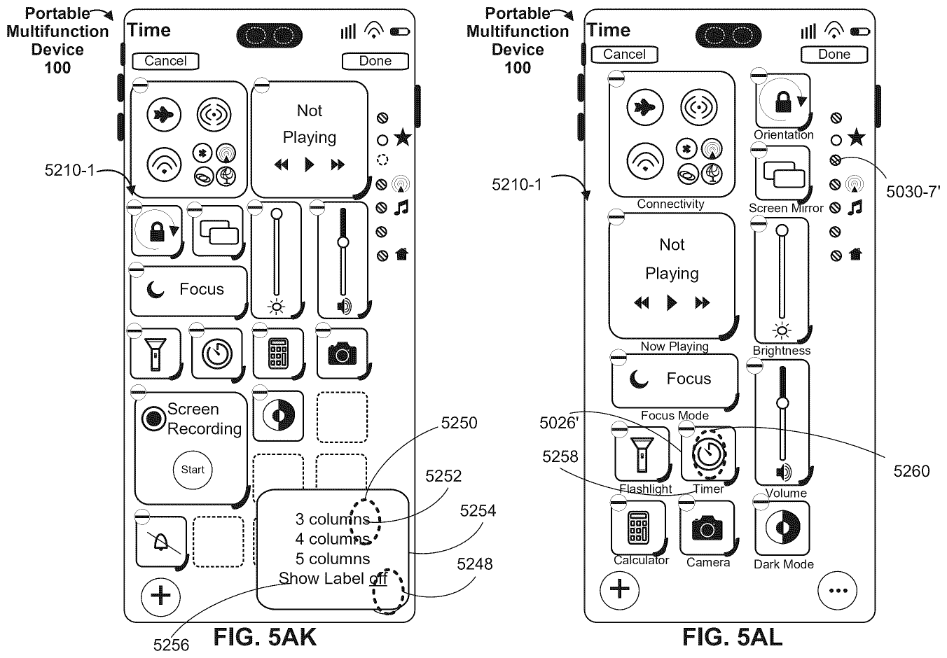

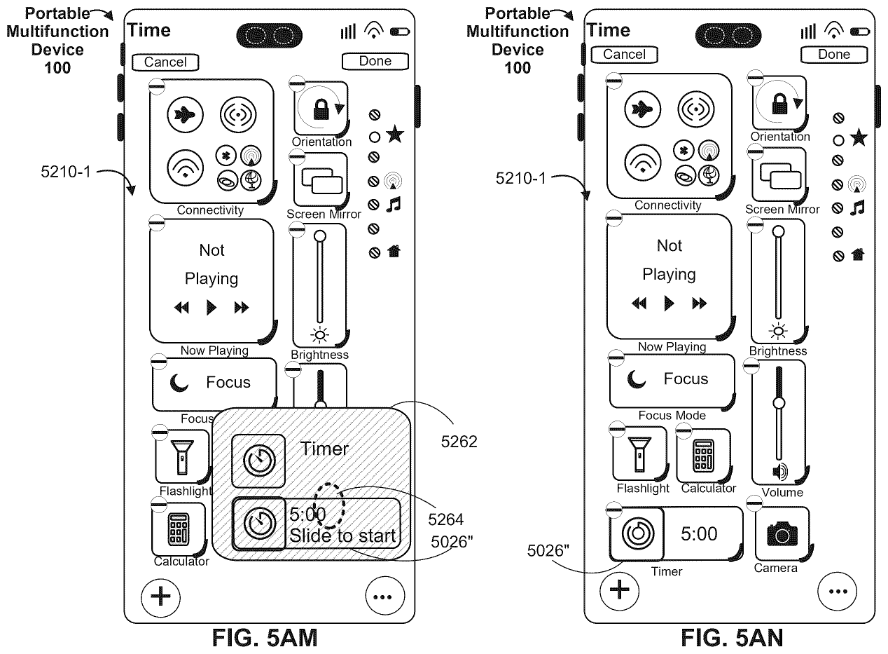

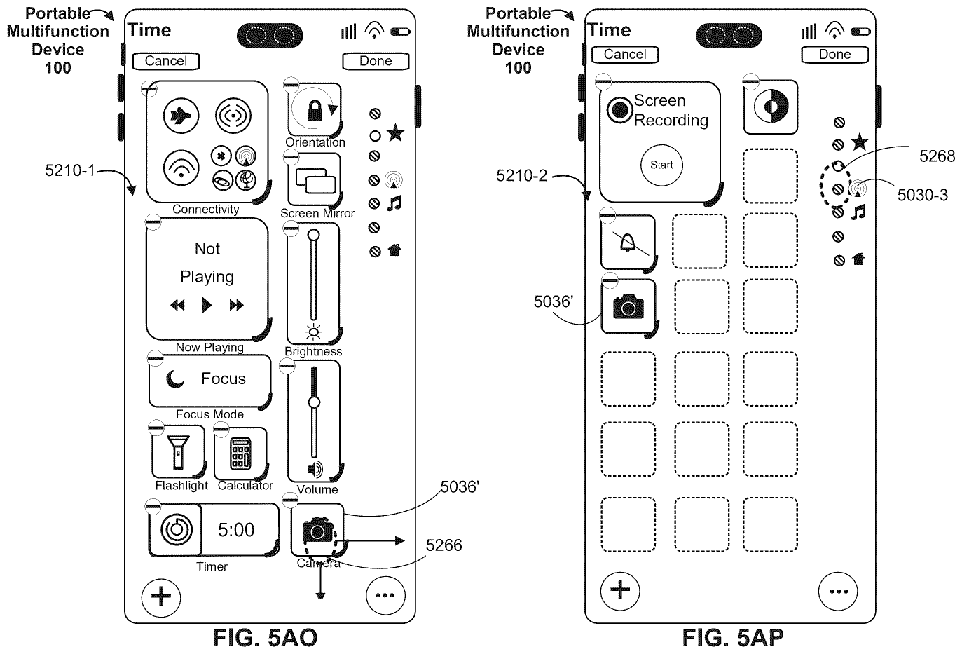

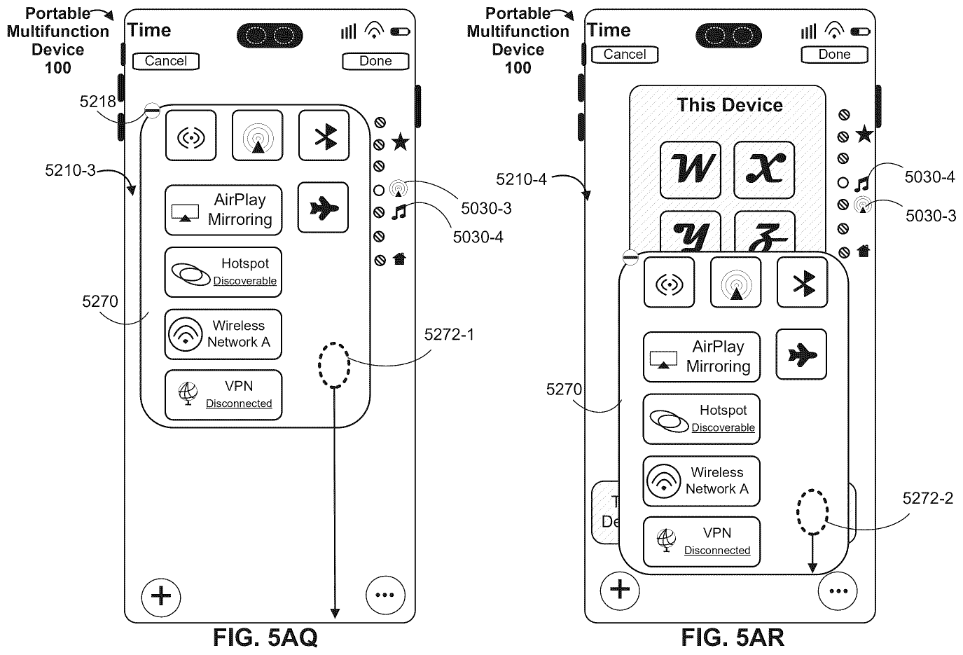

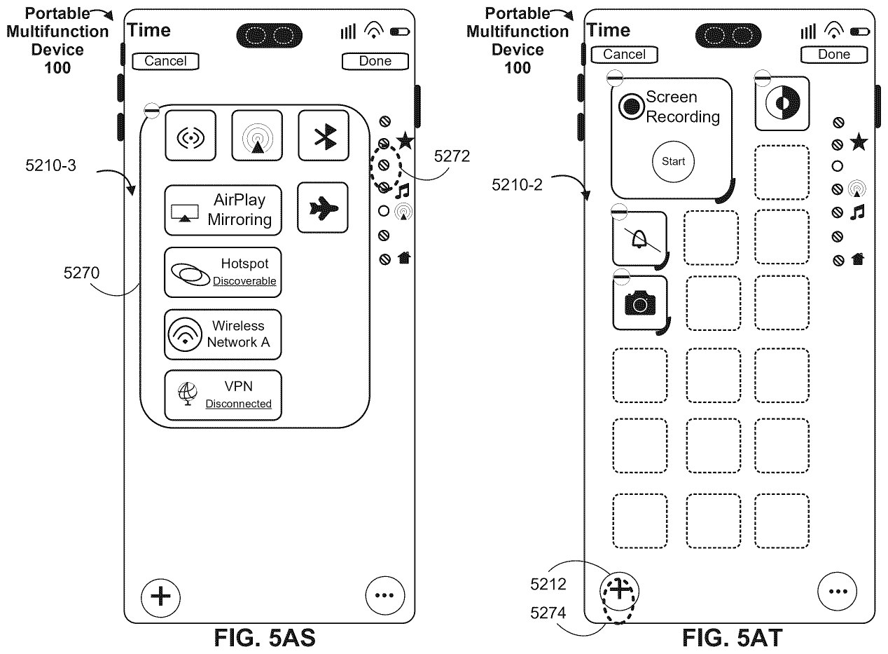

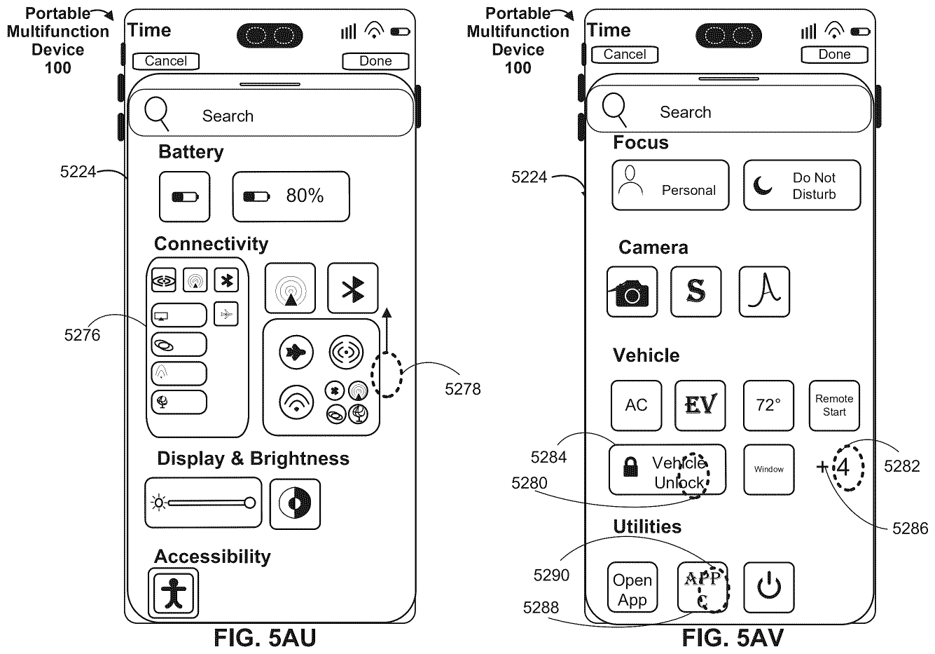

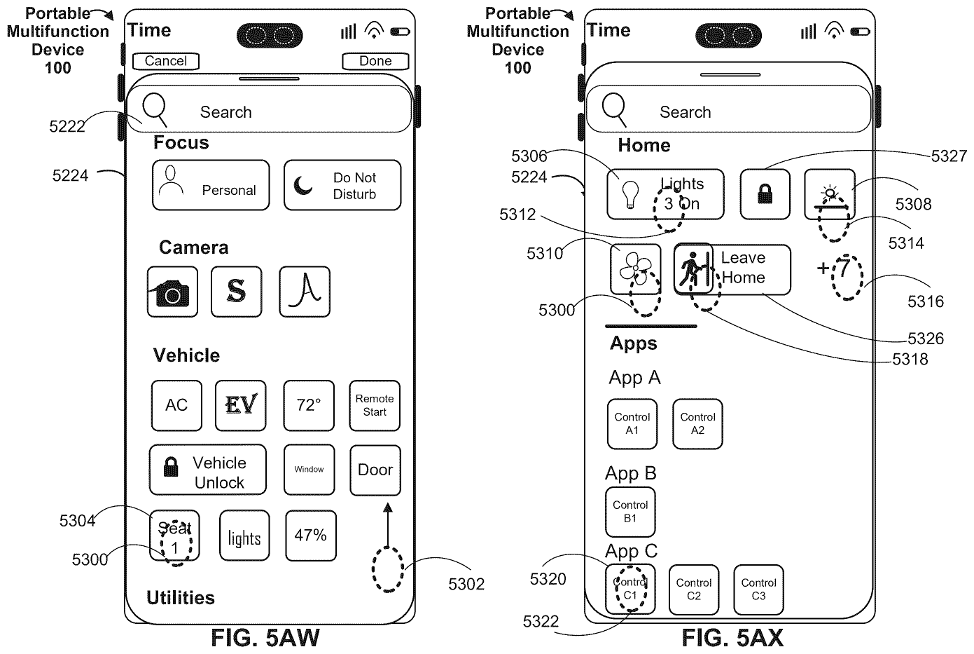

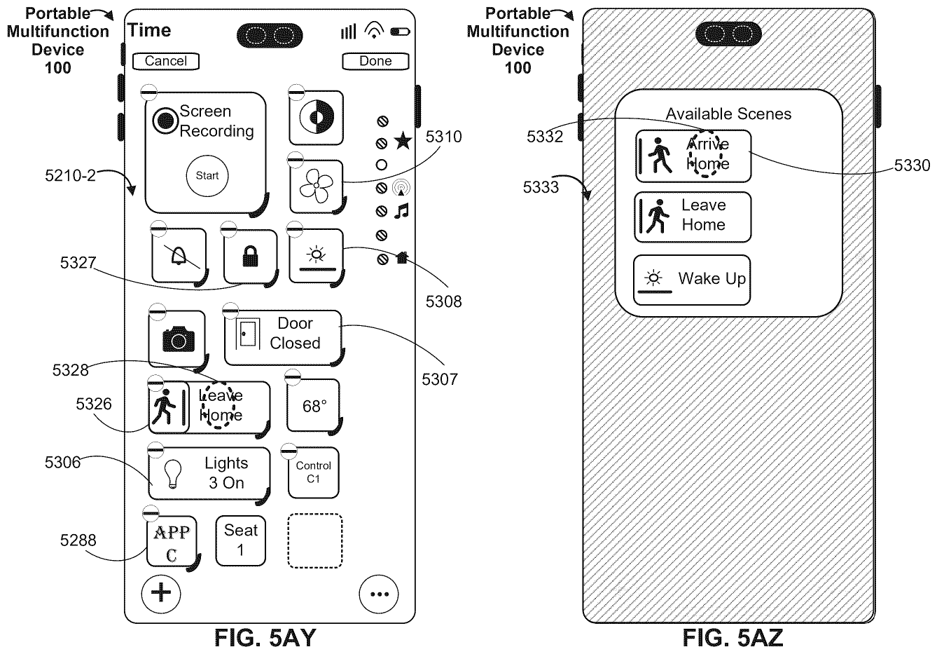

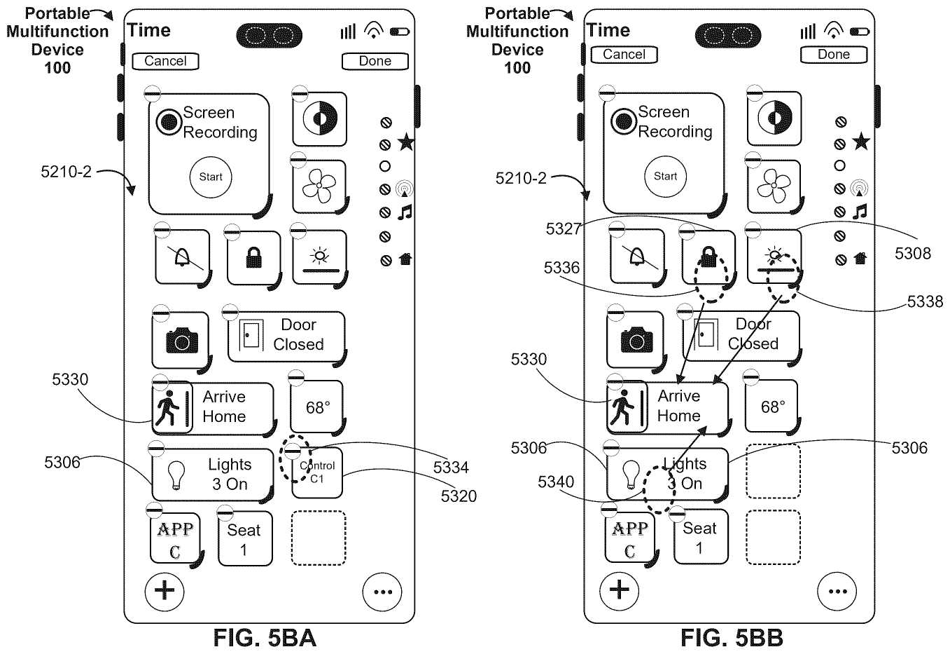

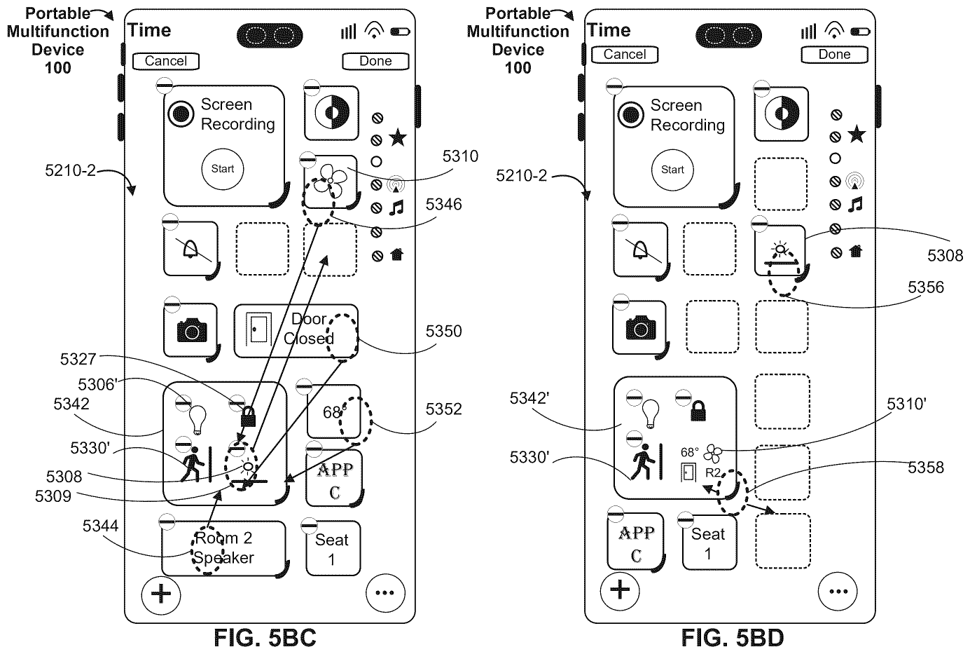

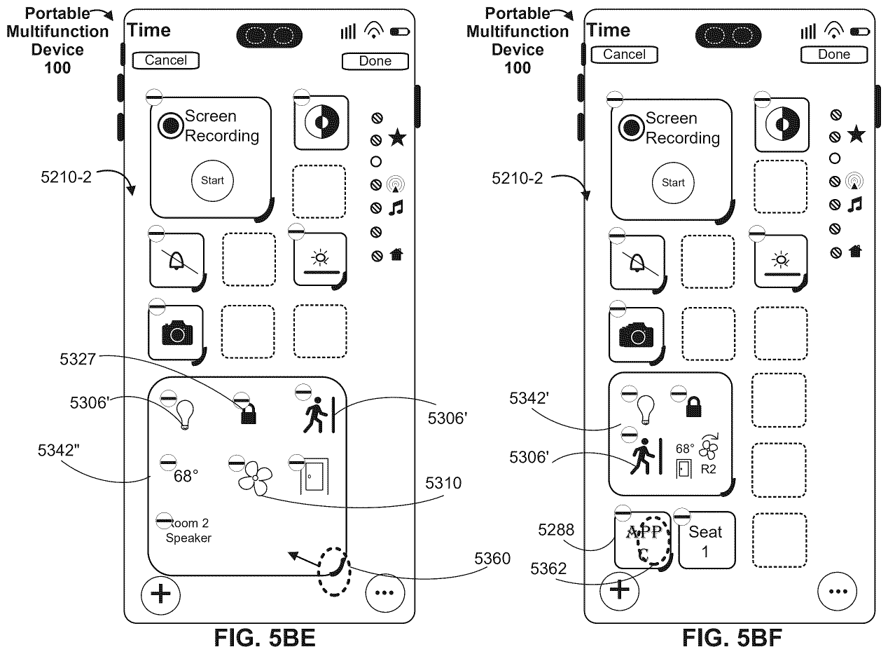

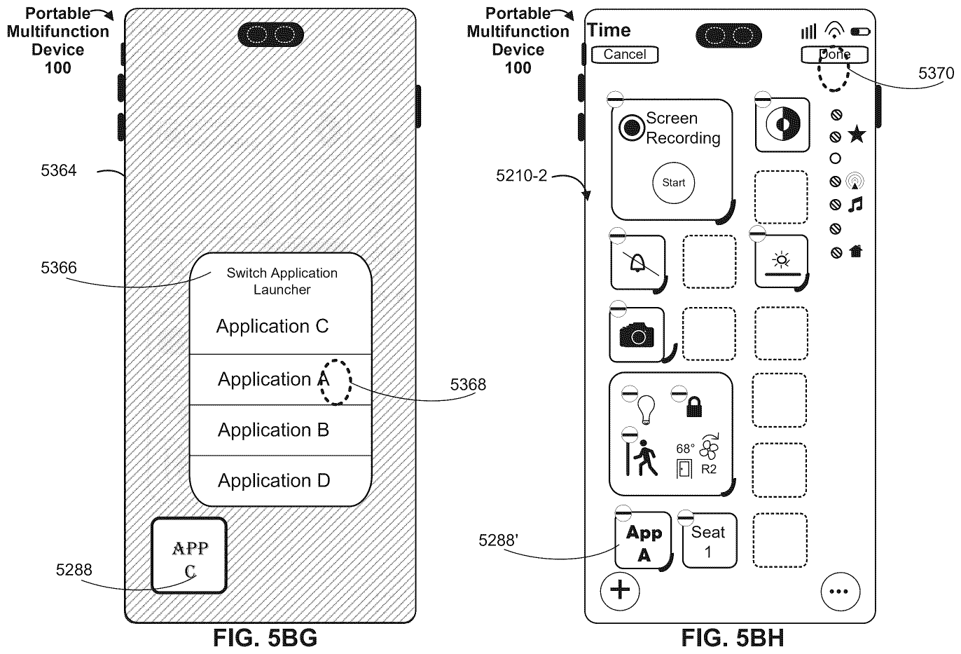

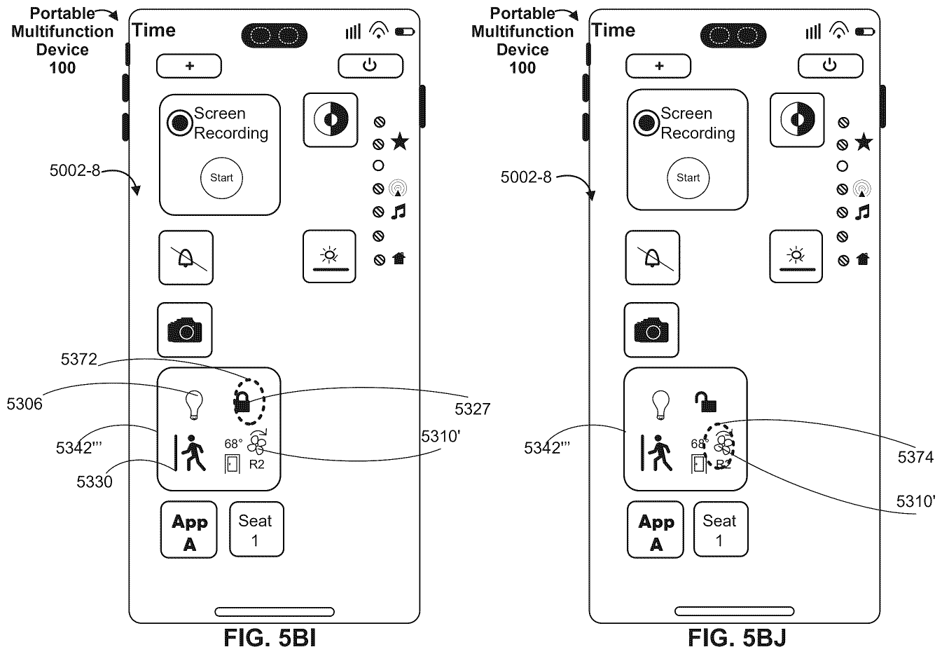

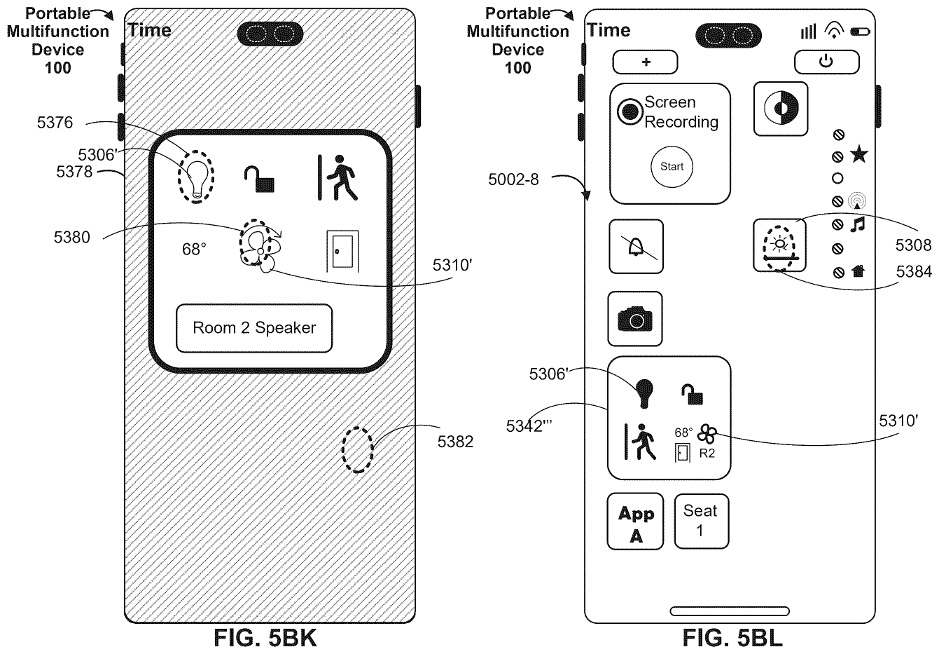

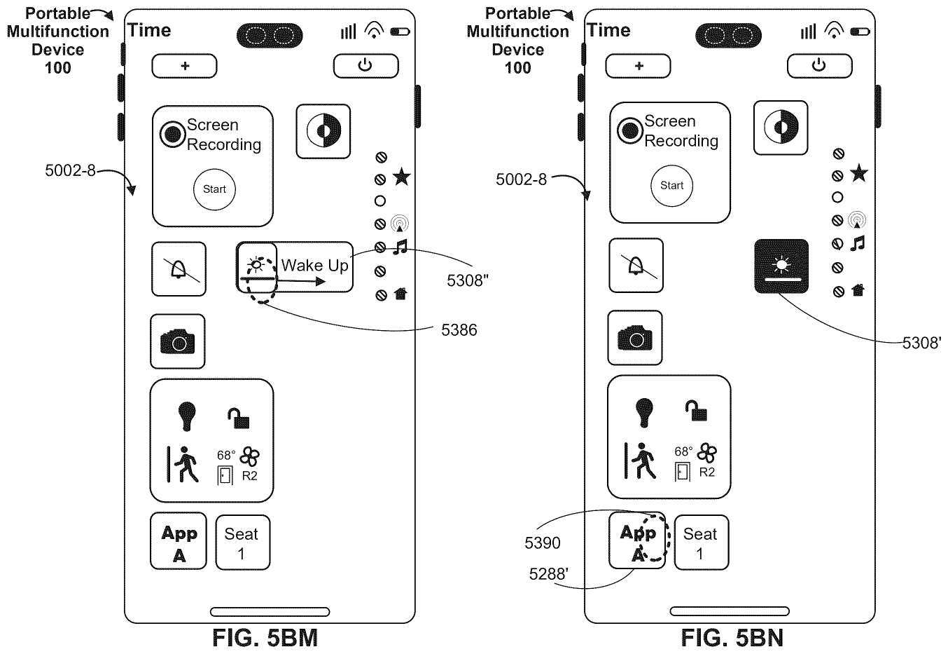

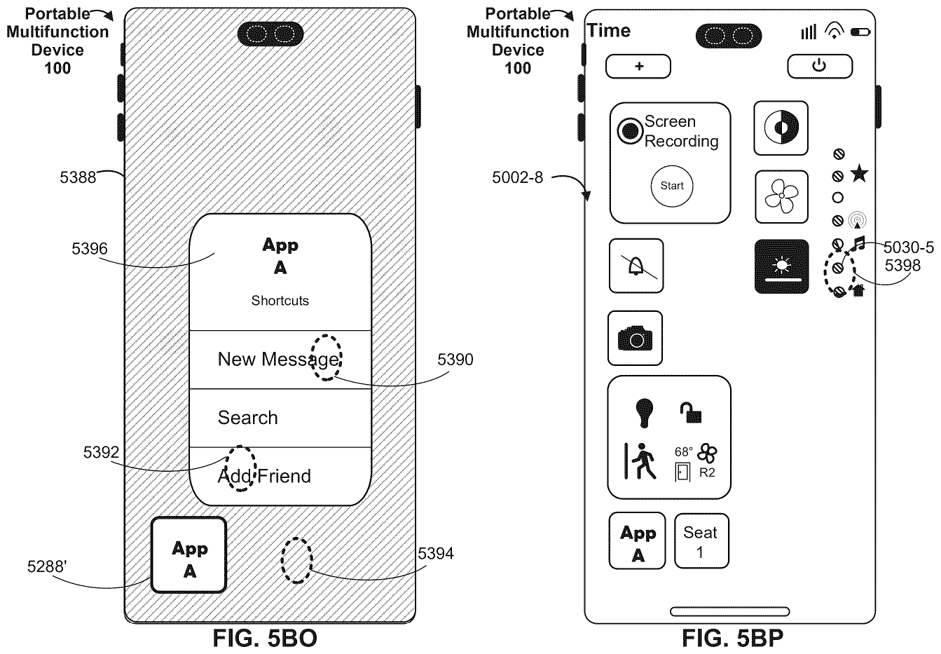

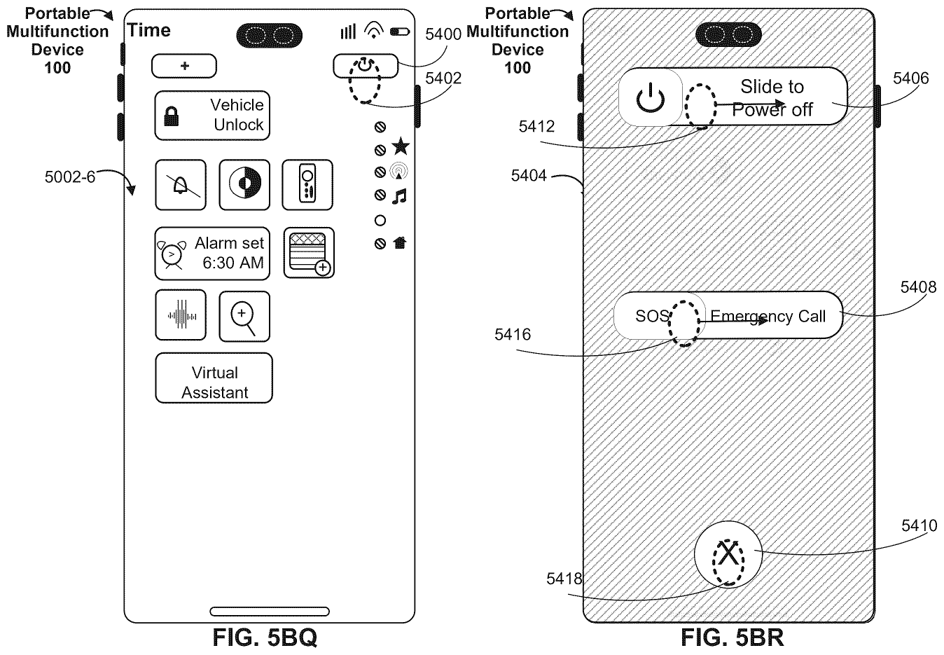

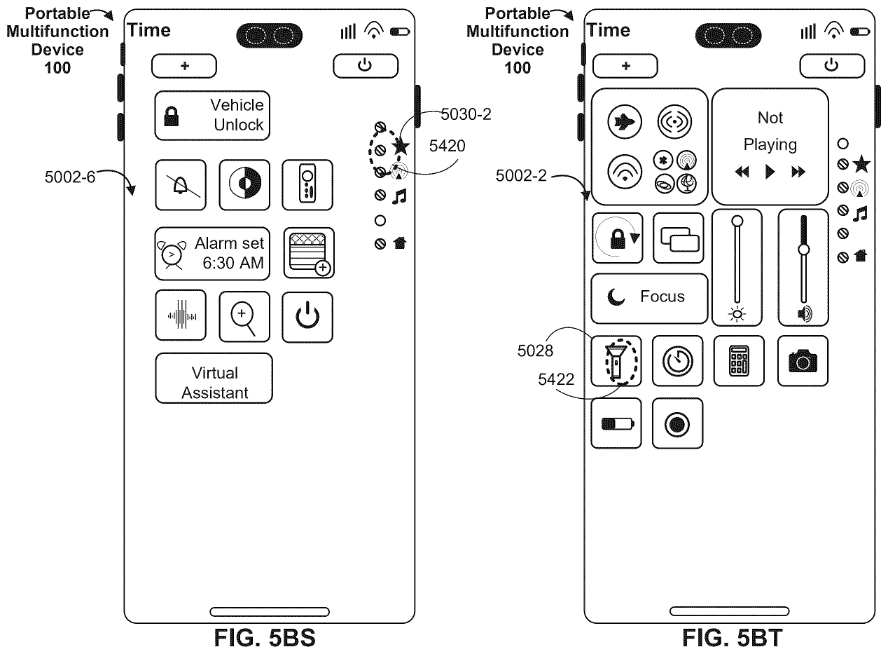

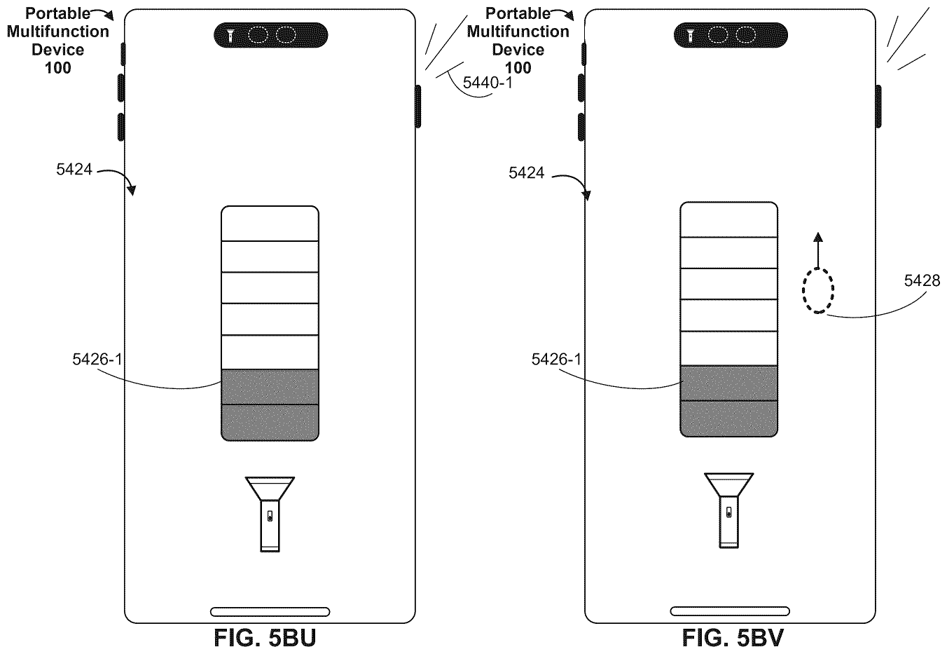

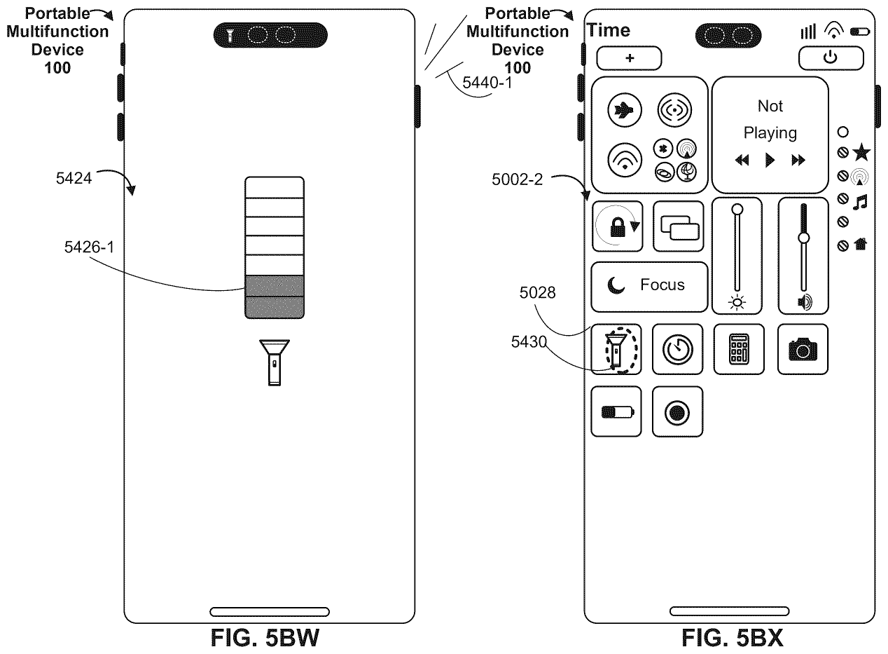

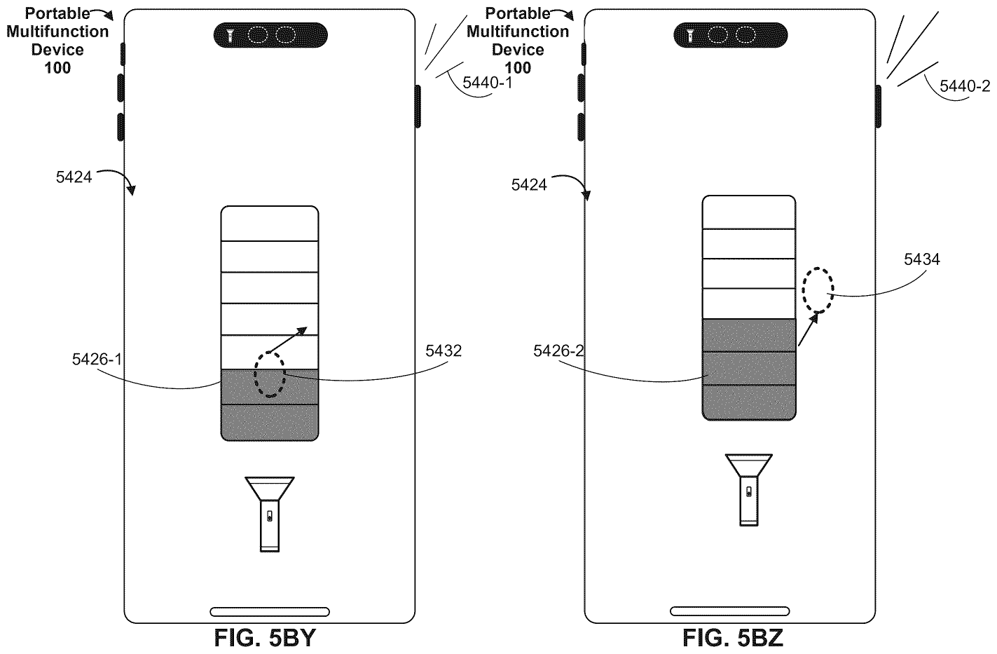

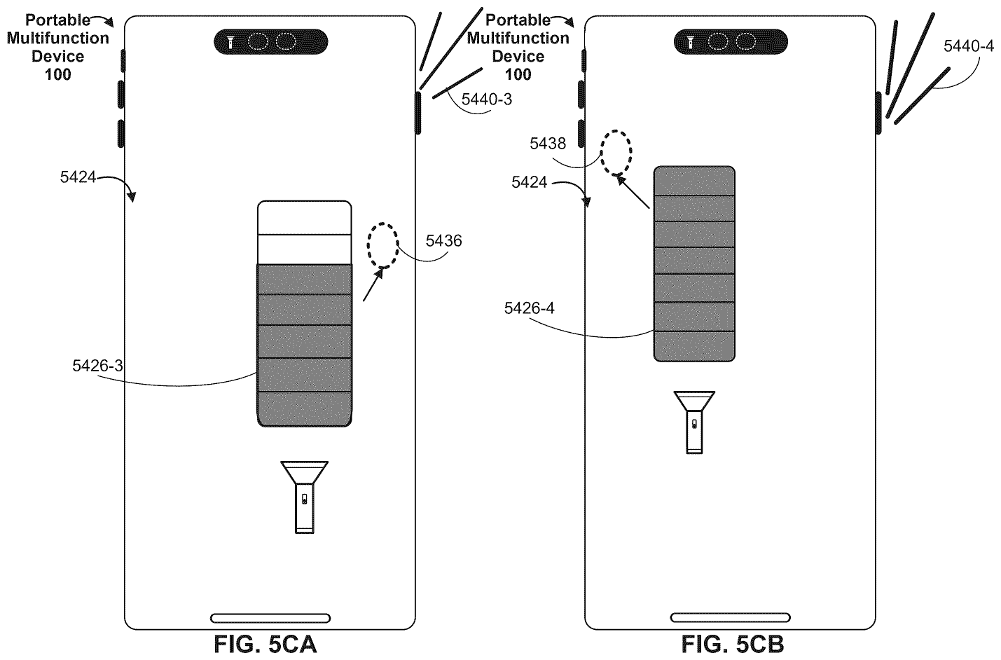

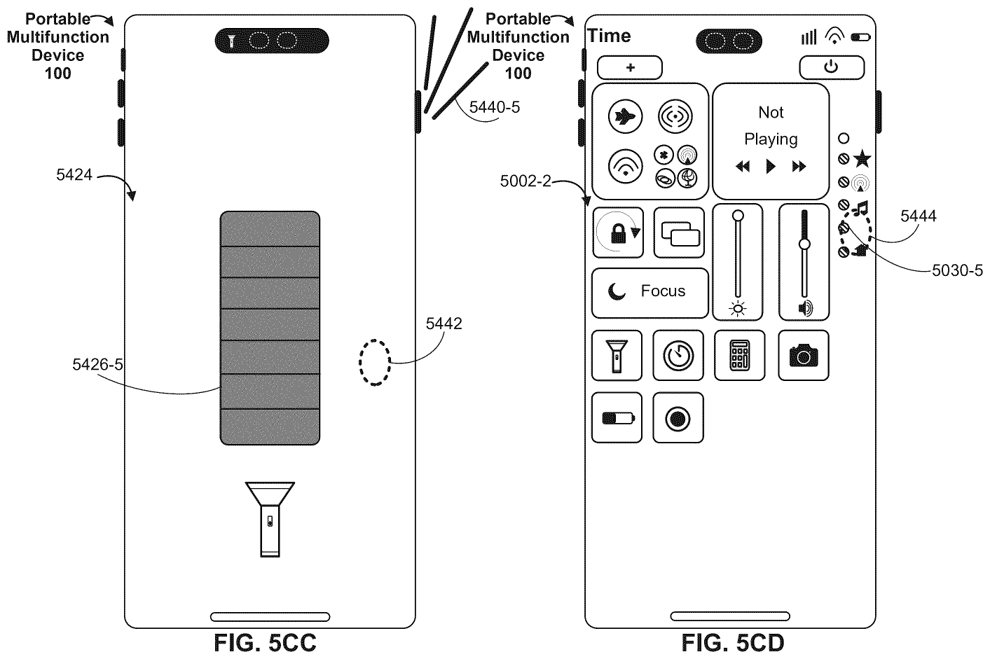

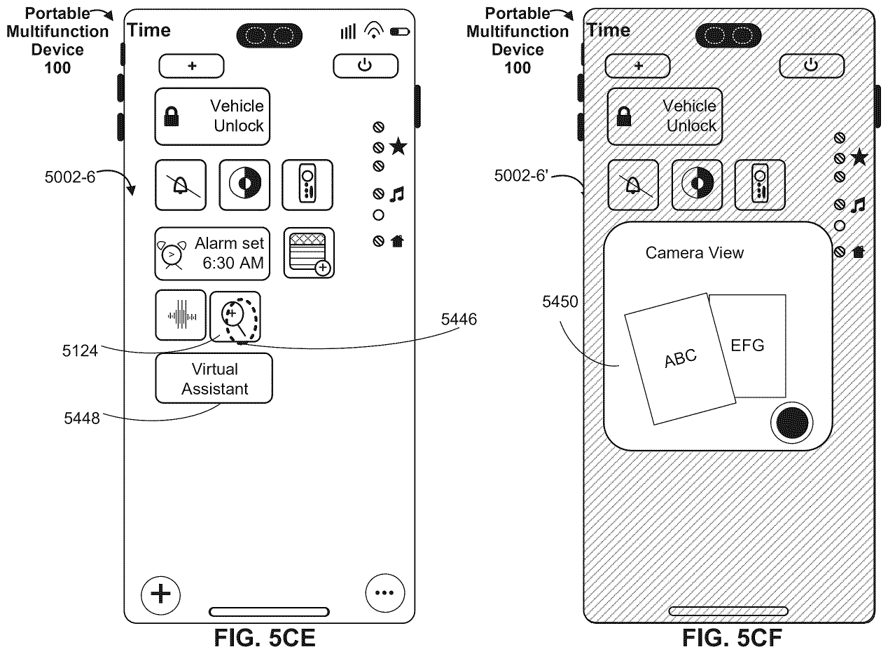

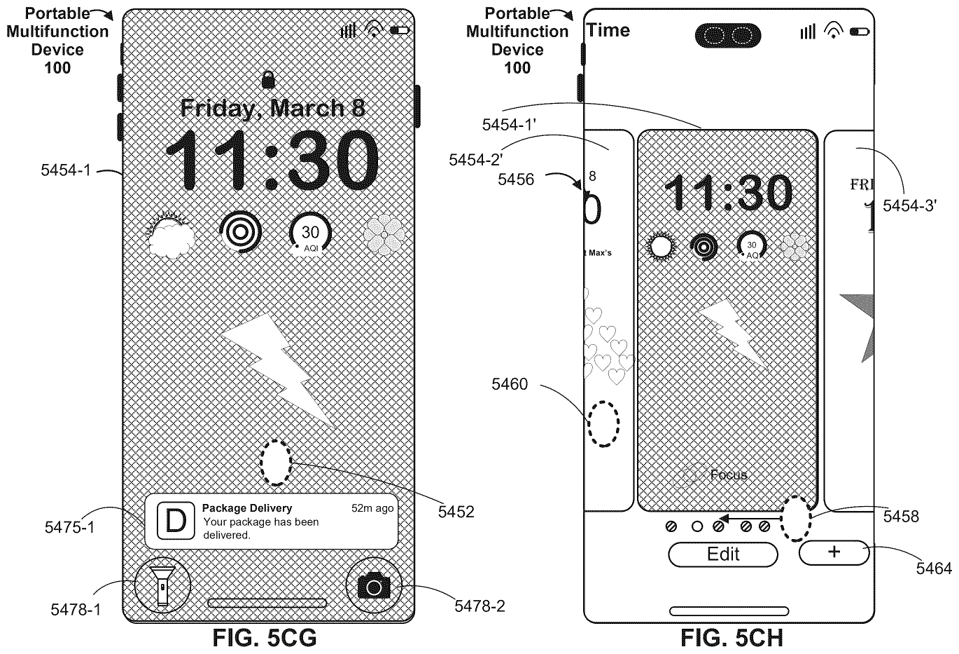

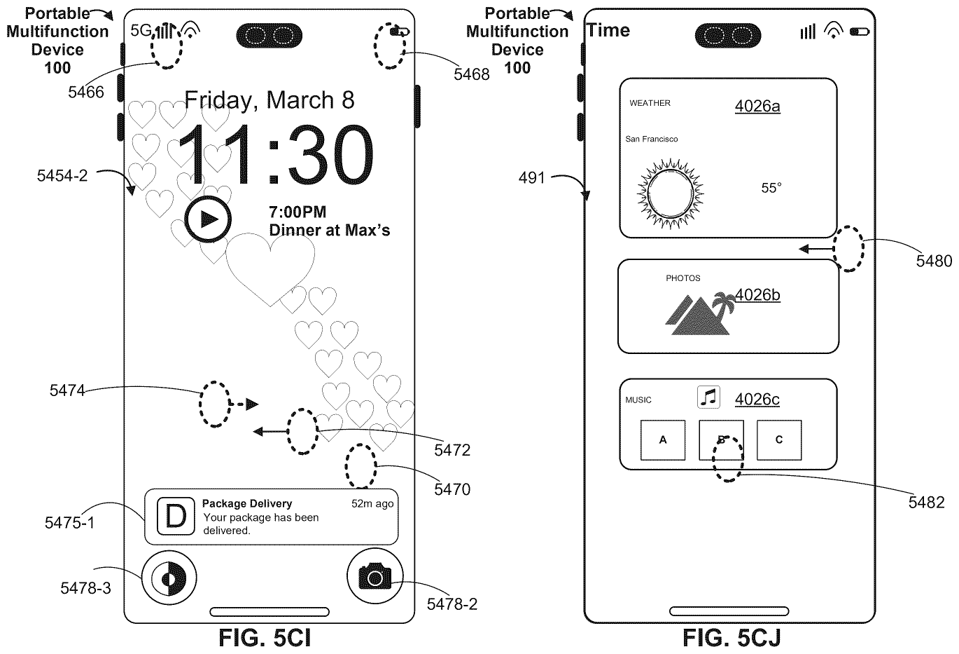

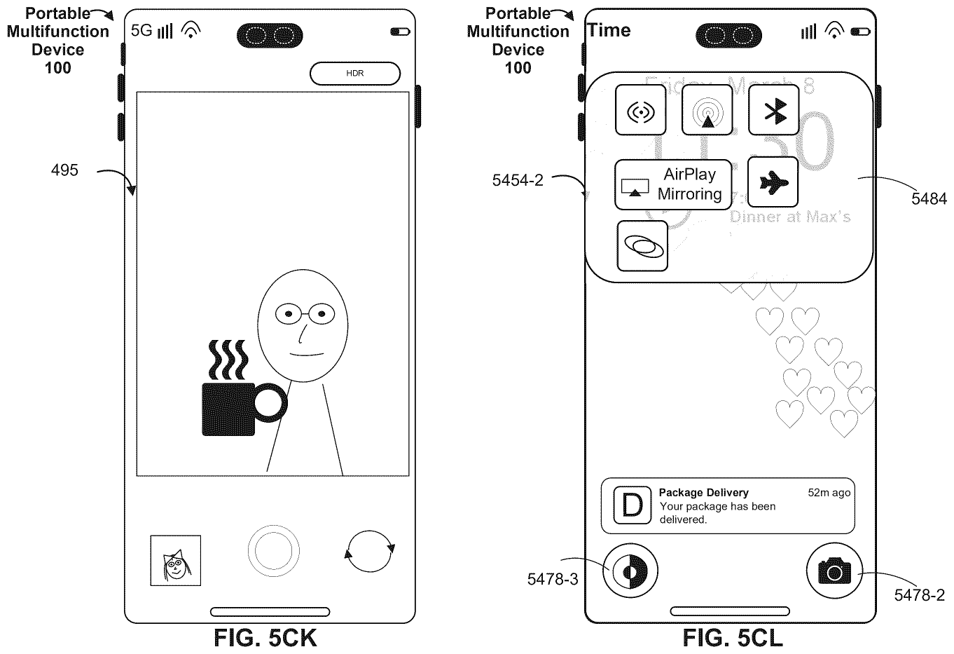

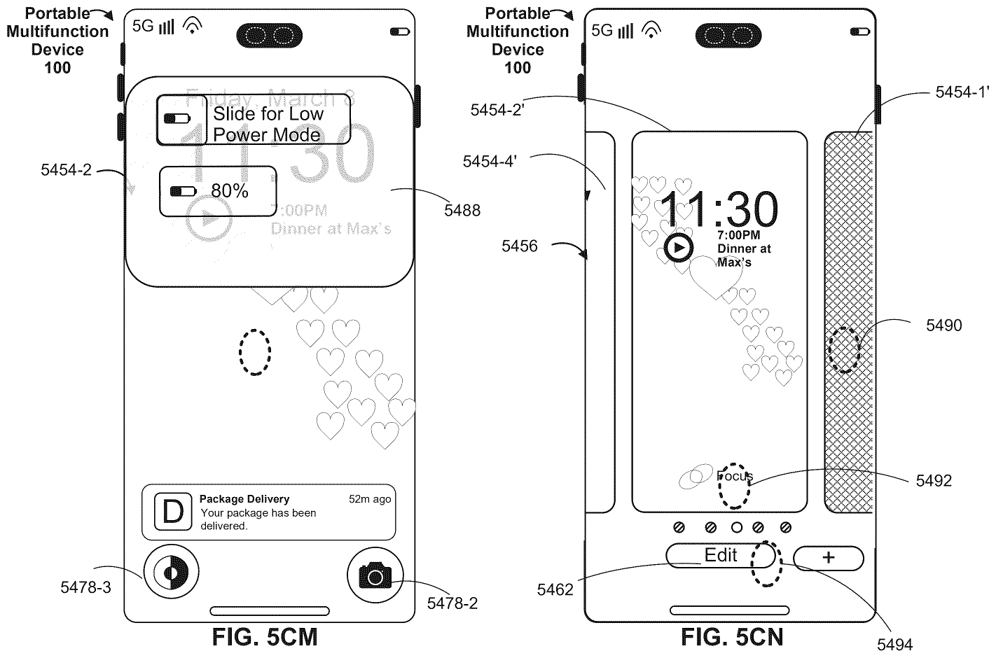

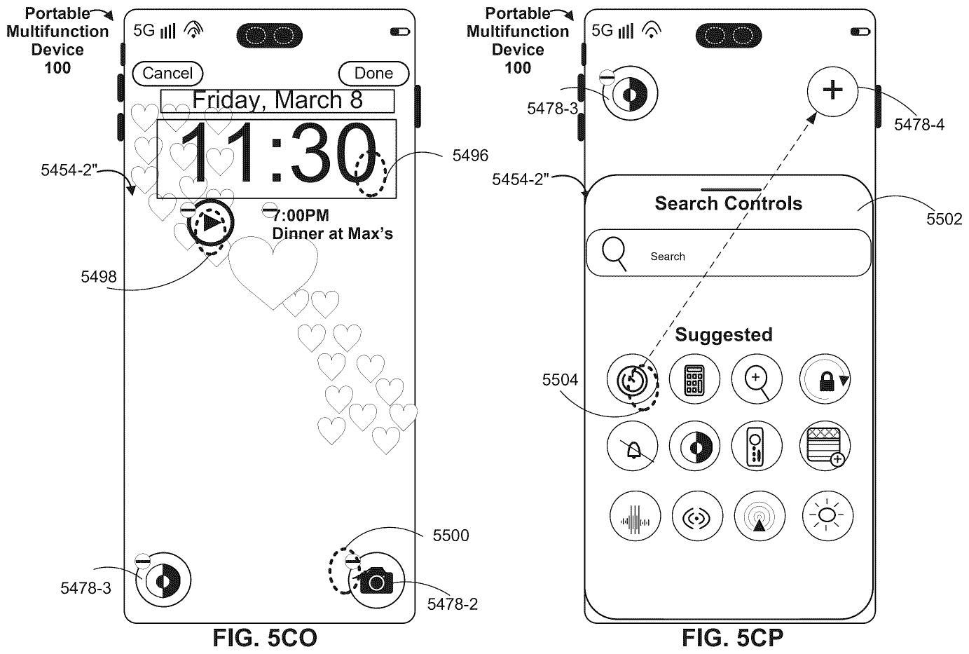

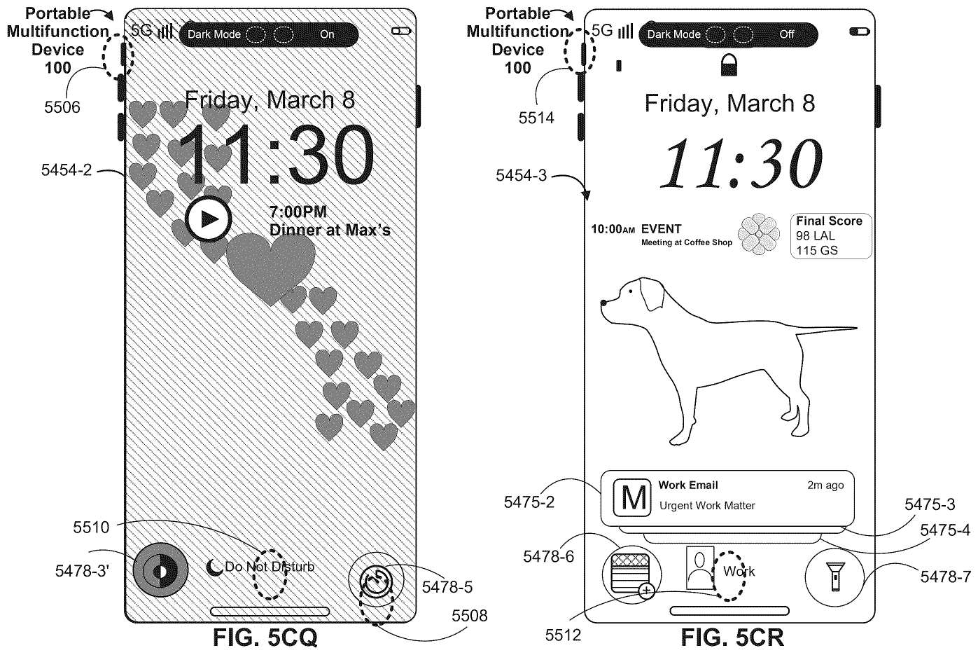

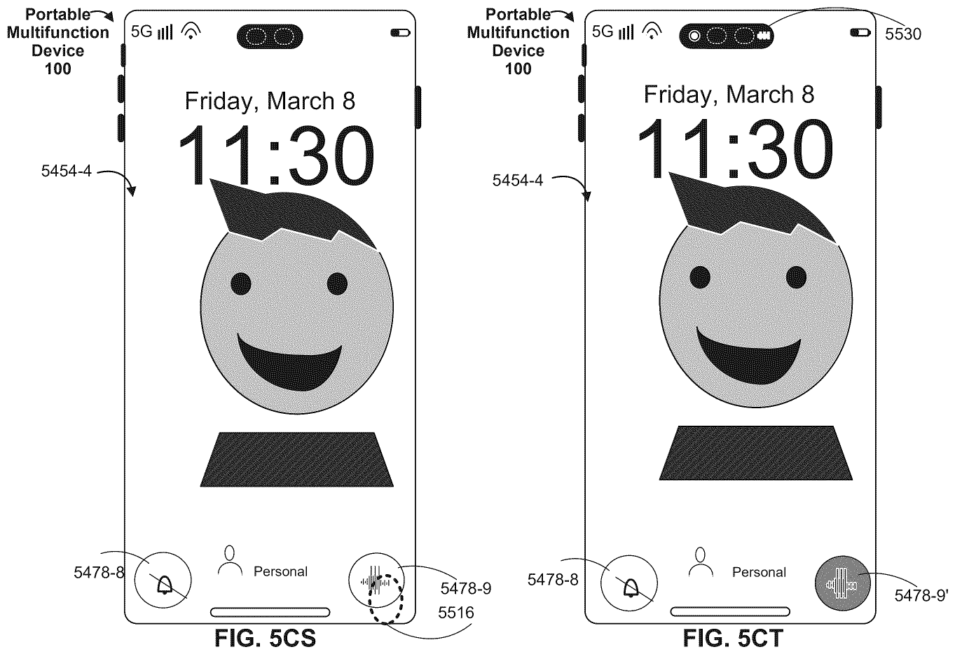

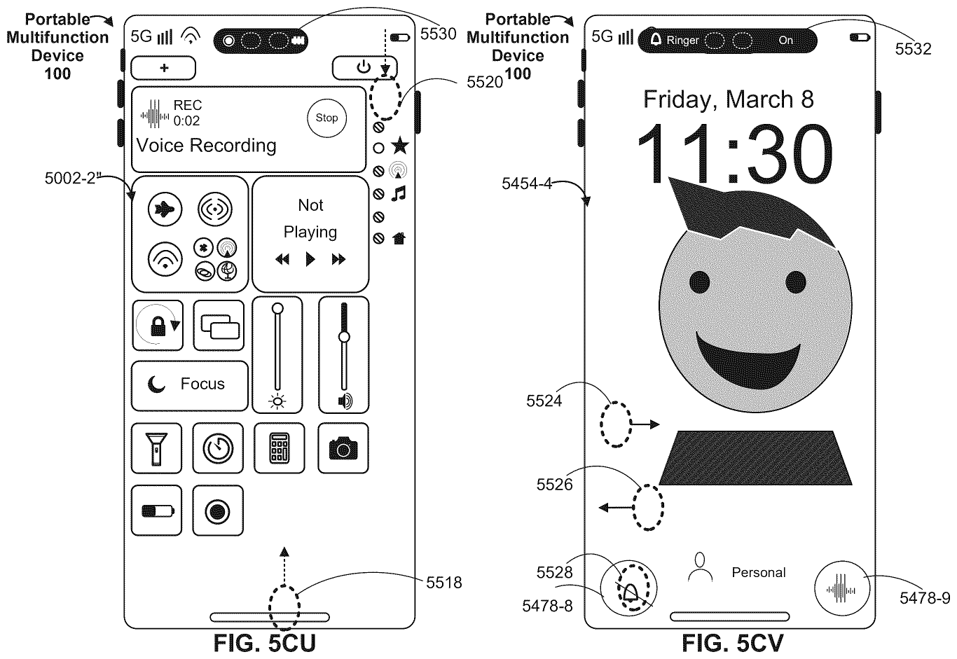

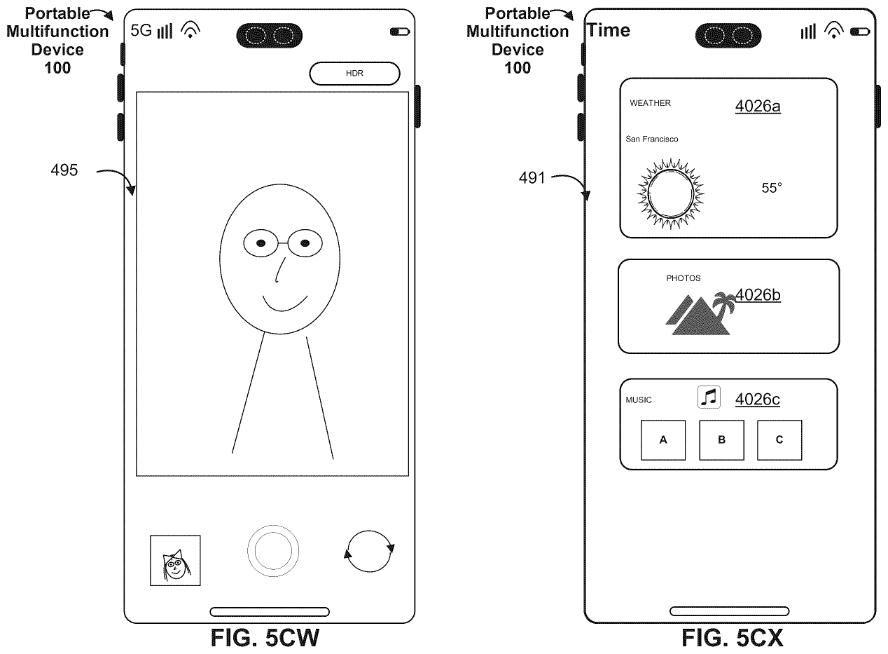

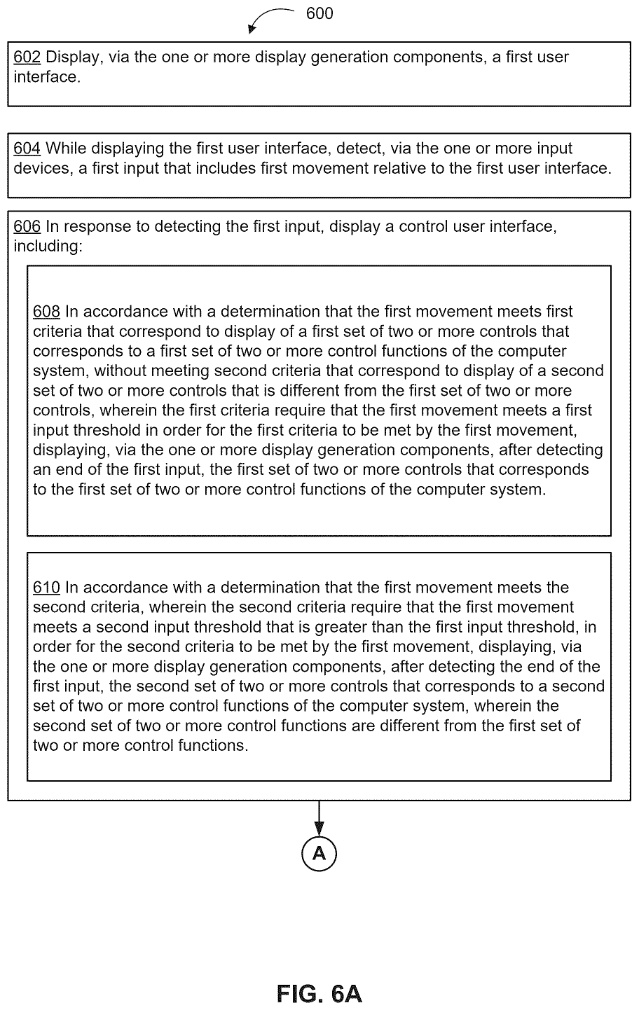

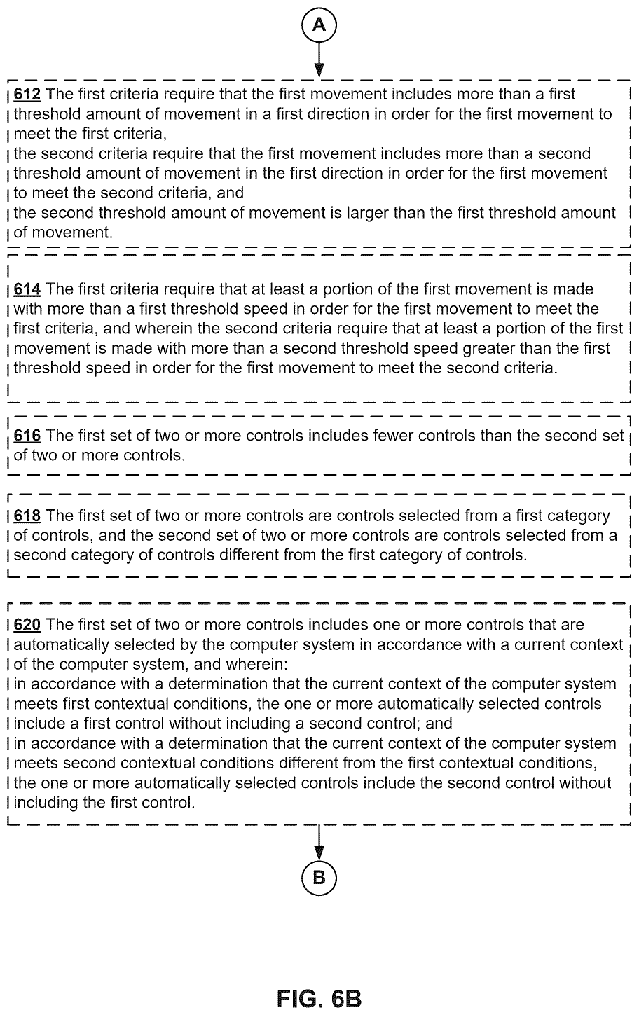

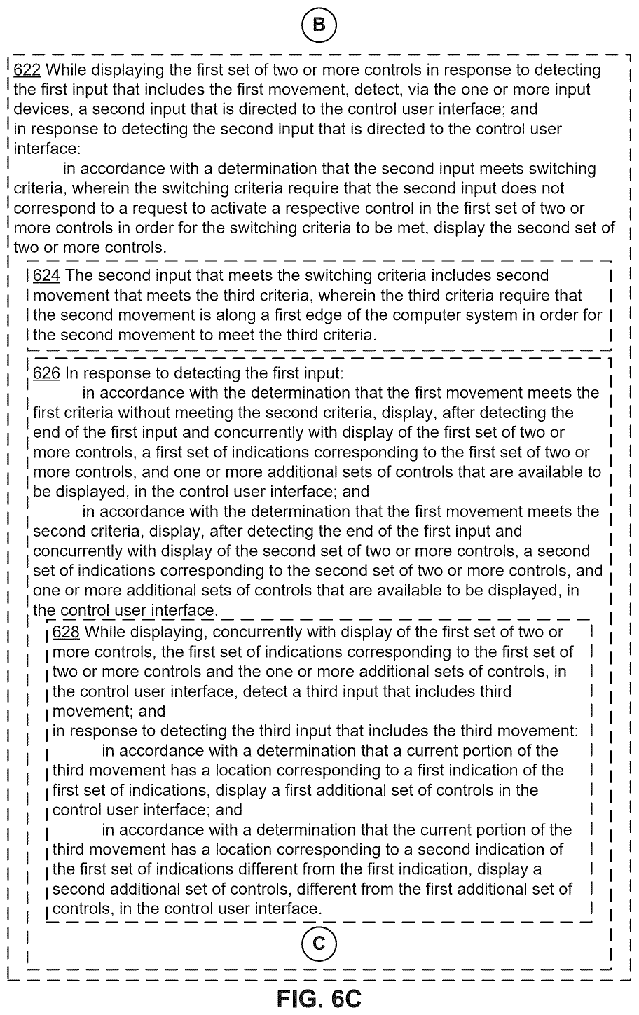

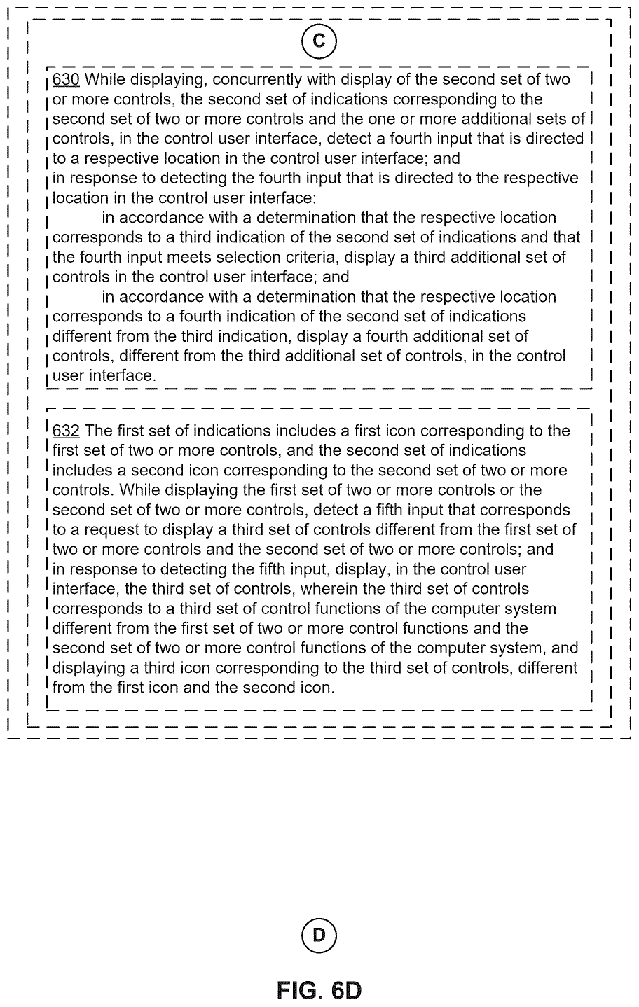

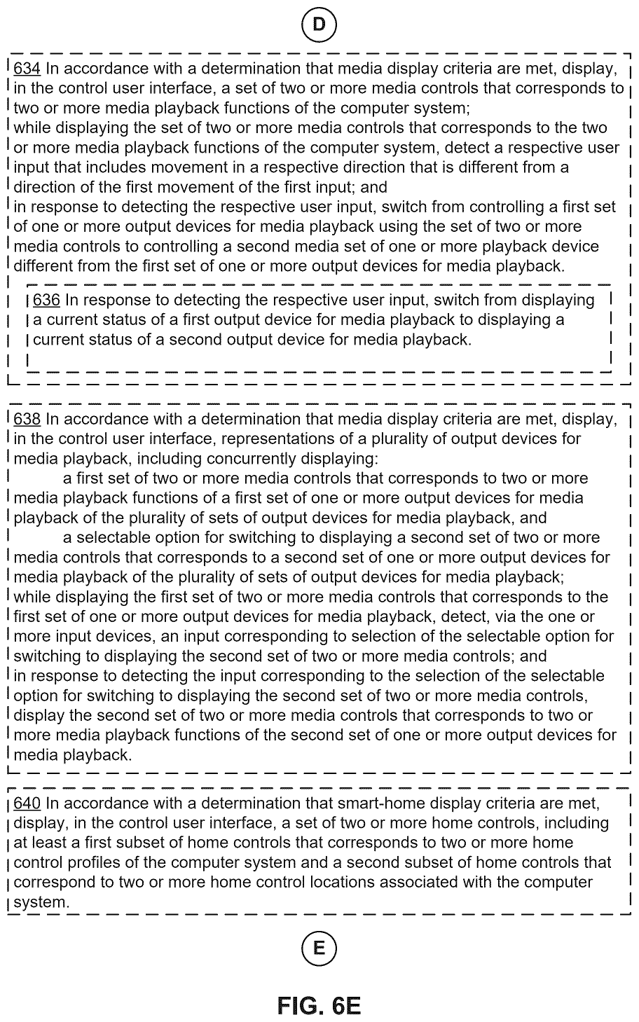

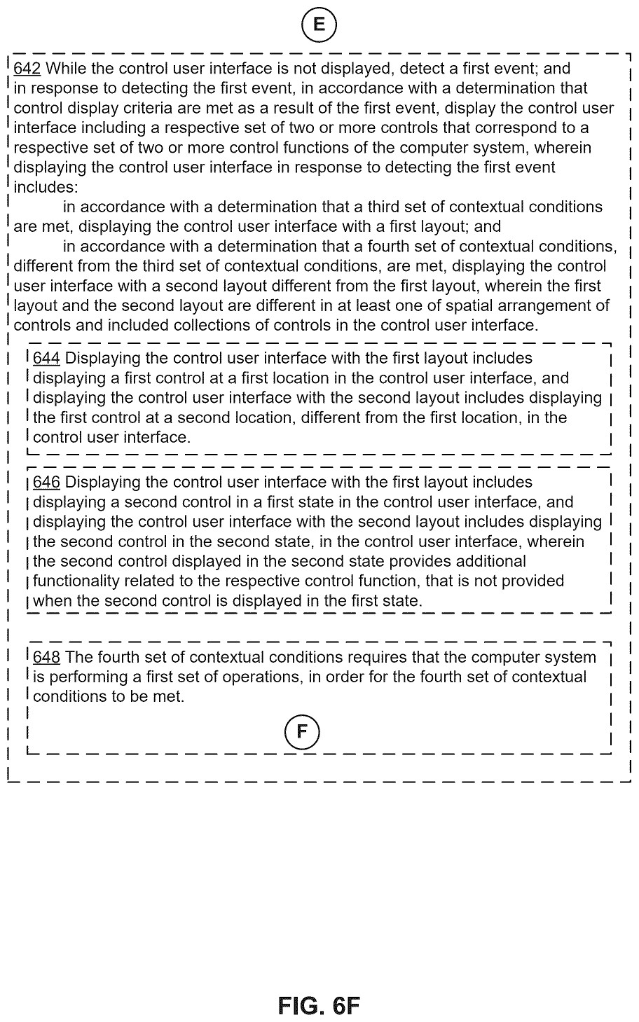

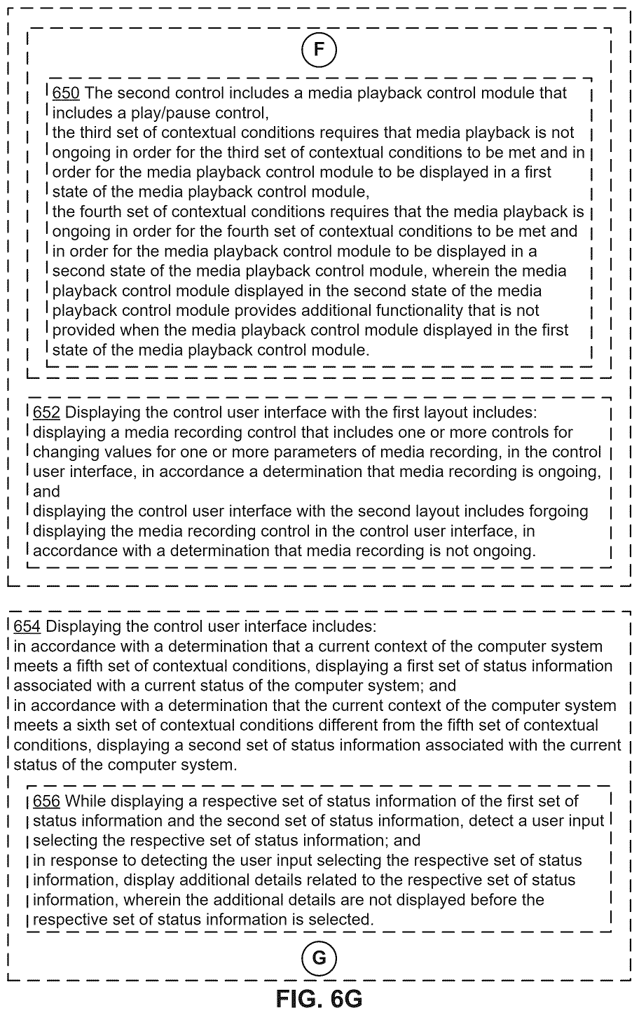

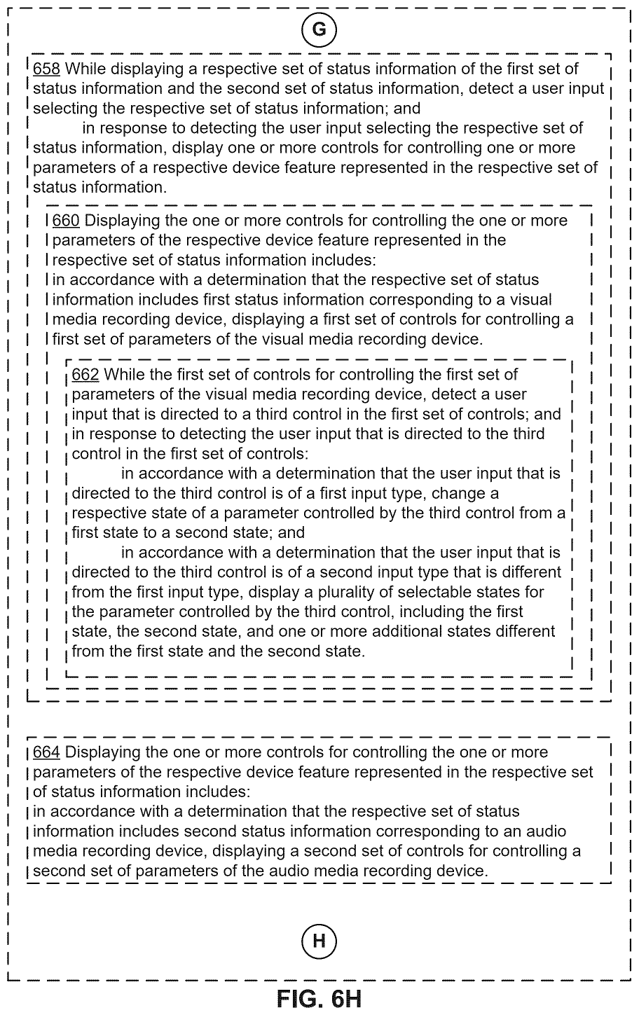

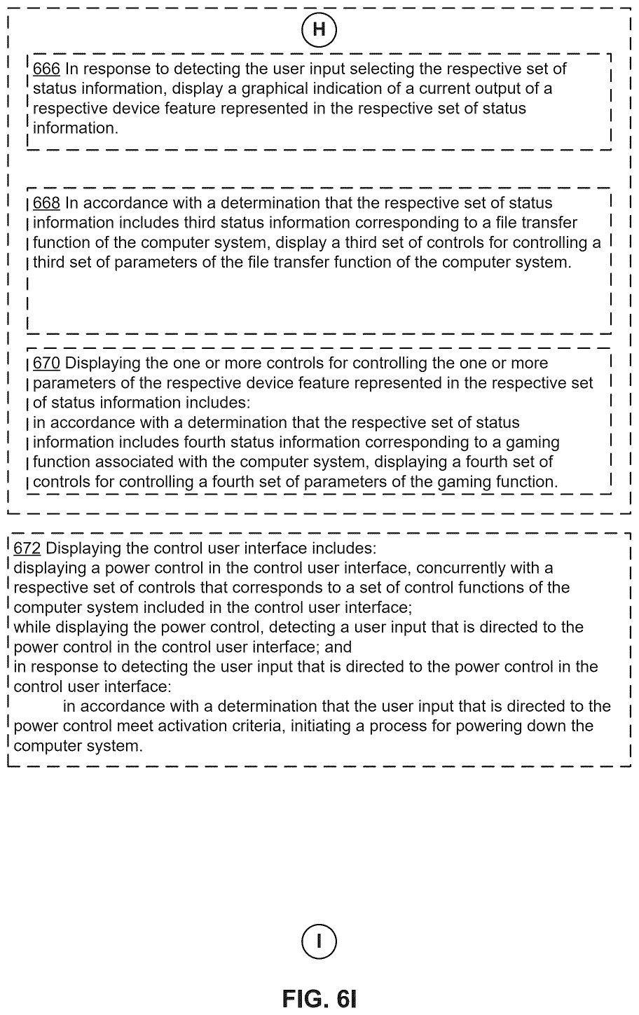

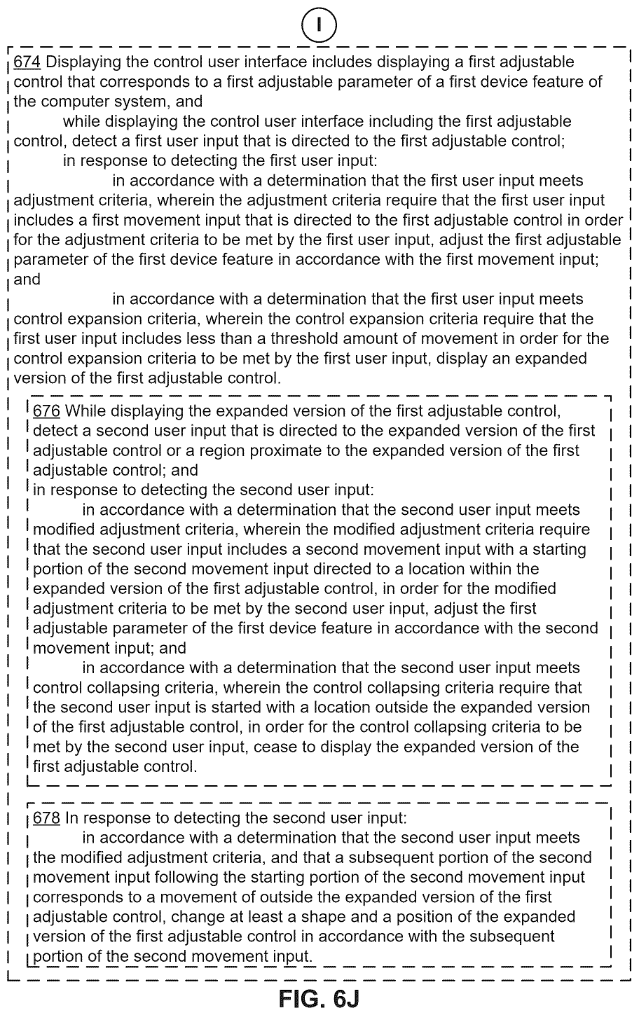

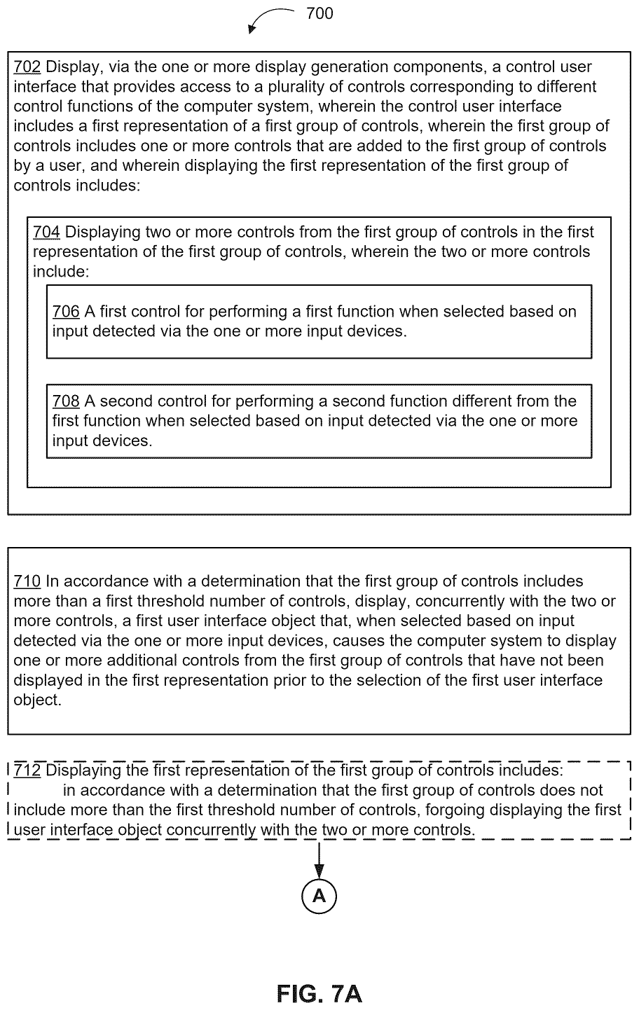

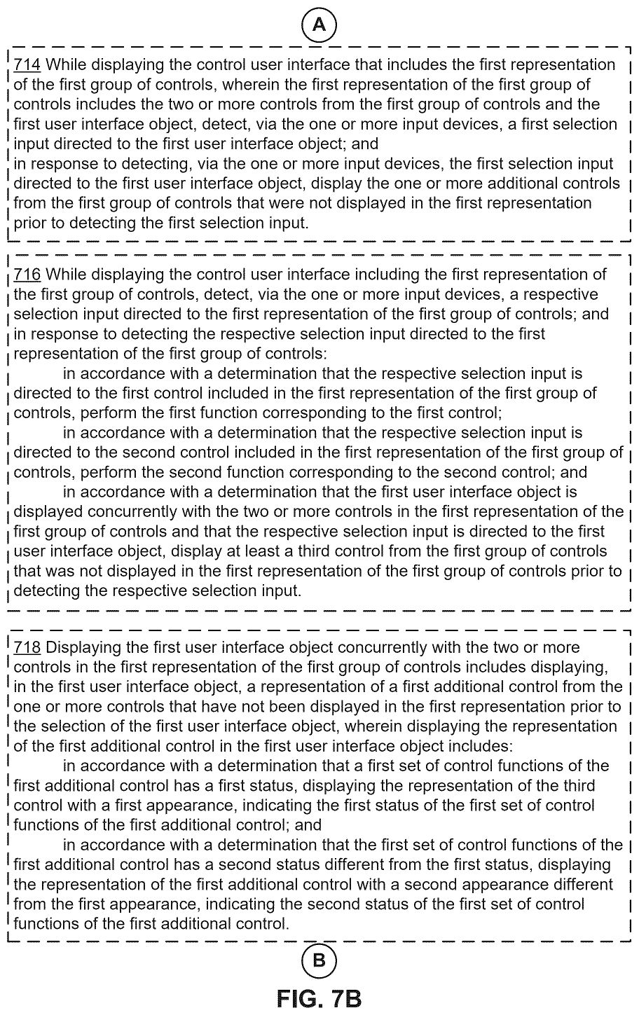

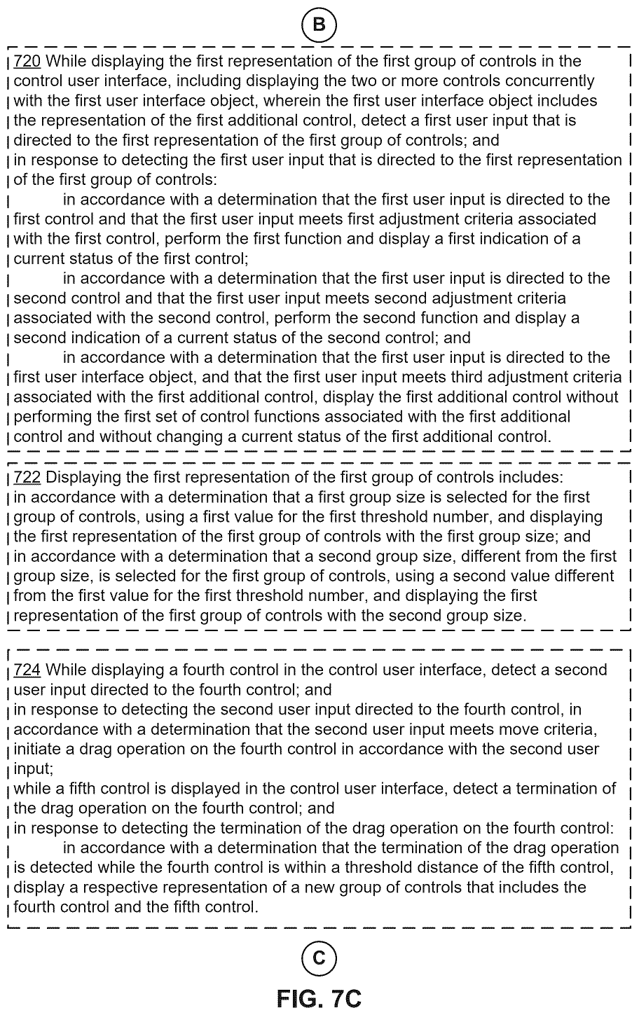

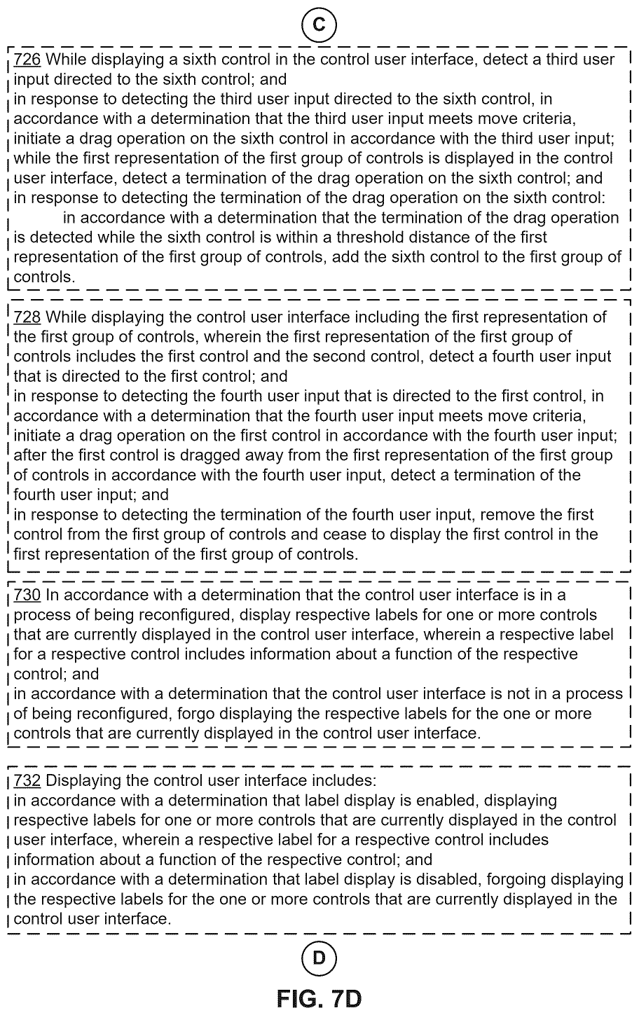

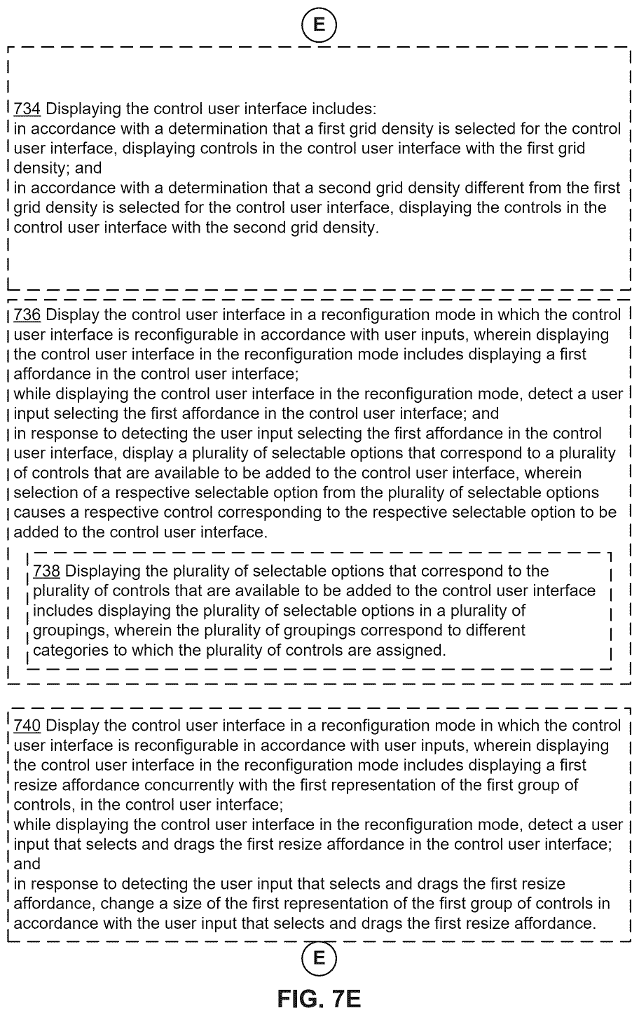

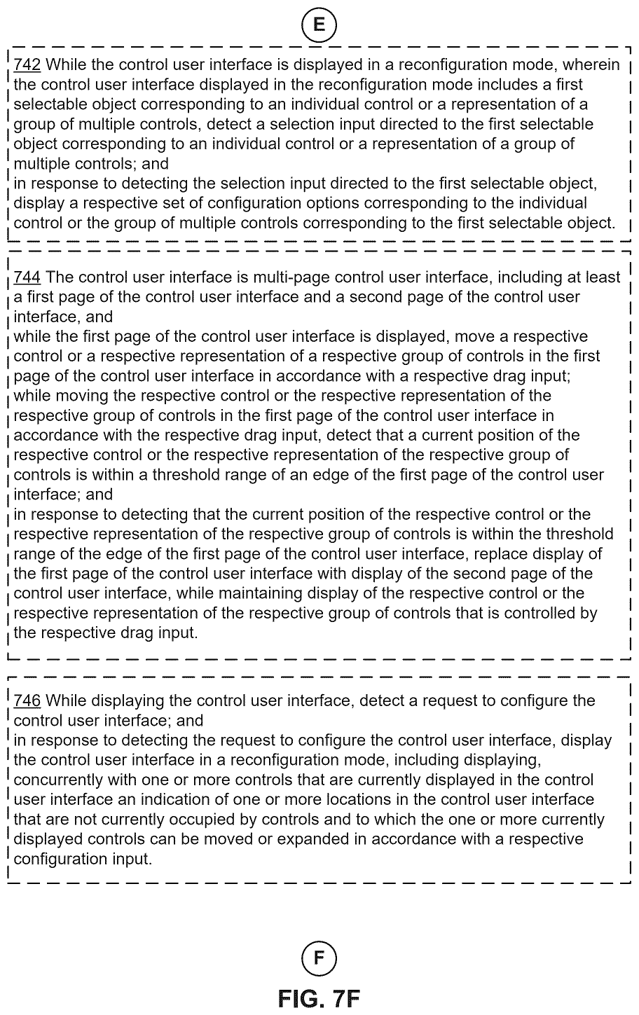

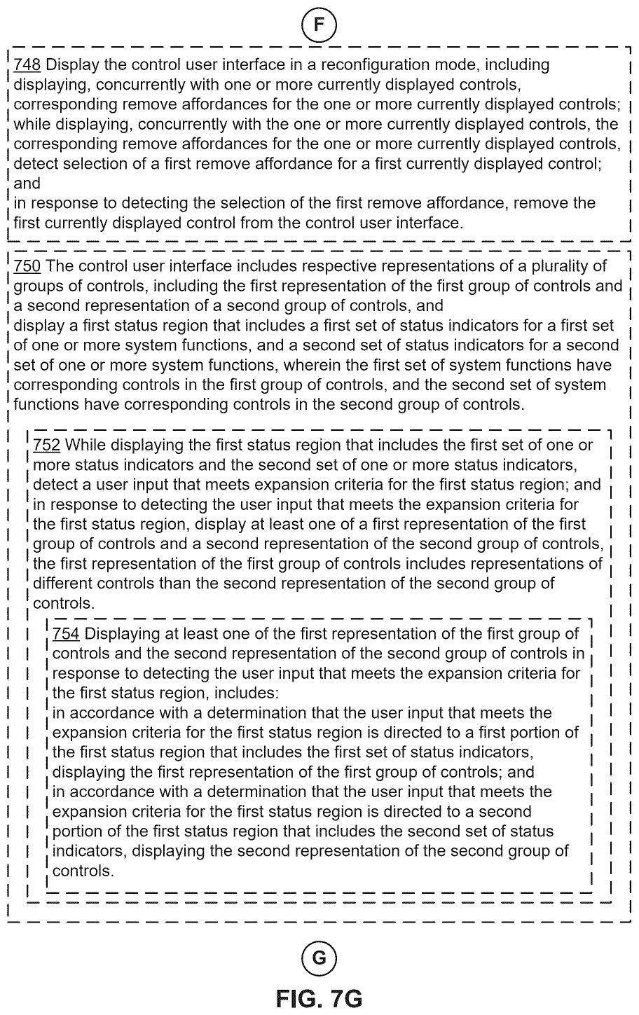

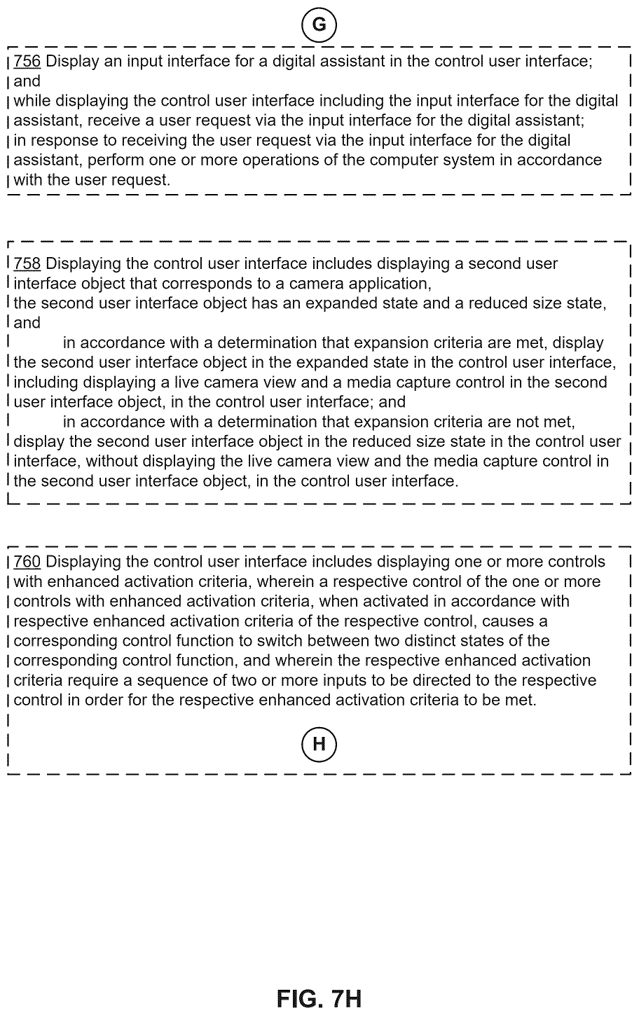

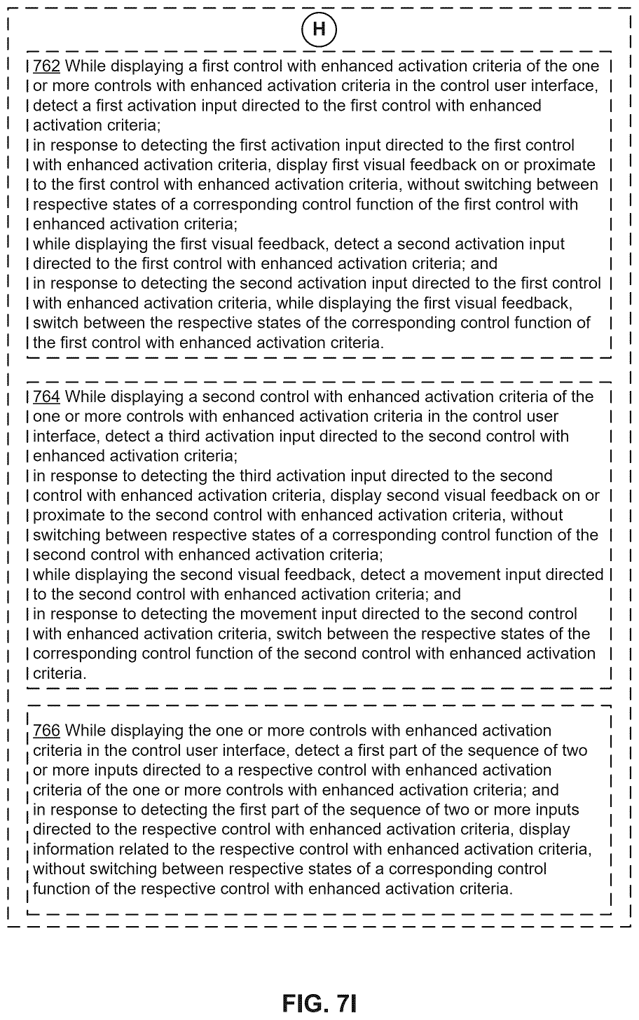

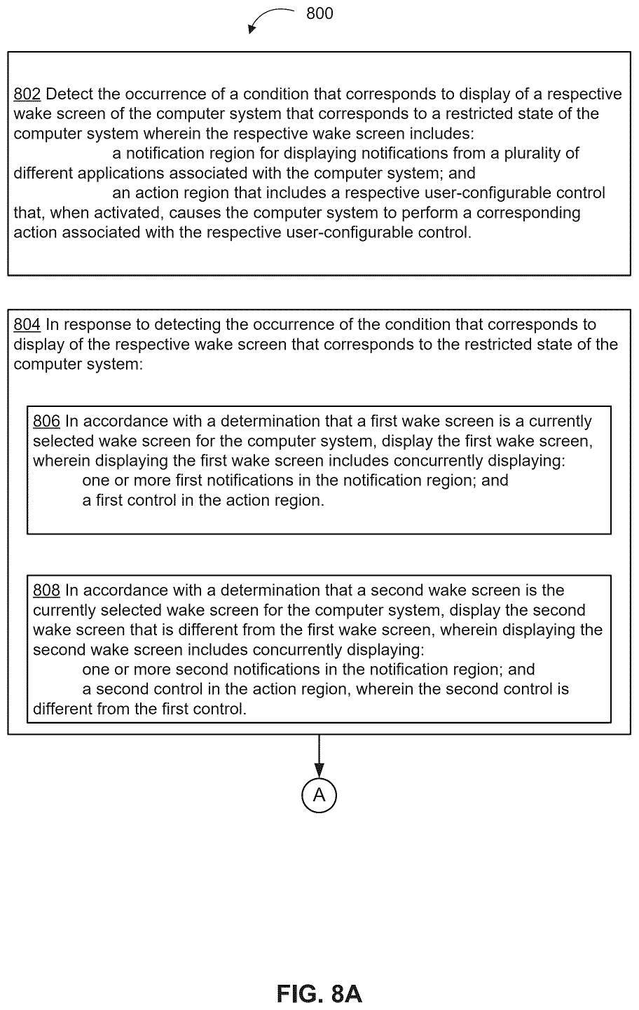

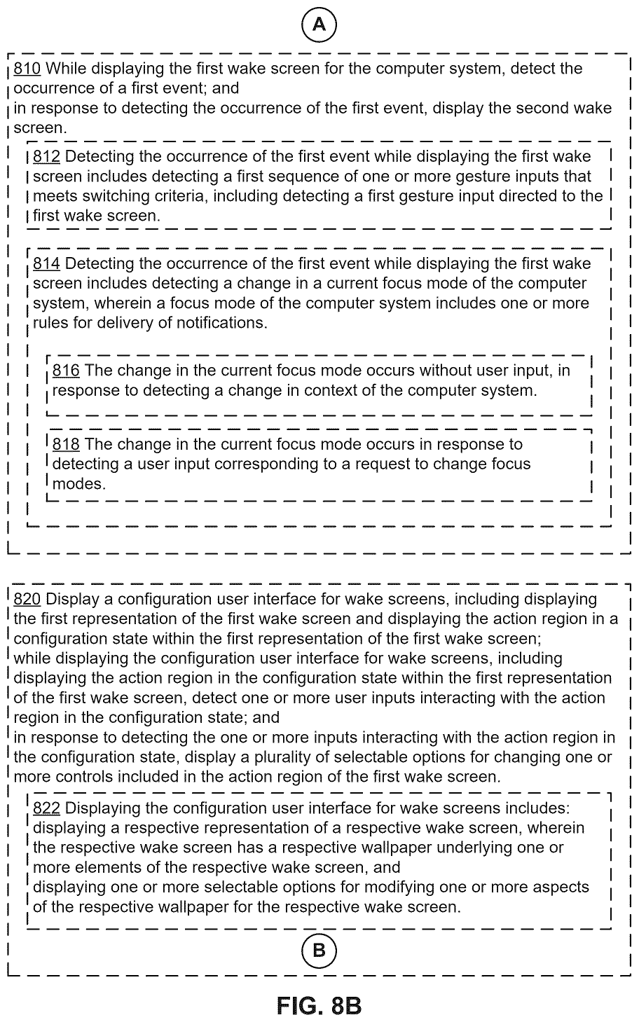

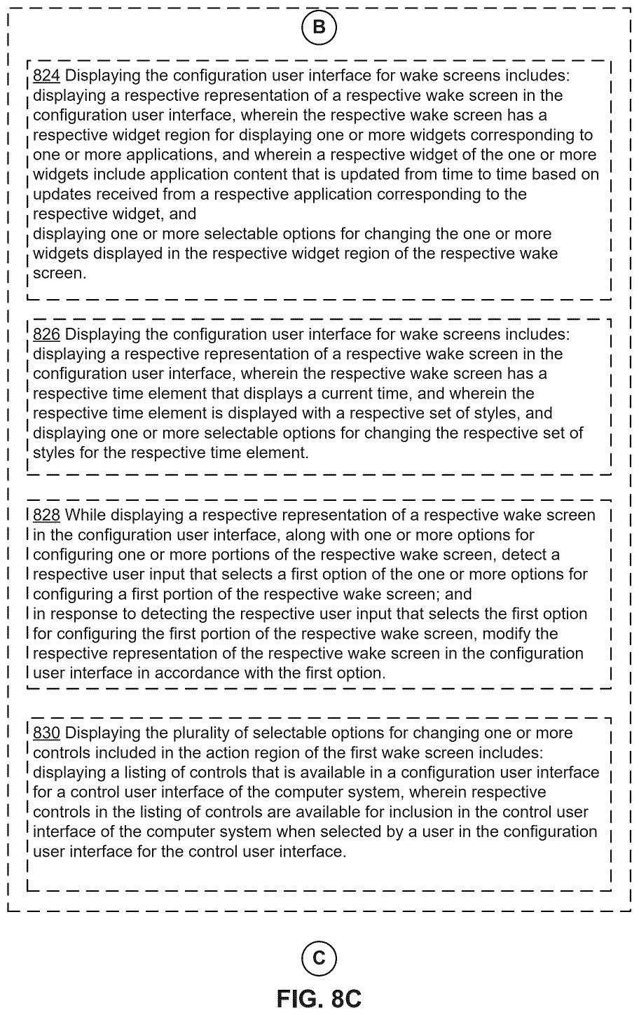

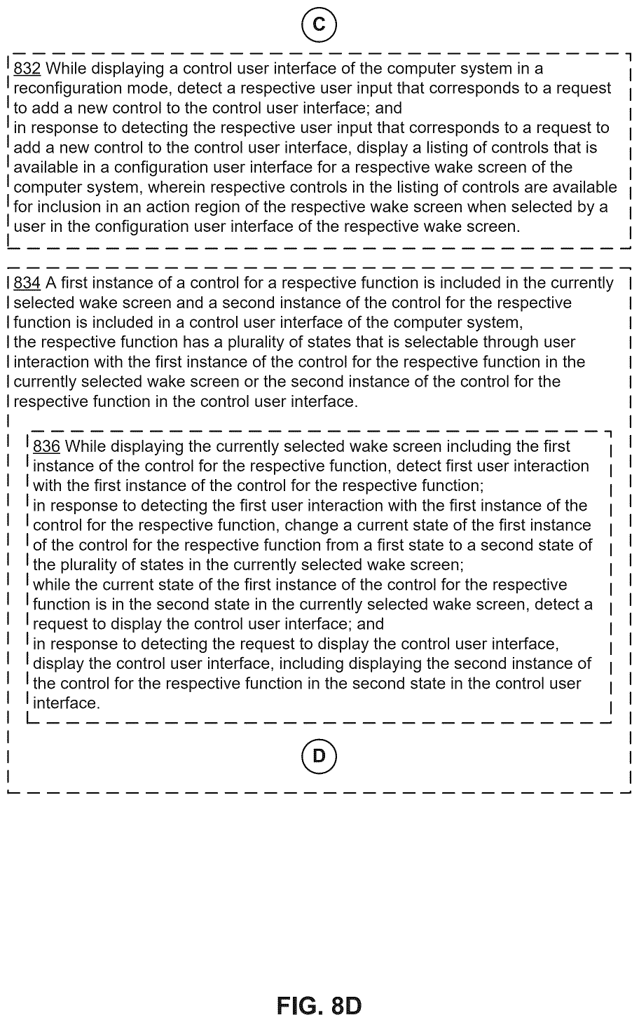

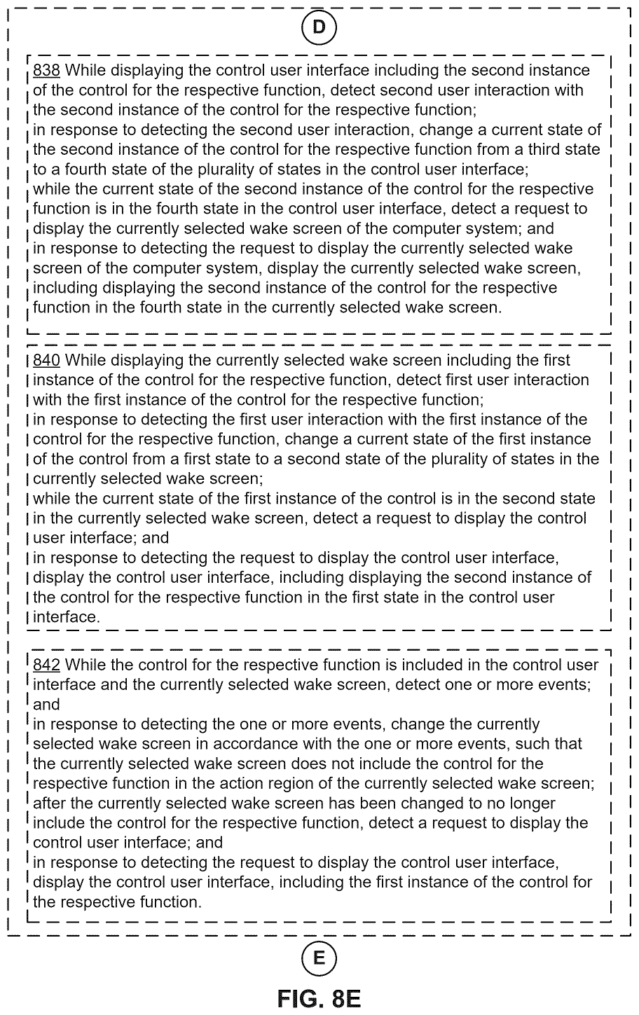

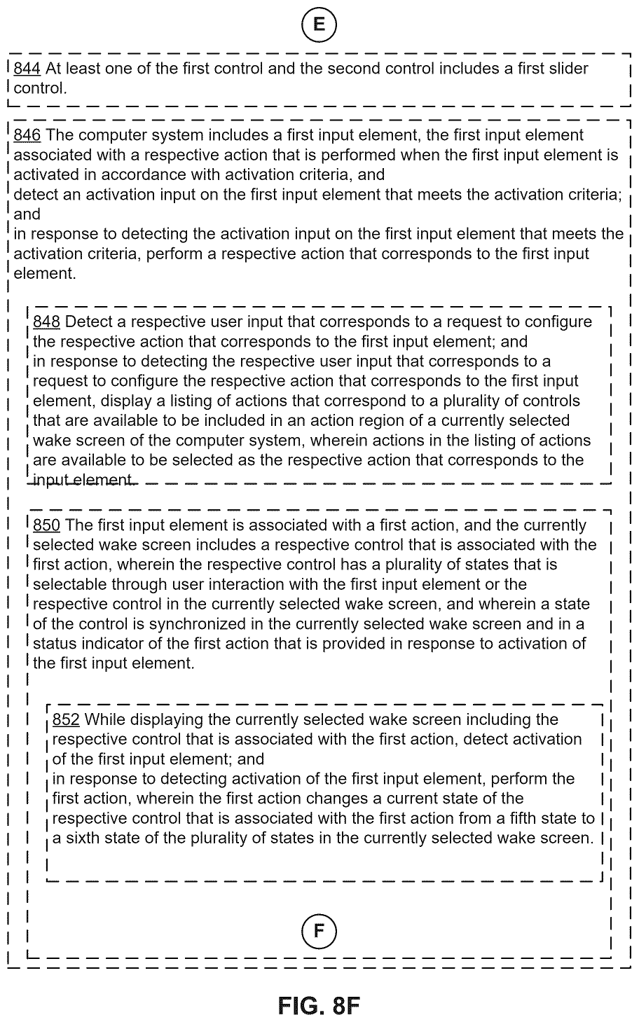

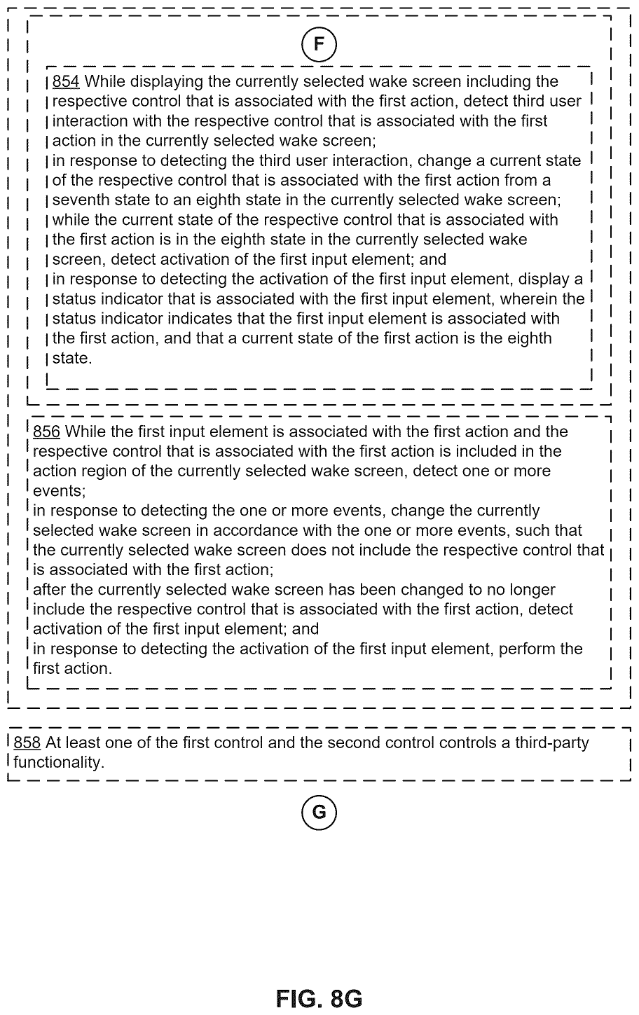

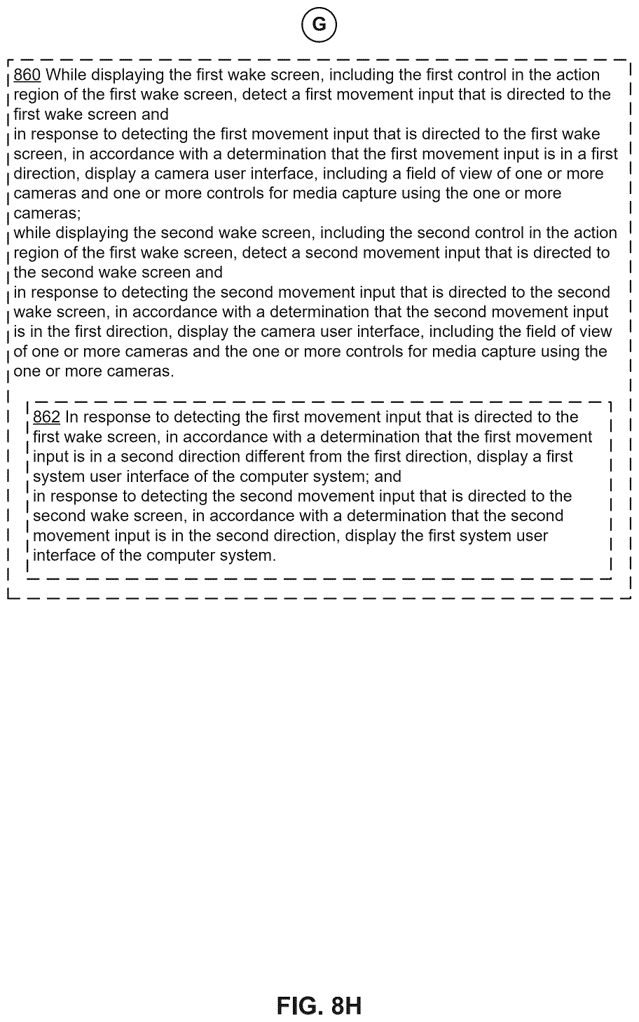

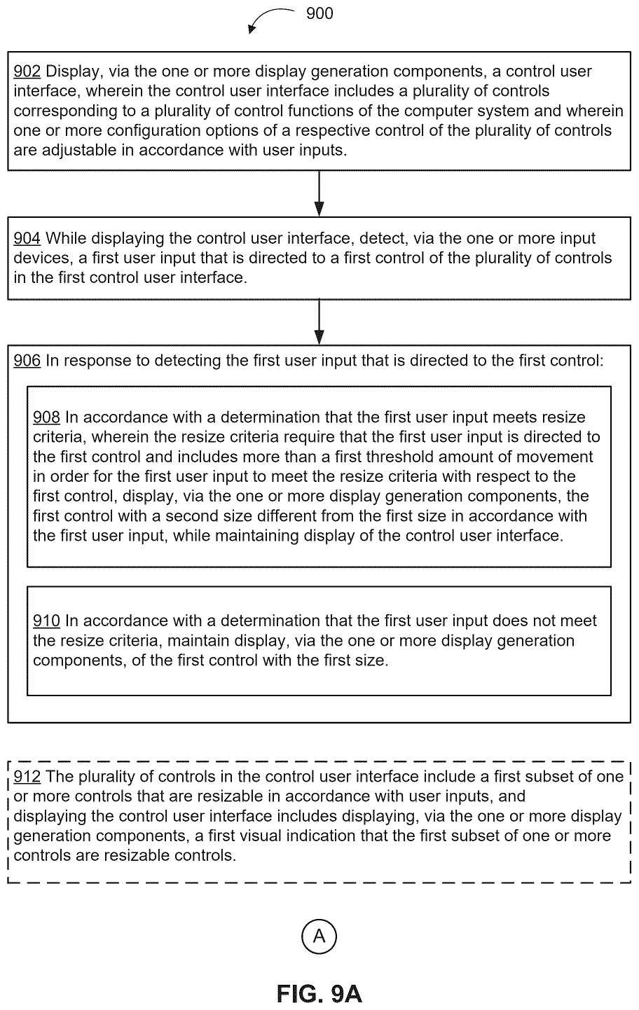

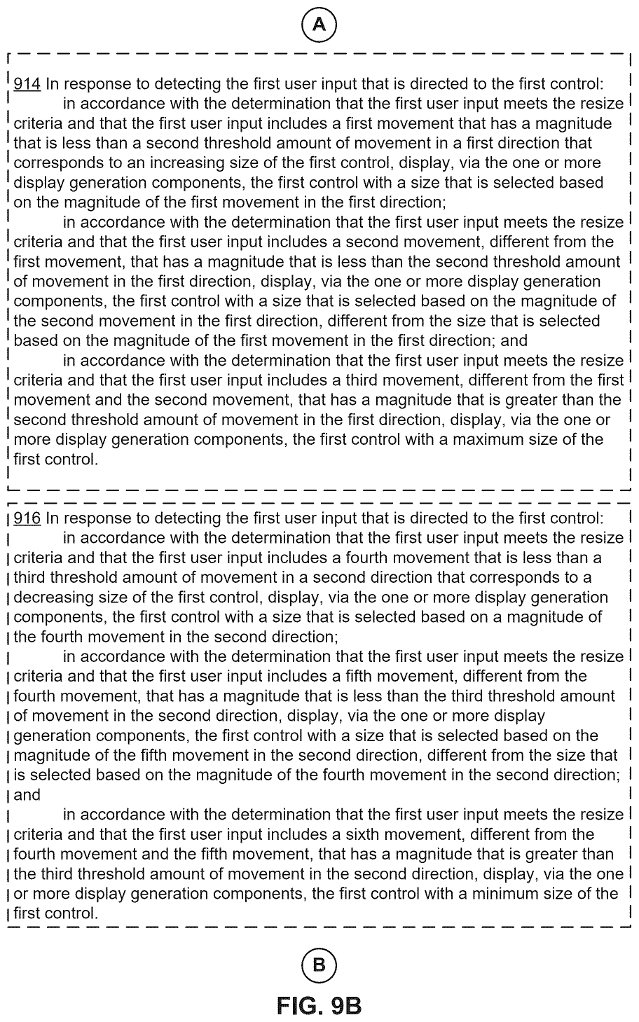

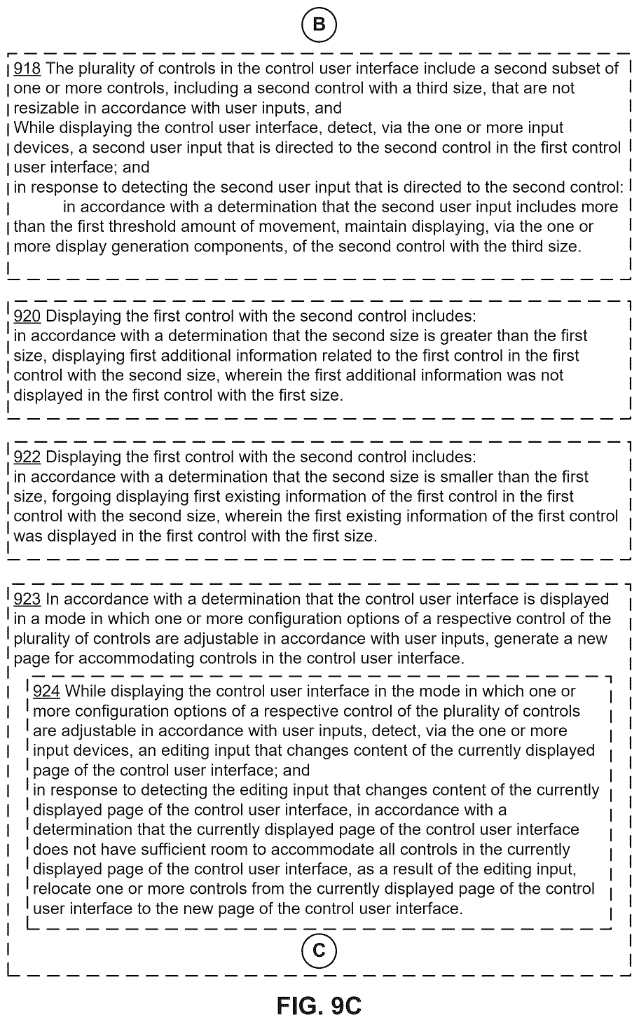

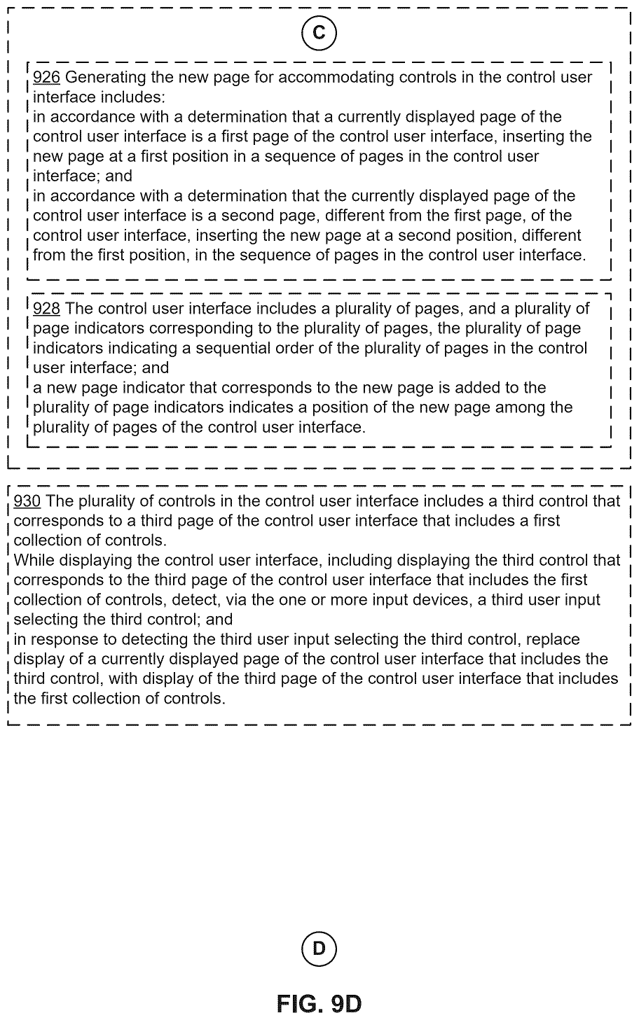

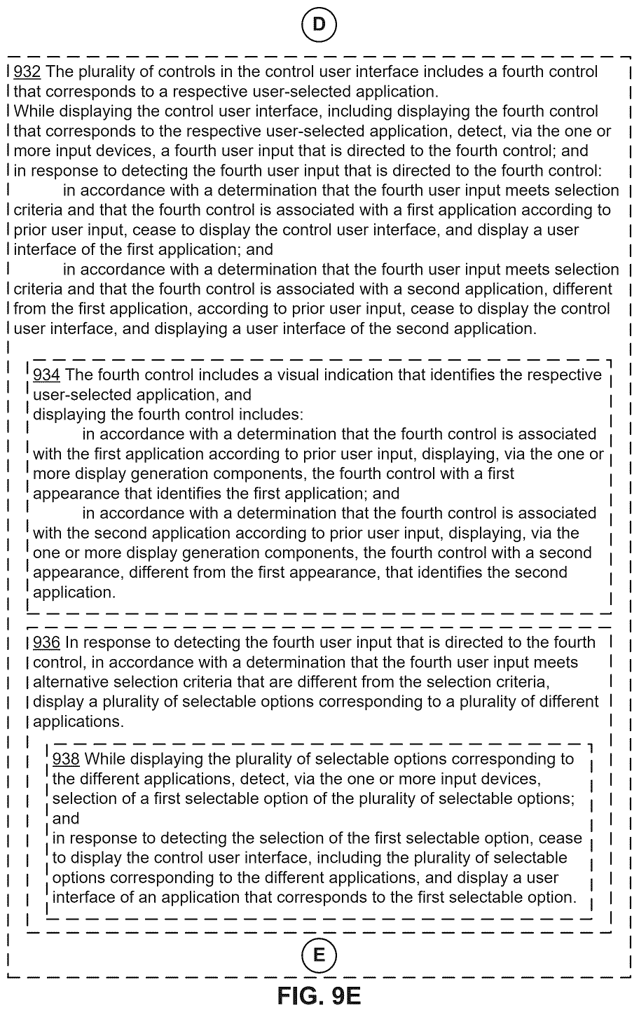

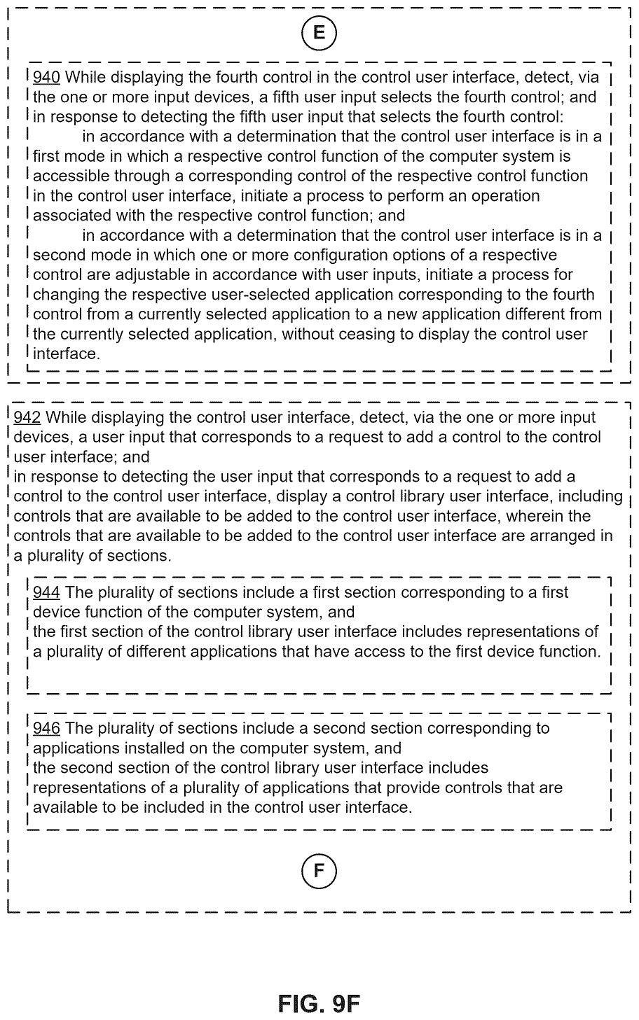

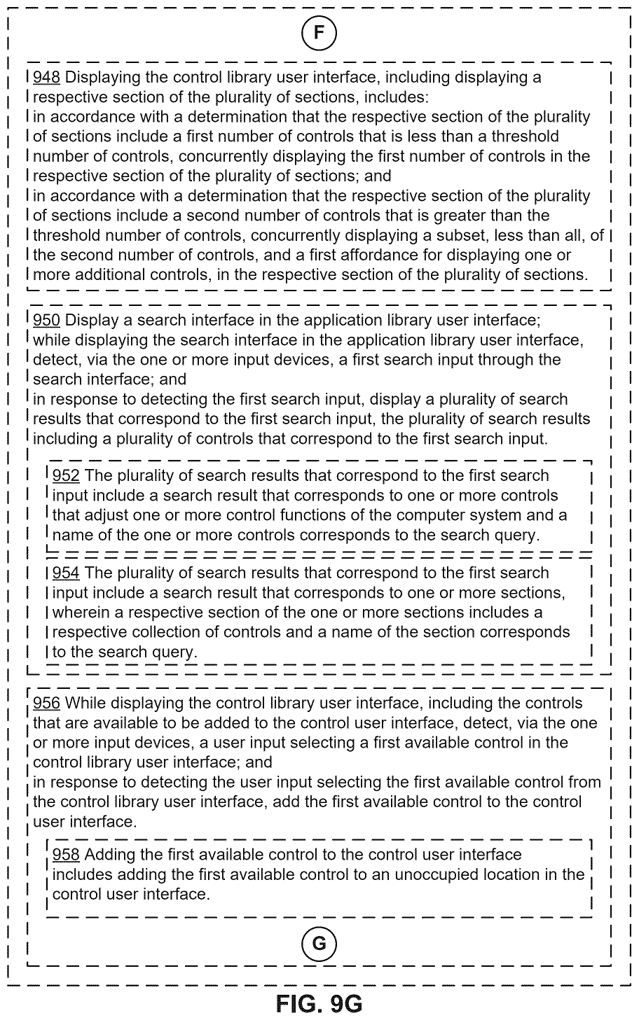

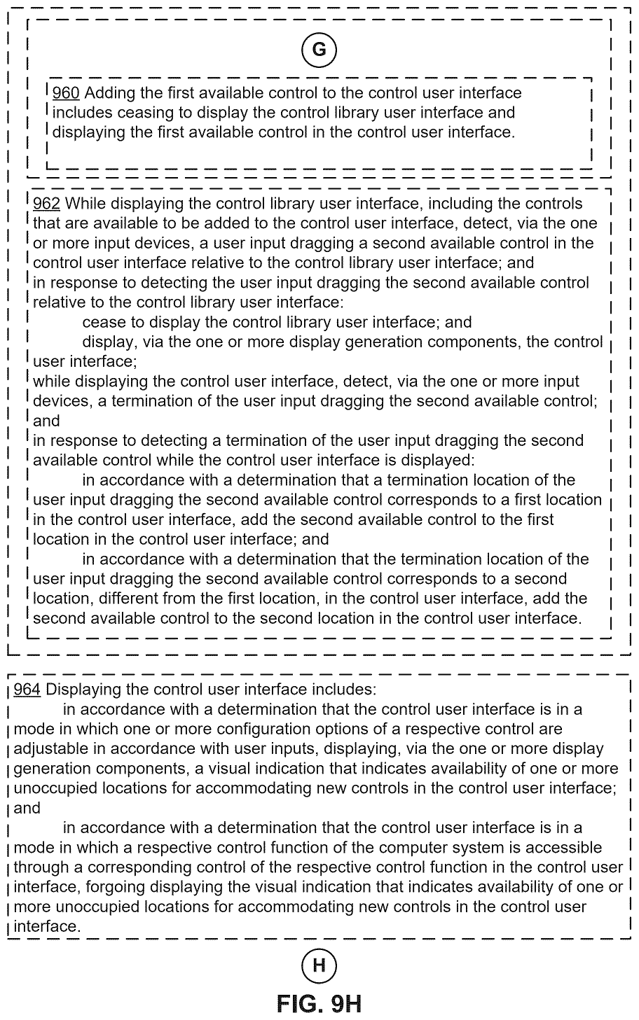

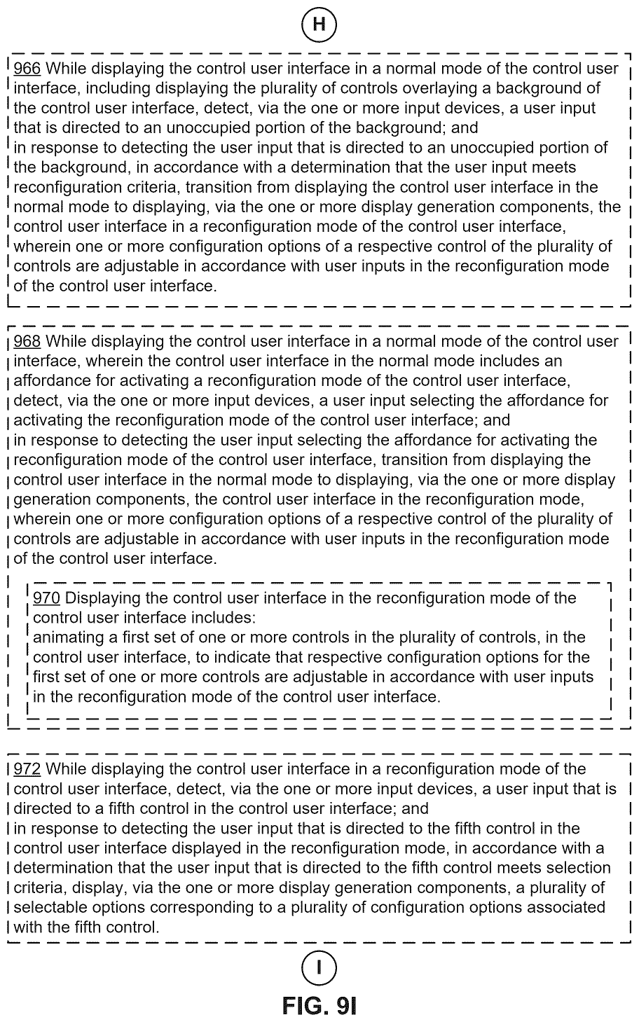

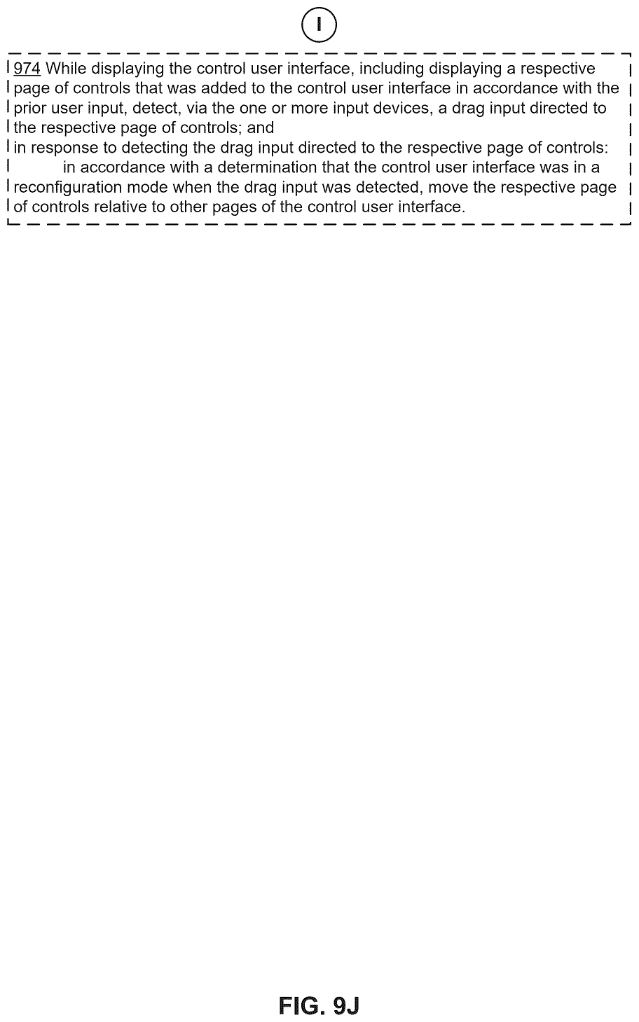

Below, FIGS. 1A-1B, 2, and 3A provide a description of example devices. FIGS. 3B-3G describe the use of Application Programming Interfaces (APIs) to perform operations. FIGS. 4A-4C2 and 5A-5CX illustrate example user interfaces for interacting with controls. FIGS. 6A-6J illustrate a flow diagram of a method of interacting with a control user interface. FIGS. 7A-7I illustrate a flow diagram of a method of configuring a control user interface. FIGS. 8A-8H illustrate a flow diagram of a method of providing quick actions in a user interface. FIGS. 9A-9J illustrate a flow diagram of a method of resizing controls in an editing control user interface. The user interfaces in FIGS. 5A-5CX are used to illustrate the processes in FIGS. 6A-6J, 7A-7I, 8A-8H and 9A-9J. In addition, unless otherwise stated unambiguously in this disclosure, the various features described with respect to one set of Figures are applicable to the same or analogous features described and/or illustrated in another set of Figures, and the descriptions are not repeated in the interest of brevity.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPU s) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IM AP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

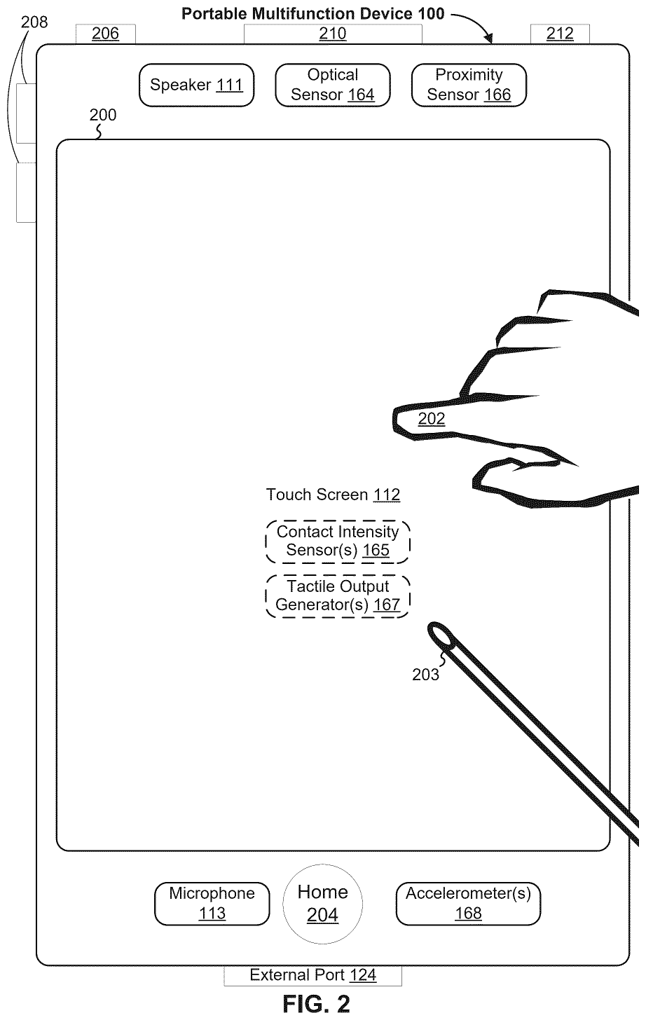

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CM OS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the User's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (e.g., in FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (e.g., in FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (e.g., in FIG. 1A) optionally does not store these modules

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HM D) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IM U (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 600 (FIGS. 6A-6J), method 700 (FIGS. 7A-7I), method 800 (FIGS. 8A-8H), and/or method 900 (FIGS. 9A-9J) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”;
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136; and
Widgets that include content from respective applications that is updated from time to time without user intervention, such as:
   Widget 448 associated with a weather application; and
   Widget 449 associated with a photos application.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties. In some embodiments, input intensity threshold are replaced by or used in conjunction with other types of input thresholds, such as time thresholds that an input and/or a characteristic of the input is maintained, speed thresholds, and/or distance thresholds for characteristics of a movement of the user input, to determine whether an input meets various criteria for triggering various operations and/or feedback.

FIGS. 4C1-4C2 illustrate an example state diagram 4000 of navigation between various user interfaces of the multifunction device 100 in accordance with some embodiments. In some embodiments, the multifunction device 100 displays a respective user interface from a plurality of different user interfaces, including a wake screen user interface 490 (also referred to as a coversheet user interface 496), a home screen user interface 492, a widget user interface 491, a control user interface 498, a search user interface 494, an application library user interface 497, and an application user interface 493 of a respective application (e.g., a camera application (e.g., camera application user interface 495), a flashlight application, a settings application, a messaging application (e.g., application user interface 493), a telephony application, a maps application, a browser application, or another type of application) of a plurality of applications. In some embodiments, the multifunction device operates in a standby mode that provides a simplified set of user interfaces and functions, when a set of conditions are met (e.g., device is charging, placed on a docking station, and/or is oriented in a landscape orientation). FIGS. 4C1-4C2 illustrate the navigation states in the normal, non-standby mode. In some embodiments, the multifunction device utilizes various portions of the display (e.g., touch-screen display 112, display 340 associated with a touch-sensitive surface, a head-mounted display, or another type of display) to display persistent content across multiple user interfaces. For example, in some embodiments, the display includes a dynamic status region 4002 for displaying alerts, status updates, and/or current states for various subscribed and/or ongoing events, and/or for various application activities, in real-time or substantially real-time. In some embodiments, the display includes a static status region 4022 for displaying status information for one or more system functions that is relatively stable over a period of time. In some embodiments, the dynamic status region 4002 changes (e.g., expands and/or shrinks) from a region that accommodate one or more hardware elements of the multifunction device (e.g., the camera lenses, microphone, and/or speakers). As described herein, although examples below are given with touch-gestures on a touch-screen display, similar functions can be implemented with a display that is associated with a touch-sensitive surface, where a location (e.g., a location on a top edge, a bottom edge, a left edge, a right edge, a top left portion, a bottom right portion, an interior portion, and/or another portion) on the touch-sensitive surface has a corresponding location (e.g., a location on a top edge, a bottom edge, a left edge, a right edge, a top left portion, a bottom right portion, an interior portion, and/or another portion) on the display (and/or on the user interface presented on the display). Furthermore, although the examples below are given with touch-gestures on a touch-screen display, similar functions can be implemented with a display that is associated with another type of input, such as a mouse inputs, a pointer inputs, gaze inputs (e.g., gazes with time and location characteristics that are directed to various portions of the displayed user interface and/or user interface elements) in conjunction with air gesture inputs (e.g., air tap, air swipe, air pinch, pinch and hold, pinch-hold and drag, and/or another type of air gestures). As described herein, although examples below are given with touch-gestures on a touch-screen display, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures).

As shown in FIG. 4C1, when the multifunction device 100 is initially powered on (e.g., in response to a long press or other activation input 4100 on a power button 116a (e.g., in FIG. 4A) of the multifunction device 100), the multifunction device displays (4100) the wake screen user interface 490 that is the initially displayed system user interface of the multifunction device 100 when the multifunction device transitions from a power off state to a power on state.

In some embodiments, while the wake screen user interface 490 is displayed after a period of time, the multifunction device 100 optionally transitions (4101) to a low power state, where the display of the multifunction device 100 is optionally turned off, or dimmed, as illustrated by user interface 489. In some embodiments, the wake screen user interface 490 remains displayed in a dimmed, always on state, while the multifunction device 100 is in the low power state. For example, in the low power state illustrated by user interface 489, the time indication and/or date indication continues to be displayed.

In some embodiments, the multifunction device 100 transitions (4101) into the low power state (e.g., turns off the display or displays the wake screen user interface 490 in the dimmed, always-on state) in response to activation of the power button 116a of the multifunction device 100 by a user input 4101 (e.g., while displaying the wake screen user interface 490, and/or any of the other user interfaces described herein).

In some embodiments, the multifunction device transitions (e.g., automatically after a period of inactivity, and/or in response to detecting a user input activating the power button 116a) into the low power state from the normal operating state in which any of a number of user interfaces (e.g., the wake screen user interface 490, the home screen user interface 492, the application user interface 493 of a respective application, or another system and/or application user interface) may be the last displayed user interface before the transition into the low power state.

In some embodiments, when the multifunction device 100 is in the low power state, the multifunction device continues to detect inputs via one or more sensors and input devices of the multifunction device (e.g., movement of the device, touch gestures (e.g., swipe, tap, or other touch input), gaze input, air gestures, impact on the device, press on the power button, rotation of a crown, or other types of inputs). In some embodiments, in response to detecting a user input via the one or more sensors and input devices of the multifunction device, the multifunction device transitions (4100) from the low power state to the normal operating state, and displays the wake screen user interface 490 in a normal, undimmed state.

In some embodiments, when the multifunction device 100 is in the low power state illustrated in user interface 489, the multifunction device continues to detect events, such as arrival of notifications and status updates (e.g., notification for messages, incoming communication requests, and/or other application-generated events and system-generated events, and status updates for sessions, subscribed events, and/or other status changes that require the user's attention). In some embodiments, in response to detecting an event that generates an alert, a notification, and/or a status update, the multifunction device transitions from the low power state to the normal operating state, and displays the alert, notification, and/or status update on the wake screen user interface 490 in the normal, undimmed state. In some embodiments, the multifunction device automatically returns to the low power mode after a short period of time after displaying the alert, notification, and/or the status update.

In some embodiments, the wake screen user interface 490 displayed in the dimmed always-on state includes the same or substantially the same set of user interface elements as the wake screen user interface 490 displayed in the normal operating state (e.g., as opposed to the dark screen shown in FIGS. 4C1 and 4C2). In some embodiments, the wake screen user interface 490 displayed in the dimmed, always-on state has fewer user interface elements than the wake screen user interface 490 displayed in the normal operating state. For example, in some embodiments, the wake screen user interface 490 displayed in the normal operating state includes a time element 4004 showing the current time, a date element 4006 showing the current date, one or more widgets 4008 that include content from respective applications that is updated from time to time without user intervention. In some embodiments, the wake screen user interface 490 displayed in the normal operating state includes one or more application icons corresponding to respective applications, such as an application icon 4010 for the flashlight application, an application icon 4012 for the camera application, or another system-recommended or user selected application. In some embodiments, the wake screen user interface 490 displayed in the normal operating state includes one or more shortcuts for accessing respective operations in one or more system-recommended and/or user-selected applications (e.g., shortcuts to play music using a media player application, to send a quick message using the messaging application, or turn on the DND or sleep mode using a system application). In some embodiments, the wake screen user interface 490 includes the dynamic status region 4002 that displays status updates or current state of an ongoing activity for one or more applications, such as a communication session, a charging session, a running timer, music playing session, delivery updates, navigation instructions, location sharing status, and/or status updates for subscribed application and system events. In some embodiments, the wake screen user interface 490 includes the static status region 4022 that displays status for one or more system functions, such as the network connection status, battery status, location sharing status, cellular signal and carrier information, and other system status information. In some embodiments, a dynamic status update (e.g., battery charging, screen recording, location sharing, and other status updates) is displayed in the dynamic status region 4002 first, and then moved to the static status region 4022 after a period of time. In some embodiments, in a dimmed always on state, the wake screen user interface 490 omits the dynamic status region 4002, static status region 4022, the application icons 4010 and 4012, and/or the shortcuts for application and/or system operations, and optionally disables interaction with remaining user interface elements (e.g., the wallpaper, the time element 4004, the date element 4006, and/or the widgets 4008) of the wake screen user interface 490.

In some embodiments, the wake screen user interface includes one or more recently received notifications (e.g., notifications 4016, or other newly received notification(s)) that correspond to one or more applications. In some embodiments, the wake screen user interface displayed in the dimmed always on state transitions into the wake screen user interface 490 in response to detecting receipt or generation of a new notification (e.g., notification 4018, FIG. 4C2, or another one or more newly received notification(s)) In some embodiments, the notifications 4016 are grouped or coalesced based on event types and/or applications corresponding to the notifications. In some embodiments, user can interact with the notifications to dismiss the notifications, sent the notifications to notification history, and/or expand the notifications to see additional notification content (e.g., optionally after valid authentication data has been requested and/or obtained). In some embodiments, the notifications displayed in the wake screen user interface may, at various times, include un-summarized notifications where the notification content of an un-summarized notification includes application content corresponding to a respective event that triggered the notification, without including a summary of the application content, and/or summaries of notifications, where the summary content of a summary for a single event includes automatically generated summary of application content corresponding to a respective event that triggered the notification, and the summary of multiple related events includes automatically generated summary of application content corresponding to multiple related events that triggered multiple notifications.

In some embodiments, the wake screen user interface 490 may be displayed while the multifunction device is in a locked state or an unlocked state. In some embodiments, when the wake screen user interface 490 is displayed while the multifunction device is in the locked state, a locked symbol 4020a is optionally displayed in the status region (e.g., dynamic status region 4002, static status region in the upper right corner of the display) or elsewhere (e.g., below the dynamic status region 4002, in the upper left corner, or in another portion of the display) in the wake screen user interface 490 to indicate that the multifunction device is in the locked state (e.g., shown in wake screen user interface 490 in FIG. 4C1), and that authentication data is required to dismiss the wake screen user interface 490 to navigate to the home screen user interface 492 or last-displayed application user interface. In some embodiments, the multifunction device automatically attempts to obtain authentication data via biometric scan (e.g., facial, fingerprint, voiceprint, and/or iris) when the wake screen user interface 490 is displayed (e.g., in the low power state, and/or the normal operating state), and automatically transitions into the unlocked state if valid authentication data is successfully obtained. In some embodiments, in conjunction with transitioning into the unlocked state, the multifunction device replaces the locked symbol 4020a with an unlocked symbol 4020b to indicate that the multifunction device is now in the unlocked state (e.g., shown in wake screen user interface 490 in FIG. 4C2).

In some embodiments, the multifunction device allows user interaction with the user interface elements of the wake screen user interface 490 when the wake screen user interface 490 is displayed in the normal operating mode.

For example, in some embodiments, selecting (e.g., by tapping, clicking, and/or air tapping) on a user interface element, such as one of the widgets 4008, status region 4002, notification 4018, and/or application icons 4010 or 4012, causes the multifunction device to navigate away from the wake screen user interface 490 and displays a respective user interface of the application that corresponds to the selected user interface element, or an enlarged version of the user interface element to show additional information and/or controls related to the initially displayed content in the selected user interface element. For example, as shown in FIG. 4C2, in response to a user input 4113 selecting message notification 4018, the computer system displays (4113) the application user interface 493 for the messaging application.

In another example, in some embodiments, an enhanced selection input 4112 (e.g., a touch and hold gesture, a light press input, or another type of input) on a respective user interface element, such as the time element 4004, the date element 4006, or a wallpaper of the wake screen user interface 490, causes the multifunction device to display a configuration user interface for configuring one or more aspects of the wake screen user interface 490 (e.g., selecting a wallpaper, configuring a color or font scheme of the user interface element, configuring how to layout the different elements of the wake screen user interface, configuring additional wake screen, selecting a previously configured wake screen, and view additional customization options for the wake screen user interface). In some embodiments, configuration of the wake screen user interface 490 is partially applied to the home screen user interface 492, and vice versa.

In some embodiments, an enhanced selection input (e.g., a touch and hold gesture, a light press input, or another type of input) on the flashlight application icon 4010 or the camera application icon 4012 causes the multifunction device to activate the flashlight of the multifunction device or display the camera user interface 495 of the camera application. For example, in response to detecting selection input 4104a on the camera application icon 4012 in the wake screen user interface 490, the multifunction device activates the camera application and displays (4104a) the camera application UI 495 (e.g., as shown in FIG. 4C1).

In some embodiments, if the multifunction device detects user interaction with the user interface elements shown in the wake screen user interface 490 and determines that the wake screen user interface is in the locked state, the multifunction device attempts to obtain authentication data from the user by displaying an authentication user interface (e.g., a passcode entry interface, a password entry user interface, and/or a biometric scan user interface). The multifunction device proceeds to navigate away from the wake screen user interface 490 and performs the operation in accordance with the user's interaction after valid authentication data has been obtained from the user.

In some embodiments, in addition to performing operations (e.g., navigating to application user interfaces, displaying expanded versions of user interface elements that show additional information, and/or displaying configuration options for a respective user interface element or the wake screen user interface), the multifunction device allows the user to navigate from the wake screen user interface 490 to other user interfaces (optionally, after valid authentication data has been obtained) in response to navigation inputs (e.g., swipe gestures or other types of navigation inputs that are directed to regions of the wake screen user interface that are not occupied by a user interface element, and/or regions of the wake screen user interface that are occupied by user interface element (e.g., widgets, application icons, and/or time elements) that do not respond to swipe gestures or said other types of navigation inputs).

For example, in some embodiments, an upward swipe gesture 4105 that starts from the bottom edge of the wake screen user interface 490 causes (4105) the multifunction device to navigate away from the wake screen user interface 490 and display the home screen user interface 492 or the last-displayed application user interface (optionally, after requesting and obtaining valid authentication data).

In some embodiments, the upward swipe gesture 4105 is a representative example of a home gesture or dismissal gesture (e.g., other examples include upward swipe gestures 4103a, 4103c, 4103d, 4103e, 4110a, and 4111a) that causes the multifunction device to dismiss the currently displayed user interface (e.g., the wake screen user interface 490, an application user interface (e.g., camera user interface 495, messages user interface 493, or another application user interface), the control user interface 498, the search user interface 494, the application library user interface 497, or the home screen configuration user interface) and navigate to the home screen user interface 492 or a last-displayed user interface (e.g., the wake screen user interface 490, the wake screen configuration user interface, the search user interface 494, an application user interface, or the home screen user interface 492).

In some embodiments, a downward swipe from a top edge (e.g., the central portion of the top edge, or any portion of the top edge) or an interior region of the wake screen user interface 490 (e.g., downward swipe 4106a, or another downward swipe) causes (4106a) the multifunction device to display the search user interface 494 that includes a search input region 4030 and one or more applications icons 4032 for recommended applications (e.g., recently used applications, and/or relevant applications based on the current context), as shown in FIG. 4C1. In some embodiments, in response to detecting a search input in the search input region 4030, the multifunction device retrieves and displays search results that include relevant application content (e.g., messages, notes, media files, and/or documents) from the different applications that are installed on the multifunction device, relevant applications (e.g., applications that are installed on the multifunction device and/or applications that are available in the app store), relevant webpages (e.g., bookmarked webpages and/or webpages newly retrieved from the Internet), and/or search results from other sources (e.g., news, social media platforms, and/or reference websites). In some embodiments, different sets of search results are provided depending on the locked and unlocked state of the multifunction device, and more details or additional search results may be displayed if the multifunction device is in the unlocked state when the search is performed. In some embodiments, the multifunction device attempts to obtain valid authentication data in response to receiving the search input, and displays different sets of search results depending on whether valid authentication data is obtained. In some embodiments, an upward swipe gesture 4103d that starts from the bottom edge of the search user interface (or another type of dismissal input) causes (4103d) the multifunction device to dismiss the search user interface 494 and redisplays the wake screen user interface 490 (e.g., since the wake screen user interface was the last displayed user interface), as shown in FIG. 4C1. In some embodiments, in response to a downward swipe 4106b from an interior region of the home screen user interface 492 causes (4106b) the multifunction device to display the search user interface 494; and in response to a subsequent upward swipe gesture 4103d from the bottom edge of the search user interface 494, the home screen user interface 492 is (4103d) redisplayed (e.g., since the home screen user interface was the last displayed user interface), as shown in FIG. 4C1.

In some embodiments, as shown in FIG. 4C1, a rightward swipe gesture 4102a that starts from a left edge or interior region of the wake screen user interface 490 causes (4102a) the multifunction device to navigate from the wake screen user interface 490 to a widget user interface 491 (or another system user interface other than the home screen user interface, such as a control user interface, a search user interface, or a notification history user interface). In some embodiments, the widget user interface 491 includes a plurality of widgets 4026 (e.g., including widget 4026a, widget 4026b and widget 4026c) that are automatically selected by the operating system and/or selected by the user for inclusion in the widget user interface 491. In some embodiments, the widgets 4026 displayed in the widget user interface 491 have form factors that are larger than the widgets 4008 displayed under the time element 4004 in the wake screen user interface 490. In some embodiments, the widgets 4026 displayed in the widget user interface 491 and the widgets 4008 displayed in the wake screen user interface 490 are independently selected and/or configured from each other. In some embodiments, the widgets 4026 in the widget user interface 491 include content from their respective applications and the content is automatically updated from time to time as the updates to the content becomes available in the respective applications. In some embodiments, selection of a respective widget (e.g., tapping on the respective widget, or providing other selection input directed to the respective widget) in the widget user interface causes the multifunction device to navigate away from the widget user interface 491 and displays a user interface of the application that corresponds to the respective widget (optionally, after valid authentication data is requested and/or obtained).

In some embodiments, an upward swipe gesture 4103a that starts from the bottom edge of the widget user interface 491 and/or a leftward swipe gesture 4103b that starts from the right edge or the interior region of the widget user interface 491 causes (4103a-1/4103b-1) the multifunction device to dismiss the widget user interface 491 and redisplay the wake screen user interface 490, as shown in FIG. 4C1.

In some embodiments, a leftward swipe gesture 4104b that starts from the right edge or interior portion of the wake screen user interface 490 causes (4104b) the multifunction device to navigate from the wake screen user interface 490 to a camera user interface 495 of the camera application. In some embodiments, access to the photo library through the camera application is restricted in the camera user interface 495 unless valid authentication data has been obtained. In some embodiments, as shown in FIG. 4C1, an upward swipe gesture 4103c that starts from the bottom edge of the camera user interface 495 or another dismissal input causes (4103c) the multifunction device to navigate away from the camera user interface 495 and redisplay the wake screen user interface 490 (e.g., since the wake screen user interface 490 is the last displayed user interface prior to displaying the camera user interface 495).

In some embodiments, a downward swipe gesture 4109a that starts from the right portion (and/or the left portion) of the top edge of the wake screen user interface (e.g., as illustrated in FIG. 4C2) causes (4109a) the multifunction device to display the control user interface 498 overlaying or replacing display of the wake screen user interface 490. In some embodiments, the control user interface 498 includes status information for one or more static status indicators displayed in the static status region 4022, and respective sets of controls 4028 (e.g., including control 4028a, control 4028b, and control 4028c) for various system functions, such as network connections (WiFi, cellular data, airplane mode, Bluetooth, and other connection types), media playback controls, display controls (e.g., display brightness, color temperature, night shift, true tone, and dark mode controls), audio controls (e.g., volume, and/or mute/unmute controls, focus mode controls (e.g., DND, work, study, sleep, and other modes in which generation of alerts and notifications are moderated based on context and configurations, and application icons (e.g., flashlight, timer, calculator, camera, screen recording, and/or other user-selected or system recommended applications))). In some embodiments, an upward swipe gesture 4110a that starts from the bottom edge of the control user interface 498 (or another dismissal input) causes the multifunction device to dismiss the control user interface 498 and redisplay (4110a-1) the wake screen user interface 490 (e.g., since the wake screen user interface 490 is the last displayed user interface prior to displaying the control user interface 498). Additional features and details regarding the control user interface 498 and user interactions related to the control user interface 498 are disclosed in other parts of this specification.

In some embodiments, an upward swipe gesture 4107 that starts from the interior region of the wake screen user interface 490 and/or an upward swipe gesture that starts from the interior of the coversheet user interface 496 (e.g., optionally, when there are no unread notifications displayed in the coversheet user interface) causes (4107) the multifunction device to display the notification history user interface that includes a plurality of previously saved notifications and notifications that have been sent directly to notification history without first being displayed on the wake screen user interface 490. In some embodiments, the notification history user interface can be scrolled to reveal additional notifications in response to an upward swipe gesture 4118 directed to the notification history in the wake screen user interface 490 and/or the coversheet user interface 496. In some embodiments, the notification history is displayed as part of the wake screen user interface 490 and/or coversheet user interface 496, and a downward swipe gesture 4103f that is directed to the interior portion of the notification history causes the notification history to cease to be displayed and causes the wake screen user interface 490 and/or coversheet user interface 496 to be redisplayed without the notification history.

As described above, after navigating from the wake screen user interface 490 to a respective user interface other than the home screen user interface (e.g., in response to a swipe gesture in the downward, leftward, or rightward directions), an upward swipe gesture 4103 (e.g., 4103a, and 4103c through 4103f) that starts from a bottom edge of the respective user interface (e.g., an upward swipe gesture that starts from the bottom edge of the touch-sensitive display that displays a respective user interface in full screen mode, or an upward swipe gesture that starts from the bottom edge of a touch-sensitive surface that corresponds to the display that displays the respective user interface) causes the multifunction device to dismiss the respective user interface and returns to the wake screen user interface 490. In contrast, an upward swipe gesture 4105 that starts from the bottom edge of the wake screen user interface 490 causes (4105) the multifunction device to navigate away from the wake screen user interface 490 and displays the home screen user interface 492, and another upward swipe gesture that starts from the bottom edge of the home screen user interface 492 does not cause the multifunction device to dismiss the home screen user interface 492 and return to the wake screen user interface 490. In other words, once the navigation from the wake screen user interface 490 to the home screen user interface 492 is completed, the multifunction device is no longer in the restricted state, and access to the application icons displayed on the home screen user interface 492 and access to the content and functions of the computer system are unrestricted to the user. The upward swipe gesture that starts from the bottom edge of the currently displayed user interface is a representative example of a dismissal input that dismisses the currently displayed user interface and redisplays the last displayed user interface. The upward swipe gesture that starts from the bottom edge of the currently displayed user interface is also a representative example of a home gesture that dismisses the currently displayed user interface and displays the home screen user interface (e.g., irrespective of whether the home screen user interface was the last displayed user interface prior to displaying the currently displayed user interface).

As shown in FIG. 4C2, once the multifunction device navigates away from the wake screen user interface 490 and displays the home screen user interface 492, the user can access the functions and applications of the multifunction device without restriction. For example, in some embodiments, the home screen user interface 492 includes multiple pages, and a respective page of the home screen user interface includes a respective set of application icons and/or widgets corresponding to different applications, and user selection of (e.g., by tapping on, clicking on, or otherwise selecting) a respective widget or application icon causes the multifunction device to display an application user interface of the application that corresponds to the respective widget or application icon.

In some embodiments, the home screen user interface 492 displays a search affordance 4034 (e.g., as illustrated in FIG. 4C1), and a tap on the search affordance 4034 causes the search user interface 494 described above to be displayed overlaying the home screen user interface 492. In some embodiments, in response to detecting an upward swipe gesture 4103d that starts from the bottom edge of the search user interface (or another dismissal input), the multifunction device dismisses the search user interface 494 and redisplays (4103d) the home screen user interface 492 (e.g., not the wake screen user interface 490, as the upward edge swipe gesture dismisses the currently displayed user interface and redisplays the last displayed system user interface).

In some embodiments, as shown in FIG. 4C1, a rightward swipe gesture 4102b that starts from the left edge of the first page of the home screen user interface 492 causes (4102b) the multifunction device to display the widget user interface 491 described above. In some embodiments, a leftward swipe gesture (e.g., gesture 4103b, or another leftward swipe gesture) that starts from the right edge or the interior region of the widget user interface or an upward swipe gesture (e.g., gesture 4103a, or another upward swipe gesture) that starts from the bottom edge of the widget user interface 491 causes (4103a-2/4103b-2) the multifunction device to navigate away from the widget user interface 491 and redisplays the first page of the home screen user interface 492 (e.g., when the home screen user interface 492 was the last displayed user interface prior to displaying the widget user interface 491).

In some embodiments, consecutive leftward swipe gestures 4116 on the home screen user interface 492, as shown in FIG. 4C2, navigates through consecutive pages of the home screen user interface 492 until the application library user interface 497 is (4116) displayed. In some embodiments, the application library user interface 497 displays application icons from multiple pages of the home screen user interface grouped into different categories. In some embodiments, the application library user interface 497 includes a search user interface element 4036 that accepts search criteria (e.g., keywords, image, and/or other search criteria) and returns application icons for relevant applications (e.g., applications that are stored on the multifunction device and/or available in the app store) as search results. In some embodiments, user selection of (e.g., by a tap input, a click input, or another type of selection input) on an application icon in the search results and/or in the application library causes the multifunction device to display the application user interface of the application that corresponds to the selected application icon.

In some embodiments, a downward swipe gesture 4109c that starts from the right portion of the top edge of the application library user interface 497 causes display of the control user interface 498 as described above. In some embodiments, an upward swipe gesture (e.g., upward swipe gesture 4110a, or another upward swipe gesture) that starts from the bottom edge of the control user interface 498 or another dismissal input causes the multifunction device to dismiss the control user interface 498 and redisplay the application library user interface 497 (e.g., since the application library user interface is the last displayed user interface before the display of the control user interface) (e.g., or redisplay another user interface (e.g., redisplay (4110a-1) the wake screen user interface 490 (e.g., if control user interface 498 is displayed in response to swipe gesture 4109a), redisplay (4110a-3) the home screen user interface 492 (e.g., if the control user interface is displayed in response to a downward swipe from the top right portion of the top edge of the display), or redisplay (4110a-2) the application user interface (e.g., if the control user interface is displayed in response to the downward swipe 4109b) that was the last displayed user interface prior to displaying the control user interface).

In some embodiments, a rightward swipe gesture 4115 that starts from the interior region or the left edge of the application library user interface 497 or an upward swipe gesture that starts from the bottom edge of the application library user interface 497 causes (4115) the multifunction device to dismiss the application library user interface 497 and redisplays the last page of the home screen user interface 492.

In some embodiments, a downward swipe gesture 4114 that starts from the interior region of the application library user interface 497 causes the multifunction device to display the application icons for applications stored on the multifunction device in a scrollable list (e.g., according to chronological or alphabetical order).

In some embodiments, an upward swipe gesture that starts from the bottom edge of the home screen user interface causes the multifunction device to display the first page of the home screen user interface 492 or display the multitasking user interface 488 (also referred to an application switcher user interface). In some embodiments, different criteria (e.g., criteria based on the speed, direction, duration, distance, intensity, and/or other characteristics) are used to determine whether to navigate to the first page of the home screen user interface 492 or to the multitasking user interface 488 in response to detecting the upward swipe gesture that starts from the bottom edge of the home screen user interface. For example, in some embodiments, a short flick and a slow and long swipe cause the multifunction device to navigate to the first page of the home screen user interface 492, while a slow and medium length swipe causes the multifunction device to display the multitasking user interface 488. In some embodiments, a navigation gesture is dynamically evaluated before the termination of the gesture is detected, and therefore, the estimated destination user interface of the navigation gesture continues to change and visual feedback regarding the estimated destination user interface continues to be provided to guide the user to conclude the gesture when the desired destination user interface is indicated by the visual feedback. In some embodiments, in response to a user input 4117 at a portion of the multitasking user interface 488 that does not correspond to an application, a last displayed user interface that is displayed before displaying the multitasking user interface 488 is displayed (e.g., home screen user interface 492 is displayed when the multitasking user interface 488 is displayed in response to user input 4111b).

In some embodiments, a reconfiguration mode of the home screen user interface 492 is displayed in which application icons and/or widgets can be repositioned in, removed from, or added to the different pages of the home screen user interface 492. In some embodiments, a touch and hold gesture or another enhanced selection input directed to the home screen user interface 492 for a respective threshold amount of time or another enhanced selection input directed to the home screen user interface 492 cause the multifunction device to display the home screen user interface 492 in the configuration mode. In some embodiments, selection of the search affordance 4034 in the home screen user interface 492 while the home screen user interface 492 is in the reconfiguration mode causes the multifunction device to display a page editing user interface for the home screen user interface in which pages of the home screen user interface may be reordered, deleted, hidden, or created. In some embodiments, a tap input on the home screen user interface in the reconfiguration mode, causes the home screen user interface to exit the reconfiguration mode. In some embodiments, a tap input on unoccupied portion of the page editing user interface causes the multifunction device to exist the page editing user interface and redisplays the home screen user interface in the reconfiguration mode. Another tap on the home screen user interface causes the home screen user interface to exit the reconfiguration mode and be redisplayed in the normal mode.

In some embodiments, while displaying the home screen user interface 492, a downward swipe gesture 4108a that starts from the top edge of the home screen user interface 492 causes (4108a) the multifunction device to cover the home screen user interface 492 with the coversheet user interface 496 (also referred to as the wake screen user interface 490 if the user interface is displayed when transitioning from a normal mode to a low-power mode, and/or vice versa (e.g., due to inactivity, due to activation of the power button, and/or due to user input that corresponds to a request to wake or lock the device)) and the access to the home screen user interface is temporarily restricted by the coversheet user interface 496. In some embodiments, while the coversheet user interface 496 is displayed, an upward swipe gesture 4103e that starts from the bottom edge of the coversheet user interface 496 dismisses (4103e) the coversheet user interface 496 and redisplays the home screen user interface 492 (e.g., since the home screen user interface is the last displayed user interface). In some embodiments, the coversheet user interface has responses to user inputs in a manner analogous to those described with respect to the wake screen user interface 490.

In some embodiments, an application user interface of a respective application can be displayed in response to user inputs in a number of scenarios, such as tapping on a widget displayed in the home screen user interface or the widget user interface; tapping on an application icon displayed in the home screen, in the widget user interface, in the search result or recommended application portion of the search user interface, in the application library user interface or in the search results provided in a search in the application library user interface; tapping on a notification on the wake screen user interface or in the notification history; tapping on a representation of an application in the multitasking user interface; or selecting a link to an application in a user interface of another application (e.g., a link to a document, a link to a phone number, a link to a message, a link to an image, and other types of links). In some embodiments, a user interface of a single application is displayed in a full-screen mode. In some embodiments, user interfaces of two or more applications are displayed in a concurrent-display configuration, such as in a side-by-side display configuration where the user interfaces of the applications are displayed adjacent to one another to fit within the display, or in an overlay display configuration where the user interface of a first application is displayed in the full-screen mode while the user interfaces of other applications are overlaid on portion(s) of the user interface of the first application (e.g., in a single stack or separately on different portions).

In some embodiments, while displaying a user interface of an application, an upward swipe gesture (e.g., upward swipe gesture 4111a, or another upward swipe gesture) that starts from the bottom edge of the application user interface (e.g., messages user interface 493, or another user interface of an application) or another dismissal input or home gesture causes (4111a-1, or 4111a-2) the multifunction device to dismiss the currently displayed application user interface, and display either the home screen user interface (e.g., shown as transition 4111a-1) or the multitasking user interface (e.g., shown as transition 4111a-1) depending on the characteristics of the upward swipe gesture. In some embodiments, while displaying home screen user interface 492, an upward swipe gesture 4111b that starts from the bottom edge of the home screen user interface causes (4111b) the multifunction device to dismiss the currently displayed home screen user interface 492, and display the multitasking user interface 488.

In some embodiments, a horizontal swipe gesture in the leftward and/or rightward direction that is performed within a bottom portion of the application use interface(s) causes the multifunction device to switch to another previously displayed application user interface of a different application. In some embodiments, the same swipe gesture that starts from the bottom portion of a respective application user interface is continuously evaluated, to determine and update an estimated destination user interface among the multitasking user interface 488, the home screen user interface 492, or a user interface of a previously displayed application, based on the characteristics of the swipe gesture (e.g., location, speed, direction, and/or change in one or more of the above), and a final destination user interface is displayed in accordance with the estimated destination user interface at the termination of the swipe gesture (e.g., lift off of the contact, reduction in intensity of the contact, a pause in movement, and/or another type of change in the input).

In some embodiments, while displaying an application user interface of a respective application (or displaying application user interfaces of multiple applications in a concurrent-display configuration), a downward swipe gesture 4108b that starts from the top edge of the application user interface(s) causes (4108b) the multifunction device to display the coversheet user interface 496 (e.g., in FIG. 4C1) (or the wake screen user interface 490 in FIG. 4C2) over the application user interface(s). The multifunction device dismisses the coversheet user interface 496 (or the wake screen user interface 490) and redisplays the application user interface(s) in response to an upward swipe gesture that starts from the bottom edge of the coversheet user interface (or another dismissal input).

In some embodiments, as shown in FIG. 4C2, a downward swipe gesture 4109b that starts from the static status region 4022 on the display cause (4109b) the multifunction device to display the control user interface 498 over the application user interface(s), and an upward swipe gesture 4110a that starts from the bottom edge of the control user interface 498 (or another dismissal input) dismisses the control user interface 498 and causes (4110a-2) the application user interfaces to be redisplayed (e.g., or the last displayed user interface that is displayed before displaying the control user interface 498).

In some embodiments, rotation of the display causes the multifunction device to display a different version of the currently displayed user interface (e.g., application user interface, home screen user interface, wake screen user interface, control user interface, notification user interface, widget user interface, application library user interface, and other user interfaces described with respect to FIGS. 4C1-4C2) that have a differently layout (e.g., landscape version vs. portrait version). In some embodiments, rotation of the display has no effect on the orientation of the respective user interface that is currently displayed.

In some embodiments, when the device is placed on a docking station or is connected wirelessly or through a contact-based connection (e.g., via electronic connection, or magnetic connection) to a charging source, rotation of the display when the wake screen user interface is displayed and/or when the device is in the low power state, cause the device to enter a standby mode, where a different set of navigation states are made available. In some embodiments, swiping in the vertical direction causes the device to navigate between different versions of a functional “face” (e.g., a user interface that provides a primary function, such as a “clock” face, a “weather” face, a “calendar” face, a “stock” face, a “photos” face, a “widget” face, or user interface that provides another function), while swiping in the horizontal direction cause the device to navigate between different functional faces. In some embodiments, swiping downward from the upper right corner of the display causes the device to display a “control” face that includes controls for various control functions of the device. Swiping upward from the bottom edge of the display when the “control” face is displayed causes the device to dismiss the “control” face and redisplay the last displayed functional face.

The above description of the navigation between user interfaces and exact appearances and components of the various user interfaces are merely illustrative and may be implemented with variations in various embodiments described herein. In addition, the transitions between pairs of user interfaces illustrated in FIGS. 4C1-4C2 are only a subset of all transitions that are possible between different pairs of user interfaces illustrated in FIGS. 4C1-4C2, and a transition to a respective user interface may be possible from any of multiple other user interfaces, in accordance with a respective user input of a same type, directed to a same interaction region of the display, and/or in accordance with a different type of input or directed to a different interactive region, in accordance with various embodiments.

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5CX illustrate example user interfaces for interacting with a control user interface in accordance with some embodiments. The user interfaces in these figures are used to illustrate the processes described below, including the processes in FIGS. 6A-6J, 7A-7I, 8A-8H and 9A-9J. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) while a location or object is targeted, such as when the location of the hand(s) and/or finger(s) are on or near the object or the location or while a focus selector is on the location or object.

FIGS. 5A-5CX illustrate example user interfaces for interacting with controls, including controls in a control user interface and/or other system user interfaces, in accordance with some embodiments. FIGS. 5A-5AB illustrate example user interfaces of navigating between pages and/or portions of a control user interface in accordance with some embodiments. FIGS. 5AC-5BH illustrate example user interfaces for editing a control user interface in accordance with some embodiments. FIGS. 5BI-5CF illustrate example user interfaces for interacting with various types of controls in a control user interface in accordance with some embodiments. FIGS. 5CG-5CX illustrate example user interfaces of interacting with a wake screen user interface, including one or more controls for quick actions on the wake screen user interface, and optionally, corresponding effects on controls in a control user interface, It is to be understood that the descriptions of features and elements (e.g., controls, inputs, groups of controls, edit controls, quick action controls, device function controls, action buttons, resize affordances, remove affordances, slider controls, expansion controls, and other objects and user interface elements) shown in some of FIGS. 5A-5CX, unless otherwise stated, are also applicable to similar or identical features and elements shown in and/or discussed with respect to another figure in FIGS. 5A-5CX, and features described in different parts of FIGS. 5A-5CX and/or descriptions can be combined or separately implemented in one or more embodiments without limitation. For illustrative purposes, the inputs described with respect to FIGS. 5A-5CX are shown as touch inputs performed by one or more contacts on a touch-screen display that specifies a target of the inputs based on the touch-location(s) of the contacts. It is to be understood that, in various embodiments, other types of inputs may be used to replace the touch inputs described with respect to FIGS. 5A-5CX. For example, for a tap input performed by a contact at a location of a target object or region, an equivalent input may include an air tap gesture that is detected at a location corresponding to the target object or region in a three-dimensional environment, an air pinch gesture that is detected while a gaze is directed to the target object or region, a click input that is detected when a focus selector such as a mouse pointer is located on the target object or region, and/or an activation input on a control device detected while the target object or region has input focus. Similarly, for a swipe gesture performed by a contact moving in a respective direction, with a respective speed, and/or by a respective distance, an equivalent input may include an air swipe gesture performed by a finger or a pair of pinched fingers, a click-hold and drag input performed by a pointing device, such as a mouse. A light press input or long press input that is performed by a contact may be replaced by another type of input that meets an input threshold (e.g., a time threshold and/or intensity threshold) with less than a threshold amount of movement, such as an air pinch gesture that is maintained with less than a threshold amount of movement for at least a threshold amount of time, a down-click input that is held for more than a threshold amount of time with less than a threshold amount of movement before an up-click is detected.

FIG. 5A illustrates a user interface displayed at device 100. In some embodiments, the user interface is a home screen user interface 5140 (e.g., corresponding to home screen user interface 492) or another user interface, such as application user interface 493, wake screen user interface 490, or widget user interface 491. In some embodiments, device 100 detects a user input 5004-1, such as a swipe user input in a first direction (e.g., a downward swipe, a leftward swipe, a rightward swipe, an upward swipe, and/or some combination of directions). In some embodiments, in response to detecting a user input 5004-1 that is detected at a respective position in the user interface 5140, such as the upper right corner of the user interface 5140, the device 100 displays a first version of control user interface 5002-1 and/or displays a second version of control user interface 5002-2, based on the user input 5004-1. In some embodiments, the control user interfaces 5002 described herein correspond to control user interface 498 described with reference to FIGS. 4C1-4C2.

In some embodiments, in accordance with a determination that the user input 5004-1 is a swipe input, which continues as user input 5004-2, as illustrated in FIG. 5B, satisfies a first speed threshold (e.g., and/or does not satisfy a second speed threshold), the first version of control user interface 5002-1 is displayed. In some embodiments, in accordance with a determination that the user input 5004-1 is a swipe input, which continues as user input 5004-3, as illustrated in FIG. 5C, that satisfies a second speed threshold (e.g., that corresponds to a faster speed than the first speed threshold), the second version of control user interface 5002-2 is displayed, optionally without displaying the first version of control user interface 5002-1.

In some embodiments, the first version of control user interface 5002-1 includes an edit control 5006 for adding, removing and/or rearranging controls in the control user interface 5002, a power control 5008 for initiating a device power off function, and optionally includes one or more controls for performing various operations at device 100. For example, the one or more controls include: a connectivity control grid 5010 that includes a plurality of controls for one or more connectivity options (e.g., turning on and/or off WiFi, Airplane mode, cellular connectivity, Bluetooth, VPN, and/or other connectivity controls), a playback platter 5012 that includes one or more controls for controlling media playback, an orientation lock control 5014 for locking a displayed orientation of the device 100 to a portrait view (e.g., and/or a landscape view) such that the displayed user interfaces do not rotate in response to detecting a rotation of the device 100, a display mirroring control 5024 for causing an external display device to display the user interface displayed on the device 100, a focus mode control 5016 for setting a notifications mode, a brightness control 5020 for changing a brightness level of the display of the device 100, and/or a volume control 5022 for adjusting a volume of the device 100. It will be understood that alternative and/or additional controls may be included in the first version of control user interface 5002-1.

In some embodiments, the second version of control user interface 5002-2 corresponds to an expanded version of the first version of the control user interface 5002-1. For example, the second version of control user interface 5002-2 includes the controls described with reference to the first version of control user interface 5002-1, and one or more additional controls, such as flashlight control 5028 for turning a flashlight of the device 100 on and/or off (e.g., and/or controlling a brightness level or color temperature of the flashlight), timer control 5026 for accessing a timer user interface and/or starting a preset timer, calculator control 5038 for accessing a calculator application, camera control 5036 for displaying a camera preview, low power mode control 5032 for turning a low power mode to reduce power consumption of the device 100 on and/or off and/or screen recording control 5034 for initiating a screen recording operation of the device 100.

In some embodiments, the device 100 detects a user input 5018 (e.g., in FIGS. 5B, 5D and 5F) corresponding to a request to expand and/or collapse the first version of control user interface 5002-1. For example, in response to the user input 5018 corresponding to a swipe in the downward direction, the second version of control user interface 5002-2 is displayed. In some embodiments, in response to the user input 5018 corresponding to a swipe in the upward direction, the first version of control user interface 5002-1 ceases to be displayed and the device 100 optionally redisplays the user interface 5140 (e.g., in FIG. 5A).

In some embodiments, the second version of control user interface 5002-2 does not correspond to an expanded version of the first version of the control user interface 5002-1. For example, the second version of control user interface 5002-2 includes a different set of controls that optionally does not include all of the controls available in the first version of the control user interface 5002-1.

In some embodiments, the control user interface 5002 includes pagination indicators 5030 (e.g., indicators 5030-1 through 5030-6). In some embodiments, each pagination indicator 5030 corresponds to a page of controls of the control user interface 5002. For example, in FIG. 5B, control user interface 5002 is displayed with 6 page indicators indicating 6 pages of controls are available in the control user interface 5002. In some embodiments, the indicator 5030-1 is highlighted or otherwise visually emphasized to indicate the currently selected page corresponds to the first version of the control user interface 5002-1. In some embodiments, one or more of the page indicators include an icon or other representation indicating contents of the respective page of the control user interface corresponding to the respective page indicator (e.g., optionally in accordance with a determination that the controls in the respective page correspond to a same type of content and/or category of controls). For example, a favorites icon is displayed as the indicator 5030-2 (e.g., instead of, or next to, a pagination dot indicator). Similarly, a connectivity icon is displayed as the indicator 5030-3 (e.g., instead of, or next to, a pagination dot indicator), a now playing icon is displayed as the indicator 5030-4 (e.g., instead of, or next to, a pagination dot indicator), and a home controls icon is displayed as indicator 5030-6 (e.g., instead of, or next to, a pagination dot indicator). In some embodiments, pages of the control user interface that are not identified as a particular type of controls (e.g., a customized page of the control user interface that the user adds and/or removes controls, including unrelated controls not related to a particular type of control) are displayed with a pagination dot, such as indicator 5030-5.

In FIGS. 5B-5C, a separate pagination indicator 5030-1 is shown as corresponding to the first version of the control user interface 5002-1. In some embodiments, pagination indicator 5030-1 is optionally not displayed (e.g., favorites indicator 5030-2 is displayed as representing both the first version of the control user interface 5002-1 and the second version of the control user interface 5002-2).

FIGS. 5D-5E illustrate that, in some embodiments, based on a distance of the swipe input 5004-1, the first version of control user interface 5002-1 and/or the second version of control user interface 5002-2 is displayed. For example, in accordance with a determination that the swipe user input 5004-1 satisfies a first distance threshold, as performed by swipe input 5004-4 in FIG. 5D, the device 100 displays the first version of control user interface 5002-1 and in accordance with a determination that the swipe user input 5004-1 satisfies a second distance threshold (e.g., that is greater than the first distance threshold), as performed by swipe user input 5004-5 in FIG. 5E, the device 100 displays the second version of control user interface 5002-2. As such, the first and/or second version of the control user interface 5002 is displayed based on a speed and/or distance (e.g., magnitude) of the user input 5004.

FIGS. 5F-5G illustrate that, in some embodiments, the first version of control user interface 5002-1′ and/or the second version of control user interface 5002-2′ are displayed within a platter that overlays the user interface 5140.

FIG. 5H illustrates in response to detecting a user input 5060, optionally as a continuation of the swipe user input 5004-1 (e.g., without detecting liftoff of the contact of user input 5004-1), overlaps with the indicator 5030-3, the device 100 displays a connectivity page of the control user interface 5002-3, and the pagination indicator 5030-3 is updated to show the connectivity page is currently displayed. In some embodiments, the connectivity page of the control user interface 5002-3 includes one or more controls related to connectivity of device 100. In some embodiments, the connectivity page of the control user interface 5002-3 includes a group of controls that are not individually editable by the user of the device 100 (e.g., the connectivity page of the control user interface 5002-3 includes a preset group of controls), as described in more detail with respect to FIGS. 5AE and 5AQ, below.

In some embodiments, the connectivity page of the control user interface 5002-3 includes, for example, a cellular connectivity control 5042 for turning on and/or off cellular connectivity at device 100, a device-to-device sharing control 5040 for searching for nearby devices and/or sharing files with another device via a local communication channel, a Bluetooth control 5052 for turning on and/or off Bluetooth connectivity, a display mirroring control 5044 for causing an external display device to display the user interface displayed on the device 100, an airplane mode control 5054 for turning on and/or off airplane mode, a hotspot control 5046 for enabling and/or disabling hotspot connectivity from the device 100, a WiFi control 5048 for turning on and/off WiFi connectivity and/or selecting a WiFi network, and a VPN control 5050 for turning on and/or off VPN. In some embodiments, user selection of a respective control causes the device 100 to perform one or more operations associated with the respective control. For example, in response to a user input 5056, such as a tap input or other selection input, directed to the hotspot control 5046, the device 100 displays a user interface element that includes indications of available hotspot devices and/or the device 100 toggles the hotspot connectivity of device 100 on and/or off. In some embodiments, in response to a user input 5058, such as a tap input or other selection input, directed to WiFi control 5048, the device 100 displays a user interface element that includes indications of available wireless networks and/or the device 100 toggles the WiFi connectivity of device 100 on and/or off. In some embodiments, one or more controls are toggles in which the user selects and/or deselects to turn the function associated with the respective control on and/or off (e.g., toggles Bluetooth, Airplane mode, cellular connectivity, or other functionality on and/or off). In some embodiments, one or more controls, when selected, provide the user with one or more user-selectable options, such as a list of available networks in response to the user input 5058, or selectable options for setting a focus mode of the device, and in response to detecting an additional user input selecting one of the selectable options, the device 100 sets the function controlled by the selected option (e.g., connects to the selected wireless network, sets the device to the selected focus mode, and/or performs another operation).

FIG. 5I illustrates a now playing page of the control user interface 5002-4. In some embodiments, the now playing page of the control user interface 5002-4 is displayed by the device 100 in response to detecting a user input 5062 (e.g., optionally a continuation of the swipe user input 5004-1 and/or the user input 5060 (e.g., without detecting liftoff of the contact of user input 5004-1 and/or the user input 5060)) that overlaps with the indicator 5030-4, and the now playing indicator 5030-4 is visually emphasized to indicate the now playing page of the control user interface 5002-4 is currently displayed.

In some embodiments, the now playing page of the control user interface 5002-4 includes a platter 5064-1 that includes information related to media that is currently played back at device 100 (e.g., “this device”). In some embodiments, if no media is currently playing back at device 100, the platter 5064-4 includes one or more recommended media content items to playback (e.g., Content W, X, Y and Z) and indicates that the device 100 is “Not Playing.” In some embodiments, the now playing page of the control user interface 5002-4 includes one or more playback controls for controlling playback of media content at device 100. For example, the one or more playback controls include a play control, which, when selected by a user input 5066, causes the device 100 to initiate playback of media content. In some embodiments, the one or more playback controls include a skip backwards control, a skip forwards control and/or a volume control. In some embodiments, in response to detecting a user input 5068, such as a tap or a swipe input, directed to the volume control, the device 100 changes the volume of the device 100.

In some embodiments, the now playing page of the control user interface 5002-4 includes one or more options 5072, 5070, and 5074 for switching between devices at which to control media playback. For example, in response to detecting a user input 5076, such as a tap input or other selection input, directed to an option 5070 for Device 2 (e.g., an external speaker, a TV, headphones, and/or another type of playback device), the now playing page of the control user interface 5002-4 is updated to display a platter 5064-2 (e.g., in FIG. 5J) that includes one or more playback controls for controlling Device 2, which is different from the device 100 (e.g., “this device”). Similarly, a user input selecting the option 5074 for controlling Device 3 enables the user to control playback at Device 3. In some embodiments, the user input 5076 is a swipe input along a bottom portion of the now playing page of the control user interface 5002-4.

FIG. 5J illustrates detecting a user input 5078 directed to the option 5072 for controlling This Device. In some embodiments, in response to detecting the user input 5078, the platter 5064-1 is redisplayed with one or more controls for controlling playback of media at device 100, as illustrated in FIG. 5K. In some embodiments, as illustrated in FIG. 5K, in response to detecting a tap input or other selection input directed to a respective indicator 5030, the device 100 displays a respective page of the control user interface 5002 that corresponds to the respective indicator 5030. In some embodiments, in response to detecting the user input 5080, such as a tap input or other selection input, directed to indicator 5030-1, the first version of the control user interface 5002-1 is displayed. In some embodiments, in response to detecting the user input 5082, such as a tap input or other selection input, directed to indicator 5030-3 corresponding to the connectivity icon, the connectivity page of the control user interface 5002-3 is displayed.

In some embodiments, in response to detecting the user input 5084, such as a tap input or other selection input, directed to indicator 5030-6 corresponding to the home controls icon, the device 100 displays a home controls page of the control user interface 5002-5, as illustrated in FIG. 5L. In some embodiments, the home controls page of the control user interface 5002-5 (e.g., in FIG. 5L) includes one or more controls for one or more home devices associated with device 100. For example, the home controls page of the control user interface 5002-5 includes a lights control 5086 for controlling one or more lights and/or displaying a status of one or more lights in the home, a lock control 5098 for locking one or more doors and/or windows, a climate control 5088 for changing a thermostat setting and/or displaying a status of a current room temperature, one or more scene controls, such as leave home scene 5090, arrive home scene 5092 and/or wake up scene 5100, and optionally one or more room controls 5094 and 5096 for controlling features of a selected room associated with the room control. In some embodiments, in response to a user selection of a scene control, one or more operations programmed for the selected scene control are performed automatically without additional user input. For example, in response to a user input 5102, such as a swipe input, to turn on the leave home scene 5090 control, the device 100 causes one or more operations associated with the leave home scene control to be performed, such as turning off one or more lights, changing the thermostat setting, and/or other programmed operations for the scene. For example, FIG. 5M illustrates that, while the leave home scene is turned on, the leave home scene control 5090′ is optionally visually updated, such as shaded in, visually emphasized, visually deemphasized, or otherwise changed relative to the leave home scene 5090 control that is displayed while the leave home scene is not active (e.g., is not turned on). For example, lights control 5086′ indicates the 3 lights have been turned off and the climate control 5088′ indicates the thermostat has been turned down in response to activation of the leave home scene control 5090′.

In some embodiments, one or more controls are swipe controls or tap controls. For example, the scene controls 5090, 5092 and 5100 (e.g., in FIG. 5L) are illustrated as swipe controls that require a swipe input to toggle the control on and/or off, while one or more other controls, such as lock control 5098 is illustrated as tap control that requires a tap input to toggle the control on and/or off. In some embodiments, one or more controls require more than one user input to activate and/or deactivate the respective control. For example, selection of the multi-step control (e.g., WiFi control 5048, room control 5094, focus mode control 5016 and/or other controls) causes the device 100 to display one or more selectable option for the user to select in order to activate the selected option. In some embodiments, a user selects whether to make a respective control a swipe and/or a tap control via an editing control user interface, as described with reference to FIG. 5AM below.

In some embodiments, in response to a user input 5106 (e.g., in FIG. 5M), such as a swipe user input, the user scrubs through the pages of the control user interface 5002 by swiping along the indicators 5030 representing the respective pages of the control user interface 5002. In some embodiments, an additional indicator 5108 is optionally dynamically displayed next to the selected indicator 5030-6 while the user input 5106 is directed to the indicator 5030-6. For example, the additional indicator 5108 indicates the selected indicator is the “Home” controls page. In some embodiments, the user input 5106 continues to swipe upwards as user input 5132 in FIG. 5N to display a page of the control user interface 5002-6 corresponding to the indicator 5030-5. In some embodiments, the page of the control user interface 5002-6 includes one or more controls added by the user that do not belong to a preset group of controls (e.g., a preset page of controls). For example, the page of the control user interface 5002-6 includes a vehicle unlock control 5112 for unlocking and/or locking a respective vehicle, a silence/ringer control 5116 for controlling a volume level of a ringer of the device 100, a dark mode control 5118 for turning on and/or off a dark mode of the display of the device 100 whereby content displayed with a light background is displayed with a black and/or dark background while dark mode is enabled, a magnifier control 5124 for opening a camera preview that includes zooming in the field of view of one or more cameras to magnify a subject in the field of view of the one or more cameras, a remote control 5128 for controlling one or more remote devices, such as televisions, speakers and/or other devices, an alarm control 5120 for opening an alarm user interface, optionally associated with a clock application, a notes control 5130 for generating a new note via a notes application, a voice recording control 5122 for initiating a voice recording, and a virtual assistant control 5126 for invoking a digital assistant of the device 100.

In some embodiments, as illustrated in FIG. 5O, the user input 5134 is detected (e.g., as a continuation of user input 5132 and user input 5106) over the favorites indicator 5030-2, and in response to the user input 5134, the second version of the control user interface 5002-2 is displayed. In some embodiments, upon liftoff of the user input 5134, the second version of the control user interface 5002-2 continues to be displayed, as illustrated in FIG. 5P. As such, the respective pages of the control user interface 5002 are displayed (e.g., as previews) while a user input scrubs over the respective indicators of the respective pages and the respective page that is displayed upon detecting an end of the user input 5134 remains displayed as the selected page.

In some embodiments, as illustrated in FIG. 5P, a user input 5136 and/or a user input 5138, such as a swipe input in an upward direction, corresponds to a request to dismiss the control user interface 5002-2. In some embodiments, the swipe user input 5138 starts at a respective location in the user interface 5002-2 corresponding to a bottom edge of the user interface 5002-2. In some embodiments, the swipe user input 5136 starts at a respective location in the user interface 5002-2 that does not correspond to an edge and optionally starts at a location in the user interface 5002-2 that does not overlap with the one or more controls displayed in the control user interface 5002-2. In some embodiments, in response to the request to dismiss the control user interface 5002-2, the device 100 redisplays the user interface that was displayed immediately prior to displaying the control user interface 5002. For example, the home screen user interface 5140 is redisplayed, as illustrated in FIG. 5Q.

FIG. 5Q illustrates an active music session that is active at device 100, as indicated by session region 5142. In some embodiments, while the music session is active, the device 100 detects a user input 5144 directed to a top right portion of the user interface 5140, and in response to detecting the user input 5144, in accordance with a determination that the user input 5144 is a swipe input downward (e.g., that continues as user input 5148, FIG. 5R, and optionally ends before or while the user input 5148 is over the favorites indication 5030-2), the device 100 displays a modified version of the second version of the control user interface 5002-2′. For example, the control user interface 5002-2′ is modified to include a larger music control 5146 while the music session is active at device 100, and optionally maintains the larger music control 5146 until a time period (e.g., 1 minute, 3 minutes, 10 minutes, or another time period) has elapsed after the music session is inactive (e.g., the device 100 ceases playback of media content). As such, the modified control user interface 5002-2′ is modified based on a current context of the device 100. In some embodiments, one or more other contexts (e.g., other than a currently active application) cause the device 100 to update the control user interface 5002-2.

FIG. 5S illustrates displaying the now playing user interface page of the control user interface 5002-4 in response to detecting user input 5150 (e.g., optionally a continuation of swipe user input 5148) that overlaps the now playing indication 5030-4. In some embodiments, in response to detecting a user input 5152 directed to a device selection icon, the device 100 displays one or more available devices (e.g., device 100 and/or one or more other devices, such as speakers, TV s, headphones or other external devices) to cause playback of the currently playing media item (e.g., Song A) to occur at the selected device of the one or more available devices. For example, in response to the user input 5152, the device 100 displays a list of available devices that includes device 100 (e.g., this device) and an external device, and in response to the user selecting the external device, via a tap input or other selection input, from the list of available devices, a command to stream Song A is sent from device 100 to the external device, such that the external device begins to play back Song A.

FIGS. 5T-5V illustrate a second version of the now playing page of the control user interface 5002-7 that is optionally displayed instead of (e.g., as an alternative to) the now playing page of the control user interface 5002-4. In some embodiments, the second version of the now playing page of the control user interface 5002-7 includes one or more platters 5064, including platter 5064-1 for This Device, platter 5064-2 for Device 2, and platter 5064-3 for Device 3. In some embodiments, the platters 5064 are displayed as stacked, such as in a deck. In some embodiments, a platter 5064 is displayed for each device for which the device 100 is currently accessing or otherwise controlling playback. In some embodiments, a user input on a respective control displayed in the platter 5064-1 causes the device 100 to perform an operation associated with the respective control. For example, in response to detecting a user input 5154, such as a tap input or other selection input, directed to the pause control, playback of Song A is paused at device 100. Similarly, user inputs directed to a respective control displayed in platter 5064-2 causes the device 100 to perform an operation associated with the respective control with respect to Device 2. As such, the controls displayed within a platter control playback at the respective device associated with the platter.

In some embodiments, the user is enabled to switch between the platters 5064-1, 5064-2 and 5064-3 via swipe and/or tap inputs. For example, a user input 5156 (e.g., in FIG. 5T), such as a tap input, directed to platter 5064-2 causes the device 100 to display platter 5064-2 in the foreground stacked on top of the platters 5064-1 and 5064-3. In some embodiments, user input 5156 is a swipe input (e.g., in the downward direction) to cause device 100 to display platter 5064-2 in the foreground, as illustrated in FIG. 5U. As illustrated in FIG. 5U, the platter 5064-2 for controlling device 2 includes controls and a playback status of Device 2, such as the currently playing media (e.g., song B) at Device 2, the volume of Device 2, and controls for controlling playback of Device 2.

In some embodiments, the device 100 detects a user input 5158 (e.g., in FIG. 5U), such as a tap input or other selection input, directed to platter 5064-3 for Device 3. In some embodiments, in response to detecting the user input 5158, the device 100 displays the platter 5064-3 in the foreground of the control user interface 5002-7 such that platter 5064-3 stacks on top of platters 5064-1 and 5064-2, as illustrated in FIG. 5V.

In some embodiments, in response to detecting a user input 5160 (e.g., in FIG. 5V) corresponding to a request to dismiss the control user interface 5002-7, home screen user interface 5140 is redisplayed, as illustrated in FIG. 5W. In some embodiments, a voice recording session is active at device 100, as indicated by the voice recording indication 5162 in the session region. In some embodiments, while the voice recording session is active, in response to detecting a user input 5164 (e.g., in FIG. 5W) corresponding to a request to display the control user interface 5002, the device 100 displays a modified version of the control user interface 5002-2″ that includes an expanded indication 5166 of the active voice recording, as illustrated in FIG. 5X, and optionally changes a position and/or layout of one or more of the other controls displayed in the control user interface 5002-2″ relative to the position and/or layout of the controls in the control user interface 5002-2. In some embodiments, the expanded indication 5166 includes one or more controls for the voice recording, such as stop control 5168. In some embodiments, in response to detecting a user input 5170 directed to the stop control 5168, the device 100 ceases the voice recording.

In some embodiments, in response to detecting the user input 5164 (e.g., in FIG. 5W) corresponding to a request to display the control user interface 5002, the device 100 displays modified version of the control user interface 5002-2′″, as illustrated in FIG. 5Y. In some embodiments, the modified version of the control user interface 5002-2′″ includes a selectable option 5174-1 for accessing additional controls (e.g., microphone controls, privacy controls and/or other controls). For example, in response to detecting a user input 5176 directed to the selectable option 5174-1, the device 100 displays the user interface 5178, as illustrated in FIG. 5Z.

In some embodiments, the user interface 5178 (e.g., in FIG. 5Z) optionally includes the expanded indication 5166 of the active voice recording. In some embodiments, the user interface 5178 does not include the expanded indication 5166 of the active voice recording. In some embodiments, the user interface 5178 displays indications of hardware (e.g., microphone(s), camera(s), speaker(s), location detection and/or other hardware) of device 100 that are currently and/or recently in use and/or being accessed. In some embodiments, the user interface 5178 includes one or more controls for settings related to the hardware. For example, in FIG. 5Z, a set of control options 5182 is displayed for the microphone that is currently being accessed by the voice recording session. In some embodiments, a representation of the audio that is obtained by the microphone is displayed as a waveform. In some embodiments, the control options 5182 include controls such as whether to enable and/or disable voice isolation, to use the microphone in a standard mode, and/or capture wide spectrum audio data. In some embodiments, in response to a user input 5188, the device 100 displays one or more options for modifying the setting (e.g., the voice isolation setting).

In some embodiments, the user interface 5178 further includes privacy indications 5184 that indicate one or more applications that are currently and/or recently using and/or accessing hardware related to privacy (e.g., microphone(s), camera(s), speaker(s), location detection and/or other hardware). For example, the voice recording application is using the microphone and location of device 100, the maps application is and/or was recently using the location of device 100 and the weather application is and/or was recently using the location of device 100.

FIG. 5AA illustrates another example of device 100 displaying modified version of the control user interface 5002-2′″ and FIG. 5AB illustrates another example of device 100 displaying the user interface 5178 while a video call is active and/or a game application is active. In some embodiments, as illustrated in FIG. 5AA, the modified version of the control user interface 5002-2′″ includes selectable option 5174-2 for accessing one or more controls (e.g., hardware controls, privacy controls and/or other controls) for the video call and selectable option 5174-3 for accessing, via user input 5192, one or more controls for a game session (e.g., turning game mode on and/or off and/or accessing settings for game mode). In some embodiments, the modified version of the control user interface 5002-2′″ includes alternative and/or additional selectable options that indicate the status of one or more operations performed at the device 100. For example, in some embodiments, an indication of a transfer state is displayed in accordance with a determination that a wireless transfer (e.g., via a device-to-device network or other wireless connection) is requested, initiated and/or ongoing, such that the status of the transfer state is displayed in the control user interface 5002.

In some embodiments, in response to detecting the user input 5190 (e.g., in FIG. 5AA), such as a tap input or other selection input, directed to selectable option 5174-2, the device 100 displays the user interface 5178 illustrated in FIG. 5AB. In some embodiments, the user interface 5178 includes a set of control options, such as for enabling and/or disabling video effects, enabling and/or disabling portrait mode, and/or changing a level of zoom, for the camera that is being accessed by the device 100. In some embodiments, a preview of the camera feed 5196 is displayed in the user interface 5178 and updates in accordance with changes made via the set of control options for the camera. For example, in response to a user input 5200 directed to the portrait mode control, in accordance with a determination that the user input is a first type of input, such as a tap input or other selection input directed to the portrait mode control, portrait mode is toggled on and/or off. In some embodiments, while portrait mode is toggled on, one or more additional settings for portrait mode are displayed, such as a depth of focus, “f” for the portrait mode. In some embodiments, in response to a user input 5198, in accordance with a determination that the user input 5198 is a second type of user input, such as a swipe, drag, tap, or other selection input directed to a respective setting of the one or more additional settings (e.g., a depth of focus setting), the device 100 updates the respective setting in accordance with the user input 5198. For example, the depth of focus setting is updated to decrease the depth of focus of portrait mode in accordance with a determination that user input 5198 is a leftward swipe input.

In some embodiments, alternative and/or additional settings are displayed, while a respective control for the settings is enabled, such that the user modifies the setting(s) from the user interface 5178 without requiring the user to navigate to a settings user interface. In some embodiments, privacy indications 5184 are updated to display that the video call application is currently accessed and/or has recently accessed a microphone and a camera of device 100, as illustrated in FIG. 5AB. In some embodiments, in response to a user input corresponding to a request to dismiss the user interface 5178, such as a tap input directed outside of the one or more controls, a swipe input upward from a bottom edge of the user interface 5178, a swipe input downward from a top right corner of the user interface 5178 and/or another type of input, the device 100 ceases display of user interface 5178 and optionally redisplays control user interface 5002-2 (e.g., or another user interface, such as a home screen user interface, an application user interface, or a wake screen user interface).

FIG. 5AC illustrates detecting a user input 5207 directed to a WiFi control displayed within the connectivity control grid 5010 in the control user interface 5002-2. In some embodiments, in response to the user input 5207, the WiFi connectivity of the device 100 is toggled off and/or on. In some embodiments, in response to detecting a user input 5209 directed to the miniature representations of connectivity controls that is displayed in the bottom right corner of the connectivity control grid 5010, the connectivity control grid 5010 is expanded (e.g., each of the miniature representations of connectivity controls are expanded to a larger size such that they are selectable by user inputs).

In some embodiments, in response to detecting a user input 5204 (e.g., in FIG. 5AC) directed to focus mode control 5016, a plurality of focus mode options are displayed such that the user is enabled to select, via a second input after user input 5204, a respective focus mode from the plurality of focus mode options. In some embodiments, in response to detecting the second input after the user input 5204, the device 100 is set to the selected respective focus mode in which notifications (e.g., all notifications or a subset, less than all, notifications (e.g., notifications of a first type, second type, or other groups of notifications)) delivery preferences are modified (e.g., notifications are silenced, delayed, summarized, or otherwise set to various notification levels) based on the selected focus mode.

In some embodiments, in response to detecting a user input 5202 (e.g., in FIG. 5AC) directed to an action button (e.g., a hardware control disposed on the surface or side of device 100, such as a solid state button, a mechanical push button, a toggle switch, or other types of hardware affordances), an operation associated with the action button is performed. For example, the action button is programmed to perform a user-selected operation. In some embodiments, the operation corresponds to an operation that is also performed in response to user selection of a control displayed in the control user interface. For example, the action button is programmed to toggle dark mode on and/or off (e.g., as described below with reference to FIGS. 5CQ-5CR), or to perform another operation, such as turning a flashlight on and/or off, starting a voice recording, setting a respective focus mode, starting a new note, and/or other operations.

FIG. 5AC further illustrates detecting a user input 5206, such as a tap input or other selection input, that is not directed to any of the controls. In some embodiments, in response to the user input 5206, the control user interface 5002-2 ceases to be displayed. In some embodiments, in accordance with a determination that the user input 5206 satisfies a first set of criteria, such as maintaining the user input 5206 for at least a threshold amount of time (e.g., a long press, press and hold, or other type of input that satisfies the first set of criteria), the device 100 displays an editing control user interface 5210-1, as illustrated in FIG. 5AD.

In some embodiments, in response to detecting a user input 5208 (e.g., in FIG. 5AC), such as a tap input or other selection input, directed to the edit control 5006, the device 100 displays the editing control user interface 5210-1 illustrated in FIG. 5AD. In some embodiments, the editing control user interface 5210-1 (e.g., in FIG. 5AD) enables the user to modify the control user interface 5002, including adding, removing, rearranging, resizing, and/or otherwise modifying the control user interface 5002. In some embodiments, the editing control user interface 5210-1 includes indications 5216 of available positions at which controls may be placed. For example, the editing control user interface 5210-1 includes representations of the controls displayed in control user interface 5002-1 in an editable state. In some embodiments, while the representations of the controls are in the editable state, the device 100 optionally animates the representations of the controls such that the representations of the controls appear to shake and/or jiggle (e.g., small animated side-to-side movements while remaining substantially in place).

In some embodiments, one or more of the representations of controls, such as a representation of the low power mode control 5032′, are displayed with a remove affordance 5218 and/or a resize affordance 5220. In some embodiments, one or more representations of controls are displayed without a remove and/or resize affordance, in accordance with a determination that a respective control cannot be removed and/or resized. In some embodiments, controls are grouped together, such as the connectivity control grid 5010, such that individual controls within the grid are not individually modifiable and the grid is modified as a whole. For example, the representation of the connectivity control grid 5010′ is displayed with one remove affordance for the grid (e.g., without displaying remove affordances on the individual controls, such as the WiFi control or the Airplane mode control) and one resize affordance for the grid.

In some embodiments, the editing control user interface 5210-1 (e.g., in FIG. 5AD) includes a placeholder pagination indication 5030-7 to represent that an additional page is available, inserted after the current page (e.g., and/or at a different position, such as before the current page or as a last page) of the control user interface 5210-1, to place additional controls. As such, in response to the user moving controls and/or adding controls that do not fit within the current page 5210-1, the controls that do not fit are automatically reflowed to the additional page represented by placeholder pagination indication 5030-7. In some embodiments, the placeholder pagination indication 5030-7 is displayed with distinct visual properties relative to the other indications 5030-1 through 5030-6 to indicate that it is temporary (e.g., until controls are added to the additional page represented by placeholder pagination indication 5030-7). For example, in response to the user selecting “Done,” without adding controls to the additional page represented by placeholder pagination indication 5030-7, the device 100 redisplays the control user interface 5002-2 (e.g., as illustrated in FIG. 5AC) without adding the additional page and without displaying the pagination indication 5030-7.

In some embodiments, in response to detecting a user input 5214 (e.g., in FIG. 5AD), such as a tap input or other selection input, directed to the add controls button 5212 in the editing control user interface 5210-1, the device 100 displays a controls search user interface 5224, as illustrated in FIG. 5AE. In some embodiments, the controls search user interface 5224 includes a search bar 5222 and one or more categories of controls, such as “suggestions”, “battery”, and “connectivity”, to enable the user to easily find and identify controls that may be added to the control user interface 5002. In some embodiments, in response to detecting a user input 5230 directed to silence control 5228, the selected silence control 5228 is added to the editing control user interface 5210-1, as illustrated in FIG. 5AF. In some embodiments, in response to detecting a user input selecting a respective control in the controls search user interface 5224, the device 100 ceases display of the controls search user interface 5224 and redisplays the editing control user interface 5210-1, including the added silence control 5228. In some embodiments, the added silence control 5228 is positioned at a first available slot (e.g., from top-to-bottom, left-to-right and/or another order of availability, as indicated by indications 5216) in the editing control user interface 5210-1. In some embodiments, the control selected from the controls search user interface 5224 is added to the respective page of the editing control user interface 5210 that is displayed while the user input (e.g., user input 5214) selecting the add controls button 5212 is detected. For example, the add controls button 5212 is displayed on each page of the editing control user interface 5210 such that the user can add controls to any of the pages directly by selecting the add controls button 5212 while the respective page is displayed.

In some embodiments, in response to detecting a user input 5232 selecting the add controls button 5212, as illustrated in FIG. 5AF, the controls search user interface 5224 is redisplayed (as illustrated in FIG. 5AE). In some embodiments, in response to a user input 5226 directed to the search bar 5222, a keyboard is optionally displayed for the user to type search terms in the search bar 5222. For example, as illustrated in FIG. 5AG, the user searches “dark mode” in the search bar 5222, and in response to the user search, the device 100 displays search results that match the user search. In some embodiments, the device 100 displays individual controls and/or categories of controls in response to the user search. For example, for a user search of “home,” the device 100 displays a category of home controls and/or one or more controls that are associated with the search term “home.”

FIG. 5AG illustrates detecting a user input 5236-1 selecting the dark mode control 5234, and detecting that user input 5236-1 is a drag input that moves across the display of device 100. In some embodiments, in response to detecting that the user input 5236-1 (e.g., in FIG. 5AG) is a drag user input, the device 100 ceases display of the controls search user interface 5224 and displays the editing control user interface 5210-1 to allow the user input 5236-1 to drag the control 5234 to a respective position in the editing control user interface 5210-1. For example, as illustrated in FIG. 5AH, the drag user input 5236-2 positions the dark mode control 5234 between the screen recording control and the silence control 5228.

In some embodiments, in response to detecting a user input 5238 (e.g., in FIG. 5AH) directed to the remove affordance 5218 of the representation of low power mode control 5032′, the representation of low power mode control 5032′ is removed from editing control user interface 5210-1, as illustrated in FIG. 5AI. In some embodiments, one or more representations of other controls in the editing control user interface (e.g., screen recording control 5034′ and/or dark mode control 5234) are optionally automatically, without user input, reflowed (e.g., moved to the left) to fill the empty space that is left by removing the representation of low power mode control 5032′. In some embodiments, the one or more representations of other controls in the editing control user interface are not automatically reflowed in response to removing the representation of low power mode control 5032′.

In some embodiments, in response to detecting a user input 5227 (e.g., in FIG. 5AH) directed to representation of silence control 5228, in accordance with a determination that the user input 5227 is a drag movement, the representation of silence control 5228 is moved in accordance with the user input 5227, for example, to a position that corresponds to an end of the user input 5227 (e.g., where the user input 5227 lifts off the display of device 100), as illustrated in FIG. 5AI.

FIG. 5AI illustrates a user input 5240 corresponding to a request to resize the representation of screen recording control 5034′. In some embodiments, the user input 5240 is a drag input or other selection input of the resize affordance. For example, dragging the resize affordance outward, away from the representation of screen recording control 5034′ causes the device 100 to increase a size of the representation of screen recording control 5034′ to the representation of screen recording control 5034″, as illustrated in FIG. 5AJ. In some embodiments, the control 5034′ has a maximum size (e.g., to fill a 2×2 grid space, a 3×2 grid space, a 3×3 grid space, or another size) and/or a minimum size (e.g., to fill a 1×1 grid space, a 1×2 grid space, or another size). For example, the control 5034′ is resized (e.g., via the user input 5240) up to its maximum size but cannot be resized (e.g., via the user input 5240 and/or another user input) to a size larger than the maximum size or to a size smaller than the minimum size. In some embodiments, different respective controls have different respective maximum sizes and/or different respective minimum sizes. In some embodiments, the representation of screen recording control 5034″ includes additional information and/or additional control options than the representation of screen recording control 5034′. For example, the representation of screen recording control 5034″ displays a control option to start screen recording 5242.

FIG. 5AJ further illustrates the device 100 detecting a user input 5246 selecting a menu button 5244, and in response to detecting the user input 5246, the device 100 displays a menu 5254, as illustrated in FIG. 5AK. In some embodiments, the menu 5254 includes one or more options for changing a layout, such as a number of columns and/or size of the representations of controls, and/or turning labels for the representations of controls on and/or off (e.g., via option 5256). For example, in response to a user input 5250 (e.g., in FIG. 5AK) directed to the option to change the layout to a 3 column layout (e.g., as opposed to the 4 column layout of the editing control user interface 5210-1 displayed in FIG. 5AK), the device 100 optionally increases a size of each respective representation of a control option in the editing control user interface 5210-1 and rearranges the representations of control options in a 3 column layout, as illustrated in FIG. 5AL.

In some embodiments, changing the layout of one page of the editing control user interface causes the layout of each of the other pages of the editing control user interface to also change. In some embodiments, each page is independently configurable to have a different layout (e.g., a first page has a 3 column layout, a second page has a 4 column layout, and/or other pages have the same and/or other layouts).

In some embodiments, changing the layout to a 3 column layout causes the device 100 to push the overflowed representations of controls to a second page of the editing control user interface 5210-2 that do not fit within the 3 column layout of the first page of the editing control user interface 5210-1. In some embodiments, in accordance with a determination that the second page of the editing control user interface 5210-2 (e.g., in FIG. 5AP) includes one or more controls, the placeholder pagination indicator 5030-7 is updated to an indicator 5030-7′ indicating that the additional page has been added and includes one or more controls.

In some embodiments, in response to detecting a user input 5248 (e.g., in FIG. 5AK) directed to the option to turn on and/or off labels (e.g., text labels describing the controls), while the option is set to “off”, the device 100 turns the labels on and displays a label for the respective representations of control options in the editing user interface 5210-1, as illustrated in FIG. 5AL. For example, the text “Timer” 5258 is displayed below the representation of the timer control 5026′. In some embodiments, labels are automatically displayed in the editing user interface 5210-1, without requiring the user to request to turn the labels on, regardless of whether or not the labels are displayed in the control user interface 5002. In some embodiments, in response to the user input 5248, the labels are turned on in the editing user interface 5210-1 and continue to be displayed in the control user interface 5002.

FIG. 5AL illustrates the device 100 detecting a user input 5260 directed to the representation of the timer control 5026′, and in response to the user input 5260, the device 100 optionally displays an animation that flips over the representation of the timer control 5026′ and presents the user with options for the representation of the timer control 5026′, as illustrated in FIG. 5AM. In some embodiments, the device 100 displays a platter 5262 that includes options for different configurations of the representation of the timer control 5026′, for example a small configuration that, when selected (e.g., via a tap input or other selection input), displays a user interface for the timer application, and a swipe configuration that is larger than the small configuration, with a preset amount of time on the timer that, when selected (e.g., via a swipe input across the “slide to start” timer control 5026″), initiates a timer for the preset amount of time (e.g., 5 minutes, 10 minutes, or another amount of time). In some embodiments, in response to detecting the user input 5264 (e.g., in FIG. 5AM) selecting the “slide to start” timer control 5026″, the “slide to start” timer control 5026″ is added to the editing control user interface 5210-1, as illustrated in FIG. 5AN. For example, the “slide to start” timer control 5026″ functions like the home scene 5090 control (e.g., in FIG. 5L) that is also a slider control.

FIG. 5AO illustrates the device 100 detecting a user input 5266 corresponding to a request to move the representation of the camera. For example, user input 5266 corresponds to a drag input to the right and/or downward and in response to the user input 5266, the device 100 displays a second page of the editing control user interface 5210-1, and the representation of the camera control 5036′ is moved to the second page of the editing control user interface 5210-2, as illustrated in FIG. 5AP.

In some embodiments, in response to detecting a user input 5268 directed to indicator 5030-3, the device 100 displays a connectivity page of the editing control user interface 5210-3 corresponding to the indicator 5030-3, as illustrated in FIG. 5AQ. In some embodiments, the connectivity page of the editing control user interface 5210-3 (e.g., in FIG. 5AQ) includes a plurality of controls that are grouped together as a preset page 5270. For example, a remove affordance 5218 is displayed for the preset page 5270 of connectivity controls, without displaying remove affordances for the individual controls within the preset page 5270. For example, the preset page 5270 is available to be added, in its entirety, from controls search user interface 5224. In some embodiments, the one or more of the indicators that include labels (e.g., indicator 5030-3, 5030-4 and 5030-6) correspond to preset pages, whereby the respective label corresponds to the type of preset page (e.g., a connectivity page, a now playing page, a home controls page, and other types of preset pages). In some embodiments, the user reorders the preset page 5270 via user input 5272-1, such as a drag user input that continues as user input 5272-2, to drag the preset page 5270 past the now playing page of the editing control user interface 5210-4, as illustrated in FIG. 5AR.

For example, FIG. 5AS illustrates the preset page 5270 of connectivity controls is reordered, as indicated by indicators 5030-4 and 5030-3, to be after the now playing editing control user interface 5210-4. FIG. 5AS illustrates the device 100 detecting a user input 5272 selecting indicator 5030-7 and, in response to the user input 5272, the device 100 displays the second page of the editing control user interface 5210-2, as illustrated in FIG. 5AT.

In some embodiments, in response to detecting a user input 5274 (e.g., in FIG. 5AT) directed to the add controls button 5212, the search user interface 5224 is displayed. In some embodiments, as illustrated in FIG. 5AU, a representation of the preset page 5276 of connectivity controls is available. For example, in response to a user input selecting the representation of the preset page 5276 from the search user interface 5224, the preset page 5270 is added as a new page to the editing control user interface 5210 (e.g., and the control user interface 5002). In some embodiments, the search user interface 5224 is scrollable, and search bar 5222 is optionally maintained at the top of the search user interface 5224, even as the control options are scrolled. For example, in response to the user input 5278 (e.g., in FIG. 5AU), the device 100 scrolls to present additional control options, presented within respective categories of controls (e.g., focus, camera, vehicle, utilities, and other categories), as illustrated in FIG. 5AV.

In some embodiments, in response to a user input 5280 (e.g., in FIG. 5AV) selecting a control 5284 (e.g., a “vehicle unlock” control) that is displayed in the first set of controls under the vehicle category, the control 5284 is added to the editing control user interface 5210-2. In some embodiments, in response to detecting the user input 5290 (e.g., in FIG. 5AV) selecting an application open control 5288 for application C, the control 5288 is added to the editing control user interface 5210-2.

In some embodiments, for a respective category, a first set of controls are displayed (e.g., a maximum number of controls in the respective category that are displayed initially), and an option 5286 for displaying additional available controls for the respective category is displayed. For example, in the “Focus” category, one or more controls for setting the current focus mode of the device 100 to a respective focus mode (e.g., personal, DND, and/or other focus modes) are provided. In some embodiments, in the “Camera” category, one or more controls, optionally associated with one or more third-party applications that access the camera of the device 100, are provided. For example, in response to activating the “S” camera control, a camera preview is opened in the “S” application user interface. In some embodiments, the “Vehicle” category includes one or more controls associated with one or more vehicle applications, such as a control for turning the air conditioning for a respective vehicle on and/or off, an electric vehicle charging application control, a thermostat control for setting a temperature for a respective vehicle, a control to remotely start a respective vehicle, a control to unlock a respective vehicle, a control to control one or more windows and/or one or more doors of a respective vehicle, a control for one or more seat settings (e.g., seat position, seat heating, and/or seat cooling) for a respective vehicle, a control for turning on and/or off headlights of a respective vehicle, and/or a battery management control for a respective vehicle, which optionally displays a status of the current battery level.

In some embodiments, the option 5286 (e.g., in FIG. 5AW) includes an indication of the number of additional controls that are available in the respective category that are not currently displayed. For example, in response to a user input 5282 (e.g., in FIG. 5AV) selecting the option 5286, an additional four vehicle controls, such as seat control 5304, lights control, door control, and battery control, are displayed under the vehicle category as a second set of controls, as illustrated in FIG. 5AW. Thus, the user is enabled to view all of the controls available for the vehicle category by selecting the option 5286 (e.g., in FIG. 5AV). In some embodiments, the user selects, via user input 5300 (e.g., in FIG. 5AW), a control 5304 from the second set of controls to add to the editing control user interface 5210-2.

FIG. 5AW illustrates a scroll input 5302 that causes the device 100 to display additional categories of controls, such as the home category and an Apps category, as illustrated in FIG. 5AX. In some embodiments, the Apps category displays indications of applications of device 100, including one or more third-party applications, that have one or more controls available to be added to the editing control user interface 5210-2. For example, control 5320 is provided by application C and, in response to user input 5322 (e.g., in FIG. 5AX) selecting control 5320, the control 5320 is added to the editing control user interface 5210-2.

In some embodiments, as illustrated in FIG. 5AX, the user selects one or more home controls to add to the editing control user interface 5210-2, for example, in response to detecting user input 5312, the device 100 adds the control 5306 to the editing control user interface 5210-2; in response to detecting user input 5314, the device 100 adds the control 5308 to the editing control user interface 5210-2; in response to detecting user input 5300, the device 100 adds control 5310 to the editing control user interface 5210-2; and in response to detecting user input 5318, the device 100 adds control 5326 to the editing control user interface 5210-2. In some embodiments, in response to the user input 5316, additional controls (e.g., 7 additional controls) under the home category are displayed in the search user interface 5224 and the user optionally selects one or more additional controls to add to the editing control user interface 5210-2.

FIG. 5AY illustrates the editing control user interface 5210-2 that includes additional controls that were added in accordance with user inputs, such as the user inputs described with reference to FIG. 5AX. For example, the control 5310 corresponds to a home control to turn a fan on and/or off, the control 5308 corresponds to a control to initiate a wake up scene, the control 5307 displays a status of a door in a respective home and controls whether the door is open or closed, control 5326 corresponds to a control to initiate the leave home scene, control 5306 corresponds to a control to turn on and/or off one or more lights in a respective home. In some embodiments, the home controls include a thermostat control for setting a temperature (e.g., set to 68 degrees in FIG. 5BA) for a heating and/or cooling system of a respective home. In some embodiments, in response to detecting a user input 5328 directed to scene control 5326, the device 100 displays a user interface 5333 that includes a plurality of options to change the scene control 5326 from a first scene (e.g., “leave home”) to a different scene (e.g., “arrive home,” “wake up,” or another scene), as illustrated in FIG. 5AZ. For example, the user input 5332 (e.g., in FIG. 5AZ) selects the scene control 5330 for the “arrive home” scene, and in response to the user input 5332, the scene control 5326 is replaced with scene control 5330, (e.g., “arrive home”) as illustrated in FIG. 5BA.

In some embodiments, in response to detecting user input 5334 (e.g., in FIG. 5BA) directed to the remove affordance of control 5320 (e.g., a control to perform one or more operations via application C), control 5320 is removed. In some embodiments, control 5320 is displayed without a resize affordance. For example, control 5320 corresponds to a third-party control for a third-party application that cannot be resized and thus is not displayed with a resize affordance in the editing control user interface 5210-2.

FIG. 5BB illustrates creating a customized group of controls by dragging one or more controls to a position that at least partially overlays another control. For example, in response to detecting user input 5336 directed to control 5327 corresponding to a drag user input that drags control 5327 (e.g., corresponding to a control for locking and/or unlocking a respective door and/or window of a home associated with the control 5327) over control 5330, a customized group of controls is created that includes control 5327 and control 5330. Similarly, in response to detecting user input 5338 dragging control 5308 over control 5330 or the newly created group including control 5330, control 5308 is added to the group of controls; and in response to detecting user input 5340 dragging control 5306 over control 5330 or the newly created group including control 5330, control 5306 is added to the group of controls. In some embodiments, the customized group of controls has a first display size, for example, a two-by-two grid of controls that can fit four total controls in the group without displaying an expand option. For example, as illustrated in FIG. 5BC, the group of controls 5342 is displayed with a first size that includes four controls: control 5306′, control 5327, control 5330′ and control 5308.

In some embodiments, in response to detecting a user input 5309 (e.g., in FIG. 5BC) corresponding to a request to remove control 5308 from the group of controls 5342, as shown in FIG. 5BC, for example via a drag input that drags control 5308 away from the group of controls 5342, the control 5308 is removed from the group of controls 5342, as shown in FIG. 5BD. In some embodiments, in response to one or more user inputs (e.g., user input 5346, user input 5350, user input 5352, and user input 5344 (e.g., in FIG. 5BC)) corresponding to requests to add additional controls to the group of controls 5342 (e.g., dragging additional controls into the group of controls 5342) that causes the group of controls to have more than the maximum number of controls that can fit in the graphical representation of the group of controls at the first size (e.g., more than four controls or another maximum number), the group of controls 5342′ displays an expand option to view the additional controls. In some embodiments, the expand option includes smaller representations of the additional controls (e.g., in a lower right corner placement location of the group of controls 5342′). In some embodiments, the smaller representations of the additional controls are not individually selectable by the user. For example, the user first needs to select the expand option to view the representations of the additional controls and then select a control from the expanded group of controls, as described with reference to FIGS. 5BJ-5BK.

In some embodiments, the device 100 detects a user input 5358 (e.g., in FIG. 5BD) selecting the resize affordance of the group of controls 5342′ (e.g., the curved affordance displayed at the lower right corner of the group of controls 5342′, or another type of resize affordance) to change a size of the customizable group of controls 5342′ from the first size (e.g., a two-by-two grid or other size) to a second size (e.g., a three-by-three grid or other size), as illustrated by group of controls 5342″ in FIG. 5BE. In some embodiments, if the number of controls in the group of controls 5342″ is less than the maximum number of controls that can be displayed in the graphical representation of the group of controls 5342″ without an expand option (e.g., for a three-by-three grid, the maximum number is nine or fewer controls (e.g., optionally with a single control taking up more than one grid space, e.g., a size two-by-one control or a size two-by-two control)), each of the controls in the group of controls 5342″ is displayed with a remove affordance. In some embodiments, controls in the group are optionally not resizable (e.g., not resizable inside the group of controls, or not resizable both inside and outside of the group of controls). In some embodiments, controls in the group are resizable (e.g., from taking up 1×1 grid space to a size two-by-one control taking up 2×1 grid space or to a two-by-two control taking up 2×2 grid space, or controls of other sizes). In some embodiments, in response to detecting user input 5360 corresponding to a request to resize the group of controls 5342″ (as shown in FIG. 5BE), such as to decrease the size by dragging the resize affordance inward toward the center of the group of controls 5342″, the group of controls is redisplayed as a size two-by-two control taking up 2×2 grid space, as illustrated in FIG. 5BF.

In some embodiments, in response to detecting a user input 5362 (e.g., a tap input, a long press input, or other selection input) selecting application open control 5288 in FIG. 5BF, the device 100 displays a menu 5366 for assigning a different application (e.g., application a, b or d) to the application open control 5288. In some embodiments, the application open control 5288 is displayed with a glyph, icon, and/or other indication representing the application that is currently associated with the application open control. For example, the application open control 5288 is a control that, when selected by the user, causes the device 100 to launch, open or otherwise display a user interface for a respective application associated with the application open control 5288. For example, in FIG. 5BF, the application open control 5288 is associated with application c (“App C”). In some embodiments, in response to the user input 5368 selecting application A from the menu 5366, the application open control 5288 is updated to be associated with application A, as illustrated by control 5288′ in FIG. 5BH, and is no longer associated with application C. In response to a user input selecting control 5288′ (e.g., by a tap input, or light press input, or another type of selection input) after the control user interface has exited the editing mode, the device 100 opens application A, instead of application C.

FIG. 5BH illustrates detecting a user input 5370 selecting the done affordance. In some embodiments, in response to the user input 5370, the device 100 ceases to display the editing control user interface 5210-2 and displays a page of the control user interface 5002-8, as illustrated in FIG. 5BI. In some embodiments, the pages of the control user interface 5002 are updated based on the changes made to the editing control user interface 5210 (e.g., the control user interface 5002 reflects the customizations and modifications made in the editing control user interface 5210). In some embodiments, in accordance with a determination that the user selects the “cancel” affordance in FIG. 5BH, the changes made to the editing control user interface 5210 are optionally not saved, and are canceled, such that control user interface 5002 reverts to the controls and/or layouts before editing the control user interface via editing control user interface 5210. In some embodiments, the device displays a respective page of the control user interface in editing mode at a time, in response to selection of the edit control 5006 concurrently displayed with and/or within the respective page, and other existing pages of the control user interface are not editable when the respective page is being edited. In the editing mode, controls may be added from the control library, removed, repositioned, grouped, removed from a group, and/or changed in format and/or associated functions, in the respective page of the control user interface. In some embodiments, once the device displays a respective page of the control user interface in editing mode, other pages are also editable, and the user is free to navigate to other pages (e.g., by dragging controls to an edge of a currently displayed page and/or swiping or tapping on the page indicators 5030) to change the different pages of the control user interface, including adding controls, removing controls, repositioning controls within a respective page or across pages, grouping control, removing controls from existing groups, and/or changing controls in terms of format and/or associated functions.

FIG. 5BI illustrates detecting a user input 5372 directed to the lock control 5327 in the group of controls 5342″. In some embodiments, in response to detecting the user input 5372, the lock control 5327 is toggled from a locked state to an unlocked. state, and the device 100 performs an operation that unlocks a lock associated with the lock control 5327 For example, the lock control 5327 displays a current status of the lock associated with the lock control 5327 has changed from the locked state to the unlocked state, as illustrated in FIG. 5BJ.

FIG. 5BJ illustrates a user input 5374 directed to the expand option that includes smaller representations of the additional controls in the group of controls 5342′″. In some embodiments, in response to the user input 5374, the group of controls 5342′″ is expanded in user interface 5378 to show the additional controls that are available within the group of controls 5342′″, as illustrated in FIG. 5BK. In some embodiments, in response to the user input 5376 selecting the light control 5306′, the light control 5306′ is updated to illustrate that the light associated with the light control 5306′ has been toggled on and/or off, as illustrated in FIG. 5BL (e.g., showing that the current status of the light is “OFF”, in contrast to the OFF state shown in FIG. 5BK).

In some embodiments, in response to detecting the user input 5380 (e.g., in FIG. 5BK), a fan associated with the fan control 5310′ is turned on and/or off and the status of the fan control 5310′ is updated (e.g., from showing an arrow (ON) to not showing an arrow (OFF)) to indicate the current status of the fan associated with the fan control 5310′. In some embodiments, in response to detecting a user input 5382 directed outside of the expanded group of controls (e.g., in FIG. 5BK), the device 100 redisplays the control user interface 5002-8, as illustrated in FIG. 5BL. In some embodiments, the appearance of the miniature representation of a control in the expansion control of a group of controls is optionally updated to indicate a current status of the control. For example, the fan symbol in the expansion control of the group of controls 5342′″ in FIG. 5BL is optionally updated to show that the fan is turned off (e.g., in contrast to the fan symbol in the expansion control of the group of controls 5342′″ in FIG. 5BJ), in accordance with some embodiments.

In some embodiments, the control 5308 is a scene control that requires more than one input, e.g., a single stage input, to enable and/or disable the scene using the control 5308. For example, in response to detecting a user input 5384 directed to the control 5308 in FIG. 5BL, the control 5308 is updated to a slider control 5308″ that requires a second user input, such as user input 5386, to swipe across the slider control 5308″ to enable and/or disable the scene associated with the control 5308, as shown in FIG. 5BM. In some embodiments, these multi-stage controls, such as the two-step control shown in FIGS. 5BL and 5BM, provide an additional level of security and/or intention for the user to enable and/or disable the control. As illustrated in FIG. 5BN, in response to the user input 5386 (e.g., a swipe along the slider control 5308″) enabling the function associated with control 5308, the control 5308′ displays the status of the scene as active (e.g., in contrast to the control 5308 shown in FIG. 5BL).

FIG. 5BN further illustrates detecting a user input 5390 directed to application open control 5288′ (e.g., currently associated with application A). In some embodiments, in accordance with a determination that the user input 5390 is a first type of input that satisfies first criteria (e.g., and/or does not satisfy second criteria after a termination of the input has been detected), such as a tap input or other selection input, the application associated with application open control 5288′ (e.g., application A) is launched. In some embodiments, in accordance with a determination that the user input 5390 is a second type of input that satisfies second criteria, such as a long press input in which the input is maintained for a threshold amount of time (e.g., 0.1 seconds, 0.25 seconds, 0.5 seconds, 1 second, 2 seconds, 5 seconds, or another amount of time) with less than a threshold amount of movement (e.g., the input is substantially stationary), a quick options menu 5396 is displayed for application A, as illustrated in FIG. 5BO.

For example, the quick options menu 5396 (e.g., in FIG. 5BO) includes a list of available operations that can be performed, optionally without first navigating to a user interface for application A. For example, the quick action cause application A to perform one or more operations associated with the quick action. For example, in response to detecting user input 5390 selecting the new message option from quick options menu 5396, the device 100 causes application A to launch a new message user interface (e.g., overlaying the control user interface or user interface 5388, without launching application A; or directly displaying the new messages user interface after launching application A). In some embodiments, in response to detecting a user input 5392 selecting the add friend option from quick options menu 5396, the device 100 causes application A to display an add friend user interface (e.g., overlaying the control user interface or user interface 5388, without launching the application A; or directly displaying the add friend user interface after launching application A). In some embodiments, the quick options menu 5396 includes an option to launch the application A, optionally without performing a particular task using application A. In some embodiments, in response to detecting a user input 5394 that is not directed to the quick options menu 5396 (e.g., in FIG. 5BO), the device 100 ceases display of the quick options menu 5396 and redisplays control user interface 5002-8, as illustrated in FIG. 5BP.

FIG. 5BP illustrates detecting a user input 5398 directed to indication 5030-5, and in response to detecting the user input 5398, the device 100 displays control user interface 5002-6 (e.g., the page of the control center user interface 5002 that corresponds to indication 5030-5), as illustrated in FIG. 5BQ. In some embodiments, in response to detecting a user input 5402 (e.g., a tap input, a long press input, or other selection input) directed to the power affordance 5400, the device 100 displays a power user interface 5404, illustrated in FIG. 5BR, that includes one or more control options, including an option 5406 (e.g. a slider control) for powering off the device 100, an option 5408 (e.g., a slider control) for making an emergency call, and/or an option 5410 for canceling the power off request. For example, in response to detecting a user input 5412 corresponding to a swipe input to activate option 5406, the device 100 shuts off. In some embodiments, in response to detecting a user input 5416 corresponding to a swipe input to activate option 5408, the device 100 initiates an emergency call to emergency services and in response to detecting a user input 5418 directed to cancel option 5410, the device 100 ceases display of the power user interface 5404 and optionally redisplays control user interface 5002-6 or another user interface. In some embodiments, the edit button and/or power affordance 5400 are available on each of the pages of control user interface 5002.

FIG. 5BS illustrates detecting a user input 5420 directed to favorites indication 5030-2 and, in response to the user input 5420, device 100 displays the favorites page of control user interface 5002-2, as illustrated in FIG. 5BT. In some embodiments, in response to detecting a user input 5422 directed to the flashlight control 5028 (e.g., in FIG. 5BT), in accordance with a determination that the user input 5422 is a first type of input that satisfies first criteria (e.g., a tap input or other selection input), the device 100 toggles the flashlight of the device on and/or off and updates the appearance of the flashlight control 5028 to indicate the current on/off state of the flashlight. In some embodiments, in response to detecting the user input 5422 directed to the flashlight control 5028, in accordance with a determination that the user input 5422 is a second type of input that satisfies second criteria (e.g., a long press input or other selection input), the device 100 turns on and/or off the flashlight (e.g., light 5440-1) and/or displays more refined control options for the flashlight in the user interface 5424 (e.g., without changing a state of the flashlight; or after turning on the flashlight, and/or after turning off the flashlight), as illustrated in FIG. 5BU.

In some embodiments, the device 100 displays an animated transition between displaying control user interface 5002-2 (e.g., in FIG. 5BT) and user interface 5424 (e.g., in FIG. 5BU). In some embodiments, the user interface 5424 includes a user interface element 5426-1 (e.g., a slider control) that controls an operation parameter, such as a brightness level or color temperature, of the flashlight. In some embodiments, while displaying the user interface 5424, the device 100 detects a user input 5428 (e.g., a swipe input that includes an upward movement along a direction corresponding to an increasing value of the slider control), as shown in FIG. 5BV. In some embodiments, in accordance with a determination that the user input 5428 is detected as starting at a location that does not overlap the user interface element 5426-1, the user input 5428 does not change (e.g., does not increase) the current value of the operation parameter, such as a brightness level or color temperature, of the flashlight, as illustrated in FIG. 5BV. In some embodiments, in response to detecting an end of the user input 5428 (e.g., liftoff of the user input), the user interface element 5426-1 is animated to shrink and/or appear to get farther away from the user, as illustrated in FIG. 5BW, as the device 100 transitions to redisplaying the control user interface 5002-2. In other words, the swipe input 5428 that started outside of the user interface element 5426-1 serves to dismiss the user interface 5424 and redisplay the control user interface 5002-2, in accordance with some embodiments.

In some embodiments, in response to detecting a user input 5430 (e.g., in FIG. 5BX) directed to the flashlight control 5028 and in accordance with a determination that the user input 5430 is a second type of input that satisfies second criteria (e.g., a long press input or other selection input), the device 100 turns on and/or off the flashlight (e.g., light 5440-1) and/or displays more refined control options for the flashlight in the user interface 5424, as illustrated in FIG. 5BY. As illustrated in FIG. 5BY, in some embodiments, while displaying the user interface 5424, the device 100 detects a user input 5432 (e.g., a drag input, a swipe input, or other input) that begins at a location in the user interface that overlaps with the user interface element 5426-1. In some embodiments, in accordance with a determination that user input 5432 begins at a location that overlaps with the user interface element 5426-1, movement of the user input 5432 causes the operation parameter, such as the brightness or color temperature, of the flashlight to change (e.g., to light 5440-2 in FIG. 5BZ) in accordance with a direction of the movement of the user input 5432. For example, movement in an upward direction (e.g., corresponding to an increasing value of the slider control) causes the value of the operation parameter, such as the brightness or color temperature, to increase, while movement in a downward direction (e.g., corresponding to a decreasing value of the slider control) causes the value of the operation parameter, such as the brightness or color temperature, to decrease. In some embodiments, the user input 5434 is a continuation of user input 5432, and even after the user input 5434 is moved to a location in the user interface 5424 that does not overlap with the user interface element 5426-2, movement of the user input 5434 continues to cause the device 100 to change the value of the operation parameter, such as the brightness level or color temperature, of the flashlight in accordance with the movement. (e.g., by an amount that corresponds to a distance traveled and/or a movement speed of the user input 5434 in the direction(s) corresponding to the increasing/decreasing value of the slider control). As such, the user input 5434 continues off of the user interface element 5426-2 but continues to control the brightness level (e.g., while user input 5434 is a continuation of the user input 5432, e.g., without detecting liftoff of the user input 5432, that started on the user interface element 5426-1).

In some embodiments, the user interface element 5426-3 is displayed as moving within the user interface 5424 in accordance with the user input 5436 (e.g., which is a continuation of the user inputs 5432 and 5434), as illustrated in FIG. 5CA. For example, the user interface element 5426-3 appears to follow the movements of the user input 5436 and optionally appears to decrease in size as the user input 5436 continues (e.g., the user interface element 5426-3 follows the movement in both up and down directions and sideways directions, and/or the size of user interface element 5436-3 changes in accordance with movement in both up and down directions and sideways directions), as illustrated in FIG. 5CA. FIG. 5CB further illustrates the animation of user interface element 5426-4 that continues to update the brightness of the flashlight (e.g., from light 5440-3 in FIG. 5CA to light 5440-4 in FIG. 5CB) in accordance with the movement of the user input 5438. (e.g., movement components in the up and down directions)

As illustrated in FIG. 5CC, in some embodiments, in response to detecting an end of the user input 5438 (e.g., liftoff of the user input 5438), the device 100 displays the user interface element 5426-5 with its initial size and position (e.g., illustrated in FIG. 5BY) before detecting the user input to change the level of brightness of the flashlight, and with the current value of the operation parameter changed in accordance with the user input. In some embodiments, the user interface 5424 ceases to be displayed in response to detecting an end of the user input 5438. In some embodiments, the user interface 5424 ceases to be displayed in response to detecting a user input 5442, such as a tap input or a swipe input, directed outside of the user interface element 5426-5 and the device 100 redisplays control user interface 5002-2.

In some embodiments, as illustrated in FIG. 5CD, in response to detecting a user input 5444 directed to indication 5030-5, the device 100 displays the page of the control user interface 5002-6 corresponding to indication 5030-5, as shown in FIG. 5CE. In some embodiments, the control user interface 5002-6 includes a magnifier control 5124. In some embodiments, in response to detecting a user input 5446 (e.g., in FIG. 5CE) directed to the magnifying control 5114, a camera preview 5450 is displayed within the control user interface 5002-6′, as illustrated in FIG. 5CF. In some embodiments, one or more other controls (e.g., a quick action control for a video conference application, a doorbell control for a doorbell that has a camera, or a camera control) that use the built-in camera of device 100 and/or another camera controlled by the device 100, optionally also, when selected, display a camera preview within the control user interface 5002.

In some embodiments, the control user interface 5002-6 further includes a virtual assistant control 5448, as shown in FIG. 5CE. In some embodiments, the virtual assistant control 5448, when selected by a user input, displays an input user interface, such as a text box for the user to type a request to the virtual assistant of device 100. In some embodiments, in response to selection of the virtual assistant control 5448, the virtual assistant of the device 100 is invoked to provide a voice input interface, such that the user inputs a voice command to make one or more requests of the virtual assistant (e.g., to perform a search, to provide a summary of missed notifications, to report on traffic or weather, and/or to perform other tasks).

FIG. 5CG illustrates a wake screen user interface 5454-1 that includes quick action control 5478-1 for turning on/off a flashlight and quick action control 5478-2 for launching a camera of device 100 (e.g., and/or displaying a user interface that includes a camera view and/or media capture controls). In some embodiments, the wake screen user interface 5454-1 includes one or more notifications, such as notification 5475-1, in a notification region that is displayed proximate to (e.g., above) the quick action control 5478-1 and/or the quick action control 5478-2. In some embodiments, the notification region is below the time indication and/or the widgets displayed on the wake screen user interface 5454-1. In some embodiments, in response to detecting a user input 5452, directed to the wake screen user interface 5454-1 (e.g., a touch input by a contact, or another type of input) in accordance with a determination that the user input 5452 is maintained for at least a threshold amount of time with less than a threshold amount of movement (e.g., a long press input that meet a first duration threshold), the device 100 displays a face switcher user interface 5456 (e.g., in FIG. 5CH) for switching between different versions of the wake screen (e.g., by swiping between and/or tapping on other representations of wake screens) and/or creating other wake screen options (e.g., by selecting the add button 5464). In some embodiments, the face switcher user interface 5456 includes face indicator dots corresponding to representations of available wake screens that are already configured, and selection of a respective face indicator dot causes the device to display the representation of the wake screen that corresponds to the selected face indicator dot. In the example shown in FIG. 5CH, there are five face indicator dots corresponding to five existing versions of wake screens, and the wake screen 5454-1 corresponds to the second face indicator dot of the five face indicator dots. In some embodiments, when a user configures one or more wake screens, each wake screen has a configurable background, configurable text, configurable widgets, and/or configurable quick actions in accordance with user's configuration inputs.

In some embodiments, the wake screen user interface 5454-1 includes a notification region that is above the quick actions 5478-1 and 5478-2 in which one or more notifications are displayed. For example, in response to detecting occurrence of an alert and/or notification, the device 100 displays a representation of the alert and/or notification in the notification region of the wake screen user interface 5454-1. For example, in FIG. 5CH, a representation 5454-1′ of the wake screen user interface 5454-1 is displayed in the face switcher user interface 5456 concurrently with a portion of a representation 5454-2′ of a second wake screen user interface and a portion of a representation 5454-3′ of a third wake screen user interface. In some embodiments, the user swipes between available wake screen user interface (e.g., via user input 5458) and selects a respective wake screen user interface to use as the current wake screen user interface of device 100. For example, in response to the user input 5460 selecting the representation 5454-2′ of the second wake screen user interface, the wake screen user interface 5454-2 is displayed as the current wake screen, as illustrated in FIG. 5CI. In some embodiments, the user interface 5454-2 (e.g., the current wake screen user interface) includes a different set of quick actions from the set of quick actions displayed in wake screen user interface 5454-1, including quick action control 5478-3 for turning dark mode on and/or off and quick action control 5478-2 for launching a camera of device 100. In some embodiments, none, one, or both of the quick actions of user interface 5454-2 are distinct from the quick actions of user interface 5454-1. In some embodiments, the user interface 5454-2 has the same, or a different set of notifications, relative to the user interface 5454-1. For example, in FIG. 5CI, the notification 5475-1 is displayed. In some embodiments, notifications that have not yet been dismissed continue to be displayed in the wake screen user interface, even after the version of the wake screen user interface changes. In some embodiments, incoming notifications (e.g., most recent notifications) are displayed in the current version of the wake screen user interface 5454-2. For example, as described with reference to FIG. 5CR, in some embodiments, one or more different notifications are displayed in the wake screen user interface 5454-3.

FIG. 5CI illustrates, while displaying the wake screen user interface 5454-2, the device 100 detects a user input 5474 corresponding to a swipe input in a first direction relative to wake screen user interface 5454-2 (e.g., a rightward swipe, a leftward swipe, or another swipe direction), and in response to detecting the user input 5474, the device 100 displays a widget user interface 491, illustrated in FIG. 5CJ, as described with reference to FIGS. 4C1-4C2. In some embodiments, within the widget user interface 491, the user interacts with one or more widgets of the widgets user interface 491 to cause the device 100 to perform one or more operations. For example, in response to detecting a user input 5482 directed to the music item “B” in music widget 4026c, the device 100 initiates playback of the music item “B” and/or displays additional information related to the music item “B” and/or displays a user interface for a music application associated with music widget 4026c. In some embodiments, in response to detecting a user input 5480, optionally a swipe input in a direction opposite the first direction, the device 100 redisplays the user interface 5454-2.

In some embodiments, in response to detecting a user input 5472 corresponding to a swipe input in a second direction (e.g., a leftward swipe, a rightward swipe, or another swipe direction different from the first direction), the device 100 displays a camera application user interface 495, illustrated in FIG. 5CK, as described with reference to FIGS. 5C1-5C2. FIG. 5CI illustrates device 100 displaying a user interface 5454-2. In some embodiments, the user interface 5454-2 is a wake screen user interface 492. In some embodiments, in response to detecting a user input 5466 directed to one or more connectivity controls that are displayed in a control bar of the user interface 5454-2 (e.g., where the control bar is displayed along a top edge of the device 100), the device 100 displays a user interface element 5484 that includes one or more additional controls for connectivity, optionally that are not shown in the control bar of the user interface 5454-2, as illustrated in FIG. 5CL. For example, instead of navigating to the one or more additional controls for connectivity via the control user interface 5002 described above, the device 100 displays the user interface element 5484 to quickly display the one or more additional controls for connectivity in response to a user input 5466 directed to the top left corner portion of the device 100 (e.g., to the one or more connectivity controls that are displayed in the control bar of the user interface 5454-2).

In some embodiments, in response to detecting a user input 5468 directed to a portion of the control bar the includes a battery icon in FIG. 5CI, the device 100 displays a user interface element 5488, as illustrated in FIG. 5CM, that includes one or more additional controls for the battery. As such, the user need not navigate to the control user interface 5002 to quickly access battery controls. Instead, in response to a user input 5468 directed to a top right corner portion of the device 100, the device 100 displays the one or more additional controls for the battery in user interface element 5488.

In some embodiments, in response to detecting a user input 5470 directed to the wake screen user interface 5454-2, and in accordance with a determination that the user input 5470 satisfies a respective set of criteria (e.g., is maintained for at least a threshold amount of time with less than a threshold amount of movement, and/or meets other criteria), the device 100 displays the face switcher user interface 5456 that includes a representation 5454-2′ of the current wake screen user interface and optionally concurrently displays at least a portion of a representation 5454-4′ of another wake screen user interface and/or representation 5454-1′ of the wake screen user interface 5454-1, as shown in FIG. 5CN In some embodiments, in response to detecting a user input 5490 directed to the representation 5454-1′, the device 100 sets the current wake screen user interface to the wake screen user interface 5454-1.

In some embodiments, in response to detecting a user input 5492 directed to the focus option in the representation of the wake screen 5454-2′ in FIG. 5CN, the device 100 displays one or more options for associating the respective user interface (e.g., user interface 5454-2 corresponding to the representation 5454-2′) with a respective focus mode. For example, the one or more options for focus modes include a do not disturb (DND) mode (e.g., that silences and/or delays a first set of one or more notifications while the DND mode is active), a personal mode (e.g., that silences and/or delays a second set of one or more notifications (e.g., notifications corresponding to one or more applications, such as work applications) while the personal mode is active), a work mode (e.g., that silences and/or delays a third set of one or more notifications (e.g., notifications corresponding to one or more applications, such as social, personal and/or other applications) while the work mode is active, a sleep mode (e.g., that silences and/or delays a fourth set of one or more notifications while the sleep mode is active), and/or other focus modes that are used to control which notifications are presented to the user while the respective focus mode is active. In some embodiments, a respective focus mode is associated with a respective wake screen user interface such that, in response to changing the current wake screen user interface to another wake screen user interface, the focus mode is set (e.g., automatically, without user input) to the respective focus mode associated with the other wake screen user interface. In some embodiments, in response to detecting a user request to change the focus mode, the current wake screen user interface is updated (e.g., automatically, without user input) to a respective wake screen user interface that is associated with the selected focus mode. In some embodiments, a respective focus mode is automatically, without user input, selected as the current focus mode based on a context of the device 100. For example, a respective focus mode is activated at a time of day, day of the week, location of the device 100, and/or based on other current contexts of the device.

In some embodiments, in response to detecting user input 5494 directed to the edit button 5462 in FIG. 5CN, the device 100 displays an editing user interface 5454-2″ for the wake screen user interface 5454-2 (e.g., the currently selected wake screen 5454-2′ in FIG. 5CN), as illustrated in FIG. 5CO. In some embodiments, the editing user interface 5454-2″ includes an option to edit the time indication and/or the date indication of the wake screen 5454-2. For example, in response to detecting a user input 5496 (e.g., in FIG. 5CO) directed to the time element, the device 100 displays a user interface element that includes one or more options for changing one or more properties of the time indication, including font, size, color and/or other formatting options. In some embodiments, the editing user interface 5454-2″ further includes an option to edit the one or more widgets displayed in the user interface 5454-2. For example, in response to detecting a user input 5498 directed to a music widget (e.g., in FIG. 5CO), the device 100 displays a user interface element that includes one or more widgets to be selected by the user to add the selected widgets to the user interface 5454-2. Further, the user removes a respective widget from the wake screen user interface 5454-2″ by providing a user input directed to a remove affordance for the respective widget.

In some embodiments, the user changes a wallpaper of the user interface 5454-2 via the editing user interface 5454-2″. For example, the user selects an image, pattern, colors, and/or other properties to be used as the wallpaper of the user interface 5454-2. In some embodiments, the editing user interface 5454-2″ further includes options for removing and/or editing the quick action controls 5478-3 and/or 5478-2. For example, in response to detecting a user input 5500 directed to the remove affordance of quick action control 5478-2 (e.g., in FIG. 5CO), the quick action control 5478-2 is moved and replaced with an add quick action option 5478-4 (e.g., in FIG. 5CP). In some embodiments, the user input 5500 is directed to the quick action control 5478-2 (e.g., instead of the remove affordance). In some embodiments, in response to detecting the user input 5500, the device 100 displays a user interface element 5502, as illustrated in FIG. 5CP, that includes options of one or more controls that may be selected to fill the quick action space that was previously assigned to the quick action control 5478-2, and optionally a search bar for searching for one or more controls that may be added as a quick action control in the wake screen user interface. In some embodiments, the one or more controls that may be selected to fill the quick action space(s) include at least some of the control options that may be selected to add to control user interface 5002. In some embodiments, the one or more controls that may be selected to fill the quick action space(s) include at least some of the control options that may be selected to be assigned to the action button of the device 100.

In some embodiments, the one or more controls that may be selected to fill the quick action space(s) include one or more third-party controls associated with applications and/or functions provided by a third-party. For example, in response to the user input 5504 (e.g., a tap input, a drag input that ends over the quick action option 5478-4, and/or another type of input) directed to the timer control (as shown in FIG. 5CP), the device 100 adds the timer control as quick action 5478-5, as illustrated in FIG. 5CQ.

In some embodiments, in response to detecting activation and/or deactivation of a respective quick action control 5478 in the wake screen user interface 5454, the device 100 performs one or more operations based on the respective quick action control 5478. For example, in FIG. 5CQ, in response to user activation of quick action control 5478-3 to activate the dark mode, the quick action control 5478-3′ is visually emphasized or otherwise changed to indicate that the dark mode is currently active, and the device 100 turns on the dark mode for the device 100. In some embodiments, the dark mode is activated via a user input 5506 directed to the action button (e.g., the hardware affordance disposed on the side of device 100, or another hardware control of device 100) (e.g., where the action button is assigned to toggle dark mode on and/or off for device 100). In some embodiments, the quick action control 5478-3′ is visually emphasized or otherwise changed to indicate dark mode is currently active in response to the user input 5506 on the action button (e.g., the state of the quick action control 5478-3 is synchronized with the function of the action button). In some embodiments, the state of the dark mode is controlled by both the quick action 5478-3 and the action button such that activation of dark mode via the quick action 5478-3 causes the dark mode state to be turned on, and a subsequent user input directed to causes the dark mode state to be turned off. Similarly, in response to a user input directed to the action button that causes the dark mode state to be turned on, such that a subsequent user input directed to the quick action 5478-3 causes the dark mode state to be turned off.

FIG. 5CQ further illustrates detecting a user input 5508 directed to timer quick action control 5478-5, and in response to detecting the user input 5508, the device 100 displays a timer application user interface to set and/or start a timer operation. In some embodiments, in response to detecting a user input 5510 directed to the focus mode, set to the DND mode on the wake screen user interface 5454-2 in FIG. 5CQ, the device 100 displays one or more focus mode options. For example, in response to the user selecting the work mode from the one or more focus mode options, the device 100 sets the active focus mode of the device from the DND mode to the work focus mode, and displays the wake screen user interface 5454-3 that is associated with the work focus mode, as illustrated in FIG. 5CR. As shown in FIG. 5CR, the wake screen user interface 5454-3 optionally include different configurations for the background, widgets, time and date elements, focus mode, and/or quick actions, from the wake screen user interface 5454-2 shown in FIG. 5CQ. In some embodiments, the wake screen user interface 5454-3 includes the quick action 5478-8 for turning a ringer on and/or off and the quick action 5478-7 for turning a flashing on and/or off. In some embodiments, the quick action 5478-7 is a slider (e.g., such that controls a brightness of the flashlight), that is optionally activated in response to a long press user input directed to the quick action 5478-7. In some embodiments, the wake screen user interface 5454-3 includes one or more notifications, such as notification 5475-2, notification 5475-3, and/or notification 5475-4. In some embodiments, the notification 5475-1 (e.g., in FIG. 5CG) continues to be displayed in the wake screen user interface 5454-3. In some embodiments, a different set of notifications is displayed in the wake screen user interface 5454-3 (e.g., one or more notifications that have been received after the version of the wake screen user interface changed). In some embodiments, the set of notifications that is displayed is based at least in part on the current focus mode (e.g., notification 5475-2, notification 5475-3, and/or notification 5475-4 correspond to notification types (e.g., associated with one or more applications) that are enabled in the work focus mode).

In some embodiments, in response to detecting a user input 5514 directed to the action button (as shown in FIG. 5CR), the device 100 deactivates the dark mode. As such, the action button is still assigned to turning on and/or off dark mode irrespective of which quick action controls are displayed in the currently displayed wake screen user interface. For example, in FIG. 5CR, the quick action control 5478-6 is for creating a new note and the quick action control 5478-4 is for controlling a flashlight in the user interface 5454-3.

In some embodiments, in response to detecting the user input 5512 directed to the focus mode that is set to work mode (e.g., in FIG. 5CR), the device 100 displays one or more focus mode options and the user selects the personal focus mode. In some embodiments, in response to the user selecting the personal focus mode and/or in response to a request to change the current version of the wake screen user interface (e.g., via the face switcher user interface 5456 in FIG. 5CN), the device 100 displays a wake screen user interface 5454-4, as illustrated in FIG. 5CS, which includes a different set of quick actions than the wake screen user interface 5454-3 shown in FIG. 5CR. In some embodiments, the quick actions that are selected for the respective wake screen user interface are selected from a collection of controls, optionally including one or more controls that are also provided as options (e.g., in the controls search user interface 5224 described with reference to FIG. 5AE) to be added to the control user interface 5002.

For example, the wake screen user interface 5454-4 includes a quick action control 5478-8 for turning a ringer of the device 100 on and/or off and a quick action control 5478-9 for starting and/or stopping a voice recording. In some embodiments, in response to detecting a user input 5516 directed to the quick action control 5478-9, the device 100 initiates a voice recording and the quick action control 5478-9′ is visually emphasized to indicate that the voice recording is in progress, as illustrated in FIG. 5CT, and the session region 5530 optionally includes an indication of the active voice recording session.

FIG. 5CU illustrates device 100 displaying the control user interface 5002-2″ (e.g., or the control user interface 5002-2′″) in response to detecting a user input 5520, as described above with reference to FIGS. 5X-5Y, while the voice recording is ongoing. In some embodiments, the control user interface 5002-2″ continues to display the status for the ongoing voice recording even after the wake screen user interface 5454-4 changes (e.g., where the quick action 5478-9 is no longer displayed on the wake screen user interface). For example, while the voice recording is ongoing, the wake screen user interface changes to the wake screen user interface 5454-3, and in response to a request to display the control user interface 5002, the control user interface 5002-2″ (e.g., or the control user interface 5002-2′″) is displayed that includes the status of the ongoing voice recording.

In some embodiments, in response to a user input 5518 corresponding to a request to dismiss the control user interface 5002-2″, e.g., an upward swipe from the bottom edge of the user interface 5002-2″), the device 100 redisplays the wake screen user interface 5454-4, as illustrated FIG. 5CV. In some embodiments, in response to detecting a user input 5528 directed to the quick action control 5478-8, the device 100 changes the ringer status (e.g., from on to off or vice-versa), as illustrated by the updates shown in session region 5532 in FIG. 5CV. In some embodiments, in response to the user input 5528, the control user interface 5002-2″ is not updated based on the state of the ringer status (e.g., the control user interface 5002-2″ does not synchronize with the quick action 5478-8).

In some embodiments, as described above with respect to FIG. 5CI, while displaying the wake screen user interface 5454-4, in response to detecting a user input 5526 (e.g., corresponding to a same type of user input as the user input 5474 in FIG. 5CI) corresponding to a swipe input in a first direction (e.g., a rightward swipe, a leftward swipe, or another swipe direction), and in response to detecting the user input 5524, the device 100 displays the widget user interface 491, illustrated in FIG. 5CX (e.g., as described with reference to FIGS. 4C1-4C2 and 5CJ). In some embodiments, as described above with respect to FIG. 5CI, while displaying the wake screen user interface 5454-4, in response to detecting a user input 5526 (e.g., corresponding to a same type of user input as user input 5472 in FIG. 5CI) corresponding to a swipe input in a second direction (e.g., a leftward swipe, a rightward swipe, or another swipe direction different from the first direction), the device 100 displays the camera application user interface 495, illustrated in FIG. 5CW, as described with reference to FIGS. 4C1-4C2 and 5CK.

FIGS. 6A-6J are flow diagrams illustrating method 600 of accessing controls in a control user interface in accordance with some embodiments. Method 600 is performed at an electronic device or computer system (e.g., device 300, FIG. 3A, or portable multifunction device 100, FIG. 1A) that is in communication with one or more display generation components (e.g., touch-sensitive displays, standalone displays, head-mounted displays, projectors, and/or other types of display devices), and one or more input devices (e.g., one or more sensors for detecting user inputs, such as cameras, touch-sensitive surfaces, touch-screen display, motion sensors, and/or other sensors and input devices). In some embodiments, the display generation component includes a touch-screen display, and the touch-sensitive surface is on or integrated with the display. In some embodiments, the display is separate from the touch-sensitive surface. Some operations in method 10000 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Method 600 provides a method for displaying a first set of controls or a second set of controls in a control user interface based on a detected type of user input. For example, in response to detecting a first type of swipe input that has a first magnitude (e.g., first speed, first distance, and/or other property), the computer system displays the first set of controls and in response to detecting a second type of swipe input that has a second magnitude (e.g., second speed, second distance, and/or other property), the computer system displays the second set of controls. Automatically disambiguating a detected input and displaying either a first set of controls or a second set of controls provides additional control options for the user to access a desired set of controls, without displaying options that clutter the user interface, and reduces a number of inputs required for the user to access the first set of controls and/or the second set of controls by performing a particular type of user input.

The computer system displays (602), via the one or more display generation components, a first user interface (e.g., a wake screen user interface, an application user interface, a lock screen user interface, a home screen user interface, or another user interface other than a control user interface that includes a plurality of control objects corresponding to a plurality of control functions of the computer system).

While displaying the first user interface (e.g., any user interface of a plurality of user interfaces, such as a system user interface or an application user interface, other than the control user interface), the computer system detects (604), via the one or more input devices, a first input that includes first movement relative to the first user interface (e.g., detects a swipe gesture that includes movement of a first contact across a touch-screen display on which the first user interface is displayed, along a first edge of the touch-screen display; detects an air gesture such as a pinch and drag gesture that includes movement in a first direction while a gaze is directed to a corner of the first user interface object, where the first direction is along a horizontal direction or vertical direction of the first user interface, or detects another user input that includes movement along a direction associated with the first user interface). For example, as described with reference to FIGS. 5A-5C, a user input 5004-1 is detected at device 100. In some embodiments, the user input 5004-1 is a swipe user input that continues as user input 5004-2 or 5004-3. In some embodiments, the user input 5004-1 is a swipe input that continues as user input 5004-4 or user input 5004-5, as described with reference to FIGS. 5D-5E.

In response to detecting the first input, the computer system displays (606) a control user interface, including: in accordance with a determination that the first movement meets first criteria that correspond to display of a first set of two or more controls that corresponds to a first set of two or more control functions of the computer system (e.g., control functions such as display brightness, network settings, WiFi connection control, Bluetooth connection control, battery setting, volume control, flashlight control, media playback controls, smart home controls, and/or other settings for one or more devices, systems, and/or hardware components of the computer system), without meeting second criteria that correspond to display of a second set of two or more controls (e.g., controls functions that include some or all of the first set of two or more control functions and two or more control functions that are not included in the first set of two or more control functions, such as display brightness, network settings, WiFi connection control, Bluetooth connection control, battery setting, volume control, flashlight control, media playback controls, smart home controls, and/or other settings for one or more devices, systems, and/or hardware components of the computer system) that is different from the first set of two or more controls, wherein the first criteria require that the first movement meets a first input threshold (e.g., a distance threshold, a speed threshold, a time threshold, a time limit, and/or other types of input thresholds) (and optionally, without exceeding a second input threshold that is greater than the first input threshold by the end of the first input) in order for the first criteria to be met by the first movement, the computer system displays (608) (and/or maintains display of), via the one or more display generation components, after detecting an end of the first input (e.g., detecting lift-off of the swipe gesture from the touch-screen, detecting cessation of the air gesture (e.g., as indicated by the release of the pointing or pinch hand configuration, or removal of the raised hand from the camera view)), the first set of two or more controls that corresponds to the first set of two or more control functions of the computer system. In some embodiments, the computer system starts to display at least some of the first set of two or more controls in response to detecting an initial portion of the first movement before the first criteria are met by the first movement, and the first set of two or more controls are displayed when the first criteria are met by at least a portion of the first movement before the end of the first movement is detected; and the computer system maintains display of the first set of two or more controls without displaying the second set of two or more controls after the end of the first input is detected (e.g., after the first movement has ended and the first input is no longer detected), if the first movement only met the first input threshold and did not meet the second input threshold. For example, the control user interface 5002-1 is displayed in response to detecting the end of user input 5004-2 (e.g., in FIG. 5B) and/or in response to detecting the end of the user input 5004-4 (e.g., in FIG. 5D), in accordance with some embodiments.

In accordance with a determination that the first movement meets the second criteria, wherein the second criteria require that the first movement meets a second input threshold (e.g., a distance threshold, a speed threshold, a time threshold, a time limit, and/or other types of input thresholds) that is greater than the first input threshold, in order for the second criteria to be met by the first movement (e.g., in some embodiments, once the first movement met the second criteria, the computer system deems that it no longer meets the first criteria (e.g., the first criteria require that the first movement does not exceed the second input threshold)), the computer system displays (610), via the one or more display generation components, after detecting the end of the first input, the second set of two or more controls that corresponds to a second set of two or more control functions of the computer system (e.g., without displaying the first set of two or more controls, or including some or all of the first set of two or more controls), wherein the second set of two or more control functions are different from the first set of two or more control functions. In some embodiments, the computer system starts to display at least some of the first set of two or more controls and/or the second set of two or more controls in response to detecting an initial portion of the first movement before the second criteria are met by the first movement, and the second set of two or more controls are displayed when the second criteria are met by at least a portion of the first movement before the end of the first movement is detected; and the computer system maintains display of the second set of two or more controls without displaying the first set of two or more controls after the end of the first input is detected (e.g., after the first movement has ended and the first input is no longer detected). In some embodiments, the first movement meets the first criteria before meeting the second criteria as the first movement continues, and the computer system first displays the first set of two or more controls when the first criteria are met, and then displays the second set of two or more controls when the second criteria are met, and the computer system maintains display of the second set of two or more controls (and optionally, without maintaining display of the first set of two or more controls). In some embodiments, the second set of two or more controls include all or a subset of the first set of two or more controls. In some embodiments, the second set of two or more controls includes none of the first set of two or more controls, and the first set of two or more controls are not displayed after the end of the first input is detected. In some embodiments, the second set of two or more controls includes none of the first set of two or more controls, and the first set of two or more controls are displayed concurrently with the second set of two or more controls, after the end of the first input is detected, if the first movement met both the first input threshold and the second input threshold. For example, the control user interface 5002-2 is displayed in response to detecting the end of user input 5004-3 (e.g., in FIG. 5B) and/or in response to detecting the end of the user input 5004-5 (e.g., in FIG. 5E), in accordance with some embodiments.

In some embodiments, the first criteria require (612) that the first movement includes more than a first threshold amount of movement in a first direction in order for the first movement to meet the first criteria (e.g., the first input threshold is a first distance threshold met by the first threshold amount of movement in the first direction), the second criteria require that the first movement includes more than a second threshold amount of movement in the first direction in order for the first movement to meet the second criteria (e.g., the second input threshold is a second distance threshold met by the second threshold amount of movement in the first direction), and the second threshold amount of movement is larger than the first threshold amount of movement. In some embodiments, the first criteria are met by a swipe gesture on a touch-screen display that has more than a first swipe distance along a left edge or a right edge of the touch-screen display (e.g., starting from the top corner or from the bottom corner of the touch-screen display and down to ⅓ of the display height from the starting point) and; by an air gesture that includes movement of a pointer or hand in the downward direction or upward direction by at least a first distance; and/or another movement input that is in a first direction and meets a first distance threshold (e.g., absolute distance or relative to a first reference point (e.g., the corner of the display, the top of the viewport, or other reference point)). In some embodiments, the second criteria and the first criteria can be met by the same input or inputs of the same input type. In some embodiments, the second criteria are met by a swipe gesture on a touch-screen display that has more than a second swipe distance along a left edge or a right edge of the touch-screen display (e.g., starting from the top corner or from the bottom corner of the touch-screen display and down to ⅔ of the display height from the starting point) and; by an air gesture that includes movement of a pointer or hand in the downward direction or upward direction by at least a second distance; and/or another movement input that is in a first direction and meets a second distance threshold (e.g., absolute distance or relative to the first reference point (e.g., the corner of the display, the top of the viewport, or other reference point)). In some embodiments, whether a movement input meets the first criteria or the second criteria is determined at the end of the movement input (e.g., if the movement input includes reversal(s) of previous portion(s) of the movement in the movement input), based on the final location of the movement input (e.g., irrespective of whether the first criteria or the second criteria were met earlier during the movement input). In some embodiments, once a movement input meets the second criteria, it can no longer meet the first criteria (e.g., even if the movement input includes reversal(s) of previous portion(s) of the movement after meeting the second criteria, it still meets the second criteria and not the first criteria). For example, as described with reference to FIGS. 5D-5E, in some embodiments, control user interface 5002-1 or control user interface 5002-2 is displayed based on a distance of the swipe input (e.g., the control user interface 5002-1 is displayed in response to detecting an end of the swipe input 5004-4 and the control user interface 5002-2 is displayed in response to detecting an end of the swipe input 5004-5, where the swipe input 5004-5 has a greater amount of movement than the swipe input 5004-4). Automatically detecting whether a user input is of a first type or a second type based on a distance and/or length of the user input, and displaying either a first set of controls or a second set of controls based on the detected type of user input, provides additional control options for the user to access a desired set of controls, without displaying options that clutter the user interface, and reduces a number of inputs required for the user to access the first set of controls and/or the second set of controls by performing a particular type of user input.

In some embodiments, the first criteria require (614) that at least a portion of the first movement is made with more than a first threshold speed (e.g., the first input threshold is the first threshold speed) in order for the first movement to meet the first criteria, and wherein the second criteria require that at least a portion of the first movement is made with more than a second threshold speed (e.g., the second input threshold is the second threshold speed) greater than the first threshold speed in order for the first movement to meet the second criteria. In some embodiments, the first criteria are met by a swipe gesture on a touch-screen display that has a characteristic swipe speed more than a first swipe speed along a left edge or a right edge of the touch-screen display (e.g., starting from the top corner or from the bottom corner of the touch-screen display) and; by an air gesture that includes movement of a pointer or hand in the downward direction or upward direction with at least a first threshold speed; and/or another movement input that is in a first direction and meets a first speed threshold (e.g., a highest speed, or an average speed). In some embodiments, the second criteria and the first criteria can be met by the same input or inputs of the same input type. In some embodiments, the second criteria are met by a swipe gesture on a touch-screen display that has a characteristic swipe speed more than a second swipe speed along a left edge or a right edge of the touch-screen display (e.g., starting from the top corner or from the bottom corner of the touch-screen display) and; by an air gesture that includes movement of a pointer or hand in the downward direction or upward direction with at least a second threshold speed; and/or another movement input that is in a first direction and meets a first speed threshold (e.g., a highest speed, a speed that at or within a threshold time window of a termination of the first movement (e.g., at or near lift-off of the contact of a swipe input; at or near release of a pinch of a pinch and drag air gesture), or an average speed). For example, a slow swipe causes display of the first set of controls and a fast swipe causes display of the second set of controls, in accordance with some embodiments. In some embodiments, contrary to that described above, the first criteria are used to trigger display of the second set of two or more controls, and the second criteria are used to trigger display of the first set of two or more controls. For example, a slower swipe causes display of the second set of controls and a faster swipe causes display of the first set of controls, in accordance with some embodiments. For example, as described with reference to FIGS. 5B-5C, in some embodiments, control user interface 5002-1 or control user interface 5002-2 is displayed based on a speed of the swipe input (e.g., the control user interface 5002-1 is displayed in response to detecting an end of the swipe input 5004-2 and the control user interface 5002-2 is displayed in response to detecting an end of the swipe input 5004-3, where the swipe input 5004-3 has a greater speed of movement than the swipe input 5004-2). Automatically detecting whether a user input is of a first type or a second type based on a speed of the user input, and displaying either a first set of controls or a second set of controls based on the detected type of user input, provides additional control options for the user to access a desired set of controls, without displaying options that clutter the user interface, and reduces a number of inputs required for the user to access the first set of controls and/or the second set of controls by performing a user input with a respective speed.

In some embodiments, the first set of two or more controls includes (616) fewer controls than the second set of two or more controls. For example, in some embodiments, the first set of two or more controls is a subset of the second set of two or more controls, the second set of two or more controls includes at least one control that is not in the first set of two or more controls. In some embodiments, the first set of controls does not overlap with the second set of controls, and the total number of controls in the first set of controls is smaller than the total number of controls in the second set of controls. For example, as described with reference to FIGS. 5B-5C, the control user interface 5002-1 includes a fewer number of controls than the control user interface 5002-2, in accordance with some embodiments. Displaying additional controls in response to detecting a user input that is greater in magnitude than the controls displayed in response to detecting a user input that has a smaller magnitude provides visual feedback about a state of the computer system, including whether the computer system detected a first type of user input or a second type of user input.

In some embodiments, the first set of two or more controls are controls selected (618) from a first category of controls (e.g., corresponding to a first category of control functions (e.g., home controls, media controls, and/or other user or system defined categories for control functions), and/or corresponding to a first control type (e.g., slider vs. dial vs. toggle)), and the second set of two or more controls are controls selected from a second category of controls (e.g., corresponding to a second category of control functions (e.g., home controls, media controls, and/or other user or system defined categories for control functions), and/or corresponding to a second control type (e.g., slider vs. dial vs. toggle)) different from the first category of controls. In some embodiments, the first set of two or more controls includes frequently used controls (or alternatively, recently used controls, or automatically recommended controls), and the second set of two or more controls includes network controls. In some embodiments, the first set of two or more controls includes network controls, and the second set of two or more controls include media playback controls. In some embodiments, the first set of two or more controls includes media playback controls, and the second set of two or more controls includes smart home controls. Other categories of controls are possible, and are optionally chosen as the first set of controls and the second set of controls, respectively. For example, as described with reference to FIGS. 5H-5I, in some embodiments, the user input 5030-3 is a continuation of user input 5004-1, such that the user navigates to a different respective control user interface 5002, including a favorites page of the control user interface 5002-2, a connectivity page of the control user interface 5002-3, a now playing page of the control user interface 5002-4 and/or another page of the control user interface based on the swipe input. Displaying different categories of controls on different pages of a control user interface such that the user can directly access a first set of controls for a first category via a first type of user input and can directly access a second set of controls for a second category via a second type of user input, provides additional control options for the user to access a desired category of controls, and reduces a number of inputs required for the user to access the first category of controls and/or the second category of controls by performing a particular type of user input.

In some embodiments, the first set of two or more controls includes (620) one or more controls that are automatically selected by the computer system in accordance with a current context of the computer system, and wherein: in accordance with a determination that the current context of the computer system meets first contextual conditions (e.g., first time of day, first day of the week, first location, first set of interaction history, a first application was recently open, and/or other first set of contextual conditions), the one or more automatically selected controls include a first control without including a second control (e.g., the first control is determined to be sufficiently relevant to the current context, while the second control is not determined to be sufficiently relevant to the current context, in order for the control to be displayed among the first set of controls); and in accordance with a determination that the current context of the computer system meets second contextual conditions (e.g., second time of day, second day of the week, second location, second set of interaction history, a second application was recently open, and/or other second set of contextual conditions) different from the first contextual conditions, the one or more automatically selected controls include the second control without including the first control (e.g., the second control is determined to be sufficiently relevant to the current context, while the first control is not determined to be sufficiently relevant to the current context, in order for the control to be displayed among the first set of controls). In one example, in some embodiments, the first set of two or more controls includes a WiFi connection control and does not include an airplane mode control, when the current location has WiFi signals and the computer system is not currently connected to WiFi; and the first set of two or more controls does not include the WiFi connection control and includes the airplane mode control, when the current location does not have WiFi signals, or if the computer system is currently connected to a stable and recognized WiFi source. In another example, in some embodiments, the one or more automatically selected controls include a flashlight control and do not include a camera control, when the current time is nighttime and/or ambient lighting is less than a threshold level; and the one or more automatically selected controls include the camera control and do not include the flashlight control when the current time is not nighttime and/or the ambient lighting is more than the threshold level. In some embodiments, a control may be excluded from display among the automatically recommended controls, not because it is not relevant to the current context but because there are other more relevant controls according to the contextual conditions used by the computer system. For example, as described with reference to FIG. 5R, in some embodiments, the control user interface 5002-2′ is updated based on one or more current contexts of the device 100, such as by updating the control user interface 5002-2′ based on an active application (e.g., an active music session). In some embodiments, as described with reference to FIGS. 5X-5Y, while a voice recording application is active, the device 100 displays a modified version of the control user interface 5002-2″ and/or 5002-2′″. Automatically updating a control user interface to include controls and/or status information related to a current context of the computer system, provides visual feedback about a state of the computer system, and reduces a number of inputs required for the user to access information related to a current context without requiring the user to navigate complex menu hierarchies.

In some embodiments, while displaying the first set of two or more controls in response to detecting the first input that includes the first movement (e.g., after detecting the end of the first input, and in accordance with the determination that the first input meets the first criteria and not the second criteria), the computer system detects (622), via the one or more input devices, a second input (e.g., an input that is of the same type as the first input, or an input that is of a different input type from the first input) (e.g., a tap gesture, a swipe gesture, an air tap, a tap and hold gesture, a pinch and drag gesture, an air swipe, or another input type) that is directed to the control user interface (e.g., a region that corresponds to the first set of controls, and/or a region that does not correspond to the first set of controls). In response to detecting the second input that is directed to the control user interface: in accordance with a determination that the second input meets switching criteria, wherein the switching criteria require that the second input does not correspond to a request to activate a respective control in the first set of two or more controls in order for the switching criteria to be met (e.g., the second input is a tap on a tab or affordance corresponding to the second set of two or more controls and not on a control that responds to tap inputs, a swipe in the first direction that starts from a location that is not occupied by a control that responds to swipe inputs, or a repeat of the first input but with longer swipe distance or greater swipe speed to meet the second criteria), the computer system displays the second set of two or more controls (e.g., and optionally ceasing to display the first set of two or more controls, and/or displaying the second set of two or more controls in at least a portion of the region that previously included the first set of two or more controls (e.g., scrolling the first set of two or more controls out of the way for the second set of two or more controls)). For example, as described with reference to FIG. 5K, in accordance with some embodiments, in response to a user input 5084, the device 100 replaces display of the now playing page of the control user interface 5002-4 with the home controls page of the control user interface 5002-5, as illustrated in FIG. 5L. In some embodiments, in response to a user input 5106 (e.g., in FIG. 5M), the user scrubs between different pages of the control user interface 5002. Enabling the user to navigate between a first set of controls and a second set of controls in response to a user input, provides additional control options for the user to access a desired set of controls, without displaying additional options that clutter the user interface, and reduces a number of inputs required for the user to switch between display of the first set of controls and/or the second set of controls.

In some embodiments, the second input that meets the switching criteria includes (624) second movement that meets the third criteria, wherein the third criteria require that the second movement is along (e.g., remains within a threshold distance of, is substantially parallel to, and/or otherwise tracks) a first edge of the computer system (e.g., along a left edge or a right edge of a touch-screen display of the computer system, or along a left edge or right edge of a touch-sensitive surface that corresponds to the display of the computer system) in order for the second movement to meet the third criteria. In some embodiments, the first criteria and the second criteria also require that the first movement is along the first edge of the computer system (e.g., along a left edge or a right edge of a touch-screen display of the computer system, or along a left edge or right edge of a touch-sensitive surface that corresponds to the display of the computer system) in order for the first movement to meet the first criteria or the second criteria. In some embodiments, the first edge is a top edge. In some embodiments, the first edge is a bottom edge. In some embodiments, the first edge is a left edge. In some embodiments, the first edge is a right edge. In some embodiments, the first edge is an edge that is selected by the computer system in accordance a user customizable setting. In some embodiments, after a first swipe along the first edge to display the first set of controls, another swipe along the first edge causes display of the second set of controls. In some embodiments, after the first swipe along the first edge to display the second set of controls, another swipe along the first edge (optionally in the opposite direction of the first swipe) causes display of the first set of controls, or another swipe along the first edge (optionally in the same direction as the first swipe) causes display of a third set of controls. In some embodiments, one short swipe causes display of the first set of controls, a long swipe causes display of the second set of controls and two consecutive swipes causes display of the first set of controls after the first short swipe and display of the second set of controls after the second short swipe. In some embodiments, a long swipe refers to a swipe distance that is greater than a first threshold distance, and a short swipe refers to a swipe distance that is less than the first threshold distance. In some embodiments, a short swipe refers to a swipe distance that is less than a second threshold distance, and a long swipe refers to a swipe distance that is greater than the second threshold distance. For example, as described with reference to FIG. 5M, in accordance with some embodiments, the user input 5106 corresponds to a swipe input along an edge of the display of the device 100, and in response to detecting the user input 5106, the device 100 displays a different page of the control user interface 5002 (e.g., the user navigates from the home controls page of the control user interface 5002-5 to another page of the control user interface 5002-6 (e.g., in FIG. 5N)). Enabling the user to navigate between a first set of controls and a second set of controls by swiping along an edge of the computer system, provides additional control options for the user to access a desired set of controls, without displaying additional options that clutter the user interface, and reduces a number of inputs required for the user to switch between display of the first set of controls and/or the second set of controls without requiring the user to navigate complex menu hierarchies.

In some embodiments, in response to detecting the first input (626): in accordance with the determination that the first movement meets the first criteria without meeting the second criteria, the computer system displays, after detecting the end of the first input and concurrently with display of the first set of two or more controls, a first set of indications corresponding to the first set of two or more controls, and one or more additional sets of controls that are available to be displayed, in the control user interface (e.g., an indication of the first set of controls, an indication of the second set of controls, an indication of a third set of controls, and/or a combined indication of multiple sets of controls that are not currently displayed) (e.g., the first set of indications is displayed as pagination dots and/or optionally includes an icon or other representation for the respective set of controls (e.g., a favorites icon, a music icon, a connectivity icon, a home icon, and/or another icon); and in accordance with the determination that the first movement meets the second criteria, the computer system displays, after detecting the end of the first input and concurrently with display of the second set of two or more controls, a second set of indications corresponding to the second set of two or more controls, and one or more additional sets of controls that are available to be displayed, in the control user interface (e.g., an indication of the second set of controls, an indication of the first set of controls, an indication of a third set of controls, and/or a combined indication of multiple sets of controls that are not currently displayed). In some embodiments, selection of a respective indication for a set of controls that is not currently displayed causes display of the corresponding set of controls in the control user interface, optionally replacing the currently displayed set of controls. For example, as described with reference to FIG. 5B, the control user interface 5002-1 and/or the control user interface 5002-2 includes pagination indicators 5030, each pagination indicator corresponding to a respective page of the control user interface 5002. In some embodiments, as described with reference to FIGS. 5K-5N, the user selects and/or scrubs using the indicators 5030 to switch between a currently displayed page of the control user interface 5002. Displaying indications of different pages that are available in the control user interface, each page option including a different set of controls, provides additional control options for the user to view that other pages of controls are available and enables the user to easily navigate to a desired set of controls by selecting a respective indication of the respective page.

In some embodiments, while displaying, concurrently with display of the first set of two or more controls, the first set of indications corresponding to the first set of two or more controls and the one or more additional sets of controls, in the control user interface, the computer system detects (628) a third input that includes third movement; and in response to detecting the third input that includes the third movement: in accordance with a determination that a current portion of the third movement has a location corresponding to a first indication of the first set of indications, displaying a first additional set of controls in the control user interface (e.g., without displaying a second additional set of controls or other additional sets of controls in the control user interface); and in accordance with a determination that the current portion of the third movement has a location corresponding to a second indication of the first set of indications different from the first indication, displaying a second additional set of controls, different from the first additional set of controls, in the control user interface (e.g., without displaying the first additional set of controls or other additional sets of controls in the control user interface). In some embodiments, the first set of indications is displayed in a row or a column along the first edge of the computer system, and as the third movement continues along the first edge of the computer system, the current portion of the third movement reaches individual indications in the first set of indications one by one; and correspondingly, the computer system displays the set of controls corresponding to the respective indication at the current location of the third movement in the control user interface (and, optionally, ceases to display sets of controls that was displayed prior to the third movement reaching the respective indication). In some embodiments, the third movement includes movement in the first direction and movement in a reverse direction of the first direction, and as a result, the location of the current portion of the third movement may move past a respective indication and return to the respective indication at a later time; and correspondingly, the computer system redisplays a previously displayed set of controls when the current location of the third movement returns to the respective indication for that set of previously displayed set of controls. In some embodiments, the interaction described above with respect to the first set of indications can also be analogously performed with the second set of indications. For example, as described with reference to FIGS. 5M-50, in some embodiments, in response to detecting the user input 5106, that optionally continues as user input 5132, the page of the control user interface 5002-6 corresponding to the pagination indicator 5030-5 is displayed as the user input 5132 scrubs over the indicator 5030-5, and as the user input continues as the user input 5134, the favorites page of the control user interface 5002-2 is displayed. Detecting a user input that scrubs over a respective indication of a respective page of controls that is available in the control user interface, and updating the user interface to display the respective page as the user input scrubs over the respective indication, provides visual feedback about a state of the computer system and makes it easier for the user to navigate between pages of controls using a scrub input directed to the displayed indications of pages of controls, thereby providing additional control options for the user.

In some embodiments, while displaying, concurrently with display of the second set of two or more controls, the second set of indications corresponding to the second set of two or more controls and the one or more additional sets of controls, in the control user interface, the computer system detects (630) a fourth input that is directed to a respective location in the control user interface (e.g., based on the location of the contact of a touch input, a location of a gaze detected in conjunction with an air gesture, the target location of a pointing device or pointing object, or other indications of location for the fourth input); and in response to detecting the fourth input that is directed to the respective location in the control user interface: in accordance with a determination that the respective location corresponds to a third indication of the second set of indications and that the fourth input meets selection criteria (e.g., the fourth input is a tap input, an air tap, an air tap with a corresponding gaze input, an air pinch, a tap-hold input, or another type of input that meets selection criteria), the computer system displays a third additional set of controls in the control user interface (e.g., without displaying a fourth additional set of controls or other additional sets of controls in the control user interface); and in accordance with a determination that the respective location corresponds to a fourth indication of the second set of indications different from the third indication, the computer system displays a fourth additional set of controls, different from the third additional set of controls, in the control user interface (e.g., without displaying the third additional set of controls or other additional sets of controls in the control user interface). In some embodiments, the first set of indications is displayed in a row or a column along the first edge of the computer system, or in a cluster, and the fourth input includes a tap on a respective indication; and correspondingly, the computer system displays the set of controls corresponding to the respective indication that is selected by the tap input, in the control user interface (and, optionally, ceases to display sets of controls that were displayed prior to the tap input). In some embodiments, multiple taps on different indications are detected consecutively, and different sets of controls corresponding to the indications selected by the tap inputs are displayed one by one after a respective tap of the multiple taps. In some embodiments, the interaction described above with respect to the second set of indications can also be analogously performed with the first set of indications. For example, as described with reference to FIG. 5K, in some embodiments, in response to detecting a tap user input, such as user input 5082, directed to the connectivity indicator 5030-3, the device 100 displays the connectivity page of the control user interface 5002-3. Detecting a user input that taps on a respective indication of a respective page of controls that is available in the control user interface, and updating the user interface to display the respective page as the user input scrubs over the respective indication, provides visual feedback about a state of the computer system and makes it easier for the user to navigate between pages of controls using tap inputs directed to the displayed indications of pages of controls, thereby providing additional control options for the user.

In some embodiments, the first set of indications includes (632) a first icon corresponding to the first set of two or more controls, and the second set of indications includes a second icon corresponding to the second set of two or more controls. In some embodiments, while displaying the first set of two or more controls or the second set of two or more controls, the computer system detects a fifth input that corresponds to a request to display a third set of controls different from the first set of two or more controls and the second set of two or more controls (e.g., a swipe along the first edge of the computer system, a tap on an indication of the third set of controls, or another input that causes the currently displayed set of controls to be replaced with a different set of controls available to be displayed in the control user interface); and in response to detecting the fifth input, displays, in the control user interface, the third set of controls (e.g., replaces display of the respective set of controls displayed in the control user interface prior to detecting the fifth input, and/or moving the respective set of controls out of way for the third set of controls), wherein the third set of controls corresponds to a third set of control functions of the computer system different from the first set of two or more control functions and the second set of two or more control functions of the computer system, and displaying a third icon corresponding to the third set of controls, different from the first icon and the second icon. In some embodiments, the first icon, the second icon, and the third icon are chosen based on the currently displayed set of controls (e.g., a home icon for a set of home controls, a media icon for a set of media playback controls, and a device icon for a set of device controls, a favorites icon for a set of saved controls, and/or a recommendation icon for a set of system recommended controls based on context). For example, as described with reference to FIG. 5B, in some embodiments, one or more pagination indicators 5030 display an icon that represents the type and/or category of controls that are included in the respective page of the control user interface 5002. For example, a connectivity icon is displayed as the indicator 5030-3 (e.g., instead of, or next to, a pagination dot indicator), a now playing icon is displayed as the indicator 5030-4 (e.g., instead of, or next to, a pagination dot indicator), and a home controls icon is displayed as indicator 5030-6 (e.g., instead of, or next to, a pagination dot indicator). Automatically identifying a category of control options that are included in a page of the control user interface and displaying a representation of the identified category as an indication of the respective page of the control user interface, provides visual feedback about a state of the computer system and reduces a number of inputs required for a user to manually assign and/or label pages of the control user interface.

In some embodiments, in accordance with a determination that media display criteria are met (e.g., media is playing at the current time, location is a room where media playing is anticipated, or presence of other contextual conditions associated with media playing; a user input that meets the distance or speed threshold for displaying the set of media controls is detected; or a user input that selects the indication for the set of media controls is detected), the computer system displays (634), in the control user interface, a set of two or more media controls that corresponds to two or more media playback functions of the computer system (e.g., replacing another set of controls that was displayed in the control user interface prior to detecting that the media display criteria are met). In some embodiments, the media display criteria are met when the first movement meets the first criteria and the first set of controls includes a set of media controls, the media display criteria are met when the first movement meets the second criteria and the second set of controls includes a set of media controls, and/or the media display criteria are met when a user input that selects the icon corresponding to the set of media controls from among a set of indications for additional sets of controls in the control user interface. In some embodiments, the set of two or more media controls that correspond to two or more media playback functions includes media playback controls (e.g., play, pause, fast forward, rewind, skip, volume control, scrubber, progress bar, mixer, track, routing control, and/or other control functions for media playback), playlists, selectable representations of media items (e.g., albums, playlists, songs, artists, system-generated recommendations, media files, videos, and/or other media items), selectable representation of output devices for media playback (e.g., speaker A, speaker B, sound system A, earphone, internal speaker, another computer system, and/or other output devices), selectable representations of playback environments (e.g., room, setting, and/or other environments). In some embodiments, while displaying the set of two or more media controls that corresponds to the two or more media playback functions of the computer system, the computer system detects a respective user input that includes movement in a respective direction that is different from a direction of the first movement of the first input (e.g., the set of media controls are displayed in response to a downward swipe, and the respective user input is a horizontal swipe (e.g., a swipe across the bottom region, the top region, the middle region, any region, or other predefined region) across the user interface that includes the set of two or more media controls); and in response to detecting the respective user input, switches from controlling a first set of one or more output devices for media playback using the set of two or more media controls to controlling a second media set of one or more playback devices different from the first set of one or more output devices for media playback. In some embodiments, the first set of one or more output devices for media playback includes a first set of media playback equipment at a first location (e.g., locally at the computer system, kitchen, dining room, or another location) and/or with a first set of configurations (e.g., a first default volume, first directionality, a first set of mixer settings, and/or other configurations), the second set of output devices for media playback includes a second set of media playback equipment at a second location (e.g., yard, deck, bedroom 1, or another location) and/or with a second set of configurations (e.g., a second default volume, second directionality, a second set of mixer settings, and/or other configurations). In some embodiments, the first set of output devices for media playback has a first playback profile (e.g., a collection of media with a first media genre, a first instrument type, a first theme, a first user profile, and/or other first characteristics that are used to identify a collection of media items, and optionally, corresponding playback options (e.g., first output equipment, first output location, first mixer setting, and/or first playback duration) for playing back the collection of media items) and the second set of output devices for media playback has a second playback profile different from the first playback profile (e.g., a collection of media with a second media genre, a second instrument type, a second theme, a second user profile, and/or other second characteristics that are used to identify a collection of media items, and optionally, corresponding playback options (e.g., second output equipment, second output location, second mixer setting, and/or second playback duration) for playing back the collection of media items). In one example, when the set of media controls (e.g., routing control, output device control, play/pause control, fast forward control, rewind control, playback progress bar, playback mode (e.g., repeat, random, or sequential)) are displayed with a respective set of media items, the computer system also displays objects that correspond to a respective set of one or more playback devices, such as a collection of media items corresponding to a respective location, a respective set of output equipment, a set of playlists corresponding to a respective playback profile, and/or other objects that corresponding to different characteristics of a respective set of playback devices. In response to the user swiping across the portion of the user interface displaying the objects that correspond the respective set of playback devices, the computer system switches to a different set of playback devices, and displays objects corresponding to the different set of playback devices, and, optionally, also automatically start playing media items in accordance with the settings of the different set of playback devices. Operations triggered by interactions with the media controls (e.g., media playback operations and/or media selection operations) will be performed with respect to the respective set of playback devices that is currently in focus in the user interface that displays the set of media controls, in accordance with some embodiments. For example, as described with reference to FIGS. 5I-5J, in some embodiments, in response to detecting a user input 5076 (e.g., a tap input and/or a swipe input), the device 100 updates the now playing page of the control user interface 5002-4 to display information and/or playback controls for Device 2. Displaying a media playback page in the control user interface, and updating the media playback page to display one or more media playback controls for another device in response to detecting a user input swiping along an edge of the computer system, provides additional control options for the user to view and/or control media playback of other devices without cluttering the user interface.

In some embodiments, in response to detecting the respective user input, the computer system switches (636) from displaying a current status of a first output device for media playback (e.g., corresponding to a first set of one or more output devices for media playback) to displaying a current status of a second output device for media playback (e.g., corresponding to a second set of one or more output devices for media playback). In some embodiments, the first output device corresponds to a first output location and the second output device corresponds to a second output location. In some embodiments, the first output device corresponds to a first type of output device and the second output device corresponds to a second type of output device. In some embodiments, the first output device corresponds to a first user profile and the second output device corresponds to a second user profile. In some embodiments, the current status of the first output device shows the type, activity, and/or settings of the first output device, and the current status of the second output device shows the type, activity and/or settings of the second output device. Switching between displaying the current status of the first output device and displaying the current status of the second output device allows the user to monitor and/or change the operations of multiple output devices at different locations easily from the computer system. For example, as described with reference to FIGS. 5I-5J, in some embodiments, in response to detecting a user input 5076 (e.g., a tap input and/or a swipe input), the device 100 updates the now playing page of the control user interface 5002-4 to display information and/or playback controls for Device 2, including displaying the status of Device 2 is playing back Song E. Displaying a media playback page in the control user interface, and updating the media playback page to display a media playback status of another device in response to detecting a user input swiping along an edge of the computer system, provides additional control options for the user to view a status of media playback at other devices without cluttering the user interface.

In some embodiments, in accordance with a determination that media display criteria are met (e.g., media is playing at the current time, location is a room where media playing is anticipated, or presence of other contextual conditions associated with media playing; a user input that meets the distance or speed threshold for displaying the set of media controls is detected; or a user input that selects the indication for the set of media controls is detected), the computer system displays (638), in the control user interface, representations of a plurality of output devices for media playback, including concurrently displaying: a first set of two or more media controls that corresponds to two or more media playback functions of a first set of one or more output devices for media playback of the plurality of sets of output devices for media playback, and a selectable option (e.g., selectable by a tap input, an air tap, an air pinch, or another type of selection input) for switching to displaying a second set of two or more media controls that corresponds to a second set of one or more output devices for media playback of the plurality of sets of output devices for media playback. In some embodiments, while displaying the first set of two or more media controls that corresponds to the first set of one or more output devices for media playback, the computer system detects, via the one or more input devices, an input corresponding to selection of the selectable option for switching to displaying the second set of two or more media controls; and in response to detecting the input corresponding to the selection of the selectable option for switching to displaying the second set of two or more media controls, the computer system displays the second set of two or more media controls that corresponds to two or more media playback functions of the second set of one or more output devices for media playback. In some embodiments, in response to detecting the input corresponding to the selection of the selectable option, the computer system displays a selectable option for switching to display media controls for one or more other sets of output devices for media playback that are different from the second set of one or more output devices for media playback. (e.g., the first set of one or more output devices for media playback and/or a third set of one or more output devices for media playback). In some embodiments, a first representation of the first set of output devices for media playback includes the first set of two or more media controls that corresponds to two or more media playback functions of the computer system that control the first set of output devices for media playback. In some embodiments, one of a plurality of sets of devices for media playback is in focus at a given time and the representation of the set of output devices for media playback that has input focus is displayed fully, while at least one of the representations of other available sets of output devices for media playback is partially visible. If a user input selects a partially revealed representation, the computer system fully reveals the selected representation, and shifts input focus to the representation of the newly selected set of output devices for media playback\. In some embodiments, the multiple representations share the same region that includes at least a subset of media controls, and selection of the media controls in this shared region causes operations to be performed with respect to the set of output devices for media playback that are currently in focus (e.g., at the top of the stack of representations for the plurality of sets of output devices for media playback). For example, as described with reference to FIGS. 5T-5V, in some embodiments, the now playing page of the control user interface 5002-7 includes a stack of representations for playback status and/or controls for a plurality of devices, and in response to detecting a user input 5156, the device 100 switches between the platters 5064-1, 5064-2 and 5064-3 via swipe and/or tap inputs to display the playback status and/or controls for another device (e.g., Device 2 and/or Device 3). Displaying a media playback page in the control user interface that includes a stack of user interface elements, each user interface element in the stack corresponding to a status and/or controls for a different playback device, and updating the media playback page to display a status and/or controls for a respective playback device in response to detecting a user input swiping along the stack and/or tapping on a respective user interface element in the stack system, provides additional control options for the user to view and/or control media playback of other devices without cluttering the user interface.

In some embodiments, in accordance with a determination that smart-home display criteria are met, the computer system displays (640), in the control user interface, a set of two or more home controls (e.g., replacing another set of controls that was displayed in the control user interface prior to detecting that the smart-home display criteria are met), including at least a first subset of home controls that corresponds to two or more home control profiles of the computer system (e.g., two or more “scenes”, where a respective “scene” includes a respective set of saved settings for a respective set of multiple smart-home appliances) and a second subset of home controls that correspond to two or more home control locations associated with the computer system (e.g., two or more “rooms”, where a respective “room” includes controls for a respective set of multiple smart-home appliances in that “room”). In some embodiments, the smart-home display criteria are met when the first movement meets the first criteria and the first set of controls includes a set of home controls, the smart-home display criteria are met when the first movement meets the second criteria and the second set of controls includes a set of home controls, and/or the smart-home display criteria are met when a user input that selects the icon corresponding to the set of home controls from among a set of indications for additional sets of controls in the control user interface. In some embodiments, the set of two or more controls include one or more controls that correspond to one or more smart home appliances (e.g., thermostat, garage door, doorbell, oven, lighting, laundry machine, and/or other individual smart home devices) and that control the state(s) and function(s) of the one or more smart home appliances. In some embodiments, the first subset of two or more home controls that correspond to two or more home control profiles include two or more affordances for different saved home control profiles, including at least a first affordance that, when selected, activates a first set of control functions in accordance with the settings of the first home control profile (e.g., a first affordance for a first setting for lighting, a first setting for temperature, a first setting for curtain, and/or a first set of settings for a first set of smart-home appliances, that are saved in the first home control profile) and a second affordance that, when selected, activates a second set of control functions in accordance with the settings of the second home control profile (e.g., a second affordance for a second setting for lighting, a second setting for temperature, a second setting for curtain, and/or a second set of settings for a second set of smart-home appliances, that are saved in the second home control profile). In some embodiments, the different home control profiles are referred to as different “scenes” and a respective scene can be established by a user or preconfigured by the computer system to control and/or activate a plurality of smart home appliances (e.g., lights, lamps, security system, thermostatic, heater, sound system, media player, doorbell, curtains, and/or other sets and combinations of appliances and equipment controlled by the computer system) for a respective mood, setting, task, time of day, and/or location (e.g., “bedtime,” “kitchen,” “reading,” “romantic,” “party,” “morning,” “dinner,” and/or other “scenes”). In some embodiments, a user input selecting a respective control for a respective home control profile causes the computer system to control the respective set of smart home appliances in accordance with the settings established in the respective home control profile, without the user having to individually control the respective set of home appliances one by one. In some embodiments, the second subset of home controls that correspond to two or more home control locations includes a respective control for a first home control location and a respective control for a second home control location, and a user input selecting the respective control for a respective home control location causes the computer system to display the set of controls for the smart home appliances associated with the respective home control location. For example, the two or more home control locations include a first icon for “kitchen,” a second icon for “primary bedroom,” a third icon for “deck,” and a fourth icon for “living room,” and/or additional icons for additional rooms or locations in the house. In one example, selection of the first icon causes display of the controls for lights in the kitchen counter, overhead light, and undercabinet lights, controls for the oven, controls for the fridge, and/or controls for other smart home appliances in the kitchen. In another example, selection of the second icon, causes the computer system to display controls for bedside lamps, overhead light, curtains, thermostat, security system, sound system, and/or the TV in the master bedroom. In another example, selection of the third icon causes the computer system to display controls for speakers, gate, lights, and/or shades on the deck of the house. In some embodiments, two or more of the icons for the different home control locations are concurrently displayed in the control user interface, concurrently with the icons for the different home control profiles, and when the user selects one of the icons for the different home control locations, a folder containing the controls for the set of smart home appliances associated with the home control location of the selected icon is opened and displayed overlaying the control user interface. For example, as described with reference to FIG. 5L, in some embodiments, the home control page of the control user interface 5002-5 includes one or more scene controls, such as leave home scene 5090, arrive home scene 5092 and/or wake up scene 5100, and optionally one or more room controls 5094 and 5096 for controlling features of a selected room associated with the room control. Displaying a home controls page in the control user interface, including displaying one or more home controls for activating one or more scenes and/or one or more home controls for controlling a respective room in the home, such that the user selects to enable a respective scene and/or view and control functions for the respective room and provides additional control options for the user and reduces a number of inputs required to access the home controls by displaying the home controls in the control user interface without requiring the user to navigate to another user interface.

In some embodiments, while the control user interface is not displayed, the computer system detects (642) a first event; and in response to detecting the first event, in accordance with a determination that control display criteria are met as a result of the first event (e.g., the first event includes a first user input that includes movement along a first edge of the display, or another system or user triggered event that causes the display of the control user interface), displays the control user interface including a respective set of two or more controls that correspond to a respective set of two or more control functions of the computer system, wherein displaying the control user interface in response to detecting the first event includes: in accordance with a determination that a third set of contextual conditions are met (e.g., at the time that the first event was detected, and/or during a time window of the first event), displaying the control user interface with a first layout; and in accordance with a determination that a fourth set of contextual conditions, different from the third set of contextual conditions, are met (e.g., at the time that the first event was detected, and/or during a time window of the first event), displaying the control user interface with a second layout different from the first layout, wherein the first layout and the second layout are different in at least one of spatial arrangement of controls and included collections of controls in the control user interface. In some embodiments, the contextual conditions that affect the layout of the control user interface includes the user profile (e.g., user A, parent, child, or guest), focus modes (e.g., DND, morning, work, study, sleep), time of day (e.g., morning, night, work day, weekend, and/or schedule of the day), location (e.g., room the computer system is in, whether the computer system is away or at home), usage history (e.g., frequencies, recencies, and/or usage patterns that different controls have been used), and/or other contextual conditions of the computer system. In some embodiments, the spatial arrangement of controls includes which set of controls are displayed first, how they are grouped together in a folder or module, which controls are displayed in proximity of one another, and/or the sizes and locations of the different controls. In some embodiments, the included collections of controls in the control user interface include which subset of controls in a group of controls are directly visible and/or accessible when the control user interface is displayed, or when a tab controlling the group of controls is selected in the control user interface. In some embodiments, the contextual conditions not only control the initial set of controls that is displayed when the control user interface is first displayed, they also affect the subsequent sets of controls that are displayed when the user browses through the different sets of controls using the indicators of the different sets of controls and/or using additional gestures along the edge of the computer system. For example, as described with reference to FIGS. 5X and 5Y, in some embodiments, while a voice recording session is active, the control user interface 5002-2 is modified, as illustrated as the modified version of the control user interface 5002-2″and/or the modified version of the control user interface 5002-2′″. Automatically determining a context based on one or more conditions of the computer system, and updating the control user interface based on the determined context, provides additional visual feedback about the state of the computer system and reduces a number of user inputs required to view status information and/or to access controls related to the current context.

In some embodiments, displaying the control user interface with the first layout includes (644) displaying a first control at a first location in the control user interface, and displaying the control user interface with the second layout includes displaying the first control at a second location, different from the first location, in the control user interface. In some embodiments, displaying the control user interface with the first layout includes displaying a second control at a third location in the control user interface, and displaying the control user interface with the second layout includes displaying the second control at a fourth location, different from the second location, in the control user interface. In some embodiments, displaying the control user interface with the first layout includes displaying a first plurality of controls with a first spatial arrangement of the first plurality of controls (e.g., first ordering of the controls, first grid size, first grid dimensions, first spacing, first way of grouping controls, and/or first overall position of the controls as a whole); and displaying the control user interface with the second layout includes displaying the first plurality of controls with a second spatial arrangement of the first plurality of controls (e.g., second ordering of the controls, second grid size, second grid dimensions, second spacing, second way of grouping controls, and/or second overall position of the controls as a whole). For example, as described with reference to FIG. 5X, in some embodiments, the expanded indication 5166 of the active voice recording causes the one or more other controls in the control user interface 5002-2″ to change in position. Displaying the control user interface such that the controls are arranged in a first layout or in a second layout based on a context of the computer system, makes more relevant controls more accessible to the user, thereby reducing a number of user inputs required to find and/or select the relevant controls.

In some embodiments, displaying the control user interface with the first layout includes (646) displaying a second control (e.g., the first control, or another control different from the first control) in a first state (e.g., in a minimized or collapsed state) in the control user interface, and In some embodiments, interaction with the second control in accordance with first interaction criteria causes performance of a respective control function corresponding to the second control (e.g., tap on the flashlight control toggles the flashlight on or off; or swipe on a volume control bar causes adjustment of volume), and interaction with the second control in accordance with second interaction criteria causes display of the first control in a second state (e.g., an expanded or maximized state) without causing performance of the respective control function (e.g., tap and hold on the flashlight control displays the flashlight control with an expanded size and enables finer adjustment of flashlight brightness; or tap and hold on the volume control expands the volume control bar that allows finer adjustment of the volume). In some embodiments, displaying the control user interface with the second layout includes displaying the second control in the second state, in the control user interface, wherein the second control displayed in the second state provides additional functionality (e.g., larger size, finer adjustment in response to user input, additional status information related to the second control, and/or additional controls for other control functions related to the main function of the second control) related to the respective control function, that is not provided when the second control is displayed in the first state. In one example, the media playback control module has a first state that includes the play/pause button, the fast forward button, the rewind button, and a routing button in a module, and tapping on one of the buttons causes performance of a corresponding control function for the currently selected media; and the media playback control module has a second, expanded state, that includes the buttons of the module shown in the first state, and additional controls, such as an album art for the currently selected media, the volume control for playback, and a playback progress control that can be used to scrub through the media item. In another example, the WiFi control displayed in the first state toggles WiFi on and off, and the WiFi control displayed in a second expanded state, optionally, does not include the toggle function, but includes a listing of WiFi servers available for selection. In another example, the display brightness control displayed in the first state is a slider control that is adjustable in response to a swipe input and shows the current display brightness level; and the display brightness control displayed in the second, expanded state, is an expanded slider control that is adjustable with finer increments, and includes additional controls for turning on/off dark mode, nightshift, and true tone for the display. For example, as described with reference to FIG. 5R, in some embodiments, while a music session is active, a larger music control 5146 is displayed in the modified version of the control user interface 5002-2′, relative to the playback platter 5012 (e.g., a collapsed version of the controls in the music control 5146) for controlling media playback, displayed in the user interface 5002-2. Displaying the control user interface such that the controls are arranged in a first layout that includes a minimized, or collapsed, version of at least one control, or in a second layout that includes a maximized, or expanded, version of the at least one control, based on a context of the computer system that determines whether the at least one control is a relevant control in the current context, makes more relevant controls more accessible to the user, thereby reducing a number of user inputs required to find and/or select the relevant controls.

In some embodiments, the fourth set of contextual conditions requires (648) that the computer system is performing a first set of operations (e.g., at the time that the first event was detected, and/or during a time window of the first event), in order for the fourth set of contextual conditions to be met. In some embodiments, the third set of contextual conditions requires that the computer system is performing a second set of operations (e.g., at the time that the first event was detected, and/or during a time window of the first event) (and, optionally, not performing the first set of operations), in order for the third set of contextual conditions to be met. In some embodiments, the first and/or second set of operations include a media playback operation, a system update operation, an application download operation, a media recording operation, a home control operation, and/or one or more other operations. For example, as described with reference to FIG. 5Y, in some embodiments, while a voice recording is active (e.g., and/or the device is performing another operation), the device 100 displays a modified version of the control user interface 5002-2″. Displaying the control user interface such that the controls are arranged in a first layout or in a second layout based on a context of whether or not the computer system is performing a respective operation, makes more relevant controls that are relevant to the respective operation more accessible to the user, thereby reducing a number of user inputs required to find and/or select the relevant controls.

In some embodiments, the second control includes (650) a media playback control module that includes a play/pause control (and, optionally, fast forward control, rewind control, and routing control), the third set of contextual conditions requires that media playback is not ongoing in order for the third set of contextual conditions to be met and in order for the media playback control module to be displayed in a first state of the media playback control module, the fourth set of contextual conditions requires that the media playback is ongoing in order for the fourth set of contextual conditions to be met and in order for the media playback control module to be displayed in a second state of the media playback control module, wherein the media playback control module displayed in the second state of the media playback control module provides additional functionality (e.g., album art, volume control for indicating a current volume setting and/or controlling volume based on user input, and/or playback progress control indicating a current playback position and/or for controlling a current playback position based on user input) that is not provided when the media playback control module displayed in the first state of the media playback control module. For example, as described with reference to FIG. 5R, in some embodiments, while a music session is active, a larger music control 5146 is displayed in the modified version of the control user interface 5002-2′, relative to the playback platter 5012 for controlling media playback, displayed in the user interface 5002-2. Displaying the control user interface such that media playback controls for a media playback session are arranged in a first layout or in a second layout based on a context of whether a state of the media playback session is active or inactive, makes more relevant controls related to the current state of a media playback session more accessible to the user, thereby reducing a number of user inputs required to find and/or select the relevant controls.

In some embodiments, displaying the control user interface with the first layout includes (652): displaying a media recording control that includes one or more controls for changing values for one or more parameters (e.g., controls for virtual lighting, image filters, virtual visual effects, audio filters, audio or visual enhancements, and/or other controls for modes and/or parameters) of media recording (e.g., audio recording, voice memo, screen recording, and/or video recording), in the control user interface, in accordance a determination that media recording is ongoing, and In some embodiments, the one or more controls for changing the values of the parameters for audio recording include one or more of a mute control, an unmute control, a voice isolation control, and a background removal control. In some embodiments, the parameters for image recording include whether a background is obscured (e.g., removed, hidden, and/or blurred), a degree of obscuring the background (e.g., a degree to which the background is blurred), whether gesture based visual effects are enabled or disabled, whether visual filters are applied to the image/video content that is being captured, and/or a degree to which visual filters are applied to image/video content that is being captured. In some embodiments, displaying the control user interface with the first layout includes displaying the control user interface with the second layout includes forgoing displaying the media recording control in the control user interface, in accordance with a determination that media recording is not ongoing. For example, as described with reference to FIG. 5Y, in some embodiments, the modified version of the control user interface 5002-2′″ includes a selectable option 5174-1 for accessing additional controls (e.g., microphone controls, privacy controls and/or other controls) while a voice recording is active. Displaying the control user interface such that voice recording controls are arranged in a first layout or in a second layout based on a context of whether a state of a voice recording session is active or inactive, makes more relevant controls related to the current state of a voice recording session more accessible to the user, thereby reducing a number of user inputs required to find and/or select the relevant controls.

In some embodiments, displaying the control user interface includes (654): in accordance with a determination that a current context of the computer system meets a fifth set of contextual conditions (e.g., conditions based on whether location tracking, location sharing, audio recording, audio communication, video recording, video communication, vehicle navigation, file transfer, and/or other data sharing or device activities that impact user privacy, took place recently or is ongoing, and/or other contextual conditions), displaying a first set of status information associated with a current status of the computer system (e.g., a first set of status indicators and/or process names related to location tracking, location sharing, vehicle navigation, voice recording, video recording, audio and video communications, and/or other status information related to user privacy and ongoing device activities); and in accordance with a determination that the current context of the computer system meets a sixth set of contextual conditions (e.g., conditions based on whether location tracking, location sharing, audio recording, audio communication, video recording, video communication, vehicle navigation, file transfer, and/or other data sharing or device activities that impact user privacy, took place recently or is ongoing, and/or other contextual conditions) different from the fifth set of contextual conditions, displaying a second set of status information associated with the current status of the computer system (e.g., a second set of status indicators and/or process names related to location tracking, location sharing, vehicle navigation, voice recording, video recording, audio and video communications, and/or other status information related to user privacy and ongoing device activities). In some embodiments, the respective set of status information associated with the current status of the computer system is displayed in a status region of the control user interface, e.g., above the respective set of controls that are displayed in the control user interface. In some embodiments, a camera icon is displayed in the status region when a camera device is being used to capture image and/or video at the present time (e.g., camera icon with a first appearance to indicate ongoing activity) or was used to capture image and/or video within a recent time window (e.g., camera icon with a second appearance to indicate recent activity). In some embodiments, a microphone icon is displayed in the status region when a microphone device is being used to capture audio at the present time (e.g., microphone icon with a first appearance to indicate ongoing activity) or was used to capture audio within a recent time window (e.g., microphone icon with a second appearance to indicate recent activity). In some embodiments, a location tracking icon is displayed in the status region when location tracking is being used to determine and share location of the computer system at the present time (e.g., location tracking icon with a first appearance to indicate ongoing activity) or was used to track or share location of the computer system within a recent time window (e.g., location tracking icon with a second appearance to indicate recent activity). In some embodiments, names and/or identifiers of one or more processes (e.g., voice call, video call, maps, file transfer, mixed reality gaming, or other applications and/or processes) that are currently ongoing or recently completed, and that are utilizing or have utilized one or more device features involving media recording, location tracking, location sharing, data sharing, file sharing, biometric scanning, navigation, and/or other activities that impact user privacy, are displayed in the status region along with the status indicators for the utilized device features (e.g., camera icon, microphone icon, file sharing icon, location tracking icon, or other indicators of device features). In some embodiments, in accordance with a determination that the current context of the computer system in indicate that no condition for triggering display of status information is met (e.g., the conditions based on whether location tracking, location sharing, audio recording, audio communication, video recording, video communication, vehicle navigation, file transfer, and/or other data sharing or device activities that impact user privacy, took place recently or is ongoing, and/or other contextual conditions are not met), the computer system forgoes displaying status information associated with the current status of the computer system (e.g., no status indicator related to location tracking, location sharing, vehicle navigation, voice recording, video recording, audio and video communications, and/or other status information related to user privacy and ongoing device activities are displayed). For example, as described with reference to FIG. 5Y, in some embodiments, the modified version of the control user interface 5002-2′″ includes a selectable option 5174-1 for accessing additional controls (e.g., microphone controls, privacy controls and/or other controls) while a voice recording is active, and selectable option 5174-2 is displayed while a video call is active (e.g., without displaying the selectable options 5164-1 and/or 5174-2 if a respective voice recording and/or video call is active). Displaying a status indicator indicating whether or not hardware and/or other data of the computer system are currently being accessed in the control user interface improves the privacy and security of the computer system by alerting the user when certain hardware and/or other data (e.g., a microphone, camera, location and/or other data) are being accessed with display of an indication in the control user interface.

In some embodiments, while displaying a respective set of status information of the first set of status information and the second set of status information, the computer system detects (656) a user input selecting the respective set of status information (e.g., selecting one of a plurality of status indicators and/or process names displayed in the status region of the control user interface, or selecting the status region as a whole (e.g., using a tap input, an air tap, an air pinch, or other types of selection input directed to a status indicator or the status region)); and in response to detecting the user input selecting the respective set of status information, the computer system displays additional details related to the respective set of status information, wherein the additional details are not displayed before the respective set of status information is selected. For example, in some embodiments, the respective set of status information includes a process name or application that is utilizing one or more device features of the computer system; in response to selection of a process name or application for a “video call” in the status region, the computer system displays a plurality of control options for controlling the device features involved in the video call process, including one or more options for controlling the camera, one or more options for controlling the microphone, and one or more options for controlling location sharing and/or file sharing if location and file sharing are involved in the video call that is currently ongoing. In some embodiments, the respective set of status information includes the icons for the device features that are in use; for example, in response to selection of the camera icon in the status region, the computer system displays the application icon(s) corresponding to the application(s) that are currently using or have recently used the camera to capture images and/or videos; in response to selection of the microphone icon in the status region, the computer system displays the application icon(s) corresponding to the application(s) that are currently using or have recently used the microphone to capture audio or voice information; and/or in response to selection of the location tracking icon in the status region, the computer system displays the application icon(s) corresponding to the application(s) that are currently tracking or sharing the user's location and/or has tracked or shared the user's location. In some embodiments, the additional details include names of processes that impact user privacy, such as the names of processes and applications that use the camera, microphone, location tracking, biometric scanning, and/or other privacy related device features. In some embodiments, the additional details related to the respective set of status information includes timing, duration, sender, receiver, destination, saved files, and/or other information related to the respective set of status information (e.g., in particular, for the device or function associated with the selected status indicator). For example, as described with reference to FIG. 5Y, in some embodiments, in response to the user input 5176, the user interface 5178 is displayed that includes the set of control options 5182 is displayed for the microphone and/or privacy indications 5184. Displaying a user-selectable status indicator indicating whether or not hardware and/or other data of the computer system are currently being accessed in the control user interface, that when selected by the user, causes the computer system to display additional information about the hardware and/or other data that is being accessed, improves the privacy and security of the computer system by alerting the user when certain hardware and/or other data (e.g., a microphone, camera, location and/or other data) are being accessed with display of an indication in the control user interface, and further reduces a number of user inputs required to view the additional information related to the hardware and/or other data.

In some embodiments, while displaying a respective set of status information of the first set of status information and the second set of status information, the computer system detects (658) a user input selecting the respective set of status information (e.g., selecting one of a plurality of status indicators and/or process names displayed in the status region of the control user interface, or selecting the status region as a whole (e.g., using a tap input, an air tap, an air pinch, or other types of selection input directed to a status indicator, process name, or the status region)). In response to detecting the user input selecting the respective set of status information, the computer system displays one or more controls for controlling (e.g., changing values, and/or states of) one or more parameters (e.g., active or inactive state, speed, vertical lighting, audio and/or video filters, duration, and/or other parameters) of a respective device feature (e.g., microphone, speaker, earphones, camera, video recording, audio recording, video transmission, audio transmission, navigation, voice recording, fingerprint scanning, facial identification scanning, telephony communication, location tracking, location sharing, file transfer, and other device features that impact user privacy and data sharing) represented in the respective set of status information (e.g., a respective device feature represented by a selected status indicator, or by one of the status indicators in the status region of the control user interface). For example, in response to selection of the camera icon or a name of a process that is currently using the camera feature in the status region, the computer system displays one or more controls for the camera to capture images and/or videos or adjusting parameters and functions of the image and/or video capturing that is ongoing; in response to selection of the microphone icon or the name of a process that is using the microphone in the status region, the computer system displays one or more controls for the microphone to capture audio or voice information and/or adjusting parameters and functions of the audio and voice capturing that is ongoing; and/or in response to selection of the location tracking icon in the status region, the computer system displays one or more controls for tracking and sharing a user's location and/or adjusting one or more parameters for location tracking and sharing that is ongoing. In some embodiments, in response to selection of a process name “video call” in the status region, the computer system displays a plurality of control options for controlling the device features involved in the video call process, including one or more options for controlling the camera, one or more options for controlling the microphone, and one or more options for controlling location sharing and/or file sharing if location and file sharing are involved in the video call that is currently ongoing. For example, as described with reference to FIG. 5Y, in some embodiments, in response to the user input 5176, the user interface 5178 is displayed that includes the set of control options 5182 is displayed for the microphone (e.g., and/or other hardware of the device 100, as described with reference to FIG. 5AA) and/or privacy indications 5184. Displaying a user-selectable status indicator indicating whether or not hardware and/or other data of the computer system are currently being accessed in the control user interface, that when selected by the user, causes the computer system to display one or more controls for controlling the hardware and/or other data that is being accessed, improves the privacy and security of the computer system by alerting the user when certain hardware and/or other data (e.g., a microphone, camera, location and/or other data) are being accessed with display of an indication in the control user interface, and provides additional control options related to the hardware and/or other data.

In some embodiments, displaying the one or more controls for controlling the one or more parameters of the respective device feature represented in the respective set of status information includes (660): in accordance with a determination that the respective set of status information includes first status information corresponding to a visual media recording device (e.g., a camera device that records still images and/or video, streams video, transmits video in a video communication, and/or performs other forms visual media recording in other processes) (e.g., in accordance with a determination that the user input selects the first status information), displaying a first set of controls for controlling a first set of parameters of the visual media recording device (e.g., controls for changing the states and/or values of one or more parameters, such as turning on or off one or more video effects, changing an orientation of the recording, changing a zoom level of the recording, turning on/off one or more image filters, changing virtual lighting, and/or other parameters of the visual media recording). For example, as described with reference to FIG. 5AB, in some embodiments, the user interface 5178 includes a set of control options, such as for enabling and/or disabling video effects, enabling and/or disabling portrait mode, and/or changing a level of zoom, for the camera that is being accessed by the device 100, including displaying a preview of the camera feed 5196. Displaying a user-selectable status indicator indicating whether or not hardware and/or other data of the computer system are currently being accessed, including whether camera data is being accessed, and displaying one or more controls for managing one or more properties of the camera data that is being accessed, improves the privacy and security of the computer system by alerting the user when the camera and/or camera data are being accessed, and provides additional control options related to the camera data.

In some embodiments, while the first set of controls for controlling the first set of parameters of the visual media recording device, the computer system detects (662) a user input that is directed to a third control (e.g., an expandable toggle control) in the first set of controls; and in response to detecting the user input that is directed to the third control in the first set of controls: in accordance with a determination that the user input that is directed to the third control is of a first input type (e.g., is a tap input, an air pinch input, an air tap input, and/or does not meet a first input threshold (e.g., does not meet a first duration threshold, a first intensity threshold, and/or a first distance threshold)), the computer system changes a respective state of a parameter controlled by the third control from a first state to a second state (e.g., two discrete values of the parameter controlled by the third control (e.g., corresponding to an ON state and an OFF state; a BRIGHT state and a DARK state; a Portrait mode and a Landscape mode; a theater mode and a TV mode; a first aspect ratio and a second aspect ratio; and other pairs of states and/or discrete values)); and in accordance with a determination that the user input that is directed to the third control is of a second input type that is different from the first input type (e.g., is a tap and hold input, a pinch and hold air gesture, a light press input, a double tap input, or meets the first input threshold that is not met by inputs of the first input type), the computer system displays a plurality of selectable states for the parameter controlled by the third control, including the first state, the second state, and one or more additional states different from the first state and the second state (e.g., displaying the plurality of selectable states along a slider control that is transformed from the first control, or displaying a plurality of selectable states in a menu that is expanded out of the first control). In some embodiments, the computer system displays a control for a visual media recording device that toggles between two main values of a parameter in response to an input of a first input type (e.g., such as a tap input, a pinch input, or another type of light weight input), and if the input is of a second input type (e.g., a tap and hold input, a light press input, a pinch and hold input, or another type of enhanced selection input), the computer system expands the control to show more values of the parameter to allow the user to select another less frequently used value or adjust the parameter with finer granularity. In some embodiments, the computer system selects the value in the expanded control in accordance with a continuation of the user input that expanded the control (e.g., a drag input that is a continuation of the tap and hold input or the pinch and hold input), and/or in accordance another input that is detected after the user input that expanded the control (e.g., another tap input, pinch input, selection input, or input of the first input type) and that specifies the value of the parameter using the expanded control. For example, as described with reference to FIG. 5AB, in some embodiments, in response to detecting the user input 5200, the portrait mode is toggled on and/or off, and in response to detecting the user input 5198, the depth of focus is changed in accordance with the user input 5198. Displaying one or more controls related to hardware and/or other data that is being accessed by the computer system, including displaying a control for one or more camera data properties that can be toggled on and/or off using a first type of user input and/or that can be controlled granularly using a second type of input, provides additional control options for the user without cluttering the display with unnecessary control options (e.g., when granular control is unavailable for a control that is turned off).

In some embodiments, displaying the one or more controls for controlling the one or more parameters of the respective device feature represented in the respective set of status information includes (664): in accordance with a determination that the respective set of status information includes second status information corresponding to an audio media recording device (e.g., a microphone that records audio or speech, streams audio, transmits audio in an audio communication, and/or performs other forms audio media recording in other processes) (e.g., in accordance with a determination that the user input selects the second status information), displaying a second set of controls for controlling a second set of parameters of the audio media recording device (e.g., controls for changing the states and/or values of one or more parameters, such as turning on or off one or more audio effects, changing a volume level of the recording, turning on/off one or more audio filters, changing background sounds, and/or other parameters of the audio media recording). For example, as described with reference to FIGS. 5Z and 5AB, in some embodiments, a set of control options 5182 for managing the microphone, optionally used for a voice recording and/or audio of a video call, is provided. Displaying a user-selectable status indicator indicating whether or not hardware and/or other data of the computer system are currently being accessed, including whether microphone data is being accessed, e.g., for audio recording, and displaying one or more controls for managing one or more properties of the microphone data that is being accessed, improves the privacy and security of the computer system by alerting the user when the microphone and/or audio data are being accessed, and provides additional control options related to the microphone data.

In some embodiments, in response to detecting the user input selecting the respective set of status information, the computer system displays (666) a graphical indication of a current output (e.g., visual indication of a current value, changes in value of one or more characteristics of the output (e.g., streaming thumbnails, bouncing audio waves, scanning progress, and/or other characteristics of the device feature)) of a respective device feature (e.g., microphone, speaker, earphones, camera, video recording, audio recording, video transmission, audio transmission, navigation, voice recording, fingerprint scanning, facial identification scanning, telephony communication, location tracking, location sharing, file transfer, and other device features that impact user privacy and data sharing) represented in the respective set of status information (e.g., a respective device feature represented by a selected status indicator, or by one of the status indicators in the status region of the control user interface). For example, in response to selection of the camera icon in the status region, the computer system displays a graphical indication of a progress or visual content of the camera output; in response to selection of the microphone icon in the status region, the computer system displays a graphical indication of a wave pattern of the audio recorded by the microphone; and/or in response to selection of the location tracking icon in the status region, the computer system displays a graphical indication of the locations that are tracked or shared. For example, as described with reference to FIGS. 5Z and 5AB, in some embodiments, a representation of the captured audio and/or a preview of the camera feed 5196 is displayed in the user interface 5178. Displaying one or more controls related to hardware and/or other data that is being accessed by the computer system, including displaying a control for one or more audio data properties that can be toggled on and/or off using a first type of user input and/or that can be controlled granularly using a second type of input, provides additional control options for the user without cluttering the display with unnecessary control options (e.g., when granular control is unavailable for a control that is turned off).

In some embodiments, in accordance with a determination that the respective set of status information includes third status information corresponding to a file transfer function of the computer system (e.g., a file transfer function via a Bluetooth connection or other close proximity, ad hoc, wireless connections, a file transfer function via FTP or other secure or persistent file transfer protocols, and/or performs other forms file transfer in other processes) (e.g., in accordance with a determination that the user input selects the third status information), the computer system displays (668) a third set of controls for controlling a third set of parameters of the file transfer function of the computer system (e.g., controls for accepting an incoming transfer request, starting an outgoing transfer to a detected recipient device, canceling an ongoing file transfer (e.g., incoming or outgoing), changing a bandwidth of the file transfer). In some embodiments, the computer system also displays a graphical indication of the ongoing file transfer processes and their corresponding progress (e.g., in terms of size of file, amount of data already transferred, amount of data remaining to be transferred, files that are queued up to be transferred, and issues and alerts related to the file transfers). For example, as described with reference to FIG. 5AA, in some embodiments, an indication of a transfer state is displayed in the modified version of the control user interface 5002-2″. Displaying a user-selectable status indicator indicating whether or not hardware and/or other data of the computer system are currently being accessed, including whether file data is being accessed, e.g., for file transfer, and displaying one or more controls for managing one or more properties of the file data and/or transfer operation, improves the privacy and security of the computer system by alerting the user when file data is being accessed, and provides additional control options related to the file data and/or transfer operation.

In some embodiments, displaying the one or more controls for controlling the one or more parameters of the respective device feature represented in the respective set of status information includes (670): in accordance with a determination that the respective set of status information includes fourth status information corresponding to a gaming function associated with the computer system (e.g., the computer system is communicating with a gaming device that is utilizing the computer system for processing, input, and/or output of a gaming experience) (e.g., in accordance with a determination that the user input selects the fourth status information), displaying a fourth set of controls for controlling a fourth set of parameters of the gaming function (e.g., controls for changing the states and/or values of one or more parameters, such as parameters and settings that affect the performance and user experience of the gaming function (e.g., allocation of processing power, display parameters, and/or audio parameters) for optimizing and enhancing the performance of the gaming function by disabling or reducing resources such as memory or processing resources consumed by one or more other processes). In some embodiments, the fourth set of controls includes a control for turning on or off a game mode which corresponds to a collective change in multiple settings and/or parameters to optimize the gaming function during an ongoing gaming experience provided by the computer system. For example, as described with reference to FIG. 5AA, in some embodiments, a game mode is turned off and/or on in response to detecting a user input 5192 in the control user interface 5002-2″″. Automatically displaying a user-selectable status indicator for enabling and/or disabling a game mode that optimizes performance of the computer system for gaming, in response to determining a gaming experience is active at the computer system, and displaying one or more controls for managing one or more properties of the game mode, provides additional control options related to the game mode and reduces a number of inputs required to navigate to a settings page to turn on and/or off the game mode.

In some embodiments, displaying the control user interface includes (672): displaying a power control in the control user interface, concurrently with a respective set of controls that corresponds to a set of control functions of the computer system (e.g., among the first set of two or more controls, the second set of two or more controls, or another set of two or more controls that are different from the first and second sets of controls) included in the control user interface; while displaying the power control, detecting a user input that is directed to the power control in the control user interface; and in response to detecting the user input that is directed to the power control in the control user interface: in accordance with a determination that the user input that is directed to the power control meet activation criteria (e.g., the user input is a tap on the power control, an air pinch directed to the power control, a tap and hold input on the power control, or another selection or enhanced selection input that is directed to the power control), initiating a process for powering down the computer system (e.g., displaying a prompt and/or an expanded control for the user to provide additional input or confirmation (e.g., a swipe or drag along a slider, another tap input, a press input, or another conformation input or continuation of the selection or enhanced selection input that caused the display of the prompt and/or expanded control) to power down the computer system, and ceasing to display the prompt and/or expanded control and restoring the control user interface including the power control if the additional input or confirmation is not received within a threshold amount of time or if a cancelation input is received). In some embodiments, in response to detecting the user input that is directed to the power control and in response to a determination that the user input does not meet the activation criteria, the computer system forgoes initiating the process for powering down the computer system (e.g., maintains display of the power control, and/or display an explanation about how to meet the activation criteria). In some embodiments, the power control is displayed in multiple pages of the control user interface, and remains displayed in the same position in the control user interface, when the respective set of controls currently visible in the control user interface changes in response to one or more user inputs (e.g., additional swipe gestures along the edge of the display, or one or more tap inputs on respective indicators for other set of controls). In some embodiments, when a new page of controls is added to the control user interface in accordance with user inputs, the power control is automatically added to the new page of the control user interface. In some embodiments, the power control is added as one of the set of controls in a page of the control user interface, and is not shown in other pages of the control user interface unless explicitly added to the other pages by the user. For example, as described with reference to FIGS. 5BQ-5BR, in some embodiments, in response to detecting a user input 5402 directed to the power affordance 5400 that is displayed on each page of the control user interface 5002, the device 100 displays the power user interface 5404. Displaying a power control for powering off the computer system within the control user interface, provides easier access to the power control and reduces the number of user inputs, including inputs that are directed to one or more physical buttons of the computer system, required to power off the computer system.

In some embodiments, displaying the control user interface includes (674) displaying a first adjustable control (e.g., a slider control, a dial, a scrubber, or another type of adjustable control) that corresponds to a first adjustable parameter of a first device feature of the computer system (e.g., volume for a speaker, brightness for the display, brightness for a flashlight, color temperature of a smart lightbulb, temperature set by a thermostat, and/or another adjustable parameter of a device feature of the computer system). In some embodiments, while displaying the control user interface including the first adjustable control, the computer system detects a first user input that is directed to the first adjustable control (e.g., a tap input, a pinch input, a tap and hold input, a swipe input, a pinch and drag input, and/or other types of user input that has a location (e.g., location of a contact, input object, focus selector, and/or gaze that is associated with the first user input) corresponding to the location of the first adjustable control). In some embodiments, in response to detecting the first user input: in accordance with a determination that the first user input meets adjustment criteria, wherein the adjustment criteria require that the first user input includes a first movement input that is directed to the first adjustable control in order for the adjustment criteria to be met by the first user input (e.g., the first user input includes a swipe input that is detected at the location of the first adjustable control, a pinch and drag input that is directed to the first adjustable control (e.g., based on the location of the gaze at the moveable value indicator of the first adjustable control at the time of the pinch input), a pinch and twist input that is directed to a dial control, or another movement input that meets adjustment criteria for the first adjustable control), the computer system adjusts the first adjustable parameter of the first device feature in accordance with the first movement input; and in accordance with a determination that the first user input meets control expansion criteria, wherein the control expansion criteria require that the first user input includes less than a threshold amount of movement in order for the control expansion criteria to be met by the first user input (e.g., the control expansion criteria requires that the first user input meets a third input threshold (e.g., the first input threshold, the second input threshold, or another input threshold that is different from the first and second input thresholds; and/or an intensity threshold and/or a time threshold, and/or the first user input is of a first input type (e.g., two-finger tap, double tap, a finger twist gesture, or another input type)), the computer system displays an expanded version of the first adjustable control (e.g., the expanded version of the first adjustable control is a magnified version of the first adjustable control, and/or allows adjustment of the first adjustable parameter with finer adjustment granularity, and/or includes additional adjustment functions and controls related to the first device feature (e.g., the additional adjustment functions and controls for a brightness control of a smart lightbulb includes controls for changing colors of lighting and color temperature of lighting). For example, as described with reference to FIG. 5BT, in some embodiments, in response to detecting the user input 5422, the flashlight control 5028 is expanded, as illustrated in FIG. 5BU. Displaying a control in the control user interface that requires two or more inputs to activate the control, including a first input to expand the control, decreases the likelihood of a user accidentally invoking the control by requiring an additional input after the control has been expanded.

In some embodiments, while displaying (e.g., in accordance with the determination that the first user input met the control expansion criteria) the expanded version of the first adjustable control, the computer system detects (676) a second user input that is directed to the expanded version of the first adjustable control or a region proximate to the expanded version of the first adjustable control (e.g., a tap input, a pinch input, a tap and hold input, a swipe input, a pinch and drag input, and/or other types of user input that has a location (e.g., location of a contact, input object, focus selector, and/or gaze that is associated with the first user input) corresponding to a location of the expanded version of the first adjustable control or unoccupied region outside of the expanded version of the first adjustable control); and in response to detecting the second user input: in accordance with a determination that the second user input meets modified adjustment criteria, wherein the modified adjustment criteria require that the second user input includes a second movement input with a starting portion of the second movement input directed to a location within the expanded version of the first adjustable control, in order for the modified adjustment criteria to be met by the second user input (e.g., the second user input includes a swipe input that is started at a location within the expanded version of the first adjustable control, a pinch and drag input that is directed to the expanded version of the first adjustable control (e.g., based on the location of the gaze within the expanded version of the first adjustable control at the time of the pinch input), a pinch and twist input that is directed to a location within an expanded version of the dial control, or another movement input that meets the modified adjustment criteria for the first adjustable control), the computer system adjusts the first adjustable parameter of the first device feature in accordance with the second movement input (e.g., adjusting the first adjustable parameter based on the starting portion of the second movement input and/or at least a portion of the second movement input after the starting portion of the second movement input); and in accordance with a determination that the second user input meets control collapsing criteria, wherein the control collapsing criteria require that the second user input is started with a location outside the expanded version of the first adjustable control, in order for the control collapsing criteria to be met by the second user input (e.g., the second user input includes a swipe input that is started at a location outside the expanded version of the first adjustable control, a pinch and drag input that is directed to a region outside of the expanded version of the first adjustable control (e.g., based on the location of the gaze outside of the expanded version of the first adjustable control at the time of the pinch input), a tap input or air pinch input that is directed to a location outside of the expanded version of the first adjustable control, or another movement input or stationary input that do not meet the modified adjustment criteria for the first adjustable control), the computer system ceases to display the expanded version of the first adjustable control (e.g., the expanded version of the first adjustable control is collapsed into the first adjustable control before the expansion, and the parameter value of the adjustable parameter is not affected by the second user input). For example, as described with reference to FIGS. 5BU-5BZ, in some embodiments, in response to detecting the user input 5428 that is off of the user interface element 5426-1, the brightness level of the flashlight is not adjusted and in response to detecting the user input 5432 that is on the user interface element 5426-1, the user input 5432 and/or the user input 5434 adjusts the brightness level of the flashlight. Displaying a control in the control user interface that requires two or more inputs to activate the control, including a first input to expand the control and a second input directed to the expanded control, such as a swipe and/or a slide input, decreases the likelihood of a user accidentally invoking the control by requiring an additional input after the control has been expanded.

In some embodiments, in response to detecting the second user input (678): in accordance with a determination that the second user input meets the modified adjustment criteria, and that a subsequent portion of the second movement input following the starting portion of the second movement input corresponds to a movement of outside the expanded version of the first adjustable control (e.g., the second user input includes a swipe input that is started at a location within the expanded version of the first adjustable control and subsequently moves outside the expanded version of the first adjustable control, a pinch and drag input that is directed to the expanded version of the first adjustable control (e.g., based on the location of the gaze within the expanded version of the first adjustable control at the time of the pinch input) and subsequently moves outside of the expanded version of the first adjustable control, or another movement input that meets the modified adjustment criteria but moves outside of the expanded version of the first adjustable control), the computer system changes at least a shape and a position of the expanded version of the first adjustable control in accordance with the subsequent portion of the second movement input (e.g., changes a size and/or moving the expanded version of the first adjustable control in accordance with a direction and/or magnitude the movement of the second user input outside of the expanded version of the first adjustable control, where a magnitude of the movement of the second user input controls a magnitude of the change in size or movement of the expanded version of the first adjustable controller and/or a direction of the movement of the second user input controls a direction of the change in size or movement of the expanded version of the first adjustable controller). In some embodiments, during the second movement input, the computer system continues to adjust the first adjustable parameter in accordance with the second movement input, even after the second movement input continues outside of the expanded version of the first adjustable control. In some embodiments, the movement of the expanded version of the first adjustable control is less sensitive to the second movement input than the value indicator showing the updated current value of the first adjustable parameter. In some embodiments, the second movement includes movement in a first direction and movement in a second direction (e.g., movements in the vertical direction and movements in the horizontal direction; movement in the axial direction and movement in the radial direction; or other pairs of orthogonal directions), the expanded version of the first adjustable control follows the movements in the first direction and the movements in the second direction, while the value indicator is adjusted in response to movements in the first direction, and does not change in response to movements in the second direction. In some embodiments, in response to detecting the termination of the second user input, in accordance with a determination that the second user input met the modified adjustment criteria and did not meet the control collapsing criteria, the computer system displays the expanded version of the first adjustable control with a default size and a default position (e.g., the starting size and position of the expanded version of the first adjustable control that are used when the expanded version of the first adjustable control was displayed in response to detecting the first user input that meets the control expansion criteria), and with an updated value for the first adjustable parameter as modified in accordance with the second movement input. In some embodiments, in response to detecting the second user input: in accordance with a determination that the second user input includes a third movement input with a starting portion of the third movement input directed to a location outside of the expanded version of the first adjustable control (e.g., the second user input does not meet the modified control adjustment criteria, and meets the control collapsing criteria) (e.g., the second user input includes a swipe input that is started at a location outside of the expanded version of the first adjustable control, a pinch and drag input that is directed to a location outside of the expanded version of the first adjustable control (e.g., based on the location of the gaze outside of the expanded version of the first adjustable control at the time of the pinch input)), the computer system changes at least a position or a location of the expanded version of the first adjustable control in accordance with the third movement input (e.g., moving and/or shrinking the expanded version of the first adjustable control without adjusting the parameter value of the first adjustable parameter (e.g., because the second user input does not meet the modified adjustment criteria) in accordance with the third movement input; and, optionally, ceasing to display the expanded version of the first adjustable control upon termination of the second user input (e.g., lift-off of the contact of the swipe input, or release of the pinch of the pinch and drag gesture), because the second user input meets the control collapsing criteria). For example, as described with reference to FIGS. 5BY-5CB, in some embodiments, as the user input 5432 continues (e.g., as a drag input that does not overlap with the user interface element 5426), the user interface element 5426 gradually decreases in size and/or animates to follow a position of the user input. Gradually shrinking a control in the control user interface, while detecting a second user input after the control has been expanded in response to a first user input, provides visual feedback about the state of the computer system.

It should be understood that the particular order in which the operations in FIGS. 6A-6J have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, and 900) are also applicable in an analogous manner to method 600 described above with respect to FIGS. 6A-6J. For example, the controls, user interfaces, and user inputs described above with reference to method 600 optionally have one or more of the characteristics of the controls, user interfaces, and user inputs described herein with reference to other methods described herein (e.g., methods 700, 800, and 900). For brevity, these details are not repeated here.

FIGS. 7A-7I are flow diagrams illustrating method 700 of configuring a control user interface in accordance with some embodiments. Method 700 is performed at an electronic device or computer system (e.g., device 300, FIG. 3A, or portable multifunction device 100, FIG. 1A) that is in communication with one or more display generation components (e.g., touch-screen displays, standalone displays, head-mounted displays, projectors, and/or other types of display devices), and one or more input devices (e.g., one or more sensors for detecting user inputs, such as cameras, touch-sensitive surfaces, touch-screen display, motion sensors, and/or other sensors and input devices). In some embodiments, the display generation component is a touch-screen display, and the touch-sensitive surface is on or integrated with the display. In some embodiments, the display is separate from the touch-sensitive surface. Some operations in method 700 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Method 700 provides a method for creating a customized group of controls in a control user interface. In some embodiments, the group of controls includes over a threshold number of controls that can be concurrently displayed with a first size, and the computer system displays a control option to expand the group of controls to view and/or select the controls that are included in the customized group of controls. Displaying a control option to expand the group of controls makes it easier for the user to access the controls within the customized group without cluttering the user interface by displaying the group of controls in the expanded state when the user does not intend to access the controls in the group of controls. Providing access to additional controls by selecting the control option to expand the group of controls reduces the number of inputs needed for the user to cause the computer system to perform an operation that is controllable by one of the additional controls in the group of controls displayed in the control user interface, without requiring the user to navigate to a separate user interface.

The computer system displays (702), via the one or more display generation components, a control user interface that provides access to a plurality of controls corresponding to different control functions of the computer system, wherein the control user interface includes a first representation of a first group of controls, wherein the first group of controls includes one or more controls that are added to the first group of controls by a user (e.g., during prior configuration of the first group of controls in a settings user interface of the control user interface, by dragging and dropping a control onto another control or a representation of an existing group of controls in a reconfiguration mode of the control user interface, and/or through other configuration processes performed by the user) For example, as described with reference to FIGS. 5BB-5BG, in some embodiments, the user configures the control user interface via editing control user interface 5210-2, including creating the group of controls 5342.

Displaying the first representation of the first group of controls includes: displaying (704) two or more controls (e.g., all of the first group of controls, but less than or equal to the first threshold number of controls in total) from the first group of controls in the first representation of the first group of controls, wherein the two or more controls include: a first control for performing (706) a first function when selected based on input detected via the one or more input devices; and a second control for performing (708) a second function different from the first function when selected based on input detected via the one or more input devices; and For example, as described with reference to FIG. 5BI, in some embodiments, the group of controls 5342″ includes a control 5327 for controlling a lock state of a door and/or window and one or more other controls.

In accordance with a determination that the first group of controls includes more than a first threshold number of controls (e.g., two, four, six, eight, or another threshold number), the computer system displays (710), concurrently with the two or more controls, a first user interface object that, when selected based on input detected via the one or more input devices, causes the computer system to display one or more additional controls from the first group of controls that have not been displayed in the first representation prior to the selection of the first user interface object (e.g., expanding the first representation to display all of controls in the first group of controls, and/or displaying the controls from the first group of controls that are not initially included in the first representation). In some embodiments, displaying the first representation of the first group of controls includes displaying a first subset of two or more controls from the first group of controls (e.g., less than or equal to a first threshold number of controls (e.g., four, six, eight, nine, ten, twelve, or sixteen)) without displaying additional controls (if any) from the first group of controls within the first representation of the first group of controls. In response to detecting selection of the first representation of the first group of controls (e.g., in response to detecting a selection input that is directed to a portion of the first representation that is not occupied by a control of the first subset of two or more controls), the computer system expands the first representation of the first group of controls and displays all of the controls from the first group of controls, including concurrently displaying controls from the first subset of two or more controls and the additional controls that were not included in the first representation of the first group of controls. For example, in some embodiments, the computer system does not display a separate user interface object within the first representation of the first group of controls as the affordance to trigger the display of the rest of the controls in the first group of controls (e.g., along with the controls originally displayed in the first representation); but instead, the unoccupied region of the first representation (e.g., the background region of the first representation) of the first group of controls is used as the reaction region for triggering the display of the rest of the controls from the first group of controls (e.g., along with the controls originally displayed in the first representation) in an expanded region. In some embodiments, if there are less than the first threshold number of controls in the first group of controls, the first representation includes one or more unoccupied placement locations for controls, and selection of the unoccupied placement locations also causes display of the expanded region that includes all of the controls in the first group of controls, but there are no additional controls from the first group to be added to the expanded region. For example, as described with reference to FIGS. 5BD-5BE, in some embodiments, a maximum number of controls that can fit in the group of controls 5342 is displayed, including displaying an expand option that optionally includes smaller representations of the additional controls.

In some embodiments, displaying the first representation of the first group of controls includes (712): in accordance with a determination that the first group of controls does not include more than the first threshold number of controls, forgoing displaying the first user interface object concurrently with the two or more controls (e.g., the two or more controls include all of the first group of controls, which is less than or equal to the first threshold number of controls in total; if there are less than the first threshold number controls in the first group, the first representation includes one or more unoccupied placement locations for controls). For example, as described with reference to FIG. 5BC, in some embodiments, while only four controls are in the group of controls 5342, the expand option that includes the smaller representations of additional controls is not displayed (e.g., because four controls can fit and be individually selectable while the group of controls 5342 is displayed with the first size in FIG. 5BC). Automatically forgoing display of an expand option for a group of controls when the group of controls has a number of controls that are concurrently displayed, without the need to display additional controls for the group that do not fit in the displayed group of controls, provides visual feedback about the state of the device and makes the user interface easier for the user to navigate without cluttering the user interface with unnecessary controls.

In some embodiments, while displaying the control user interface that includes the first representation of the first group of controls, wherein the first representation of the first group of controls includes the two or more controls from the first group of controls and the first user interface object (e.g., because the first group of controls includes more than the first threshold number of controls), the computer system detects (714), via the one or more input devices, a first selection input directed to the first user interface object (e.g., a tap input, an air pinch gesture, an air tap gesture, a double tap input, a click input, a gaze and dwell input, and/or activation of a hardware control, while a focus selector, a gaze, and/or the input itself is on the first user interface object, or another type of selection input that has an associated location corresponding to the location of the first user interface object); and in response to detecting, via the one or more input devices, the first selection input directed to the first user interface object, the computer system displays the one or more additional controls from the first group of controls that were not displayed in the first representation prior to detecting the first selection input. In some embodiments, the one or more additional controls are displayed concurrently with the two or more controls that were displayed in the first representation prior to the detection of the first selection input. In some embodiments, at least some, or all, of the controls from the two or more controls are displayed concurrently with the one or more additional controls, after the detection of the first selection input. For example, as described with reference to FIG. 5BJ, in some embodiments, in response to detecting the user input 5374 directed to the expand option, the controls are expanded as illustrated in FIG. 5BK. Detecting a user input directed to a control option to expand a group of controls, and in response to detecting the user input, displaying additional controls that are included in the group of controls for the user to view and/or select the additional controls provides the user with access to additional control options and reduces the number of inputs needed for the user to navigate to a separate user interface to cause the computer system to perform an operation that is controllable by one of the additional controls in the group of controls displayed in the control user interface without requiring the user to navigate to a separate user interface.

In some embodiments, while displaying the control user interface including the first representation of the first group of controls, the computer system detects (716), via the one or more input devices, a respective selection input directed to the first representation of the first group of controls (e.g., a tap input, an air pinch gesture, an air tap gesture, a double tap input, a click input, a gaze and dwell input, and/or activation of a hardware control, while a focus selector, a gaze, and/or the input itself is on the first representation, or another type of selection input that has an associated location corresponding to the location of the first representation); and in response to detecting the respective selection input directed to the first representation of the first group of controls: in accordance with a determination that the respective selection input is directed to the first control included in the first representation of the first group of controls, the computer system performs the first function corresponding to the first control (e.g., without performing the second function corresponding to the second control and without displaying the additional controls in the first group of controls); in accordance with a determination that the respective selection input is directed to the second control included in the first representation of the first group of controls, the computer system performs the second function corresponding to the second control (e.g., without performing the first function and without displaying the additional controls from the first group of controls); and in accordance with a determination that the first user interface object is displayed concurrently with the two or more controls in the first representation of the first group of controls and that the respective selection input is directed to the first user interface object, the computer system displays at least a third control from the first group of controls that was not displayed in the first representation of the first group of controls prior to detecting the respective selection input (e.g., without performing the first function corresponding to the first control or the second function corresponding to the second control). For example, in some embodiments, the control user interface includes a group representation for network connectivity, and the group representation includes a first control for turning on/off the WiFi, a second control for turning on/off Bluetooth, a third control for turning on/off airplane mode, and a first user interface object for displaying additional controls from the first group of controls. In some embodiments, in response to the computer system detecting a tap input on the group representation, the computer system activates the first control to turn on/off WiFi if the tap input is detected at the location of the first control, activates the second control to turn on/off Bluetooth if the tap input is detected at the location of the second control, activates the third control to turn on/off airplane mode if the tap input is detected at the location of the third control, and expands the group representation to display additional controls included in the first group of controls, including at least a fourth control for turning on/off personal hotspot, a fifth control for turning on/off cellular data, a sixth control for turning on/off proximity-based file transfer, or other controls not displayed in the group representation before detecting the tap input. In some embodiments, if the representation of the group does not include a separate user interface object (e.g., the first user interface object) for expanding the first representation to show the rest of the controls in the first group of controls, selection inputs directed to individual controls causes the computer system to perform respective operations associated with the individual controls, while selection input directed to unoccupied regions of the first representation causes the computer system to display the rest of the controls from the first group of controls along with the controls that were displayed the first representation. For example, in some embodiments, as described with reference to FIG. 5BI, in response to detecting the user input 5372, the device 100 performs the function corresponding to the control 5327, and in response to detecting the user input 5374 in FIG. 5BJ, the device 100 expands the group of controls 5342′″ to display additional controls, as illustrated in FIG. 5BK. Displaying two or more controls in a group of controls concurrently with a control option to expand the group of controls (e.g., to view one or more additional controls in the group of controls) and determining whether a user input is directed to a respective control of the two or more controls and/or the control option to expand the group of controls to perform a respective operation based on the user input provides the user with additional control options within a same user interface, thereby reducing a number of inputs required to find and/or select various controls displayed in different user interfaces.

In some embodiments, displaying the first user interface object concurrently with the two or more controls in the first representation of the first group of controls includes (718) displaying, in the first user interface object, a representation of a first additional control (e.g., the third control, fourth control, fifth control, or sixth control) from the one or more controls (and optionally, representations of other additional controls from the first group of controls) that have not been displayed in the first representation prior to the selection of the first user interface object, wherein displaying the representation of the first additional control in the first user interface object includes: in accordance with a determination that a first set of control functions of the first additional control (e.g., a battery level of a smart home appliance that is controlled by the first additional control, a temperature of a thermostat controlled by the first additional control, an on/off state of a garage door controlled by the first additional control, the on/off state and/or a color of a lightbulb controlled by the first additional control, or another set of one or more states and/or parameter values of one or more functions controlled by the first additional control) has a first status (e.g., first state(s) and/or value(s) for the first set of control functions controlled by the first additional control), displaying the representation of the third control with a first appearance (e.g., with first graphical symbols, colors, appearance properties, numerical values, and/or textual indications corresponding to the first state(s) and/or values), indicating the first status of the first set of control functions of the first additional control; and in accordance with a determination that the first set of control functions of the first additional control has a second status (e.g., second state(s) and/or value(s) for the first set of control functions controlled by the first additional control) different from the first status, displaying the representation of the first additional control with a second appearance (e.g., with second graphical symbols, colors, appearance properties, numerical values, and/or textual indications corresponding to the second state(s) and/or values) different from the first appearance, indicating the second status of the first set of control functions of the first additional control. In some embodiments, the first user interface object includes the representation of multiple controls (e.g., two or more, and less than or equal to the first threshold number of controls) out of the additional controls that were not directly included in the first representation of the first group of controls. In some embodiments, representations of the multiple controls in the first user interface object have appearances that correspond to the current status of the multiple controls (e.g., the appearance of the representation of an additional control is an indication of a current state (e.g., an on/off state, an indication of progress, a percentage value of a controlled value, a current value of a controlled parameter, and/or an absolute value of a controlled value) of the set of control functions of the additional control from the first group of controls (e.g., displayed as a reduced scale image of the additional control that shows a current state of the additional control (e.g., on/off state, a current value of the additional control, or another indication of the state of the function managed by the additional control)). For example, as described with reference to FIG. 5BL, in some embodiments, the status of the fan control 5310′ (e.g., which is displayed with a miniature size as part of the expand option for the group of controls) is updated (e.g., from showing an arrow to not showing an arrow) to indicate the current status of the fan associated with the fan control 5310′. Displaying a control option to expand the group of controls that includes status information for the controls that are in the group of controls, including status information for one or more controls that are not displayed with the first size, provides ongoing feedback about a status of the one or more controls and reduces a number of inputs required for the user to view the status of the one or more controls.

In some embodiments, while displaying the first representation of the first group of controls in the control user interface, including displaying the two or more controls concurrently with the first user interface object, wherein the first user interface object includes the representation of the first additional control (e.g., the first user interface object that includes the indication of the current state of at least one of the one or more additional controls from the first group of controls that are not displayed prior to selection of the first user interface object), the computer system detects (720) a first user input that is directed to the first representation of the first group of controls (e.g., a touch input that is on the first representation, an air gesture that is detected when a gaze is directed to the fourth representation, a mouse click when a focus selector is on the first representation, activation of a hardware control when the first representation has input focus, or another input that has a target location corresponding to the first representation); and in response to detecting the first user input that is directed to the first representation of the first group of controls: in accordance with a determination that the first user input is directed to the first control and that the first user input meets first adjustment criteria associated with the first control (e.g., the first control is a toggle control and the first user input is an air tap on the first control, an air pinch gesture when a gaze is directed to the first control, a mouse click when a focus selector is on the first control, or another selection input that is detected when the target location of the selection input is on the first control; or the first control is a slider control and the first user input is a swipe input on the first control, a pinch and drag gesture when a gaze is directed to the first control, a click and drag mouse input when a focus selector is on the first control, or another movement input that is detected when the target location of the movement input is on the first control), the computer system performs the first function (e.g., turning on/off the first control or adjust a value of the first control) and displays a first indication of a current status of the first control (e.g., changing the appearance of the first control to show the current state and/or the current value as changed by the first user input); in accordance with a determination that the first user input is directed to the second control and that the first user input meets second adjustment criteria associated with the second control (e.g., the second control is a toggle control and the first user input is an air tap on the second control, an air pinch gesture when a gaze is directed to the second control, a mouse click when a focus selector is on the second control, or another selection input that is detected when the target location of the selection input is on the second control; or the second control is a slider control and the first user input is a swipe input on the second control, a pinch and drag gesture when a gaze is directed to the second control, a click and drag mouse input when a focus selector is on the second control, or another movement input that is detected when the target location of the movement input is on the second control), the computer system performs the second function (e.g., turning on/off the second control or adjust a value of the second control) and displays a second indication of a current status of the second control (e.g., changing the appearance of the second control to show the current state and/or the current value as changed by the first user input); and in accordance with a determination that the first user input is directed to the first user interface object, and that the first user input meets third adjustment criteria associated with the first additional control (e.g., the first additional control is a toggle control, and the first user input is an air tap on the first additional control, an air pinch gesture when a gaze is directed to the first additional control, a mouse click when a focus selector is on the first additional control, or another selection input that is detected when the target location of the selection input is on the first additional control; or the first additional control is a slider control and the first user input is a swipe input on the first additional control, a pinch and drag gesture when a gaze is directed to the first additional control, a click and drag mouse input when a focus selector is on the first additional control, or another movement input that is detected when the target location of the movement input is on the first additional control), the computer system displays the first additional control (e.g., at a non-reduced scale) without performing the first set of control functions associated with the first additional control and without changing a current status of the first additional control. In some embodiments, once the first additional control is displayed (e.g., not as a representation of the first additional control, but as an actual control), a subsequent user input that meets the third adjustment criteria associated with the first additional control is detected at the location of the first additional control, and in response to detecting the subsequent user input, the computer system performs the third function corresponding to the first additional control and adjusts the current status of the first additional control in accordance with the subsequent user input. For example, in some embodiments, as described with reference to FIG. 5BI, in response to detecting the user input 5372 directed to the control 5327, the device 100 performs the operation associated with the control 5327. Similarly, user inputs directed to the other controls that are displayed with the first size, including control 5306 and/or control 5330, causes the device 100 perform the respective operation associated with the respective control, while in response to detecting the user input 5374 (e.g., that overlaps with the control 5310′), the control 5310′ is not activated to perform the operation associated with the control 5310′, and is instead expanded to be displayed with the first size, as illustrated in FIG. 5BK. Automatically updating status information for one or more controls that are not displayed with the first size, without requiring the user to expand the group of controls, provides ongoing feedback about a status of the one or more controls and reduces a number of inputs required for the user to view the current status of the one or more controls.

In some embodiments, displaying the first representation of the first group of controls includes (722): in accordance with a determination that a first group size (e.g., a size of the group of controls) is selected for the first group of controls (e.g., by a user or by the computer system), using a first value for the first threshold number, and displaying the first representation of the first group of controls with the first group size (e.g., a first size of the graphical representation for the module or group control, a first combination of rows and columns in terms of grid size); and in accordance with a determination that a second group size, different from the first group size, is selected for the first group of controls (e.g., by a user or by the computer system), using a second value different from the first value for the first threshold number, and displaying the first representation of the first group of controls with the second group size (e.g., a second size of the graphical representation for the module or group control, a second combination of rows and columns in terms of grid size). For example, in some embodiments, the first threshold number is automatically selected by the computer system in accordance with a respective size of the first representation of the first group of controls (e.g., a size corresponding to a 2×2 grid space, a size corresponding to a 2×4 grid space, or another size specified in accordance with a layout and total number of controls the group representation can accommodate according to the layout). For example, in some embodiments, for a second representation of a second group of controls that has a greater size than the first representation of the first group of controls, a greater threshold number of controls is required for the first user interface object to be displayed in the second representation of the second group of controls because the second representation of the second group of controls can display more controls directly than the first representation of the first group of controls. In some embodiments, the user can adjust the size of the first representation of the first group of controls to make it bigger (e.g., to have more rows or columns to accommodate controls), such that more controls from the first group of controls can be directly displayed in the first representation of the first group of controls. In some embodiments, adjusting the size of the first representation of the first group of controls causes the computer system to cease to display the first user interface object in the first representation of the first group of controls and display the additional controls directly in the first representation of the first group of controls with the expanded size. For example, in some embodiments, as described with reference to FIGS. 5BD-5BE, the size of the group of controls 5342″ is larger than the size of the group of controls 5342″ and thus displays more controls with the first size (e.g., in a 3×3 grid space rather than a 2×2 grid space). Selecting a threshold number of controls that can be concurrently displayed while the group of controls is displayed with a first size, and automatically updating the threshold number of controls to a different number of controls while the group of controls is displayed with a second size that is different from the first size, maximizes use of the available space for displaying controls in the group of controls at the current displayed size of the group of controls.

In some embodiments, while displaying a fourth control (e.g., the first control before the first group of controls were created, or another control in the control user interface) in the control user interface, the computer system detects (724) a second user input directed to the fourth control (e.g., a touch input that is on the fourth control, an air gesture that is detected when a gaze is directed to the fourth control, a mouse click when a focus selector is on the fourth control, activation of a hardware control when the fourth control has input focus, or another input that has a target location corresponding to the fourth control); and in response to detecting the second user input directed to the fourth control, in accordance with a determination that the second user input meets move criteria (e.g., the second user input is a touch-hold followed by drag input that is detected at the location of the fourth control, or the second user input is a selection input followed by movement while the selection input is maintained (e.g., a pinch gesture with a gaze directed to the fourth control followed by movement of the hand while the pinch is maintained), or the second user input is a click-hold and drag input that is detected when the focus selector is on the fourth control), the computer system initiates a drag operation on the fourth control in accordance with the second user input (e.g., moves the fourth control away from its original location in the control user interface, optionally, from within another group representation displayed in the control user interface); while a fifth control (e.g., the second control before the first group of controls were created, or another control in the control user interface) is displayed in the control user interface (e.g., while the drag operation on the fourth control is not yet terminated), the computer system detects a termination of the drag operation on the fourth control (e.g., in response to detecting a termination of the second user input, such as liftoff of a touch input, release of a pinch of a pinch and drag air gesture, release of the mouse button of a click-hold and drag input, or termination of another type of movement input); and in response to detecting the termination of the drag operation on the fourth control: in accordance with a determination that the termination of the drag operation is detected while the fourth control is within a threshold distance of the fifth control, the computer system displays a respective representation of a new group of controls that includes the fourth control and the fifth control (e.g., the fifth control is transformed into a group representation of the new group of controls that includes the fourth control and the fifth control) (e.g., the first representation of the first group of controls, or another representation of another group of controls). In some embodiments, in response to detecting the termination of the drag operation on the fourth control, in accordance with a determination that the fourth control is not within a threshold distance of another control in the control user interface, completing the move of the fourth control from its original location to a new location in the control user interface. In some embodiments, the first group of controls are created by dragging the first control and dropping it onto the second control to create a new group containing the first control and the second control, with the representation of the new group including the first control and the second control. Additional controls may be added to the first group of controls by dragging and dropping additional controls onto the representation of the new group, in accordance with some embodiments. For example, in some embodiments, as described with reference to FIG. 5BB, the group of controls 5342 (e.g., in FIG. 5BC) is created by one or more user inputs (e.g., user input 5336, user input 5338, user input 5340, and/or other user inputs) dragging controls over the control 5330. Creating a group of controls, including a first and second control, in response to a user input that drags the second control to a position in the user interface that overlaps with a displayed position of the first control, enables the user to quickly and efficiently create groups of controls without requiring the user to navigate complex menu hierarchies, thereby reducing a number of inputs required to create groups of controls.

In some embodiments, while displaying a sixth control in the control user interface (e.g., the first control before the first control was added to the first group of controls, one of the additional controls in the first group of controls before the control was added to the first group of controls, or another control in the control user interface), the computer system detects (726) a third user input directed to the sixth control (e.g., the second user input, or another user input, that is directed to the sixth control) (e.g., a touch input that is on the sixth control, an air gesture that is detected when a gaze is directed to the sixth control, a mouse click when a focus selector is on the sixth control, activation of a hardware control when the sixth control has input focus, or another input that has a target location corresponding to the sixth control); and in response to detecting the third user input directed to the sixth control, in accordance with a determination that the third user input meets move criteria (e.g., the third user input is a touch-hold followed by drag input that is detected at the location of the sixth control, or the third user input is a selection input followed by movement while the selection input is maintained (e.g., a pinch gesture with a gaze directed to the sixth control followed by movement of the hand while the pinch is maintained) or the third user input is a click-hold and drag input that is detected when the focus selector is on the sixth control), the computer system initiates a drag operation on the sixth control in accordance with the third user input (e.g., moves the sixth control away from its original location in the control user interface, optionally, from within another group representation displayed in the control user interface); while the first representation of the first group of controls is displayed in the control user interface (e.g., while the drag operation on the sixth control is not yet terminated), the computer system detects a termination of the drag operation on the sixth control (e.g., in response to detecting a termination of the third user input, such as liftoff of a touch input, release of a pinch of a pinch and drag air gesture, release of the mouse button of a click-hold and drag input, or termination of another type of movement input); and in response to detecting the termination of the drag operation on the sixth control: in accordance with a determination that the termination of the drag operation is detected while the sixth control is within a threshold distance of the first representation of the first group of controls, the computer system adds the sixth control to the first group of controls (and, optionally, displays the sixth control in the first representation of the first group of controls if there is less than the first threshold number of controls in the first group of controls at the time). In some embodiments, in response to detecting the termination of the drag operation on the sixth control, in accordance with a determination that the termination of the drag operation is detected while the sixth control is outside the threshold distance of the first representation of the first group of controls, the computer system forgoes adding the sixth control to the first group of controls (e.g., the sixth control is placed at a placement location outside of the first representation of the first group of controls). In some embodiments, adding the sixth control into the first group of controls causes the computer system to display the first user interface object in the first representation of the first group of controls, if the addition of the sixth control into the first group of controls causes the total number of controls in the first group to exceed the first threshold number of controls. In some embodiments, the sixth control is represented in the first user interface object. In some embodiments, the sixth control is displayed directly in the first representation, while another control previously displayed directly in the first representation is moved into the first user interface object or cease to be represented in the first representation (e.g., becomes one of the additional controls that will be displayed when the first user interface object is selected by a selection input). For example, in some embodiments, as described with reference to FIG. 5BC, after the group of controls 5342 is created, additional controls are added to the group of controls 5342 by dragging the controls (e.g., via user input 5344, user input 5352, user input 5346, and/or other user inputs) over the group of controls 5342. Adding another control to a group of controls in response to a user input that drags the other control to a position in the user interface that overlaps with the displayed group of controls, enables the user to quickly and efficiently add one or more controls to an existing group of controls without requiring the user to navigate complex menu hierarchies, thereby reducing a number of inputs required to add controls to a group of controls.

In some embodiments, while displaying the control user interface including the first representation (e.g., a reduced representation that includes a subset of controls and optionally the first user interface object, or a fully expanded representation that includes all of the controls in the first group) of the first group of controls, wherein the first representation of the first group of controls includes the first control and the second control (and optionally, the first user interface object when the first representation is a reduced representation, or other additional controls from the first group when the first representation is a fully expanded representation), the computer system detects (728) a fourth user input that is directed to the first control (e.g., a touch input that is on the first control, an air gesture that is detected when a gaze is directed to the first control, a mouse click when a focus selector is on the first control, activation of a hardware control when the first control has input focus, or another input that has a target location corresponding to the first control); and in response to detecting the fourth user input that is directed to the first control, in accordance with a determination that the fourth user input meets move criteria (e.g., the fourth user input is a touch-hold followed by drag input that is detected at the location of the first control, or the fourth user input is a selection input followed by movement while the selection input is maintained (e.g., a pinch gesture with a gaze directed to the first control followed by movement of the hand while the pinch is maintained), or the fourth user input is a click-hold and drag input that is detected when the focus selector is on the first control), initiating a drag operation on the first control in accordance with the fourth user input (e.g., moving the first control away from its original location in the first representation of the first group of controls shown in the control user interface); after the first control is dragged away from (e.g., outside of a threshold distance from) the first representation of the first group of controls in accordance with the fourth user input, the computer system detects a termination of the fourth user input (e.g., in response to detecting a termination of the fourth user input, such as liftoff of a touch input, release of a pinch of a pinch and drag air gesture, release of the mouse button of a click-hold and drag input, or termination of another type of movement input); and in response to detecting the termination of the fourth user input, the computer system removes the first control from the first group of controls and ceases to display the first control in the first representation of the first group of controls (and, optionally, displays the first control in the representation of another group of controls or as a standalone control in the control user interface depending on the location of the first control when the fourth user input is terminated). In some embodiments, the computer system ceases to display the first user interface object in the first representation of the first group of controls, after the first control is removed from the first group of controls by the fourth user input, because the total number of controls in the first group of controls drops below the first threshold number of controls. For example, in some embodiments, as described with reference to FIG. 5BC, in response to detecting the user input 5309 that drags the control 5308 out of the group of controls 5342, the control 5308 is removed from the group of controls 5342′. Removing a control from a group of controls in response to a user input that drags the respective control away from the displayed group of controls, to a position in the user interface that is outside of the displayed group of controls, enables the user to quickly and efficiently remove one or more controls from an existing group of controls without requiring the user to navigate complex menu hierarchies, thereby reducing a number of inputs required to remove controls from a group of controls

In some embodiments, displaying the control user interface includes (730): in accordance with a determination that the control user interface is in a process of being reconfigured (e.g., when controls are being moved, or enabled to be dragged, in a reconfiguration mode), displaying respective labels for one or more controls that are currently displayed in the control user interface, wherein a respective label for a respective control includes information about a function of the respective control (e.g., information about an operation that is performed by the respective control or an application with which the respective control is associated); and in accordance with a determination that the control user interface is not in a process of being reconfigured (e.g., controls are fixed in location, and the reconfiguration mode is terminated or not started), forgoing displaying the respective labels for the one or more controls that are currently displayed in the control user interface (e.g., in accordance with a determination that label display is not enabled in the settings user interface of the control user interface). In some embodiments, the process for configuring the control user interface can be triggered through several entry points, such as touch-hold on a control to initiate a drag operation on the control, selecting an edit control displayed in the control user interface, and/or selecting an “add” control displayed in the control user interface. For example, in some embodiments, as described with reference to FIG. 5AL, respective labels for the respective controls are optionally displayed in the editing control user interface 5210-1 without being displayed in the control user interface 5002. Dynamically displaying labels for respective controls while editing a control user interface without displaying the labels for the respective controls while display the control user interface, provides additional visual feedback to the user while the user is editing the control user interface.

In some embodiments, displaying the control user interface (e.g., when the control user interface is not currently in the reconfiguration mode) includes (732): in accordance with a determination that label display is enabled (e.g., in a settings user interface for the control user interface), displaying respective labels for one or more controls that are currently displayed in the control user interface, wherein a respective label for a respective control includes information about a function of the respective control (e.g., information about an operation that is performed by the respective control or an application with which the respective control is associated); and in accordance with a determination that label display is disabled (e.g., in the settings user interface for the control user interface), forgoing displaying the respective labels for the one or more controls that are currently displayed in the control user interface. For example, in some embodiments, as described with reference to FIG. 5AK, the respective labels for the respective controls are turned on and/or off in response to user selection and/or deselection of an option 5256. Enabling the user to turn labels for respective controls on and/or off, such that the labels are either displayed or not displayed in a control user interface, provides additional control options for the user thereby providing the user with greater control for customizing the control user interface.

In some embodiments, displaying the control user interface includes (734): in accordance with a determination that a first grid density (e.g., three columns of controls in a respective row, or five columns of controls in a respective row) is selected for the control user interface, displaying controls in the control user interface with the first grid density; and in accordance with a determination that a second grid density (e.g., four columns of controls in a respective row, or six columns of controls in a respective row) different from the first grid density is selected for the control user interface, displaying the controls in the control user interface with the second grid density. In some embodiments, the user can select the grid density for the control user interface in a settings user interface of the control user interface, and the computer system rearranges the controls in the control user interface in accordance with the grid density established in the settings user interface. For example, in some embodiments, as described with reference to FIG. 5AK, the user selects (e.g., via user input 5250) a number of columns to include in the grid layout in the editing control user interface 5210-1. Enabling the user to change a grid density and/or layout of the control user interface, such that controls in the control user interface are displayed with a particular size and/or layout within a grid of possible positions for controls in the control user interface, provides additional control options for the user thereby providing the user with greater control for customizing the control user interface.

In some embodiments, the computer system displays (736) the control user interface in a reconfiguration mode in which the control user interface is reconfigurable in accordance with user inputs (e.g., a mode in which controls can be rearranged individually or as a group, moved individually or as a group, grouped, regrouped, added, and/or deleted in accordance with user inputs), wherein displaying the control user interface in the reconfiguration mode includes displaying a first affordance (e.g., an “add” button, a “plus” sign, or other representations of the “add control” affordance) in the control user interface (e.g., concurrently with the first representation of the first group of controls, and one or more other controls and representations of other groups of controls); while displaying the control user interface in the reconfiguration mode, the computer system detects a user input selecting the first affordance in the control user interface (e.g., the input is a tap input on the first affordance, an air tap or air pinch gesture that is detected at a location of the first affordance, an air tap or air pinch gesture that is detected with a corresponding gaze input is directed to the first affordance, a mouse click when a focus selector is on the first affordance, activation of a hardware control when the first affordance has input focus, or another type of input that meets selection criteria); and in response to detecting the user input selecting the first affordance in the control user interface, the computer system displays a plurality of selectable options (e.g., controls, names of controls, and/or icons representing controls, including representations of the controls and/or previews of the controls that indicate respective sets of control functions associated with the different controls) that correspond to a plurality of controls that are available to be added to the control user interface (e.g., controls that are not currently included in the control user interface, controls that are not currently included in the currently displayed page of the control user interface, and/or controls that are not included in the currently displayed group of controls (e.g., in an expanded representation for a group of controls)), wherein selection of a respective selectable option from the plurality of selectable options (e.g., selected by a tap input on the respective option, an air tap or air pinch gesture that is detected at a location of the respective option, an air tap or air pinch gesture that is detected with a corresponding gaze input is directed to the respective option, a mouse click when a focus selector is on the respective option, activation of a hardware control when the respective option has input focus, or another type of input that meets selection criteria with respect to the respective option) causes a respective control corresponding to the respective selectable option to be added to the control user interface (e.g., to the currently displayed page of the control user interface, or to the currently expanded group of controls). In some embodiments, while displaying the plurality of selectable options, the computer system detects selection of a first selectable option from the plurality of selectable options; and in response to detecting the selection of the first selectable option, the computer system adds a respective control corresponding to the first selectable option to the control user interface. In some embodiments, the first selectable option includes a preview of the appearance of the respective control corresponding to the first selectable option. For example, in some embodiments, as described with reference to FIG. 5AF, in response to a user input 5232 selecting the add controls button 5212, a search user interface 5224 is displayed for adding additional controls to the control user interface. Providing a user-selectable control for adding one or more additional controls to a control user interface while the user is editing the control user interface, including displaying a set of available controls that can be added to the control user interface in response to detecting a user input selecting the user-selectable controls, provides additional control options for the user thereby providing the user with greater control for customizing the control user interface.

In some embodiments, displaying the plurality of selectable options (e.g., controls, names of controls, and/or icons representing individual controls, groups of controls, and/or pages of controls) that correspond to the plurality of controls (e.g., individual controls, groups of controls, and/or pages of controls) that are available to be added to the control user interface includes (738) displaying the plurality of selectable options in a plurality of groupings, wherein the plurality of groupings correspond to different categories to which the plurality of controls are assigned. For example, the plurality of selectable options corresponding to the plurality of controls are grouped into categories for network connectivity, media playback, smart home control, device settings, applications, and/or other categories of controls, in accordance with some embodiments. In some embodiments, in addition to the selectable options for adding individual controls to the control user interface, the plurality of selectable options also include one or more selectable options for adding different groups of controls to the control user interface, and the selectable option for adding a respective group of controls include previews of at least a subset of the controls that are included in the respective group of controls. In some embodiments, the plurality of selectable options include one or more selectable options of adding whole pages of controls to the control user interface. In some embodiments, the plurality of selectable options for a respective grouping, including selectable options for adding individual controls, groups of controls, and/or pages of controls, to the control user interface. In some embodiments, the selectable option for adding a respective page of controls to the control user interface includes previews of at least a subset of the individual controls and/or groups of controls included in the respective page of controls. For example, in some embodiments, as described with reference to FIGS. 5AU-5AX, the search user interface 5224 displays a plurality of available controls within respective categories of controls. Displaying a set of available controls that can be added to the control user interface according to different categories of controls, makes it easier for the user to navigate through the set of available controls, thereby reducing a number of inputs required for the user to browse and/or find different control options.

In some embodiments, the computer system displays (740) the control user interface in a reconfiguration mode in which the control user interface is reconfigurable in accordance with user inputs (e.g., a mode in which controls can be rearranged or moved individually, as a group, or as a whole page, grouped, regrouped, removed from a group or page, added, and/or deleted in accordance with user inputs), wherein displaying the control user interface in the reconfiguration mode includes displaying a first resize affordance concurrently with the first representation of the first group of controls (e.g., displaying one or more resize handle(s) on the edge(s) or corner(s) of the first representation), in the control user interface (e.g., concurrently with one or more other controls, representations of other groups of controls and their corresponding resize affordances); while displaying the control user interface in the reconfiguration mode, the computer system detects a user input that selects and drags the first resize affordance in the control user interface; and in response to detecting the user input that selects and drags the first resize affordance (e.g., dragging the resize handle to a different size for the first representation), the computer system changes a size of the first representation of the first group of controls in accordance with the user input (e.g., in accordance with a direction and/or magnitude of the user input) that selects and drags the first resize affordance (and optionally, changing the first threshold number of controls that is required for displaying the first user interface object in the first representation of the first group, and/or changing the number of controls that are currently displayed in the first representation of the first group of controls). In some embodiments, the first representation has a number of predefined sizes, and the first representation snaps to a respective size of the number of predefined sizes based on the location of the first resize affordance at the time that the sixth user input releases the first resize affordance. In some embodiments, changing the size of the first representation of the first group of controls in accordance with the user input that selects and drags the first resize affordance includes: in accordance with a determination that the first resize affordance is displaced by a first displacement amount (e.g., first amount of movement with a first magnitude and a first direction) upon termination of the user input that selects and drags the first resize handle, displaying the first representation of the first group of controls with a first adjusted size (e.g., first adjusted numbers of rows and columns for placing controls) (and optionally, a first adjusted number of visible controls); and in accordance with a determination that the first resize affordance is displaced by a second displacement amount (e.g., second amount of movement with a second magnitude and a second direction), different from the first displacement amount, upon termination of the user input that selects and drags the first resize handle, displaying the first representation of the first group of controls with a second adjusted size (e.g., second adjusted numbers of rows and/or columns for placing controls) different from the first adjusted size (and optionally, a second adjusted number of visible controls from the first group of controls, different from the first adjusted number of visible controls). For example, in some embodiments, as described with reference to FIGS. 5AI-5AJ, in response to the user input 5240, such as a drag user input, the size of the control 5034′ is updated to an increased size as the control 5034″. Enabling the user to change a size of a respective control that is displayed in the control user interface, such that the respective control optionally displays additional information and/or control options for the respective control, provides additional control options for the user thereby providing the user with greater control for customizing the control user interface.

In some embodiments, while the control user interface is displayed in a reconfiguration mode (e.g., a mode in which the control user interface is reconfigurable in accordance with user inputs, a mode in which controls can be rearranged individually or as a group, moved individually or as a group, grouped, regrouped, added, and/or deleted in accordance with user inputs), wherein the control user interface displayed in the reconfiguration mode includes a first selectable object corresponding to an individual control or a representation of a group of multiple controls (e.g., the first representation of the first group of controls, and/or one or more representations of other groups of controls) (e.g., the first selectable object is an individual control or a representation of a group of controls, that is concurrently with one or more other controls, representations of other groups of controls and their corresponding resize affordances), the computer system detects (742) a selection input (e.g., a tap input, an air tap, an air pinch, a mouse click, an activation of a hardware affordance, or other types of selection input) directed to (e.g., based on the location of the contact for a touch input, location of a gaze detected during an air gesture, location of the focus selector during a click input, or location of input focus during activation of a hardware affordance) the first selectable object corresponding to an individual control or a representation of a group of multiple controls (e.g., the selection input is, optionally, detected on the first selectable object, such as an individual control, or the first representation of the first group of controls (e.g., the first control or the second control, on the first user interface object, or on an unoccupied region of the first representation of the first group of controls)); and in response to detecting the selection input directed to the first selectable object, the computer system displays a respective set of configuration options corresponding to the individual control or the group of multiple controls corresponding to the first selectable object (e.g., the set of configuration options includes the applications that can be associated with the individual control, the default state for the individual control, the parameters that can be associated with the individual control, the size and/or type of the individual control, the size of the representation for the group of multiple controls, the category assigned to the group of multiple controls, the name of the group of multiple controls, and/or other settings related to the group of multiple controls and how they are accessible in the control user interface). In some embodiments, the computer system displays an animated transition in response to the selection input to show the first selectable object (e.g., an individual control or a representation of a group of multiple controls) flips over to display the respective set of configuration options for the first selectable object on the back of the first selectable object that corresponds to an individual control or a group of multiple controls. In some embodiments, the first selectable object that corresponds to an individual control or a group of multiple controls is referred to as a “control” as well, since even in the case where the first selectable object is a representation of a group of controls, the representation itself includes two or more individual controls from the group of controls that can be used to directly access the control functions of the two or more individual controls from the group of controls. For example, in some embodiments, as described with reference to FIG. 5AL-5AM, the user configures options for the timer control 5026′ by selecting, via user input 5260 the timer control 5026′, using the platter 5262 that includes options for different configurations of the timer control 5026′. Enabling the user to configure one or more properties of a respective control that is displayed in the control user interface, for example to set one or more default operations and/or to modify operations associated with the respective control, provides additional control options for the user thereby providing the user with greater control for customizing the control user interface.

In some embodiments, the control user interface is multi-page control user interface, including at least a first page of the control user interface and a second page of the control user interface (e.g., two pages that are consecutive and not concurrently visible to the user). In some embodiments, while the first page of the control user interface is displayed (e.g., in a reconfiguration mode, a mode in which the control user interface is reconfigurable in accordance with user inputs, and/or a mode in which controls can be rearranged individually or as a group, moved individually or as a group, grouped, regrouped, added, and/or deleted in accordance with user inputs), the computer system moves (744) a respective control or a respective representation of a respective group of controls in the first page of the control user interface in accordance with a respective drag input (e.g., a tap-hold input by a contact on the respective control or representation followed by a drag input by the contact; a pinch gesture that is directed when a gaze is directed to the respective control or representation, followed by movement of the hand while maintaining the pinch posture of the hand, a click and drag input by a mouse when the focus selector is on the respective control or representation, or another type of drag input with the respective control or representation as the target of the drag input); while moving the respective control or the respective representation of the respective group of controls in the first page of the control user interface in accordance with the respective drag input, the computer system detects that a current position of the respective control or the respective representation of the respective group of controls is within a threshold range of an edge (e.g., a bottom edge and/or a side edge) of the first page of the control user interface; and in response to detecting that the current position of the respective control or the respective representation of the respective group of controls is within the threshold range of the edge of the first page of the control user interface, the computer system replaces display of the first page of the control user interface with display of the second page of the control user interface, while maintaining display of the respective control or the respective representation of the respective group of controls that is controlled by the respective drag input. In some embodiments, while the second page of the control user interface is displayed, the computer system detects termination of the drag input; and in response to detecting the termination of the drag input, the computer system displays the respective control or the respective representation of the respective group of control at a location in the second page of the control user interface (e.g., the respective control or the respective representation of the respective group of controls is inserted into the second page based on the drop-off location specified by the termination location of the drag input). In some embodiments, insertion of the respective control or representation of the respective group of controls into the second page of the control user interface optionally causes one or more controls or representations of groups of controls to overflow to a new page of the control user interface. For example, in some embodiments, as described with reference to FIG. 5AO, in response to the user input 5266 to drag the camera control 5036′ to a different page, the device 100 moves the control 5036′ in accordance with the user input 5266. Navigating to a next page of the control user interface while the user is editing the control user interface in response to detecting that a control and/or group of controls is dragged to an edge of the current page, reduces the number of inputs required to change between a current page and a next page of the control user interface.

In some embodiments, while displaying the control user interface, the computer system detects (746) a request to configure the control user interface (e.g., detecting a touch-hold and drag input on a control or a representation of a group of controls, detecting selection of a reconfiguration affordance associated with the control user interface, or otherwise receiving an input to initiate reconfiguration of the control user interface); and in response to detecting the request to configure the control user interface, the computer system displays the control user interface in a reconfiguration mode (e.g., a mode in which the control user interface is reconfigurable in accordance with user inputs, a mode in which controls can be rearranged individually or as a group, moved individually or as a group, grouped, regrouped, added, and/or deleted in accordance with user inputs), including displaying, concurrently with one or more controls that are currently displayed in the control user interface (optionally including individual controls, such as the third control, and representations of groups of controls, such as the first representation of the first group of controls) (e.g., concurrently with one or more other individual controls, representations of other groups of controls and their corresponding resize affordances), an indication of one or more locations in the control user interface that are not currently occupied by controls and to which the one or more currently displayed controls can be moved or expanded in accordance with a respective configuration input (e.g., a drag input, and/or a resize input). In some embodiments, the indication includes an outline of one or more sizes for the controls such as individual controls and/or the representations of groups of controls (e.g., when a drag input is detected on an individual control, a representation of a group of controls, a resize handle of a representation of a group of controls, or before any input is detected on the individual control or representation of a group of controls). In some embodiments, the indication includes highlighted regions in the control user interface to which the individual controls and/or the representations of groups of controls can be moved or expanded. For example, in some embodiments, as described with reference to FIG. 5AD, the device 100 displays indications 5216 that identify available positions within the grid layout of the editing control user interface 5210-1 in which controls may be placed. Automatically providing indications of available positions (e.g., in a grid layout) at which controls may be added in the control user interface while the user is editing the control user interface, increases the efficiency of the user editing the control user interface according to a preset layout, thereby reducing the number of inputs required for editing the control user interface without requiring the user to manually identify available positions for the controls.

In some embodiments, the computer system displays (748) the control user interface in a reconfiguration mode (e.g., the editing control user interface 5210-1) (e.g., a mode in which the control user interface is reconfigurable in accordance with user inputs, a mode in which controls can be rearranged individually or as a group, moved individually or as a group, grouped, regrouped, added, and/or deleted in accordance with user inputs), including displaying, concurrently with one or more currently displayed controls (e.g., one or more individual controls, such as the third control, and/or representations of groups of controls, such as the first representation of the first group of controls, and other individual controls and/or representations of other groups of controls, such as those that are concurrently displayed with the third control and the first representation of the first group of controls), corresponding remove affordances for the one or more currently displayed controls (e.g., the “x” or “-” icons displayed adjacent or attached to the individual controls and the representations of groups of controls); while displaying, concurrently with the one or more currently displayed controls, the corresponding remove affordances for the one or more currently displayed controls, the computer system detects selection of a first remove affordance for a first currently displayed control (e.g., the corresponding remove affordance for one of the individual control or the representation of one of the groups of controls); and in response to detecting the selection of the first remove affordance, the computer system removes the first currently displayed control from the control user interface (e.g., ceasing to display the control in the currently visible portion of the control user interface, without inserting the control in other portions of the control user interface that is not currently visible). For example, in some embodiments, as described with reference to FIG. 5AD, the controls in the editing control user interface 5210-1 are displayed with respective remove affordances, such as remove affordance 5218. Displaying individual remove affordances for respective controls while the user is editing the control user interface, such that, in response to user selection of a respective remove affordance, the respective control is removed from the control user interface, provides the user with an additional level of control while editing the control user interface and reduces a number of inputs required for the user to remove controls from the control user interface.

In some embodiments, the control user interface includes (750) respective representations of a plurality of groups of controls (e.g., groups based on different categories of controls, or manually created groups of controls), including the first representation of the first group of controls and a second representation of a second group of controls. In some embodiments, the computer system displays (e.g., along a top edge, or another edge of the display) (e.g., while the control user interface is not displayed, or while the first group of controls and the second group of controls are not displayed in the control user interface) a first status region that includes a first set of status indicators for a first set of one or more system functions (e.g., status indicators for one or more network connections, the battery level, location sharing, and/or other system functions), and a second set of status indicators for a second set of one or more system functions (e.g., status indicators for one or more active mode, media playback status, and/or other system functions), wherein the first set of system functions have corresponding controls in the first group of controls (and not in the second group of controls), and the second set of system functions have corresponding controls in the second group of controls (and not in the first group of controls). In some embodiments, the first status region is displayed in a top edge region of the display area provided by the display generation component (e.g., top edge of the touch-screen display or top edge region of a field of view provided by a head-mounted display). In some embodiments, the first status region includes multiple portions, where the first set of status indicators and the second set of status indicators are displayed in different portions of the first status region, optionally separated by another status region (e.g., the region that displays dynamically updated status information regarding ongoing activities or new activities occurring on the computer system). In some embodiments, some or all of the first set and/or second set of status indicator are persistently displayed (e.g., across multiple types of system user interfaces (e.g., home screen user interface, wake screen user interface, coversheet user interface, widget user interface, and/or notification user interface) and/or application user interfaces of different applications). In some embodiments, some or all of the first set of status indicators remains displayed, when the control user interface is not displayed. In some embodiments, some or all of the controls in the first set and/or second set of status indicators are dynamically selected for inclusion in the first status region, in accordance with a current context associated with the computer system, such as the active modes (e.g., location sharing, paired devices, or active focus modes), ongoing activities (e.g., navigation, network activities, media playing and/or capturing, subscribed event updates), and/or the changes or current values of the parameters (e.g., low battery, battery charging) corresponding to the controls. In some embodiments, the first status region remains displayed with status information, when the computer system switches from displaying the control user interface to displaying other user interfaces (e.g., a home screen user interface, a wake screen user interface, a widget screen user interface, a notification user interface, an application user interface and/or another user interface) and the control user interface is no longer displayed. For example, in some embodiments, as described with reference to FIGS. 5CL and 5CM, a user interface element 5484 and/or a user interface element 5488 is displayed that includes one or more controls related to the status indicators displayed in the control bar. Displaying status information for the computer system in a status bar, provides visual feedback about a state of the computer system.

In some embodiments, while displaying the first status region that includes the first set of one or more status indicators and the second set of one or more status indicators, the computer system detects (752) a user input that meets expansion criteria for the first status region (e.g., the user input is a downward swipe input on a portion of the first status bar displayed along the top edge of the display, or a tap input on a portion of the first status bar, or another input interacting with the first status bar to expand the first status bar); and in response to detecting the user input that meets the expansion criteria for the first status region, the computer system displays (e.g., in the control user interface (e.g., displayed in response to the user input that meets the expansion criteria for the first status region), or without displaying the control user interface) at least one of a first representation of the first group of controls (e.g., in the compact form, or fully expanded form) and a second representation of the second group of controls, (e.g., in the compact form, or fully expanded form) the first representation of the first group of controls includes representations of different controls than the second representation of the second group of controls (e.g., the first group of controls includes more controls than the second group of controls, the first group of controls includes fewer controls than the second group of controls, the first group of controls includes one or more controls that are not included in the second group of controls, and/or the second group of controls includes one or more controls that are not included in the first group of controls). For example, in some embodiments, as described with reference to FIGS. 5CL and 5CM, a respective user interface element 5484 is displayed in response to detecting the user input 5466 directed to connectivity status information displayed in the control bar; and user interface element 5488 is displayed in response to detecting the user input 5468 that displays battery status information in the control bar. Displaying one or more controls that are related to status information displayed in the status bar in response to a user input directed to the status bar, enables the user to access the one or more controls that are related to the status information quickly and efficiently, thereby reducing a number of inputs requires to view the one or more controls that are related to the status information, and further provides additional control options for the user.

In some embodiments, displaying at least one of the first representation of the first group of controls and the second representation of the second group of controls in response to detecting the user input that meets the expansion criteria for the first status region, includes (754): in accordance with a determination that the user input that meets the expansion criteria for the first status region is directed to a first portion of the first status region (e.g., on a first side of the first status bar) that includes the first set of status indicators (e.g., and not the second set of status indicators), displaying the first representation of the first group of controls (e.g., without displaying the second representation of the second group of controls); and in accordance with a determination that the user input that meets the expansion criteria for the first status region is directed to a second portion of the first status region (e.g., on a second side of the first status bar) that includes the second set of status indicators (e.g., and not the first set of status indicators), displaying the second representation of the second group of controls (e.g., without displaying the first representation of the first group of controls). In some embodiments, the first set of status indicators includes network connectivity status indicators, and the first group of controls includes network connectivity controls; and the second set of status indicators includes a battery status indicator, and the second group of controls includes battery and/or power controls. For example, in some embodiments, as described with reference to FIGS. 5CL and 5CM, the different user interface elements 5484 and/or 5488 are displayed based on a location of the user input directed to the control bar. Displaying a first set of controls that are related to a first set of status information that is displayed in a first side of the status bar in response to a user input directed to the first side of the status bar, and displaying a second set of controls that are related to a second set of status information that is displayed in a second side of the status bar in response to a user input directed to the second side of the status bar, enables the user to access a desired respective set of controls that are related to the status information displayed in the respective side of the status bar quickly and efficiently, thereby reducing a number of inputs requires to view the respective set of controls that are related to the status information, and further provides additional control options for the user.

In some embodiments, the computer system displays (756) an input interface for a digital assistant (e.g., a textual input field for entering a textual command for the digital assistant, an affordance for capturing a speech input addressing the digital assistant) in the control user interface; and while displaying the control user interface including the input interface for the digital assistant, the computer system receives a user request via the input interface for the digital assistant (e.g., receiving a speech input via a microphone, a typed input in a text input field, or another input that is detected and interpreted by the digital assistant). In some embodiments, the user request includes a wakeup request followed by a task description, such as “Hi, assistant, turn on the kitchen light,” or “Mr. Butler, activate bedtime scene.” In some embodiments, in response to receiving the user request via the input interface for the digital assistant, the computer system performs one or more operations of the computer system in accordance with the user request (e.g., including control functions available in the control user interface includes control functions that can be activated and/or adjusted by directly manipulating the controls in the control user interface). For example, in some embodiments, instead of locating one or more controls in the control user interface for one or more control functions, the computer system allows the user to provide a user request to a digital assistant's input interface, and automatically performs the one or more controls functions without having to require the user to activate the controls using touch inputs or gesture inputs on those controls directly. In some embodiments, the digital assistant is accessible when the control user interface is not displayed, and optionally, when another user interface (e.g., the wake screen user interface, an application user interface, the home user interface, the application library user interface, or another user interface) is displayed. In some embodiments, the input interface for the digital assistant is displayed in other user interfaces and/or the digital assistant is directly accessible by using a special wake up speech input to activate the speech input interface of the digital assistant. In some embodiments, the digital assistant optionally interprets the speech input with contextual information, including and not limited to the currently displayed user interface, and optionally performs operations that are not limited to those available in the control user interface (e.g., performing location searches in maps, or keyword searches in messages and email, recommending restaurants, looking up dictionary definitions, or other operations unrelated to control functions). In some embodiments, the input interface for the digital assistant is available across multiple contexts, e.g., when user interfaces (e.g., home screen user interface, wake screen user interface, widget user interface, notification user interface, or other user interfaces) other than the control user interface is displayed and/or when the display is turned off or in a low-power mode, and the input interface for the digital assistant is provided in response to a user input requesting the assistance of the digital assistant, such as a voice input with a trigger word “hey, assistant!” an air gesture input such as a palm flip air gesture while a gaze is directed to the hand, activation of a hardware control with a double press input, or another type of user input that is configured to cause the input interface of the digital assistant to be provided to the user. For example, in some embodiments, as described with reference to FIGS. 5CE, a virtual assistant control 5448 enables a user to type to the virtual assistant in the control user interface 5002-6. Displaying a control in the control user interface that allows the user to provide one or more inputs to a digital assistant of the computer system, enables the user to access the digital assistant more easily and further provides additional modes of providing input to the digital assistant, including by using voice commands and/or typing inputs.

In some embodiments, displaying the control user interface includes (758) displaying a second user interface object that corresponds to a camera application (e.g., the second user interface object includes a camera application icon, a camera module that includes one two or more camera controls, an expanded camera module that includes a live view and one or more camera control(s)), the second user interface object has an expanded state and a reduced size state. In some embodiments, the expanded camera module that is optionally displayed in the control user interface by default or based on context, or in response to a user input expanding the module initially displayed in the reduced size state. In some embodiments, the camera module is initially displayed in the control user interface by default. In some embodiments, in accordance with a determination that expansion criteria are met (e.g., based on a default setting for the camera module, based on contextual conditions, or in response to a user input (e.g., a touch-hold input on the reduced camera module and/or camera application icon) expanding the camera module from the reduced state), the computer system displays the second user interface object in the expanded state in the control user interface, including displaying a live camera view (e.g., live view in a viewfinder of the camera, with or without automatic capturing of media at the same time) and a media capture control (e.g., a button to start or stop capturing video, short video, bursts of images, or still images) in the second user interface object, in the control user interface (e.g., with other controls in the control user interface at least partially visible, optionally, in a dimmed, blurred, or reduced visibility state); and in accordance with a determination that expansion criteria are not met (e.g., by default the reduced state of the camera module is displayed when the control user interface including the camera module is displayed), the computer system displays the second user interface object in the reduced size state in the control user interface (e.g., just the camera application icon), without displaying the live camera view and the media capture control in the second user interface object, in the control user interface. In some embodiments, a tap input on the second user interface object in the reduced size state causes the computer system to navigate away from the control user interface, and launch the camera application and display a user interface of the camera application. In some embodiments, a tap and hold input on the second user interface object in the reduced size state causes the computer system to expand the second user interface object within the control user interface, where the second user interface object in the expanded state includes the live camera view and one or more media capture controls that are available in the user interface of the camera application, but does not leave the control user interface (e.g., so that other controls in the control user interface remain easily accessible to the user when the second user interface object is reduced to the reduced size state in the control user interface (e.g., by a tap input outside of the second user interface object)). For example, in some embodiments, as described with reference to FIGS. 5CF, a camera preview 5450 is displayed in the control user interface 5002-6′. Displaying a control in the control user interface that, when activated, displays a camera preview that is captured by one or more cameras of the computer system, increases the privacy and security of the computer system by alerting the user when an operation of the computer system is accessing one or more cameras of the computer system.

In some embodiments, displaying the control user interface includes (760) displaying one or more controls (e.g., toggle controls and/or controls with multiple discrete states (e.g., the first control and/or the second control can be toggle controls, or other controls in the control user interface can be toggle controls)) with enhanced activation criteria, wherein a respective control of the one or more controls with enhanced activation criteria, when activated in accordance with respective enhanced activation criteria of the respective control, causes a corresponding control function to switch between two distinct states of the corresponding control function, and wherein the respective enhanced activation criteria require a sequence of two or more inputs to be directed to the respective control in order for the respective enhanced activation criteria to be met. For example, in some embodiments, as described with reference to FIGS. 5BL-5BN, the control 5308 requires a first user input 5384 to cause the device 100 to display the slider control 5308″ that is then activated by another user input 5386. Displaying a control in the control user interface that requires two or more inputs to activate the control, including a first input to display one or more available states of the control, and a second input directed to the desired state of the control, provides additional control options for the user to select a desired state of the control and decreases the likelihood of a user accidentally invoking the control by requiring an additional input after selecting the control.

In some embodiments, while displaying a first control with enhanced activation criteria (e.g., flashlight, garage door control, thermostat control, or other toggle controls) of the one or more controls with enhanced activation criteria in the control user interface, the computer system detects (762) a first activation input directed to the first control with enhanced activation criteria (e.g., a tap on the first toggle control, an air pinch gesture while the gaze is directed to the first toggle control, or another type of selection input directed to the first toggle control); in response to detecting the first activation input directed to the first control with enhanced activation criteria, the computer system displays first visual feedback (e.g., label, explanation or guidance on how to change the state of the control, information on the current state of the control, and/or other visual feedback (e.g., animated movement, change in appearance, size, and/or other visual properties) to indicate that the first activation input is detected on the first control) on or proximate to the first control with enhanced activation criteria, without switching between respective states of a corresponding control function of the first control with enhanced activation criteria; while displaying the first visual feedback (e.g., visual feedback is maintained during the time window that the second selection input is recognized as a sequence of inputs for toggling the first toggle control), the computer system detects a second activation input directed to the first control with enhanced activation criteria. In some embodiments, the first activation input and the second activation inputs are both selection inputs directed to the first control. In some embodiments, the second activation input is a repeat of the first activation input. In some embodiments, the second activation input is a continuation of the first activation input (e.g., the first activation input is a tap-hold input on the first control and the second activation input is a swipe performed by the same contact as the tap-hold input; the first activation input is a light press input, and the second activation input is a second press input performed with the same contact as the first activation input). In some embodiments, the second activation input is a separate input detected after the termination of the first activation input (e.g., the first activation input is a first tap on the first control, and the second activation input is a second tap on the first control displayed with the first visual feedback (e.g., expanded version of the first control; the first activation input is a tap-hold input on the first control, and the second activation input is a tap input on the first control with the first visual feedback, detected after lift-off of the tap-hold input)). In some embodiments, the first activation input and the second activation input are of different input types. In some embodiments, the first activation input and the second activation input are of the same input type (e.g., touch input, movement input, press input, air tap gesture, air pinch gesture detected in conjunction with gaze, or other types of input) but different threshold values (e.g., time threshold, distance threshold, intensity threshold, or other input thresholds). In some embodiments, in response to detecting the second activation input directed to the first control with enhanced activation criteria, while displaying the first visual feedback, the computer system switches between the respective states (e.g., first state and second state, ON and OFF states, open and closed states, light and dark states, fast and slow states, a plurality of focus mode states (e.g., sleep, work, personal, do not disturb, or other focus modes), or other distinct states of the corresponding control function of the first toggle control) of the corresponding control function of the first control with enhanced activation criteria. In some embodiments, if the second activation input is not detected (e.g., no input is detected after the first activation input was detected and the first visual feedback is displayed; or if an input that is of a different type or value from the second activation input is detected), and as such the respective enhanced activation criteria for the first control are not met by the first activation input followed by the second activation input, the computer system forgoes switching between the respective states of the control function of the first control (e.g., and ceases to display the first visual feedback and restores the display of the control user interface). For example, in some embodiments, as described with reference to FIG. 5BM, the device 100 updates the control 5308″ to change visual appearance (e.g., as a slider control) to indicate that the user has selected the control 5308. Updating display of a control in the control user interface in response to detecting a first input that causes the computer system to display one or more available states of the control, and detecting a second input directed to the desired state of the control while continuing to update display of the control, provides visual feedback about a state of the computer system while detecting a user input.

In some embodiments, while displaying a second control with enhanced activation criteria (e.g., flashlight, WiFi, nightshift, garage door control, thermostat control, or other toggle controls) of the one or more controls with enhanced activation criteria in the control user interface, the computer system detects (764) a third activation input directed to the second control with enhanced activation criteria (e.g., a tap on the second control, an air pinch gesture while the gaze is directed to the second control, or another type of activation input directed to the second control); in response to detecting the third activation input directed to the second control with enhanced activation criteria, the computer system displays second visual feedback (e.g., visual feedback is maintained during the time window that the second activation input is recognized as a sequence of inputs for toggling the first control) on or proximate to the second control with enhanced activation criteria, without switching between respective states (e.g., first state and second state, ON and OFF states, open and closed states, light and dark states, fast and slow states, a plurality of focus mode states (e.g., sleep, work, personal, do not disturb, or other focus modes), or other distinct states of the corresponding control function of the second control) of a corresponding control function of the second control with enhanced activation criteria; while displaying the second visual feedback (e.g., visual feedback is maintained during the time window that the second activation input is recognized as a sequence of inputs for toggling the second control), the computer system detects a movement input (e.g., a swipe input performed with the same contact as the third selection input, an air swipe gesture performed while the pinch is still maintained after the air pinch gesture that selected the second toggle control) directed to the second control with enhanced activation criteria; and in response to detecting the movement input directed to the second control with enhanced activation criteria, the computer system switches between the respective states (e.g., first state and second state, ON and OFF states, open and closed states, light and dark states, fast and slow states, a plurality of focus mode states (e.g., sleep, work, personal, do not disturb, or other focus modes), or other distinct states of the corresponding control function of the second control) of the corresponding control function of the second control with enhanced activation criteria. In some embodiments, the computer system requires that the direction of the movement input (e.g., left or right) to corresponds to the direction of the state that is not the current state of the control function of the second toggle control (e.g., a toggle that can switch between two states indicated by the left and right positions of the toggle in the second toggle control). In some embodiments, if the movement input is not detected (e.g., no input is detected after the third activation input was detected and the second visual feedback is displayed; or if an input that is of a different type or have a movement value or direction that does not meet the distance and direction requirement for the enhanced activation criteria of the second control), and as such the respective enhanced activation criteria for the second control are not met by the third activation input followed by no movement input or insufficient movement input, the computer system forgoes switching between the respective states of the control function of the second control (e.g., and ceases to display the first visual feedback and restores the display of the control user interface). For example, in some embodiments, as described with reference to FIG. 5BM, the user input 5386 activates the slide control 5308″. Displaying a control in the control user interface that requires two or more inputs to activate the control, including a first input to enable the control and a second input directed to the enabled control, such as a swipe and/or a slide input, decreases the likelihood of a user accidentally invoking the control by requiring an additional input after the control has been expanded.

In some embodiments, while displaying the one or more controls with enhanced activation criteria in the control user interface, the computer system detects (766) a first part of the sequence of two or more inputs (e.g., the first activation input, the third activation input, or another activation input) directed to a respective control with enhanced activation criteria of the one or more controls with enhanced activation criteria (e.g., the first control with enhanced activation criteria, the second control with enhanced activation criteria, or a third control with enhanced activation criteria); and in response to detecting the first part of the sequence of two or more inputs directed to the respective control with enhanced activation criteria, the computer system displays information (e.g., label of control, and/or explanation or guidance on what is required to change the state of the control) related to the respective control with enhanced activation criteria, without switching between respective states of a corresponding control function of the respective control with enhanced activation criteria. For example, in some embodiments, as described with reference to FIG. 5BM, the device 100 displays text “Wake Up” and/or another label for the control 5308″ after detecting the user input 5384 selecting the control 5308. Providing additional information about a selected control, such as by displaying a label for the selected control, provides the user with visual feedback about the state of the computer system and enables the user to request additional information about the control without requiring the user to navigate complex menu hierarchies.

It should be understood that the particular order in which the operations in FIGS. 7A-7I have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600, 800, and 900) are also applicable in an analogous manner to method 700 described above with respect to FIGS. 7A-7I. For example, the controls, user interfaces, and user inputs described above with reference to method 700 optionally have one or more of the characteristics of the controls, user interfaces, and user inputs described herein with reference to other methods described herein (e.g., methods 600, 800 and 900). For brevity, these details are not repeated here.

FIGS. 8A-8H are flow diagrams illustrating method 800 of providing quick actions in a user interface in accordance with some embodiments. Method 800 is performed at an electronic device or computer system (e.g., device 300, FIG. 3A, or portable multifunction device 100, FIG. 1A) that is in communication with one or more display generation components (e.g., touch-sensitive displays, standalone displays, head-mounted displays, projectors, and/or other types of devices), and one or more input devices (e.g., one or more sensors for detecting user inputs, such as cameras, touch-sensitive surfaces, touch-screen display, motion sensors, and/or other sensors and input devices). In some embodiments, the display generation component is a touch-screen display and the touch-sensitive surface is on or integrated with the display. In some embodiments, the display is separate from the touch-sensitive surface. Some operations in method 700 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Method 800 provides a method for displaying a respective set of quick action options at respective locations on a respective wake screen user interface. For example, in response to a wake screen user interface changing from a first version of the wake screen to a second version of the wake screen, the set of quick action options is updated from a first set of quick action options to a second set of quick action options, whereby the respective set of quick action options are displayed at a same position within each respective version of the wake screen. Automatically updating a set of quick action options that are available in accordance with changing the current version of the wake screen provides additional control options for the user to access a different sets of quick action options based on the current version of the wake screen, and reduces a number of inputs required for the user to cause the device to perform one or more operations associated with a respective quick action option without requiring the user to navigate away from the wake screen user interface. Further, providing quick action options that are available on the wake screen of the device improves the privacy and security of the computer system by enabling limited access to operations without requiring the user to unlock the computer system.

The computer system detects (802) the occurrence of a condition that corresponds to display of a respective wake screen of the computer system (e.g., detecting a user input corresponding to a request to display a wake screen such as a button press, device movement, or gesture and/or detecting a wake event such as an alarm going off, or a notification arriving while a device is in a locked or low-power state) that corresponds to a restricted state of the computer system (e.g., a respective one of a plurality of lock screen user interfaces, wake screen user interfaces, dimmed always-on user interfaces, or instances of another type of system user interface that is displayed when the computer system transitions into a low-power or locked state, and/or that must be dismissed in order to access a home screen user interface of the computer system) (e.g., a respective wake screen associated with a first user, user account, and/or user profile corresponding to a first user identity), wherein the respective wake screen includes: a notification region for displaying notifications from a plurality of different applications associated with the computer system (e.g., as described with reference to the notification 5475-1 in FIG. 5CG) (e.g., the notification region includes one or more notifications when the respective wake screen is displayed at a time when notifications are available to be displayed due to prior occurrences of events corresponding to the notifications); and an action region that includes a respective user-configurable control that, when activated (e.g., by a tap input, a touch-hold input, a light press input, an air pinch gesture, or another input that meets activation criteria), causes the computer system to perform a corresponding action associated with the respective user-configurable control. In some embodiments, the occurrence of the condition that corresponds to display of a respective wake screen causes the computer system to display the respective wake screen in a normal state, rather than a configurable state. In some embodiments, the computer system displays the respective wake screen in the configurable state or displays a configurable representation of the respective wake screen in a configuration user interface, in response to user inputs (e.g., tap and hold on the respective wake screen to display the configuration user interface, and/or selecting a “customization” button for the respective wake screen user interface) that correspond to a request to configure the respective wake screen or select a different wake screen as the currently selected wake screen, and a currently selected wake screen is displayed in a normal state once the user exits the configuration user interface (e.g., by tapping on a representation of a wake screen to select it, or tapping on a done button in the configuration user interface). For example, in some embodiments, as described with reference to FIG. 5CG, the wake screen user interface 5454-1 that includes quick action 5478-1 and a quick action 5478-2 (e.g., in the action region).

In response to detecting the occurrence of the condition that corresponds to display of the respective wake screen that corresponds to the restricted state of the computer system (804) (and that corresponds to the first user, user account, and/or user profile corresponding to the first user identity): in accordance with a determination that a first wake screen is a currently selected wake screen for the computer system (and for the first user, user account, and/or user profile corresponding to the first user identity), the computer system displays (806) the first wake screen, wherein displaying the first wake screen includes concurrently displaying: one or more first notifications in the notification region (e.g., unread notifications received while the computer system was in the restricted state before the condition for displaying the wake screen user interface had occurred) (e.g., as described with reference to FIG. 5CG, the notification 5475-1 is displayed in the wake screen user interface 5454-1) and a first control in the action region (e.g., the first control was selected and added to the action region in accordance with previous user inputs receiving during a configuration process for configuring the first wake screen, for the first user account and first user identity) (e.g., the wake screen user interface 5454-1 includes the quick action 5478-1 for turning on a flashlight and/or the quick action 5478-2 for accessing a camera preview in a camera application).

In response to detecting the occurrence of the condition that corresponds to display of the respective wake screen that corresponds to the restricted state of the computer system (804) (and that corresponds to the first user, user account, and/or user profile corresponding to the first user identity): in accordance with a determination that a second wake screen is the currently selected wake screen for the computer system (and for the first user, user account, and/or user profile corresponding to the first user identity), the computer system displays (808) the second wake screen (and for the first user, user account, and/or user profile corresponding to the first user identity) that is different from the first wake screen, wherein displaying the second wake screen includes concurrently displaying: one or more second notifications (e.g., unread notifications received while the computer system was in the restricted state before the condition for displaying the wake screen user interface had occurred) in the notification region (e.g., the first notifications and the second notifications are notifications for the first user, user account, and/or user profile corresponding to the first user identity, and may be the same, different, have one or more notifications in common, or have none in common, depending on the time the respective wake screen is displayed) (e.g., as described with reference to FIG. 5CR, the notification 5475-2 and/or the notification 5475-3 and/or the notification 5475-4 are displayed in the wake screen user interface 5454-3); and a second control (e.g., the second control was selected and added to the action region in accordance with previous user inputs receiving during a configuration process for configuring the second wake screen, for the first user account and first user identity) in the action region, wherein the second control is different from the first control (e.g., the first control and the second control were selected by a user during configuration of the first wake screen and the second wake screen that are associated with the first user, user account, and/or user profile corresponding to the first user identity). For example, the wake screen user interface 5454-3 includes the quick action 5478-6 for initiating a new note in a notes application. In some embodiments, the first control and the second control correspond to two different applications, such as a camera application, a flashlight application, a messaging application, a stop watch application, an electronic payment application, an alarm clock application, a calculator application, a screen recording application, a voice memo application, or other applications and a main function of any of the applications mentioned above. In some embodiments, the action region is located at the bottom region of the wake screen (e.g., in a row, and/or on the left and right portions that are easily accessible to the user's finger(s) when the user is holding and using the computer system with one hand). In some embodiments, the first notifications displayed in the notification region of the first wake screen are notifications that are allowed to be displayed in a first notification delivery mode associated with the first wake screen, and the second notifications displayed in the notification region of the second wake screen are notifications that are allowed to be displayed in a second notification delivery mode associated with the second wake screen. For example, the first wake screen and the second wake screen are wake screens associated with different focus modes, such as a DND mode, a quiet mode, a morning mode, or other modes of the computer system that restrict and/or adjust normal notification delivery policies of the computer system in different manners (e.g., restricting or permitting different applications, people, and/or content), and the first notifications are notifications permitted by the notification delivery policy of a first focus mode and the second notifications are notifications permitted by the notification delivery policy of a second focus mode different from the first focus mode. In some embodiments, one of the available focus modes may be a normal or default mode in which all notifications are permitted, while other focus modes modify the notification delivery rules for the normal or default mode to restrict delivery of some notifications while allowing delivery of other notifications.

In some embodiments, while displaying the first wake screen for the computer system (e.g., the first wake screen for the first user, user account, and/or user profile corresponding to the first user identity), the computer system detects (810) the occurrence of a first event (e.g., detects one or more user inputs that correspond to a request to switch from displaying the first wake screen to a second wake screen of the plurality of system user interfaces that correspond to the restricted state of the computer system and that is associated with the first user, user account, and/or user profile of the first user identity; or detects a condition that corresponds to display the wake screen has been met by the occurrence of the event, after configuration of the wake screen has been updated by the user during configuration of the wake screen of the first user, user account, and/or user profile of the first user identity); and in response to detecting the occurrence of the first event (e.g., detecting the one or more user inputs that correspond to a request to switch from displaying the first system user interface to the second system user interface (e.g., detecting a touch and hold input, a light press input, or another user input that meets switching criteria); or detecting a condition that corresponds to display the wake screen has been met by the occurrence of the event, after configuration of the wake screen has been updated by the user), the computer system displays the second wake screen (e.g., replacing display of the first wake screen, optionally, without exiting the restricted state of the computer system). In some embodiments, when switching from displaying the first wake screen to displaying the second wake screen in response to detecting the occurrence of the first event (e.g., the occurrent of the first event does not include going through the manual configuration process to modify aspects of the first wake screen to convert it into the second wake screen), the computer system, optionally, changes the wallpaper, the font and color scheme of the time and date indication, the active focus mode (e.g., sleep, DND, work, and other modes that sets the time and/or location-based preferences for notification delivery, available application functions, application restrictions, and alert generation for the computer system) of the computer system, widgets with automatically updatable application content, available controls for performing application functions) in accordance with the differences between the first wake screen and the second wake screen (e.g., based on the configurations of the first wake screen and the second wake screen saved from previous configuration sessions or configured based on system defaults). For example, in some embodiments, as described with reference to FIG. 5CI, in response to detecting the user input 5470, the face switcher user interface 5456 is displayed (e.g., in FIG. 5CN), and in response to detecting the user input 5490, the user interface 5454-2 (e.g., in FIG. 5CQ) is displayed as the currently selected wake screen user interface. Updating the currently selected version of the wake screen user interface from a first version to a second version, optionally without unlocking the computer system, improves the privacy and security of the computer system while providing the user with access to multiple versions of the wake screen user interface.

In some embodiments, detecting the occurrence of the first event while displaying the first wake screen includes (812) detecting a first sequence of one or more gesture inputs that meets switching criteria (e.g., switching criteria for switching wake screens associated with the same user identity and/or user profile, rather than switching the account, user identity, or user profile which leads to display of different wake screens associated with different user accounts, identities or user profiles), including detecting a first gesture input directed to the first wake screen (e.g., the first gesture input does not activate an object (e.g., widget, shortcut, application icon, or other objects activable by a normal selection input, such as a tap input or an air pinch input) displayed on the first wake screen). In some embodiments, the switching criteria require that the first sequence of one or more gesture input includes a swipe gesture in a first direction (e.g., a horizontal swipe gesture, a touch and hold gesture followed by a swipe gesture made with the same contact, a touch and hold gesture or a light press gesture made by one contact, followed by one or more swipe gestures make by one or more other contacts, an air pinch gesture, followed by a drag gesture performed while maintaining the pinch posture of the hand, and/or other selection and drag or swipe gestures). In some embodiments, the computer system displays a selection user interface for wake screens, including a selectable representation of the first wake screen, a selectable representation of the second wake screen, and/or a selectable representation of one or more other wake screens. In some embodiments, the selectable representations of the available wake screens are displayed with respective customization buttons, and selection of a respective customization button for a respective representation of a respective wake screen causes the respective wake screen to be displayed in a configuration user interface where one or more aspects of the respective wake screen can be modified by a user. In some embodiments, the selection user interface allows the user to browse through the selectable representations of available wake screens, and select one as the currently selected wake screen for subsequent display when the condition for displaying a respective wake screen of the computer system is met. In some embodiments, the sequence of one or more user inputs includes a first input to enter the selection user interface, optionally, one or more second user inputs to browse through selectable representations of available wake screens and/or one or more third user inputs to create new wake screens, and finally a fourth user input to select one of the available wake screens as the currently selected wake screen and exit the selection user interface. In some embodiments, the sequence of one or more user inputs includes a single input (e.g., a tap-hold and swipe gesture, an air pinch and drag gesture, or another single gesture) that switches the currently selected wake screen from the first wake screen to the second wake screen without having to display the selection user interface, when the second wake screen is an adjacent option for the first wake screen in the selection user interface. In some embodiments, the computer system requires that the sequence of one or more inputs is detected in a bottom portion of touch-screen display, or an unoccupied portion of the first wake screen, in order to meet the switching criteria. For example, in some embodiments, as described with reference to FIG. 5CI, in response to detecting the user input 5470, optionally a long press user input or other selection input, the face switcher user interface 5456 is displayed (e.g., in FIG. 5CN), wherein the user provides a swipe input to view additional versions of the wake screen user interface, and in response to detecting the user input 5490 directed to a representation of another wake screen user interface, the wake screen user interface 5454-2 (e.g., in FIG. 5CQ) is displayed as the currently selected wake screen user interface Updating the currently selected version of the wake screen user interface from a first version that includes a first set of quick action options to a second version that includes a second set of quick action options, in response to detecting a user input or sequence of user inputs that includes a long press and/or a swipe input, optionally without unlocking the computer system, improves the privacy and security of the computer system while providing the user with access to multiple versions of the wake screen user interface, thereby providing the user with additional control options via the different sets of quick action options.

In some embodiments, detecting the occurrence of the first event while displaying the first wake screen includes (814) detecting a change in a current focus mode of the computer system, wherein a focus mode of the computer system includes one or more rules for delivery of notifications. In some embodiments, the change in focus mode includes starting a focus mode that was not active (e.g., replacing another focus mode as the current focus mode of the computer system). In some embodiments, the change in focus mode includes ending a focus mode that has been active (e.g., replacing it with another focus mode as the current focus mode of the computer system). For example, in some embodiments, as described with reference to FIGS. 5CQ-5CR, a focus mode of the device 100 is updated in accordance with a change in the wake screen user interface from the wake screen user interface 5454-2 to the wake screen user interface 5454-3. Updating the currently selected version of the wake screen user interface from a first version that includes a first set of quick action options to a second version that includes a second set of quick action options, in response to detecting a change of the current focus mode of the computer system, optionally without unlocking the computer system, improves the privacy and security of the computer system while providing the user with access to multiple versions of the wake screen user interface and reduces a number of inputs required to change the wake screen user interface by associating a respective version of the wake screen user interface with a respective focus mode, thereby providing the user with additional control options via the different sets of quick action options.

In some embodiments, the change in the current focus mode occurs (816) without user input, in response to detecting a change in context of the computer system (e.g., a change in time, location, movement, connection to one or more wired or peripherals, a change in which applications are running, a beginning or end of a calendar event or other contextual cues that are tied to automatically changing focus modes at the computer system). In some embodiments, the computer system requires that a first set of contextual conditions are no longer met and a second set of contextual conditions are met, in order to switch from a first focus mode to a second focus mode, and switching from displaying the first wake screen to displaying the second wake screen. In some embodiments, the first wake screen does not correspond to any contextual conditions, and is displayed by default, and the computer system requires that a second set of contextual conditions to be met to activate the second focus mode, and switching from displaying the first wake screen to displaying the second wake screen. In some embodiments, the second wake screen does not correspond to any contextual conditions, and the computer system exits the first focus mode when a first set of contextual conditions are no longer met, and switches from displaying the first wake screen to the second wake screen. In some embodiments, different wake screens are associated with different focus modes, and a respective wake screen is automatically selected as the currently selected wake screen based on a match between the current context and the contextual conditions associated with the respective wake screen. In some embodiments, changing focus modes based on changing context does not necessarily cause a change in the currently selected wake screen for the computer system, and does not switch the wake screen that is currently displayed. In some embodiments, the different sets of contextual conditions for entering or exiting different focus modes are established for the same user identity and/or user profile, rather than for switching the accounts, user identities, or user profiles which leads to display of different wake screens associated with different user accounts, identities or user profiles. For example, as described with reference to FIG. 5CN, in some embodiments, a respective focus mode is associated with a current context of the device 100. Automatically changing the current focus mode of the computer system based on a detected context of the computer system, without requiring explicit input from the user, reduces a number of inputs required to change the currently selected focus mode.

In some embodiments, the change in the current focus mode occurs (818) in response to detecting a user input corresponding to a request to change focus modes (e.g., a request to start a focus mode and/or a request to end a focus mode). In some embodiments, the user input that corresponds to a request to change focus modes includes a user selecting one of the focus modes from a menu of available focus modes. In some embodiments, the computer system displays the menu of available focus modes in response to a user input selecting an affordance on the currently displayed wake screen (e.g., a focus mode indicator shown at the same or substantially the same location across multiple wake screens) or a user input directed to a notification settings user interface for associating one or more notification delivery rules with an existing or new focus mode. For example, in some embodiments, as described with reference to FIG. 5CQ, in response to detecting the user input 5510, the device 100 displays one or more focus mode options for the user to set a current focus mode. Changing the current focus mode of the computer system in response to a detected user input requesting to change the current focus mode, provides the user with additional control options for setting the focus mode of the computer system.

In some embodiments, the computer system displays (820) a configuration user interface for wake screens (e.g., the user interface 5454-2″, FIG. 5CO), including displaying the first representation of the first wake screen and displaying the action region in a configuration state within the first representation of the first wake screen; while displaying the configuration user interface for wake screens, including displaying the action region in the configuration state within the first representation of the first wake screen, the computer system detects one or more user inputs interacting with the action region (e.g., interacting with an “add” affordance when the action region is not currently occupied by a control, and/or interacting with a deletion affordance when the action region is currently occupied by a control) in the configuration state (e.g., detecting a tap input on the action region, an air tap gesture directed to a location of the action region, a pinch gesture detected while a gaze is directed to the action region, a click input when a focus selector is on the action region, or another type of input that has a target region overlapping with a reactive region of the action region); and in response to detecting the one or more inputs interacting with the action region in the configuration state, the computer system displays a plurality of selectable options for changing one or more controls included in the action region of the first wake screen (e.g., a deletion affordance to delete the first control from the first wake screen, and a listing of controls that can be selected and added to the action region of the first wake screen). In some embodiments, the computer system detects an input that deletes the first control from the first representation of the first wake screen and selects and adds the second control to the action region of the first representation of the first wake screen, and exits the configuration user interface. As a result, the second wake screen is a modified version of the first wake screen and the first wake screen no longer exists. In some embodiments, the user saves the modified first wake screen as a new, second wake screen, and the unmodified version of the first wake screen is still the first wake screen that now coexist with the second wake screen as available wake screens for user selection as the currently selected wake screen. In some embodiments, the editing of wake screens is performed for the same user identity and/or user profile, rather than for creating and configuring different user accounts, user identities, or user profiles which leads to display of different wake screens associated with the different user accounts, identities or user profiles. For example, in some embodiments, as described with reference to FIGS. 5CO-5CP, the user removes the quick action 5478-2 and adds, via the user input 5504, a different control as the quick action 5478-5 (e.g., in FIG. 5CQ). Enabling the user to update the set of quick action options that are associated with a respective version of the wake screen user interface while the user is editing the wake screen user interface provides the user with additional control options to customize the wake screen user interface, and further provides the user with additional control options via the set of quick action options that are selected for display on the wake screen user interface, even while the computer system is in a locked state, thereby improving the privacy and security of the computer system.

In some embodiments, displaying the configuration user interface for wake screens includes (822): displaying a respective representation of a respective wake screen (e.g., the first representation of the first wake screen, the second representation of the second wake screen, or another representation of another wake screen), wherein the respective wake screen has a respective wallpaper underlying one or more elements of the respective wake screen (e.g., time element, widgets, shortcuts to application functions, controls, notifications, subscribed events, live updates, and/or other elements that are persistently or transiently displayed overlaying the wallpaper), and displaying one or more selectable options for modifying one or more aspects of the respective wallpaper for the respective wake screen (e.g., options for changing a color scheme, images, light and dark modes, image filters, dimensionality, layering of content, included set of photos, included set of images, and/or other aspects of the wallpaper that affect its appearance and/or its interaction with other elements of the respective wake screen). In some embodiments, the configuration user interface is for editing the wake screens associated with the same user identity and/or user profile, rather than for wake screens associated with different accounts, user identities, or user profiles. For example, in some embodiments, as described with reference to FIG. 5CO, the editing user interface 5454-2″ for the user interface 5454-2 includes options for changing a wallpaper of the wake screen user interface 5454-2. Displaying one or more options for updating one or more settings for a wallpaper background of the wake screen user interface while the user is editing the wake screen user interface provides additional control options for the user to customize the wake screen user interface.

In some embodiments, displaying the configuration user interface for wake screens includes (824): displaying a respective representation of a respective wake screen in the configuration user interface (e.g., the first representation of the first wake screen, the second representation of the second wake screen, or another representation of another wake screen), wherein the respective wake screen has a respective widget region (e.g., below the time element, above the time element, or at another dedicated location on the wake screen) for displaying one or more widgets corresponding to one or more applications, and wherein a respective widget of the one or more widgets include application content that is updated from time to time based on updates received from a respective application corresponding to the respective widget (e.g., a weather widget that displays updated weather based on updates from the weather application, a fitness widget that displays updated fitness information based on updates received from a fitness monitoring application, a stock widget that displays updated stock information based on updates received from the stock application, and/or other widgets corresponding to other applications), and displaying one or more selectable options for changing the one or more widgets displayed in the respective widget region of the respective wake screen (e.g., options for displaying a listing of available widgets, options for choosing the content (e.g., type of content, contextually selected content, and/or other content aspects) and display format (e.g., color scheme, size, dimensions, font, and/or other appearance aspects) of a respective widget that is available for inclusion in the respective widget region, options for changing the update frequency, and/or update triggers for the content of a respective widget that is available to be included in the respective widget region). In some embodiments, the configuration user interface is for editing the wake screens associated with the same user identity and/or user profile, rather than for wake screens associated with different accounts, user identities, or user profiles. In some embodiments, in response to detecting one or more user input selecting an “add widget” affordance displayed in the widget region of the wake screen, the computer system displays a menu including respective representations of widgets that are available to be added to the widget region of the wake screen, and/or respective representations of applications that have widgets that are available to be added to the widget region of the wake screen. In response to detecting selection of a representation of a first widget from the menu, the computer system adds the first widget to the widget region of the wake screen. In response to detecting a user input dragging and dropping a second widget from the menu to the widget region, the computer system adds the second widget to the widget region. In response to a user selecting and dragging the first widget relative to the second widget in the widget region, the computer system switches the relative positions of the first widget and the second widget in the widget region. In response to selection of a representation of an application in the menu, the computer system displays different widgets of the application, including widgets that have different application content from the application, widgets of different formats and/or sizes, and widgets with other differences in configurable parameters. In response to user input selecting and/or dragging a third widget displayed for the selected application, the computer system adds the third widget to the widget region. In response to detecting a user input selecting a deletion affordance for a respective widget in the widget region, the computer system removes the respective widget from the widget region, and optionally, repositions the remaining widgets in the widget region.

In some embodiments, widgets that are displayed in the respective widget region of the respective wake screen also referred to as “mini-application objects” or “user interface object that includes application content,” and the widgets provide a limited subset of functions and/or information available from their corresponding applications without requiring the applications to be launched. In some embodiments, a widget that is displayed at a placement location is fixed and does not automatically switch to a different widget or widget for a different application. In some embodiments, a widget stack is implemented such that multiple widgets share the same placement location and are displayed at different times at the same placement location. In some embodiments, the widget region of the wake screen only accommodates widgets and not widget stacks. In some embodiments, the widget region of the wake screen also accommodates at least one widget stack that rotate through (e.g., in accordance with a rotation schedule, in response to user inputs, and/or in response to changing contextual conditions) multiple widgets at the same placement location in the widget region. In some embodiments, the application content that is contained in a widget is user configurable and includes a specific type of informational content, and/or a specific application function without requiring the user to open the corresponding application. A widget is different from an application window which displays the user interface of an open application. In some embodiments, a limited set of application functions is provided in a widget, such as text input function or selection function, and the input received through the widget is provided to the corresponding application, so the application is updated according to the input without requiring the user to actually open the application. In some embodiments, the application content included in a widget is dynamically updated by the computer system when the same application content is updated in the corresponding application, even when the application is not currently open on the display generation component. For example, in some embodiments, as described with reference to FIG. 5CO, in response to detecting the user input 5498, the editing user interface 5454-2″ is updated to display options for adding, removing and/or modifying the widgets displayed in the user interface 5454-2. Displaying one or more options for updating one or more widgets that are displayed in the wake screen user interface while the user is editing the wake screen user interface provides additional control options for the user to customize the wake screen user interface and improves the privacy and security of the computer system by displaying the one or more widgets on the wake screen user interface without requiring the user to unlock the computer system.

In some embodiments, displaying the configuration user interface for wake screens includes (826): displaying a respective representation of a respective wake screen (e.g., the first representation of the first wake screen, the second representation of the second wake screen, or another representation of another wake screen) in the configuration user interface, wherein the respective wake screen has a respective time element that displays a current time (e.g., in a digital time format, or in an analog time format), and wherein the respective time element is displayed with a respective set of styles (e.g., font, color, translucency, outline, text styles, size, relative sizes between time and date elements, existence of date element, position of time element relative to other elements of the wake screen, such as the wallpaper, subject of wallpaper image, widgets, and/or other elements that overlap with the time element), and displaying one or more selectable options for changing the respective set of styles for the respective time element (e.g., options for changing the font, color, size, translucency, display layer, time format, and/or other aspects of the time element, and/or displaying a listing of available fonts, colors, sizes, time formats, and/or options for other aspects of the time element). In some embodiments, the configuration user interface is for editing the wake screens associated with the same user identity and/or user profile, rather than for wake screens associated with different accounts, user identities, or user profiles. In some embodiments, in response to detecting a user input selecting the time element of the wake screen in the configuration user interface, the computer system displays selectable options for different fonts, a slider for different font sizes, and selectable options and/or a color picker for different font colors. In response to a user input selecting a first font different from a current font of the time element, the computer system displays the time element with the first font. In response to a user input selecting a different font size or drags the size indicator on the slider control for font size, the computer system adjusts the font size of the time element. In response to a user input selecting a first color different from the current color for the time element, the computer system displays the time element with the first color. In some embodiments, in response to detecting a user input selecting a date element of the wake screen in the configuration user interface, the computer system displays selectable options for one or more reduced size widgets for displaying within the date element along with regular current date information, where the reduced size widgets includes application information such as current weather, current location, new mail, fitness data, and/or other application information from different applications. In response to a user input selecting a first reduced size widget, the computer system updates the content of the date element to include the application content of the first reduced size widget, along with the current date information. For example, in some embodiments, as described with reference to FIG. 5CO, the editing user interface 5454-2″ includes options for editing the date and/or time displayed in the user interface 5454-2, for example, in response to detecting the user input 5496, the device 100 displays options for changing a color, font, size and/or other properties of the displayed time. Displaying one or more options for updating one or more settings for displaying a date and/or time indication in the wake screen user interface while the user is editing the wake screen user interface provides additional control options for the user to customize the wake screen user interface.

In some embodiments, while displaying a respective representation of a respective wake screen in the configuration user interface (e.g., the first representation of the first wake screen, the second representation of the second wake screen, or another representation of another wake screen), along with one or more options for configuring one or more portions of the respective wake screen (e.g., options for changing the action region, options for changing the widget region, options for changing the time element, and/or options for changing other regions of the respective wake screen), the computer system detects (828) a respective user input that selects a first option of the one or more options for configuring a first portion of the respective wake screen; and in response to detecting the respective user input that selects the first option for configuring the first portion of the respective wake screen, the computer system modifies the respective representation of the respective wake screen in the configuration user interface in accordance with the first option (e.g., add a selected/dragged widget to the widget region, or add a selected/dragged control to the action region, replace a current color, font, or style of the time element based on the selected/dragged color, font, or style for the time element). In some embodiments, the respective user input that selects the first option for configuring the first portion of the respective wake screen includes a tap input on the first option. In some embodiments, the respective user input that selects the first option for configuring the first portion of the respective wake screen includes a select and drag input on the first option and a release input when the first option is dragged to a location over a visible portion of the respective wake screen (e.g., any visible portion, or the first portion of the respective wake screen). For example, in some embodiments, as described with reference to FIG. 5CP, in response to the user input 5504, which is a drag input, tap input and/or another selection input, the timer control is added to the quick action option 5478-4. Enabling the user to select a respective quick action option to be included in the wake screen user interface while the user is editing the wake screen user interface, including enabling the user to select the respective quick action via a tap input and/or via a drag and drop input, provides additional control options for the user to add the respective quick action option to the wake screen user interface and provides improved access to the selected quick action options from the wake screen user interface.

In some embodiments, displaying the plurality of selectable options for changing one or more controls included in the action region of the first wake screen includes (830): displaying a listing of controls that is available in a configuration user interface for a control user interface of the computer system, wherein respective controls in the listing of controls are available for inclusion in the control user interface of the computer system when selected by a user in the configuration user interface for the control user interface. For example, in some embodiments, the wake screen action region and the configurable portion of the control user interface of the computer system have the same set of available controls that can be selected and added to the wake screen action region and the configurable portion of the control user interface. In some embodiments, only a subset of the controls available to be included in the control user interface is made available for inclusion in the wake screen action region. In some embodiments, the wake screen action region and the configuration portion of the control user interface have separate configuration user interfaces and configuration processes and do not need to be the same. In some embodiments, the wake screen action region and the configurable portion of the control user interface are synchronized and changing one will cause the other to change accordingly. In some embodiments, the computer system displays the listing of controls that are available to be included in the action region of the wake screen in a manner analogous to how the listing of controls that are available to be included in the control user interface when a user input for adding a control to the control user interface is detected (e.g., as described with respect to method 700). For example, in some embodiments, the available controls are grouped in accordance with their categories. In some embodiments, a control is added to the action region in response to a selection input directed to the control in the listing (e.g., a tap input on the control, an air tap at the location of the control, an air pinch gesture detected when a gaze is on the control, a click input detected when a focus selector is on the control, or another type of selection input that is targeting the location of the control). In some embodiments, a control is added to the action region in response to a movement input that is directed to the control in the listing and that drags and drops the control outside of the platter that contains the listing of controls (e.g., a tap-hold and drag input on the control, an air pinch gesture detected when a gaze is on the control followed by a pinch and drag gesture, a click-hold and drag input detected when a focus selector is on the control, or another type of select and drag input that is targeting the location of the control, that terminates when the control is outside of the container of the listing of controls). For example, in some embodiments, as described with reference to FIG. 5CR, the one or more controls that may be selected to fill the quick action space(s) include at least some of the control options that may be selected to add to control user interface 5002. Providing a collection of controls from which the user selects controls to add to a control user interface and/or from which the user selects controls to add as a quick action option to be displayed in the wake screen user interface, improves the user's access to controls in the collection of controls from the control user interface and/or from the wake screen user interface, thereby reducing a number of inputs required to activate the respective controls.

In some embodiments, while displaying a control user interface of the computer system in a reconfiguration mode (e.g., as described with reference to method 700), the computer system detects (832) a respective user input that corresponds to a request to add a new control to the control user interface (e.g., detecting user selection of an “add control” affordance displayed in the control user interface in the reconfiguration mode); and in response to detecting the respective user input that corresponds to a request to add a new control to the control user interface, the computer system displays a listing of controls that is available in a configuration user interface for a respective wake screen of the computer system, wherein respective controls in the listing of controls are available for inclusion in an action region of the respective wake screen when selected by a user in the configuration user interface of the respective wake screen. For example, in some embodiments, the wake screen action region and the configurable portion of the control user interface of the computer system have the same set of available controls that can be selected and added to the wake screen action region and the configurable portion of the control user interface. In some embodiments, only a subset of the controls available to be included in the control user interface is made available for inclusion in the wake screen action region. In some embodiments, the wake screen action region and the configuration portion of the control user interface have separate configuration user interfaces and configuration processes and do not need to be the same. In some embodiments, the wake screen action region and the configurable portion of the control user interface are synchronized and changing one will cause the other to change accordingly. For example, in some embodiments, as described with reference to FIG. 5CR, the one or more controls that may be selected to fill the quick action space(s) include at least some of the control options that may be selected to add to control user interface 5002. Providing a collection of controls from which the user selects controls to add to a control user interface and/or from which the user selects controls to add as a quick action option to be displayed in the wake screen user interface, improves the user's access to controls in the collection of controls from the control user interface and/or from the wake screen user interface, thereby reducing a number of inputs required to activate the respective controls.

In some embodiments, a first instance of a control for a respective function (e.g., the first control, the second control, or another control that is included in the action region of the currently selected wake screen) is (834) included in the currently selected wake screen (e.g., the first wake screen, the second wake screen, or another wake screen of the computer system) and a second instance of the control for the respective function is included in a control user interface (e.g., in the action region of the control user interface and the action region of the currently selected wake screen) of the computer system, wherein the respective function has a plurality of states that is selectable through user interaction with the first instance of the control for the respective function in the currently selected wake screen or the second instance of the control for the respective function in the control user interface. In some embodiments, the same control icon is used for different instances of the same control on the wake screen and the control user interface. In some embodiments, slightly different icon images are used for the different instances of the same control on the wake screen and the control user interface. In some embodiments, the computer system detects one or more inputs directed to the wake screen including one or more inputs directed to a representation of the control on the wake screen; and in response to detecting the one or more inputs directed to the wake screen, changes a state of the control (e.g., and performs an operation associated with the control at the computer system). In some embodiments, after detecting the one or more inputs, the computer system detects one or more inputs directed to a control user interface that is separate from the wake screen including one or more inputs directed to a representation of the control on the control user interface; and in response to detecting the one or more inputs directed to the control user interface, the computer system changes a state of the control (e.g., and performing an operation associated with the control at the computer system). For example, in some embodiments, when different instances of the control for a respective control function are included in both the control user interface and a respective wake screen, the state of the respective control function is synchronized across the wake screen and the control user interface, as reflected in the appearance of the different instances of the control shown in the wake screen and the control user interface, irrespectively of whether the change in the state of the respective control function is caused by interaction with the instance of the control shown in the wake screen or by interaction with the instance of the control shown in the control user interface. For example, in some embodiments, as described with reference to FIGS. 5CT-5CU, while the quick action 5478-9′ for a voice recording is activated on the wake screen user interface 5454-4, the control user interface 5002-2″ is synchronized to indicate the voice recording is activated. Automatically synchronizing a state of a respective control that is included in a control user interface and as a quick action option that is displayed in the wake screen user interface, provides real-time feedback about the state of the respective control without requiring the user to navigate between the control user interface and/or the wake screen user interface, thereby reducing a number of inputs.

In some embodiments, while displaying the currently selected wake screen including the first instance of the control for the respective function, the computer system detects (836) first user interaction with the first instance of the control for the respective function; and in response to detecting the first user interaction with the first instance of the control for the respective function, the computer system changes a current state of the first instance of the control for the respective function from a first state to a second state of the plurality of states in the currently selected wake screen (e.g., the first user interaction includes tapping on the first instance of the control to display the plurality of states as selectable options and selecting the second state from the plurality of states; or touching and holding on the first instance of the control to expand the first instance of the control into a slider control or toggle control and swiping along the slider control or toggle control to switch to the second state of the plurality of states). In some embodiments, the state of an instance of the control in a user interface corresponds to the state of the respective function controlled by the control; and a change in the state of the instance of the control in a user interface corresponds to a change in the state of the respective function controlled by the control. In some embodiments, while the current state of the first instance of the control for the respective function is in the second state in the currently selected wake screen, the computer system detects a request to display the control user interface; and in response to detecting the request to display the control user interface, the computer system displays the control user interface, including displaying the second instance of the control for the respective function in the second state in the control user interface. In some embodiments, changing the current state of the at least one control includes changing one or more visual properties of the at least one control (e.g., shading the control, illuminating the control, changing a color of the control, changing a status indicated by the control, and/or other updates to the control) and, in response to detecting the first user interaction, the at least one control displayed in the action region of the wake screen is updated to have a different set of visual properties (e.g., than before detecting the first user interaction) and the at least one control displayed in the control user interface is also updated to have the different set of visual properties. For example, in some embodiments, as described with reference to FIGS. 5CT-5CU, while the quick action 5478-9′ for a voice recording is activated on the wake screen user interface 5454-4, the control user interface 5002-2″ is synchronized to indicate the voice recording is activated. Automatically synchronizing a state of a respective control that is included in a control user interface and as a quick action option that is displayed in the wake screen user interface, where the state of the control is activated and/or deactivated via the quick action option in the wake screen user interface, provides real-time feedback about the state of the respective control without requiring the user to navigate between the control user interface and/or the wake screen user interface, thereby reducing a number of inputs.

In some embodiments, while displaying the control user interface including the second instance of the control for the respective function, the computer system detects (838) second user interaction with the second instance of the control for the respective function; and in response to detecting the second user interaction, the computer system changes a current state of the second instance of the control for the respective function from a third state to a fourth state of the plurality of states in the control user interface (e.g., the second user interaction includes tapping on the second instance of the control to display the plurality of states as selectable options and selecting the fourth state from the plurality of states; or touching and holding on the second instance of the control to expand the second instance of the control into a slider control or toggle control and swiping along the slider control or toggle control to switch to the fourth state of the plurality of states). In some embodiments, the state of an instance of the control in a user interface corresponds to the state of the respective function controlled by the control; and a change in the state of the instance of the control in a user interface corresponds to a change in the state of the respective function controlled by the control. In some embodiments, while the current state of the second instance of the control for the respective function is in the fourth state in the control user interface, the computer system detects a request to display the currently selected wake screen of the computer system; and in response to detecting the request to display the currently selected wake screen of the computer system, the computer system displays the currently selected wake screen, including displaying the second instance of the control for the respective function in the fourth state in the currently selected wake screen (e.g., in the action region of the currently selected wake screen). For example, changing the current state of the at least one control includes changing one or more visual properties of the at least one control (e.g., shading the control, illuminating the control, changing a color of the control, changing a status indicated by the control, and/or other updates to the control) and, in response to detecting the second user interaction, the at least one control displayed in the control user interface is updated to have a different set of visual properties (e.g., than before detecting the second user interaction) and the at least one control displayed in the action region of the wake screen is also updated to have the different set of visual properties. For example, in some embodiments, as described with reference to FIGS. 5CT-5CU, in response to the user deactivating the voice recording (e.g., by selecting the stop button) in the control user interface 5002-2″, the quick action 5478-9 displayed in the wake screen user interface 5454-4 is synchronized to indicate the voice recording is deactivated. Automatically synchronizing a state of a respective control that is included in a control user interface and as a quick action option that is displayed in the wake screen user interface, where the state of the control is activated and/or deactivated via the control user interface, provides real-time feedback about the state of the respective control without requiring the user to navigate between the control user interface and/or the wake screen user interface, thereby reducing a number of inputs.

In some embodiments, while displaying the currently selected wake screen including the first instance of the control for the respective function, the computer system detects (840) first user interaction with the first instance of the control for the respective function; and in response to detecting the first user interaction with the first instance of the control for the respective function, the computer system changes a current state of the first instance of the control from a first state to a second state of the plurality of states in the currently selected wake screen (e.g., the first user interaction includes tapping on the first instance of the control to display the plurality of states as selectable options and selecting the second state from the plurality of states; or touching and holding on the first instance of the control to expand the first instance of the control into a slider control or toggle control and swiping along the slider control or toggle control to switch to the second state of the plurality of states). In some embodiments, the state of an instance of the control in a user interface corresponds to the state of the respective function controlled by the control; and a change in the state of the instance of the control in a user interface corresponds to a change in the state of the respective function controlled by the control. In some embodiments, while the current state of the first instance of the control is in the second state in the currently selected wake screen, the computer system detects a request to display the control user interface; and in response to detecting the request to display the control user interface, the computer system displays the control user interface, including displaying the second instance of the control for the respective function in the first state in the control user interface. In some embodiments, some (e.g., a first subset) or all of the controls in both the control user interface and the currently selected wake screen are synchronized when the states of the controls are changed in either the currently selected wake screen or the control user interface. In some embodiments, some (e.g., a second subset different from the first subset) or all of the controls in both the control user interface and the currently selected wake screen are not synchronized, and when changing the states of the controls in a respective user interface does not cause the states of the controls in the other user interface to change. For example, in some embodiments, as described with reference to FIGS. 5CV, the control user interface 5002-2″ does not update based on and/or synchronize with the state of the quick action 5478-8. Maintaining the state of the respective control displayed in the control user interface even while the wake screen user interface, and corresponding quick action options, change, such that the quick action options are not synchronized with an activated control in the control user interface, allows the user to continue accessing the control via the control user interface, without requiring the user to navigate through complex menu hierarchies, even after the current wake screen user interface has been changed.

In some embodiments, while the control for the respective function is included in the control user interface and the currently selected wake screen, the computer system detects (842) one or more events; and in response to detecting the one or more events, the computer system changes the currently selected wake screen in accordance with the one or more events (e.g., either the currently selected wake screen is modified directly in a configuration process, or the currently selected wake screen is changed from one preconfigured wake screen to another preconfigured wake screen due to user selection, contextual conditions, and/or other events), such that the currently selected wake screen does not include the control for the respective function in the action region of the currently selected wake screen. In some embodiments, after the currently selected wake screen has been changed to no longer include the control for the respective function, the computer system detects a request to display the control user interface; and in response to detecting the request to display the control user interface, the computer system displays the control user interface, including the first instance of the control for the respective function (e.g., the control is not removed from the control user interface, in response to changing the wake screen). For example, in some embodiments, as described with reference to FIG. 5CU, the modified version of the control user interface 5002-2″ continues to display the status of the active voice recording, even after the current version of the wake screen user interface 5454 changes (e.g., to a wake screen user interface 5454-3 that does not include the quick action 5478-9 corresponding to the voice recording control). Maintaining the state of the respective control displayed in the control user interface even while the wake screen user interface, and corresponding quick action options, change, allows the user to continue accessing the control via the control user interface, without requiring the user to navigate through complex menu hierarchies, even after the current wake screen user interface has been changed.

In some embodiments, at least one of the first control and the second control includes (844) a first slider control (e.g., a slider control for adjusting text size, volume, or display brightness). In some embodiments, the first slider control is also included in a control user interface of the computer system, e.g., in a user-configurable portion and/or action region of the control user interface. In some embodiments, the state of the first slider control is synchronized between the respective wake screen that includes the first slider control (e.g., when the respective wake screen is displayed), and the control user interface that includes the first slider control, irrespective of whether the value or state of the first slider control is changed in the respective wake screen or in the control user interface. In some embodiments, the state of the first slider control is not synchronized between the respective wake screen that includes the first slider control, and the first slider control reflects the value of a control function in the current context (e.g., text size for the user interface that was displayed on the wake screen, or on a user interface displayed right before displaying the control user interface). In some embodiments, the first slider control includes a value indicator that indicates a current value of a first parameter controlled by the first slider control, relative to a value range of the first parameter. In some embodiments, the first control updates the current value of the first parameter by moving the value indicator relative to the first slider control in accordance with a movement input (e.g., a swipe gesture, a pinch and drag gesture, a click-hold and drag input, or another type of movement input) that is directed to the first slider control. In some embodiments, the computer system displays the current value of the first parameter in the first control prior to detecting any input directed to the first control, without displaying a slider control for adjusting the current value for the first parameter; and the computer system displays the slider control in response to a first input or an initial portion of the user input that is directed to the first control (e.g., a tap input, a touch-hold input, a pinch and hold gesture, a light press input, or another input that is directed to the first control). In some embodiments, the computer system adjusts the current value of the first parameter in response to one or more second inputs or a continuation of the first input that is directed to the value indicator (e.g., dragging the value indicator relative to the slider control). In some embodiments, the computer system forgoes adjusting the current value of the first parameter after the slider control is displayed in response to the first input or the initial portion of the user input that is directed to the first control, if additional inputs or subsequent portions of the user input do not include movement relative to the slider control (e.g., if no additional input is detected, or if the additional inputs do not include movement or are not directed to the slider control). For example, in some embodiments, as described with reference to FIG. 5CR, in some embodiments, the quick action 5478-7 is a slider control. Displaying a slider control for the control displayed as a quick action option in the wake screen user interface, provides the user with more refined control for performing an operation associated with the slider control.

In some embodiments, the computer system includes (846) a first input element (e.g., an action button, a touch-sensitive region along an edge of the computer system, or another hardware element of the computer system), the first input element associated with a respective action that is performed when the first input element is activated in accordance with activation criteria (e.g., when the first input element is pressed by a press input, tapped by a tap input, or otherwise activated by a user input of a first type). In some embodiments, the computer system detects an activation input on the first input element that meets the activation criteria; and in response to detecting the activation input on the first input element that meets the activation criteria, the computer system performs a respective action (e.g., takes a picture, turns on/off the flashlight, turns on/off silent mode, starts/stops a voice memo, and/or other actions) that corresponds to the first input element. For example, in some embodiments, as described with reference to FIG. 5CR, the one or more controls that may be selected to fill the quick action space(s) include at least some of the control options that may be selected to be assigned to the action button of the device 100. Enabling the user to assign an activation button that, when activated, causes the computer system to perform an operation that is also caused via activation of a control displayed as a quick action option in the wake screen user interface, provides the user with additional ways to access the control and cause the computer system to perform the operation associated with the control.

In some embodiments, the computer system detects (848) a respective user input that corresponds to a request to configure the respective action that corresponds to the first input element (e.g., selecting “action button” in a settings user interface, or pressing and holding the first input element to trigger a configuration mode for the first input element); and in response to detecting the respective user input that corresponds to a request to configure the respective action that corresponds to the first input element, the computer system displays a listing of actions that correspond to a plurality of controls (e.g., controls for launching the camera user interface, turning on/off the flashlight, and/or starting/stopping voice memo recording, and other controls for actions) that are available to be included in an action region of a currently selected wake screen of the computer system, wherein actions in the listing of actions are available to be selected as the respective action that corresponds to the input element. In some embodiments, in response to selection of a first action in the listing of actions, the computer system associates the first action with the first input element, and the next time that the first input element is activated by a user input, the computer system performs the first action. In some embodiments, the listing of actions corresponds to only a subset of the controls that are available to be included in the control user interface. In some embodiments, the listing of actions that are available to be associated with the first input element corresponds to the same set of controls that are available to be included in the currently selected wake screen. For example, in some embodiments, as described with reference to FIGS. 5CQ-5CR, a user input 5506 on the action button causes dark mode to be activated and/or deactivated, and a user input directed to the quick action 5478-3′ also causes dark mode to be activated and/or deactivated. Enabling the user to assign an activation button, selected from a collection of available controls, that, when activated, causes the computer system to perform an operation that is also caused via activation of a control displayed as a quick action option, optionally selected from the collection of available controls, in the wake screen user interface, provides the user with additional ways to access the control and cause the computer system to perform the operation associated with the control

In some embodiments, the first input element is (850) associated with a first action, and the currently selected wake screen includes a respective control that is associated with the first action, wherein the respective control has a plurality of states that is selectable through user interaction with the first input element or the respective control in the currently selected wake screen, and wherein a state of the control is synchronized in the currently selected wake screen and in a status indicator of the first action that is provided in response to activation of the first input element (e.g., the visual feedback indicate the effect of performing the first action which changes the state of the control). For example, in some embodiments, the first input element can be associated with an action for turning on/off a flashlight function, capturing a photo, starting/stopping a voice recording, turning on/off a silent mode, or turning on/off a focus mode, and the currently selected wake screen can also include a control for the same action. When the user activates the first input element, the computer system performs the action (e.g., turning on a flashlight function, capturing a photo, starting a voice recording, turning on a silent mode, or turning on a focus mode) in response to the interaction with the first input element, and updates the state of the control for the same action included in the action region of the currently selected wake screen; and when the user interacts with the control for the same action in the action region of the currently selected wake screen, the starting state of the control has been changed based on the earlier activation of the first input element, and performing the action in response to the interaction with the control in the currently selected wake screen further changes the state of the control (e.g., turning off the flashlight function, dismissing a camera user interface, stopping the voice recording, turning off the silent mode, or turning off the focus mode). For example, in some embodiments, as described with reference to FIGS. 5CQ-5CR, the dark mode state is synchronized in both the quick action 5478-3′ and the state controlled by the action button via the user input 5506 (e.g., when dark mode is on, selection of the action button causes dark mode to turn off, and vice-versa). Automatically synchronizing a state of a respective control that is controlled via an action button and is displayed as a quick action option that is displayed in the wake screen user interface, provides real-time feedback about the state of the respective control without requiring the user to manually request the current status for the respective control, thereby reducing a number of inputs.

In some embodiments, while displaying the currently selected wake screen including the respective control that is associated with the first action, the computer system detects (852) activation of the first input element; and in response to detecting activation of the first input element, the computer system performs the first action, wherein the first action changes a current state of the respective control that is associated with the first action from a fifth state to a sixth state of the plurality of states in the currently selected wake screen. In some embodiments, a change in the state of the plurality of states associated with the first action causes the computer system to update one or more visual properties of the respective control (e.g., shading the control, illuminating the control, changing a color of the control, changing a status indicated by the control, and/or other updates to the control) such that, in response to detecting that the state has changed in response to activation of the first input element, the respective control is displayed with a different set of visual properties to indicate the current state of the first action cause by activation of the first input element. For example, in some embodiments, as described with reference to FIGS. 5CQ-5CR, in response to detecting the user input 5506 directed to the action button, the status of the quick action 5478-3′ is updated. Automatically synchronizing a state of a respective control that is controlled via an action button and is displayed as a quick action option that is displayed in the wake screen user interface, where the respective control is activated and/or deactivated via selection of the action button and causes the state of the quick action option to update, provides real-time feedback about the state of the respective control without requiring the user to manually request the current status for the respective control, thereby reducing a number of inputs.

In some embodiments, while displaying the currently selected wake screen including the respective control that is associated with the first action, the computer system detects (854) third user interaction with the respective control that is associated with the first action in the currently selected wake screen; in response to detecting the third user interaction, the computer system changes a current state of the respective control that is associated with the first action from a seventh state to an eighth state in the currently selected wake screen; while the current state of the respective control that is associated with the first action is in the eighth state in the currently selected wake screen, the computer system detects activation of the first input element; and in response to detecting the activation of the first input element, the computer system displays a status indicator that is associated with the first input element, wherein the status indicator indicates that the first input element is associated with the first action, and that a current state of the first action is the eighth state. For example, in some embodiments, as described with reference to FIGS. 5CQ-5CR, in response to a user input selecting the quick action 5478-3′, the dark mode state is synchronized such that a subsequent input directed to the action button causes the state to toggle the dark mode from the current state. Automatically synchronizing a state of a respective control that is controlled via an action button and is displayed as a quick action option that is displayed in the wake screen user interface, where the respective control is activated via selection of the control displayed as the quick action option, such that a subsequent activation of the action button causes the respective control to change from the current active state to an inactive state, provides alternative ways for the user to access the control without regard to how the control was activated.

In some embodiments, while the first input element is associated with the first action and the respective control that is associated with the first action is included in the action region of the currently selected wake screen, the computer system detects (856) one or more events; in response to detecting the one or more events, the computer system changes the currently selected wake screen in accordance with the one or more events (e.g., either the currently selected wake screen is modified directly in a configuration process, or the currently selected wake screen is changed from one preconfigured wake screen to another preconfigured wake screen due to user selection, contextual conditions, and/or other events), such that the currently selected wake screen does not include the respective control that is associated with the first action; after the currently selected wake screen has been changed to no longer include the respective control that is associated with the first action, the computer system detects activation of the first input element; and in response to detecting the activation of the first input element, the computer system performs the first action (e.g., even though the wake screen no longer includes the control that corresponds to the first action, the first input element is still associated with the first action). In some embodiments, the action that is associated with the first input element remains unchanged even when the wake screen changes, for at least a period of time after the wake screen has changed. In some embodiments, the computer system provides a prompt asking the user to confirm whether to match the action of the first input element to the control in the action region of the currently selected wake screen (e.g., after a period of time since the last change of the wake screen). For example, in some embodiments, as described with reference to FIGS. 5CQ-5CR, the wake screen user interface 5454-3 does not include a quick action for dark mode, and the user input 5514 directed to the action button continues to control the dark mode state. Maintaining the control associated with the action button, even while the wake screen user interface and corresponding quick action options change, provides additional control options for the user and reduces a number of inputs required for the user to activate and/or deactivate the control associated with the action button by keeping the control accessible via the action button regardless of a currently selected wake screen user interface.

In some embodiments, at least one of the first control and the second control controls (858) a third-party functionality (e.g., functionality provided via a third-party application installed on the computer system, a functionality that controls an external device that is not part of the computer system). For example, in some embodiments, the action region of the currently selected wake screen (and optionally, the listing of actions associated with the first input element, and/or the control user interface) includes controls for controlling an external device functions, such as a function of a vehicle that is separate from the computer system (e.g., the computer system is a mobile phone, and includes a control for controlling the lock of a vehicle, an air conditioning system of the vehicle, or an engine of the vehicle), a smart home appliance that is separate from the computer system (e.g., the computer system is a mobile phone and includes a control for controlling a thermostat, a light, a garage door, a security camera, a sound system, and/or other devices). In some embodiments, the external device functions can be controlled separately by the operating systems of the external devices, but the control provided on the wake screen, control user interface, and/or via the input element of the computer system also controls those device functions (e.g., through communication between the computer system and the external devices, and corporation between the makers of the computer system and the external devices in designing and implementing the controls and the device functions (e.g., sharing protocols, application user interfaces, and/or standards)). For example, in some embodiments, as described with reference to FIG. 5CP, in some embodiments, the available controls that may be added to the quick action option 5478-4 include one or more third-party controls. Allowing the user to select a control associated with a third-party application as a quick action option to be displayed in the wake screen user interface, provides additional control options for the user and improves the privacy and security of the device by enabling access to limited third-party functionality without requiring the user to unlock the computer system.

In some embodiments, while displaying the first wake screen, including the first control in the action region of the first wake screen, the computer system detects (860) a first movement input that is directed to the first wake screen (e.g., a swipe input by a contact on the first wake screen (e.g., in a portion that is not a notification), a pinch and drag air gesture that is detected when the gaze is directed to the first wake screen (e.g., in a portion that is not a notification)); and in response to detecting the first movement input that is directed to the first wake screen, in accordance with a determination that the first movement input is in a first direction (e.g., leftward direction, rightward direction, upward direction, downward direction, or another direction relative to the first wake screen), the computer system displays a camera user interface, including a field of view of one or more cameras and one or more controls for media capture using the one or more cameras. In some embodiments, while displaying the second wake screen, including the second control in the action region of the first wake screen, the computer system detects a second movement input that is directed to the second wake screen (e.g., a swipe input by a contact on the second wake screen (e.g., in a portion that is not a notification), a pinch and drag air gesture that is detected when the gaze is directed to the second wake screen (e.g., in a portion that is not a notification)); and in response to detecting the second movement input that is directed to the second wake screen, in accordance with a determination that the second movement input is in the first direction (e.g., leftward direction, rightward direction, upward direction, downward direction, or another direction relative to the first wake screen), the computer system displays the camera user interface, including the field of view of one or more cameras and the one or more controls for media capture using the one or more cameras. In some embodiments, irrespective of which wake screen of a plurality of wake screens is the currently selected wake screen and irrespective of which control is included in the action region of the currently selected wake screen, a movement input that is directed to the currently selected wake screen and that is in the first direction relative to the currently selected wake screen causes the computer system to display the camera user interface. In some embodiments, a movement that is directed to the currently selected wake screen user interface and that is in a different direction from the first direction causes the computer system to display another system user interface, such as a home screen user interface (optionally, with an appearance corresponding to the appearance of the currently selected wake screen) if the movement input is in a second direction different from the first direction, or a widget user interface if the movement input is in a third direction different from the first and the second directions. For example, in some embodiments, as described with reference to FIGS. 5CI and 5CK, in response to detecting the user input 5472, the camera user interface 495 is displayed. Similarly, as described with reference to FIGS. 5CV-5CW, in response to detecting the user input 5526, the camera user interface 495 is displayed. Allowing the user to perform a swipe input, from the wake screen user interface, that causes the computer system to display a camera preview user interface, regardless of the quick actions that are included in the wake screen user interface, reduces the number of inputs needed to access the camera preview and improves the privacy and security of the device by enabling access to limited camera functionality without requiring the user to unlock the computer system.

In some embodiments, in response to detecting the first movement input that is directed to the first wake screen, in accordance with a determination that the first movement input is in a second direction different from the first direction (e.g., leftward direction, rightward direction, upward direction, downward direction, or another direction relative to the first wake screen), the computer system displays (862) a first system user interface of the computer system (e.g., home screen user interface, a notification user interface, or a widget user interface); and in response to detecting the second movement input that is directed to the second wake screen, in accordance with a determination that the second movement input is in the second direction, the computer system displays the first system user interface of the computer system. For example, in some embodiments, as described with reference to FIGS. 5CI-5CK, in response to detecting the user input 5474, the user interface 491 is displayed and in response to detecting the user input 5472, the camera user interface 495 is displayed. Similarly, as described with reference to FIGS. 5CV and 5CX, in response to detecting the user input 5524, the user interface 491 is displayed. Allowing the user to perform a swipe input, from the wake screen user interface, that causes the computer system to display a system user interface, regardless of the quick actions that are included in the wake screen user interface, reduces the number of inputs needed to access the system user interface and improves the privacy and security of the device by enabling access to limited functionality available via the system user interface without requiring the user to unlock the computer system.

It should be understood that the particular order in which the operations in FIGS. 8A-8H have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600, 700 and 900) are also applicable in an analogous manner to method 800 described above with respect to FIGS. 8A-8H. For example, the controls, user interfaces, and user inputs described above with reference to method 800 optionally have one or more of the characteristics of the controls, user interfaces, and user inputs described herein with reference to other methods described herein (e.g., methods 600, 700 and 900). For brevity, these details are not repeated here.

FIGS. 9A-9J are flow diagrams illustrating method 900 of resizing controls in an editing control user interface in accordance with some embodiments. Method 900 is performed at an electronic device or computer system (e.g., device 300, FIG. 3A, or portable multifunction device 100, FIG. 1A) that is in communication with one or more display generation components (e.g., touch-screen displays, standalone displays, head-mounted displays, projectors, and/or other types of display devices), and one or more input devices (e.g., sensors and devices for detecting user inputs, such as touch-sensitive surfaces, touch screen displays, cameras, motion sensors, controllers, joysticks, and/or other sensors and/or input devices). In some embodiments, the display generation component is a touch-screen display, and the touch-sensitive surface is on or integrated with the display. In some embodiments, the display is separate from the touch-sensitive surface. Some operations in method 900 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Method 900 provides a method for configuring a control in a control user interface. In some embodiments, the control is displayed with a first size, and in response to detecting a user input, such as a drag user input, corresponding to a request to resize the control, the control is displayed with a second size. Enabling the user to resize a control in a control user interface by dragging on the control, provides additional options for the user to customize the control user interface by updating the size of the control without requiring the user to navigate through complex menu hierarchies, thereby reducing the number of inputs needed for the user to resize the control that is displayed in the control user interface.

The computer system displays (902), via the one or more display generation components, a control user interface (e.g., in a reconfiguration mode of the control user interface or while the control user interface is in another mode of operation (e.g., normal operation, or initial configuration)), wherein the control user interface includes a plurality of controls (e.g., controls for adjusting values or settings of parameters corresponding to the respective control functions of the controls) corresponding to a plurality of control functions of the computer system (e.g., controls for controlling one or more device functions, such as network connections, notification delivery modes, flashlight, display brightness, volume, a smart home appliance, a vehicle, and/or other device functions that can be controlled by the computer system) and wherein one or more configuration options of a respective control of the plurality of controls (e.g., a position, a size, corresponding parameters a control function, and/or a corresponding control function of the respective control, as opposed to the current values of the parameters of the control function corresponding to the respective control (e.g., the current values are adjustable in the regular mode of the control user interface, and not adjustable in the reconfiguration mode)) are adjustable in accordance with user inputs (e.g., the one or more configuration options are displayed and/or are adjustable while the control user interface is displayed in the reconfiguration mode, and/or in the initial configuration of the control user interface). For example, in some embodiments, as described with reference to FIGS. 5AD, the editing control user interface 5210-1′ enables the user to modify the control user interface 5002, including adding, removing, rearranging, resizing, and/or otherwise modifying the control user interface 5002.

While displaying the control user interface (e.g., in the reconfiguration mode of the control user interface and/or in the initial configuration of the control user interface), the computer system detects (904), via the one or more input devices, a first user input that is directed to a first control of the plurality of controls in the first control user interface. In some embodiments, the user inputs that are directed to the respective control are directed to an interior portion of the respective control, a corner or edge of the respective control, and/or a resize affordance that is associated with the respective control (e.g., an affordance displayed on or adjacent to a corner or edge of the respective control) in the control user interface. In some embodiments, a user input that is directed to a respective control (e.g., a portion of the respective control or an affordance associated with the respective control) includes a touch-hold input optionally followed by a drag input on a portion of the control or the resize affordance associated with the control, a pinch gesture optionally followed by a drag gesture where the pinch gesture is detected when a gaze is directed to a portion of the control or the resize affordance associated with the control, a click-hold input by a mouse optionally followed by a drag input where the click-hold input is detected when a focus selector is on a portion of the control or the resize affordance associated with the control, or another type of selection input or enhanced selection input, optionally followed by a movement input, where the selection input or enhanced selection input is detected when a target location of the input corresponds to a location of a portion of the control or the resize affordance associated with the control in the control user interface. For example, in some embodiments, as described with reference to FIG. 5AI, the device 100 detects the user input 5240 directed to the representation of control 5034′ in the editing control user interface 5210-1; as described with reference to FIG. 5AH, the device 100 detects one or more user inputs directed to various controls in the editing control user interface 510-1.

In response to detecting the first user input that is directed to the first control (906), the computer system: in accordance with a determination that the first user input meets resize criteria, wherein the resize criteria require that the first user input is directed to the first control (e.g., a first portion of the first control such as an edge of the first control, a corner of the first control, a resize affordance displayed on or adjacent to an edge or corner of the first control) and includes more than a first threshold amount of movement (e.g., a movement relative to a center of the first control by a non-negligible amount and/or an amount that is sufficient to indicate an intent to resize the first control (e.g., while the first control is kept substantially stationary in the control user interface, as opposed to being moved as a whole in the control user interface)) in order for the first user input to meet the resize criteria with respect to the first control, displays (908), via the one or more display generation components, the first control with a second size different from the first size in accordance with the first user input (e.g., changing the size of the first control from the first size to the second size in accordance with the magnitude and/or direction of the movement of the first user input), while maintaining display of the control user interface (e.g., while maintaining display of the control user interface in the reconfiguration mode and/or in the initial configuration mode) (e.g., resizing occurs in the control user interface while the control user interface is displayed, and the first user input, including the movement of the first user input, is detected entirely while the control user interface is displayed, and without the computer system navigating to a different user interface, such as a settings user interface for the control user interface). For example, in some embodiments, as described with reference to FIG. 5AI, the user input 5240 is a drag input or other selection input of the resize affordance that causes the device 100 to increase a size of the representation of screen recording control 5034′ to the representation of screen recording control 5034″, as illustrated in FIG. 5AJ.

In response to detecting the first user input that is directed to the first control (906), the computer system: in accordance with a determination that the first user input does not meet the resize criteria (e.g., the first user input is directed to a second portion of the first control that is different from the first portion of the first control (e.g., the second portion of the first control is an interior portion of the first control away from the edge or corner of the first control) and/or the second user input includes less than the threshold amount of movement (e.g., the second user input is substantially stationary relative to the first control)), maintains display (910), via the one or more display generation components, of the first control with the first size (e.g., forgoes displaying the first control at the second size in the control user interface). In some embodiments, the first user input includes a movement input, but the starting location of the first user input is not directed to the first portion of the first control, so the first user input does not meet the resize criteria, and the computer system ignores the first user input if the first user input does not meet the criteria for triggering other operations. In some embodiments, the first user input meets the criteria for performing another operation with respect to the first control or the control user interface as a whole, and the computer system performs the operation, accordingly, depending on the criteria that are met by the first user input. In some embodiments, in response to detecting the first user input, in accordance with a determination that the first user input meets scroll criteria (e.g., the first user input includes more than the threshold amount of movement and is directed to an interior portion of the first control and not on an edge, corner, or resize affordance of the first control), the computer system scrolls the control user interface to display additional controls that were not visible in the control user interface prior to the first user input. In some embodiments, in response to detecting the first user input, in accordance with a determination that the first user input meets option display criteria (e.g., the first user input includes less than a threshold amount of movement and is maintained for at least a threshold amount of time, meets a first intensity threshold, or meets another type of input threshold while being directed to the first control), the computer system displays a plurality of configuration options associated with the first control (e.g., in a pop-up menu, and/or on the back of the first control). In some embodiments, in response to detecting the first user input, in accordance with a determination that the first user input meets control move criteria (e.g., the first user input includes a movement input and the start of the first user input is directed to an interior portion of the first control and not on an edge, a corner, or a resize affordance of the first control), the computer system moves the first control from a first position to a second position different from the first position in the control user interface. In some embodiments, in response to detecting the first user input, in accordance with a determination that the first user input meets removal criteria (e.g., the first user input is a selection input directed to a removal affordance displayed on or adjacent to the first control), the computer system removes the first control from the control user interface. For example, in some embodiments, as described with reference to FIG. 5AH, the user input 5227 is a drag movement (e.g., that is not directed to the resize affordance 5220) that does not change a size of the silence control 5228.

In some embodiments, the plurality of controls in the control user interface include (912) a first subset of one or more controls (e.g., including the first control and, optionally, one or more other controls in the control user interface) that are resizable in accordance with user inputs (and optionally, include a second subset of one or more controls that are not resizable in accordance with user inputs), and displaying the control user interface (e.g., in a reconfiguration mode of the control user interface or while the control user interface is in another mode of operation (e.g., normal operation, or initial configuration)) includes displaying, via the one or more display generation components, a first visual indication that the first subset of one or more controls are resizable controls (and that the second subset of controls, if any, are not resizable). In some embodiments, the first visual indication includes individual visual indications (e.g., respective resize affordances, highlighted outlines, and/or other visual indications) for each control in the first subset of one or more controls, a visual indication (e.g., a color, a highlight, an animated visual effect, and/or another change in visual appearance) that is applied to the first subset of one or more controls and but not applied to other controls that are not resizable controls, or a visual indication (e.g., a color, a highlight, an animated visual effect, and/or another change in visual appearance) that is applied to controls that are not resizable, but is not applied to the first subset of one or more controls. For example, in some embodiments, as described with reference to FIGS. 5AI-5AJ, a resize affordance is displayed for respective controls in the editing control user interface 5210. Enabling the user to change a size of a respective control that is displayed in the control user interface, such that the respective control optionally displays additional information and/or control options for the respective control, provides additional control options for the user thereby providing the user with greater control for customizing the control user interface.

In some embodiments, in response to detecting the first user input that is directed to the first control (914): in accordance with the determination that the first user input meets the resize criteria (e.g., the first user input includes more than the first threshold amount of movement relative to the center of the first control) and that the first user input includes a first movement that has a magnitude that is less than a second threshold amount of movement in a first direction that corresponds to an increasing size of the first control (e.g., the second threshold amount of movement is an amount of movement that resizes the first control to its maximum size, and the first direction corresponds to a direction that points away from the center of the first control)), the computer system displays, via the one or more display generation components, the first control with a size that is selected based on the magnitude of the first movement in the first direction; in accordance with the determination that the first user input meets the resize criteria (e.g., the first user input includes more than the first threshold amount of movement relative to the center of the first control) and that the first user input includes a second movement, different from the first movement, that has a magnitude that is less than the second threshold amount of movement in the first direction, the computer system displays, via the one or more display generation components, the first control with a size that is selected based on the magnitude of the second movement in the first direction, different from the size that is selected based on the magnitude of the first movement in the first direction (e.g., before the first control reaches the maximum size, it can be resized based on a magnitude of the movement of the first user input); and in accordance with the determination that the first user input meets the resize criteria (e.g., the first user input includes more than the first threshold amount of movement relative to the center of the first control) and that the first user input includes a third movement, different from the first movement and the second movement, that has a magnitude that is greater than the second threshold amount of movement in the first direction, the computer system displays, via the one or more display generation components, the first control with a maximum size of the first control (e.g., irrespective of an amount that a magnitude of the third movement exceeds the second threshold amount of movement in the first direction). For example, in some embodiments, as described with reference to FIG. 5AI, controls have a maximum size, for example, control 5034′ has a maximum size (e.g., to fill a 2×2 grid space, a 3×2 grid space, a 3×3 grid space, or another size). Enabling the user to change a size of a respective control that is displayed in the control user interface up to a maximum size, such that the respective control optionally displays additional information and/or control options for the respective control, provides additional control options for the user while preventing the user from increasing the size of the control beyond the maximum size to avoid overtaking the user interface, which further prevents problems with rendering display of a control that is too large.

In some embodiments, in response to detecting the first user input that is directed to the first control (916): in accordance with the determination that the first user input meets the resize criteria (e.g., the first user input includes more than the first threshold amount of movement relative to the center of the first control) and that the first user input includes a fourth movement that is less than a third threshold amount of movement in a second direction that corresponds to a decreasing size of the first control (e.g., the third threshold amount of movement is an amount of movement that resizes the first control to its minimum size, and the second direction corresponds to a direction that points toward the center of the first control), the computer system displays, via the one or more display generation components, the first control with a size that is selected based on a magnitude of the fourth movement in the second direction; in accordance with the determination that the first user input meets the resize criteria (e.g., the first user input includes more than the first threshold amount of movement relative to the center of the first control) and that the first user input includes a fifth movement, different from the fourth movement, that has a magnitude that is less than the third threshold amount of movement in the second direction, the computer system displays, via the one or more display generation components, the first control with a size that is selected based on the magnitude of the fifth movement in the second direction, different from the size that is selected based on the magnitude of the fourth movement in the second direction (e.g., before the first control reaches the minimum size, it can be resized based on a magnitude of the movement of the first user input); and in accordance with the determination that the first user input meets the resize criteria (e.g., the first user input includes more than the first threshold amount of movement relative to the center of the first control) and that the first user input includes a sixth movement, different from the fourth movement and the fifth movement, that has a magnitude that is greater than the third threshold amount of movement in the second direction, the computer system displays, via the one or more display generation components, the first control with a minimum size of the first control (e.g., irrespective of an amount that a magnitude of the sixth movement exceeds the third threshold amount of movement in the second direction). For example, in some embodiments, as described with reference to FIG. 5AI, controls have a minimum size, for example, a minimum size to fill a 1×1 grid space, a 1×2 grid space, or another size. Enabling the user to change a size of a respective control that is displayed in the control user interface down to a minimum size, without changing the size of the control to be smaller than the minimum size, provides additional control options for the user while preventing the user from decreasing the size of the control beyond the minimum size, thereby improving the efficiency of interacting with the control which would be difficult for a user to view and/or interact with at a size smaller than the minimum size.

In some embodiments, the plurality of controls in the control user interface include (918) a second subset of one or more controls, including a second control with a third size, that are not resizable in accordance with user inputs (e.g., the fixed-size controls are visually distinguished from the first subset of controls that are resizable controls (e.g., displayed without the resize affordance and/or other visual indications that are displayed with respect to the first subset of controls)). In some embodiments, while displaying the control user interface (e.g., in the reconfiguration mode of the control user interface and/or in the initial configuration of the control user interface), the computer system detects, via the one or more input devices, a second user input that is directed to the second control in the first control user interface; and in response to detecting the second user input that is directed to the second control, the computer system: in accordance with a determination that the second user input includes more than the first threshold amount of movement (e.g., a movement relative to a center of the second control by a non-negligible amount and/or an amount that is sufficient to indicate an intent to resize the second control (e.g., while the second control is kept substantially stationary in the control user interface, as opposed to being moved as a whole in the control user interface)), maintains displaying, via the one or more display generation components, of the second control with the third size (e.g., the size of the second control is not changed by the second user input even though it includes more than the first threshold amount of movement). In some embodiments, the second user input meets the criteria for performing another operation with respect to the second control or the control user interface as a whole, and the computer system performs the operation, accordingly, depending on the criteria that are met by the second user input. In some embodiments, in response to detecting the second user input, in accordance with a determination that the second user input meets scroll criteria (e.g., the second user input includes more than the threshold amount of movement and is directed to an interior portion of the second control or an edge or corner of the second control), the computer system scrolls the control user interface to display additional controls that were not visible in the control user interface prior to the second user input. In some embodiments, in response to detecting the second user input, in accordance with a determination that the second user input meets option display criteria (e.g., the second user input includes less than a threshold amount of movement and is maintained for at least a threshold amount of time, meets a first intensity threshold, or meets another type of input threshold while being directed to the second control), the computer system displays a plurality of configuration options associated with the second control (e.g., in a pop-up menu, and/or on the back of the second control). In some embodiments, in response to detecting the second user input, in accordance with a determination that the second user input meets control move criteria (e.g., the second user input includes a movement input and the start of the second user input is directed to an interior portion of the second control), the computer system moves the second control from a third position to a fourth position different from the third position in the control user interface. In some embodiments, in response to detecting the second user input, in accordance with a determination that the second user input meets removal criteria (e.g., the first user input is a selection input directed to a removal affordance displayed on or adjacent to the first control), the computer system removes the second control from the control user interface. For example, in some embodiments, as described with reference to FIG. 5BA, the control 5320 cannot be resized and thus is not displayed with a resize affordance in the editing control user interface 5210-2. Providing one or more controls that cannot be resized by the user, even in response to a drag user input, prevents the user from increasing and/or decreasing the size of the control to maintain a readability and/or legibility of the one or more controls that are not designed to be displayed with a different size.

In some embodiments, displaying the first control with the second control includes (920): in accordance with a determination that the second size is greater than the first size (e.g., in width and/or in height) (e.g., the size of the first control is increased by the first user input), displaying first additional information related to the first control (e.g., additional information related to the value(s) of the parameter(s) adjustable by the first control, additional control functions that are controlled by the first control, additional controls related to the control function of the first control) in the first control with the second size, wherein the first additional information was not displayed in the first control with the first size (e.g., enlarging the size of the first control causes the first control to display additional status information). For example, in some embodiments, as described with reference to FIG. 5AI, the representation of screen recording control 5034″ (e.g., displayed with an increased size) includes additional information and/or additional control options than the representation of screen recording control 5034′. Enabling the user to change a size of a respective control that is displayed in the control user interface to a larger size that displays additional status information and/or control options for the respective control, provides additional control options for the user thereby providing the user with greater control for customizing the control user interface.

In some embodiments, displaying the first control with the second control includes (922): in accordance with a determination that the second size is smaller than the first size (e.g., in width and/or in height) (e.g., the size of the first control is decreased by the first user input), forgoing displaying first existing information of the first control (e.g., additional information related to the value(s) of the parameter(s) adjustable by the first control, additional control functions that are controlled by the first control, additional controls related to the control function of the first control) in the first control with the second size, wherein the first existing information of the first control was displayed in the first control with the first size (e.g., reducing the size of the first control causes the first control to display less status information). For example, in some embodiments, in response to detecting a user input to decrease a size of the representation of screen recording control 5034″ (e.g., back to the size of the representation of screen recording control 5034′), the representation of screen recording control 5034′ includes less status information than the representation of screen recording control 5034″. Enabling the user to change a size of a respective control that is displayed in the control user interface to a smaller size that displays less information for the respective control provides additional control options for the user, thereby providing the user with greater control for customizing the control user interface, and allows the user to add a greater number of controls within the display area by decreasing the size of the individual controls.

In some embodiments, in accordance with a determination that the control user interface is displayed in a mode in which one or more configuration options of a respective control of the plurality of controls (e.g., a position, a size, corresponding parameters a control function, and/or a corresponding control function of the respective control, as opposed to the current values of the parameters of the control function corresponding to the respective control (e.g., the current values are adjustable in the regular mode of the control user interface, and not adjustable in the reconfiguration mode)) are adjustable in accordance with user inputs (e.g., the one or more configuration options are displayed and/or are adjustable while the control user interface is displayed in the reconfiguration mode, and/or in the initial configuration of the control user interface), the computer system generates (923) a new page for accommodating controls (e.g., a new blank page, as indicated by an added page indicator among a plurality of page indicators for existing pages of the control user interface, optionally, in a position immediately after the currently displayed page of the control user interface) in the control user interface. In some embodiments, the new page and the new page indicator are added to the control user interface in response to detecting a user input editing a control (e.g., resizing the control, displaying additional configuration options of the control, moving the control, or otherwise changing one or more configurations of the control) in the control user interface. In some embodiments, the new page and the new page indicator are added when the control user interface enters the reconfiguration mode from a normal mode, in response to a user input that corresponds to a request to display the control user interface in the reconfiguration mode (e.g., a touch-hold input directed to a control for more than a threshold amount of time, a touch-hold input directed to the control user interface for more than a threshold amount of time, a touch-hold input directed to a control followed by a drag input, or selection of a menu option that corresponds to activation of the reconfiguration mode, and/or other user inputs, such as air gestures, inputs made through a pointing device or other input types devices, that correspond to the touch inputs described above). In some embodiments, in accordance with a determination that the new page does not include any controls at the time that the control user interface exits the reconfiguration mode, the computer system removes the new page and its corresponding page indicator from the control user interface. In some embodiments, in accordance with a determination that the currently displayed page of the control user interface changes, the computer system moves the new page to a different position (e.g., to a position immediately after the currently displayed page of the control user interface) in the control user interface. For example, in some embodiments, as described with reference to FIG. 5AD, a placeholder pagination indication 530-7 is displayed in the editing control user interface 5210-1 to indicate that an additional page is available. Automatically adding a blank page to the control user interface while editing the control user interface, such that additional controls are reflowed onto the blank page, enables the user to add controls to the blank page and reduces the number of inputs required to add additional controls without requiring the user to manually create a new blank page for the control user interface.

In some embodiments, while displaying the control user interface in the mode in which one or more configuration options of a respective control of the plurality of controls are adjustable in accordance with user inputs, the computer system detects (924), via the one or more input devices, an editing input that changes content of the currently displayed page of the control user interface (e.g., the first user input that increases the size of the first control, or another user input that resizes a control in the currently displayed page of the control user interface or adds one or more controls to the currently displayed page of the control user interface); and in response to detecting the editing input that changes content of the currently displayed page of the control user interface, in accordance with a determination that the currently displayed page of the control user interface does not have sufficient room to accommodate all controls in the currently displayed page of the control user interface, as a result of the editing input, the computer system relocates one or more controls (e.g., one or more controls at the bottom portion of the currently displayed page) from the currently displayed page of the control user interface to the new page of the control user interface. In some embodiments, controls are reflowed to accommodate new controls added to the currently displayed page of the control user interface, and/or the larger size of a resized control, and when there is no room to accommodate all of the controls in the currently displayed page, the last few controls are pushed off to the next page of the control user interface which is the new page that was added to the control user interface when the editing of the control user interface (e.g., the currently displayed page of the control user interface) was started. In some embodiments, in response to detecting the editing input that changes content of the currently displayed page of the control user interface, in accordance with a determination that the currently displayed page of the control user interface has sufficient room to accommodate all controls in the currently displayed page of the control user interface, as a result of the editing input, the computer system forgoes relocating controls from the currently displayed page of the control user interface to the new page of the control user interface. For example, in some embodiments, as described with reference to FIG. 5AD, in response to the user moving controls and/or adding controls that do not fit within the current page 5210-1, the controls that do not fit are reflowed to an additional page of the control user interface. Automatically reflowing one or more controls from a page that does not have space for the one or more controls to a new page of the control user interface reduces the number of inputs required to rearrange controls and enables the user to add additional controls without requiring the user remove controls from the page.

In some embodiments, generating the new page for accommodating controls (e.g., a new blank page, as indicated by an added page indicator among a plurality of page indicators for existing pages of the control user interface, optionally, in a position immediately after the currently displayed page of the control user interface) in the control user interface includes (926): in accordance with a determination that a currently displayed page of the control user interface is a first page of the control user interface, inserting the new page at a first position in a sequence of pages in the control user interface; and in accordance with a determination that the currently displayed page of the control user interface is a second page, different from the first page, of the control user interface, inserting the new page at a second position, different from the first position, in the sequence of pages in the control user interface (e.g., the new blank page is associated with different locations in the sequence of pages of the control user interface depending on which page is being edited (e.g., the new blank page is inserted after a page that is currently being edited)). For example, in some embodiments, as described with reference to FIG. 5AD, the additional page is inserted after the current page of the control user interface 5210-1. Automatically adding a blank page to the control user interface while editing the control user interface to a respective position within the existing pages that is based on the page that is currently being edited reduces the number of inputs required to find and navigate to the blank page by presenting the blank page in an easily accessible position relative to the page of the control user interface that is currently being edited.

In some embodiments, the control user interface includes (928) a plurality of pages (e.g., a plurality of collections of controls corresponding to different categories of controls and/or different sets of related controls) of the control user interface that are not concurrently displayed when the control user interface is displayed), and a plurality of page indicators corresponding to the plurality of pages (e.g., indications for different collections, categories, and/or different sets of controls), the plurality of page indicators indicating a sequential order of the plurality of pages in the control user interface; and a new page indicator that corresponds to the new page is added to the plurality of page indicators indicates a position of the new page among the plurality of pages of the control user interface. In some embodiments, the control user interface is arranged into a plurality of pages of controls, and a respective page includes a respective collection or set of controls that are clustered into a single arrangement separate from other collections and/or sets of controls of the control user interface. In some embodiments, when one page of the control user interface is the currently displayed page, other pages of the control user interface are not concurrently displayed (optionally, a hint or edge portion(s) of the adjacent page(s) are concurrently displayed with the currently displayed page). In some embodiments, the computer system chooses which page of the control user interface to display as the currently displayed page, based on the characteristics of the input (e.g., magnitude, distance, and/or speed) that is used to display the control user interface, the page indicator or indication that is selected by a user input, a scroll input that reaches beyond the end of the currently displayed page, and/or an editing input that is causing navigation into a destination page (e.g., an input that drags and moves a control from one page to another page). More details of the page indicator and its interaction are provided with respect to FIGS. 5B, 5K-5N, 5AD and accompanying descriptions in method 600 (e.g., operations 626-632). For example, in some embodiments, as described with reference to FIG. 5AD, a placeholder pagination indication 5030-7 is displayed to represent that an additional page is available. Displaying an indication of a newly added blank pages that is available in the control user interface, in addition to displaying indications of each page of the control user interface, provides additional control options for the user and makes it more efficient for the user to view that other pages of controls are available, which further enables the user to easily navigate to a desired page, including the newly added blank page, by selecting a respective indication of the respective page.

In some embodiments, the plurality of controls in the control user interface includes (930) a third control that corresponds to a third page of the control user interface that includes a first collection of controls (e.g., a control that corresponds to the smart home control page, a control that corresponds to the network connection control page, a control that corresponds to the media playback control page, or another control that corresponds to another page of the control user interface). In some embodiments, while displaying the control user interface, including displaying the third control that corresponds to the third page of the control user interface that includes the first collection of controls, the computer system detects, via the one or more input devices, a third user input selecting the third control. In some embodiments, detecting the third user input selecting the third control includes detecting a tap input on the third control, detecting an air tap gesture at the location of the third control, detecting an air pinch gesture while a gaze is directed to the third control, detecting a click input while a focus selector is on the third control, detecting activation of a controller while the third control has input focus, and/or detecting another type of selection input that targets the third control. In some embodiments, in response to detecting the third user input selecting the third control, the computer system replaces display of a currently displayed page of the control user interface that includes the third control, with display of the third page of the control user interface that includes the first collection of controls (e.g., navigating from the currently displayed page that includes the third control to the page of controls corresponding to the third control). In some embodiments, each page of the control user interface has a corresponding indication or page indicator, and the computer system updates the indications or page indicators to indicate that the currently displayed page is the third page, after navigating to the third page of the control user interface in response to the third user input. For example, in some embodiments, as described with reference to FIG. 5B, control user interface 5002 is displayed with 6 page indicators indicating 6 pages of controls are available in the control user interface 5002. Detecting a user input that selects a respective indication of a respective page of controls that is available in the control user interface, and updating the user interface to display the respective page in response to the user input that selects the respective indication, provides additional controls options for a user to navigate between pages of controls, thereby reducing the time and/or number of inputs to switch between pages of controls.

In some embodiments, the plurality of controls in the control user interface includes (932) a fourth control that corresponds to a respective user-selected application (e.g., a control that corresponds to the calculator application, a control that corresponds to a weather application, a control that corresponds to a memo application, or another control that corresponds to another application that is associated with the fourth control by a user). In some embodiments, while displaying the control user interface, including displaying the fourth control that corresponds to the respective user-selected application, the computer system detects, via the one or more input devices, a fourth user input that is directed to the fourth control; and in response to detecting the fourth user input that is directed to the fourth control: in accordance with a determination that the fourth user input meets selection criteria (in some embodiments, the selection criteria are met by a tap input, an air tag gesture, a tap and hold input, or other selection input that is directed to a location that corresponds to the fourth control and/or that a focus selector is on the fourth control while the input is detected) and that the fourth control is associated with a first application according to prior user input, the computer system ceases to display the control user interface, and displays a user interface of the first application (e.g., launching the first user-selected application); and in accordance with a determination that the fourth user input meets selection criteria and that the fourth control is associated with a second application, different from the first application, according to prior user input, the computer system ceases to display the control user interface, and displaying a user interface of the second application (e.g., launching the second user-selected application). In some embodiments, detecting the fourth user input that meets the selection criteria with respect to the fourth control includes detecting a tap input on the fourth control, detecting an air tap gesture at the location of the fourth control, detecting an air pinch gesture while a gaze is on the fourth control, detecting a click input while a focus selector is on the fourth control, detecting activation of a controller while the fourth control has input focus, and/or detecting another type of selection input that targets the fourth control. For example, in some embodiments, as described with reference to FIG. 5BF, the application open control 5288 is associated with application c (“App C”), such that in response to detecting a user input selection the application open control 5288, the device 100 launches, opens or otherwise displays a user interface for a respective application associated with the application open control 5288 (e.g., App C). Displaying an application open control in the control user interface that, when activated, launches an application that is associated with the application open control, provides additional control options for the user and reduces the number of inputs needed to access the application without navigating away from the control user interface.

In some embodiments, the fourth control includes (934) a visual indication (e.g., a graphical symbol, a glyph, a name, or other visual indications) that identifies the respective user-selected application, and displaying the fourth control includes: in accordance with a determination that the fourth control is associated with the first application according to prior user input, displaying, via the one or more display generation components, the fourth control with a first appearance that identifies the first application; and in accordance with a determination that the fourth control is associated with the second application according to prior user input, displaying, via the one or more display generation components, the fourth control with a second appearance, different from the first appearance, that identifies the second application. For example, in some embodiments, the fourth control includes a symbol or graphic that corresponds to (e.g., substantially the same, or the same except for a limited set of aspects, such as color, size, and/or small details) the symbol or graphic used in an application icon of the respective user-selected application (e.g., application icon used on the home screen user interface for the respective user-selected application, an application icon used in a widget of the respective user-selected application that is displayed on the wake screen, the widget screen, and/or the home screen). In some embodiments, the fourth control does not have the same shape as the application icon, but has a shape that corresponds to the shape of other controls in the control user interface (e.g., the application launcher controls in the control user interface are circular in shape, and the application icons on the home screen are squarish in shape). For example, in some embodiments, as described with reference to FIG. 5BF, the application open control 5288 includes a glyph, icon, and/or other indication that represents application C. Displaying an application open control in the control user interface with a visual indication of which application is associated with the application open control provides additional information to the user about which application is associated with the application open control without requiring the user to provide additional inputs to request the information about which application is associated with the application open control.

In some embodiments, in response to detecting the fourth user input that is directed to the fourth control, in accordance with a determination that the fourth user input meets alternative selection criteria that are different from the selection criteria, the computer system displays (936) (e.g., in a menu or platter displayed adjacent the fourth control, overlaying a portion of the control user interface (e.g., blurred and/or darked control user interface)) a plurality of selectable options corresponding to a plurality of different applications (e.g., application launcher icons for different applications, such as quick application launching controls included in the wake screen). In some embodiments, detecting the fourth user input that meets the enhanced selection criteria with respect to the fourth control includes detecting a tap-hold input on the fourth control that meets a first input threshold (e.g., a duration and/or intensity threshold), detecting an air tap and hold gesture at the location of the fourth control that meets a first input threshold (e.g., a duration threshold), detecting an air pinch and hold gesture that meets a first input threshold (e.g., a duration threshold) while a gaze is on the fourth control, detecting a click and hold input that meets a first input threshold (e.g., a duration threshold) while a focus selector is on the fourth control, detecting activation of a controller that meets a first input threshold (e.g., a duration threshold or an intensity threshold) while the fourth control has input focus, and/or detecting another type of enhanced selection input that targets the fourth control. In some embodiments, the enhanced selection input includes detecting an initial portion of an input that meets the selection criteria, except that instead of detecting termination of the input, the computer system detects a subsequent portion of the input that meets the additional requirement of the enhanced selection criteria, such as a requirement for duration, intensity, and/or a movement or repetition of the earlier portion. For example, in some embodiments, as described with reference to FIGS. 5BN-5BO, in response to detecting the user input 5390, a quick options menu 5396 is displayed for application A, as illustrated in FIG. 5BO. Enabling the user to provide an input, such as a long press input, on a control to access one or more quick options related to the control, decreases the likelihood of a user accidentally invoking the quick options while also providing the user with efficient access to the quick options without requiring the user to open an application to view and/or interact with the quick options, thereby reducing an amount of time and number of user inputs required to access the quick options.

In some embodiments, while displaying the plurality of selectable options corresponding to the different applications, the computer system detects (938), via the one or more input devices, selection of a first selectable option of the plurality of selectable options (e.g., detects a user input that meets the selection criteria with respect to the first selectable option, such as a tap input on the first selectable option, an air tap at the location of the first selectable option, an air pinch with a gaze directed to the first selectable option, a click input detected when a focus selector is on the first selectable option, an activation of a control when the first selectable option has input focus, or another type of selection input that targets the first selectable option); and in response to detecting the selection of the first selectable option, the computer system ceases to display the control user interface, including the plurality of selectable options corresponding to the different applications, and displays a user interface of an application that corresponds to the first selectable option (e.g., launching the application that corresponds to the first selectable option). For example, in some embodiments, as described with reference to FIG. 5BO, in response to a user input directed to the quick options menu 5396, the device 100 optionally launches the application A (e.g., to perform a task using application A). Automatically opening an application associated with a control in response to detecting a user input, such as a tap input, directed to the control displayed in the control user interface, enables the user to access an application without navigating away from the control user interface, thereby reducing an amount of time and number of user inputs required to launch the application.

In some embodiments, while displaying the fourth control in the control user interface, the computer system detects (940), via the one or more input devices, a fifth user input selects the fourth control (e.g., the fifth user input is directed to the fourth control and meets the selection criteria with respect to the fourth control); and in response to detecting the fifth user input that selects the fourth control: in accordance with a determination that the control user interface is in a first mode (e.g., normal mode or a non-editing mode) in which a respective control function of the computer system is accessible through a corresponding control of the respective control function in the control user interface, the computer system initiates a process to perform an operation associated with the respective control function (and, optionally, ceases to display the control user interface and displaying a user interface of the respective user-selected application); and in accordance with a determination that the control user interface is in a second mode (e.g., reconfiguration mode, or editing mode) in which one or more configuration options of a respective control are adjustable in accordance with user inputs, the computer system initiates a process for changing the respective user-selected application corresponding to the fourth control from a currently selected application to a new application different from the currently selected application (from the first application to the second application, or from the second application to the first application, or switching between another pair of applications that can be associated with the fourth control), without ceasing to display the control user interface (and without launching either the currently selected application or the new application). In some embodiments, additional selection inputs directed to the fourth control causes the computer system to continue to switch the respective application that corresponds to the fourth control to another new application (e.g., selecting the next application in a listing of available applications as the respective user-selected application corresponding to the fourth control). In some embodiments, as the respective user-selected application for the fourth control changes from one application to another application, the appearance of the fourth control (e.g., the graphics and/or symbol on the fourth control) also updates to reflect the identity of the application that is now associated with the fourth control. For example, in some embodiments, as described with reference to FIGS. 5BF-5BG, in response to detecting a user input 5362 (e.g., a tap input, a long press input, or other selection input) selecting application open control 5288, the device 100 displays a menu 5366 for assigning a different application (e.g., application a, b or d) to the application open control 5288. Enabling the user to change which application is associated with an application open control, which provides quick actions and/or launches the application associated with the control, while editing the control user interface, provides the user with additional options to customize the control user interface and improves the efficiency with which the user accesses the selected application by including the application open control in the control user interface, without requiring the user to provide additional inputs to find and open the application.

In some embodiments, while displaying the control user interface (e.g., in a reconfiguration mode of the control user interface or while the control user interface is in another mode of operation (e.g., normal operation, or initial configuration)), the computer system detects (942), via the one or more input devices, a user input that corresponds to a request to add a control to the control user interface (e.g., detecting selection of the “add” button in the control user interface, and/or detecting selection of a control library affordance in the control user interface); and in response to detecting the user input that corresponds to a request to add a control to the control user interface, the computer system displays a control library user interface, including controls that are available to be added to the control user interface, wherein the controls that are available to be added to the control user interface are arranged (e.g., separated visually and/or spatially by dividers and/or unoccupied space) in a plurality of sections (e.g., sections corresponding to different categories of controls, different types of controls, and/or other divisions and/or groupings of controls). For example, in some embodiments, as described with reference to FIGS. 5AU-5AX, the search user interface 5224 displays a plurality of available controls within respective categories of controls. Displaying a set of available controls that can be added to the control user interface according to different categories of controls, makes it easier for the user to navigate through the set of available controls, thereby reducing a number of inputs required for the user to browse and/or find different control options.

In some embodiments, the plurality of sections include (944) a first section corresponding to a first device function of the computer system (e.g., camera, microphone, speaker, location services, tactile output generators, and/or another device function that utilizes a peripheral device and/or hardware component of the computer system and that is made available to different applications through an Application Programming Interface (API)), and the first section of the control library user interface includes representations of a plurality of different applications that have access to (e.g., through an API provided by the computer system for the first device function) the first device function (e.g., the representations of the applications are controls for launching the respective applications, and/or controls for displaying status information on the use of the first device function by the respective applications). For example, in some embodiments, the plurality of sections in the application library user interface includes a camera section that includes representations of different applications that have access to the camera function of the computer system, and the representations of the different applications can be used as controls to display user interfaces of the different applications that control the camera function, and/or status information regarding how the camera function has been and/or is being used by the different applications. Similarly, in some embodiments, the plurality of sections in the application library user interface includes a location services section that includes representations of different applications that have access to the location services function of the computer system, and the representations of the different applications can be used as controls to display user interfaces of the different applications that have used or is using the location services of the computer system, and/or status information regarding how the location services function has been and/or is being used by the different applications. For example, in some embodiments, as described with reference to FIG. 5AV, in the “Camera” category of the search user interface 5224, one or more controls, optionally associated with one or more third-party applications that access the camera of the device 100, are provided. Providing a library of controls that includes displaying controls according to various categories, including a category for applications that access one or more cameras of the computer system, improves the user's access to controls in the library of controls and reduces the amount of time and number of user inputs required to navigate the library of controls.

In some embodiments, the plurality of sections include (946) a second section corresponding to applications installed on the computer system (e.g., the first application, the second application, other applications that provide controls that can be included in the control user interface), and the second section of the control library user interface includes representations of a plurality of applications (e.g., application names, application icons, symbols and/or graphics identifying the applications, section heading with the names and/or icons of the applications) that provide controls that are available to be included in the control user interface (optionally, a representation of a respective application is displayed concurrently with a corresponding set of controls that are available to be included in the control user interface). For example, in some embodiments, the plurality of sections in the application library user interface includes an application section that includes representations of different applications that provide controls that can be included in the control user interface, where the controls provided by the applications are grouped by application in the application section. For example, in some embodiments, in the application section, two controls are listed under a first application, and three controls are listed under a second application, while one control is listed under a third application. In some embodiments, the controls provided by a respective application corresponds to different control functions of the computer system that is accessible by the respective application, and activation of a respective control provides access to the control function corresponding to the respective control through the respective application. In some embodiments, the controls provided by a respective application corresponds to different functions provided by the respective application, and activation of a respective control provides access to a respective function of the respective application. For example, in some embodiments, as described with reference to FIG. 5AW, the Apps category of the search user interface 5224 displays indications of applications of device 100, including one or more third-party applications. Providing a library of controls that includes a section for one or more controls associated with a respective application that are grouped and/or organized according to the different applications, enables the user to quickly and efficiently navigate the library of controls by viewing the controls for a respective application, thereby reducing the amount of time and number of user inputs required to navigate the library of controls.

In some embodiments, displaying the control library user interface, including displaying a respective section of the plurality of sections (e.g., only some sections of the control library user interface are visible at a given time, and additional sections are moved into view when the user scrolls the control library user interface with one or more scroll inputs), includes (948): in accordance with a determination that the respective section of the plurality of sections include a first number of controls that is less than a threshold number of controls, concurrently displaying the first number of controls in the respective section of the plurality of sections; and in accordance with a determination that the respective section of the plurality of sections include a second number of controls that is greater than the threshold number of controls, concurrently displaying a subset, less than all, of the second number of controls, and a first affordance for displaying one or more additional controls (e.g., an expansion affordance), in the respective section of the plurality of sections. In some embodiments, the threshold number of controls is a number that is selected by the computer system for the respective section, based on the sizes and/or numbers of the controls in the respective section. In some embodiments, the threshold number of controls is the same number for all sections of the plurality of sections. In some embodiments, while concurrently displaying the subset, less than all, of the second number of controls, and the first affordance, in the respective section of the plurality of sections, the computer system detects a user input selecting the first affordance; and in response to detecting the user input selecting the first affordance, the computer system displays additional controls in the respective section (e.g., expanding the area occupied by the respective section, and optionally, enabling scrolling of the controls in the respective section if all controls from the respective section cannot be concurrently displayed). For example, in some embodiments, as described with reference to FIG. 5AX, in response to detecting the user input 5316 (e.g., directed to an affordance for displaying one or more additional controls), additional controls (e.g., 7 additional controls) under the home category are displayed. Displaying a control option that, when selected, enables the user to view additional controls within a category of controls, when there are more than a threshold number of controls within the category without displaying the control option when there are fewer than the threshold number of controls within the category, provides the user with access to additional control options without cluttering the user interface unnecessarily when additional controls are unavailable.

In some embodiments, the computer system displays (950) a search interface (e.g., a search input area for entering search keywords, and/or a search input interface enabling a search to be performed using voice input) in the application library user interface; while displaying the search interface in the application library user interface, the computer system detects, via the one or more input devices, a first search input (e.g., search keywords, and/or other search criteria) through the search interface; and in response to detecting the first search input, the computer system displays a plurality of search results that correspond to the first search input, the plurality of search results including a plurality of controls that correspond to the first search input (e.g., individual controls, group representations for groups of controls, pages of controls, and/or sections of controls, that correspond to the first search input (e.g., having functions, descriptions, names, and/or constituent controls, matching the search keywords in the first search input)). For example, in some embodiments, as described with reference to FIGS. 5AE and 5AG, the controls search user interface 5224 includes a search bar 5222 and in response to the user search “dark mode” in the search bar 5222, the device 100 displays search results that match the user search. Enabling a user to provide a search input to search for controls and/or categories of controls that are presented in a library of controls reduces the amount of time and number of user inputs required to navigate through the library of controls to locate a desired control.

In some embodiments, the plurality of search results that correspond to the first search input include (952) a search result that corresponds to one or more controls that adjust one or more control functions of the computer system and a name of the one or more controls corresponds to the search query. For example, in some embodiments, as described with reference to FIG. 5AG, in response to the user search “dark mode” in the search bar 5222, the device 100 displays the dark mode control 5234. Enabling a user to provide a search input to search for controls that are presented in a library of controls reduces the amount of time and number of user inputs required to navigate through the library of controls to locate a desired control.

In some embodiments, the plurality of search results that correspond to the first search input include (954) a search result that corresponds to one or more sections, wherein a respective section of the one or more sections includes a respective collection of controls and a name of the section corresponds to the search query. For example, in some embodiments, as described with reference to FIGS. 5AE-5AG, in some embodiments, in response to a user search of “home,” (e.g., corresponding to a section) the device 100 displays a category of home controls and/or one or more controls that are associated with the search term “home.” Enabling a user to provide a search input to search for categories of controls that are presented in a library of controls reduces the amount of time and number of user inputs required to navigate through the library of controls to locate a desired control associated with a category identified by the search input.

In some embodiments, while displaying the control library user interface, including the controls that are available to be added to the control user interface, the computer system detects (956), via the one or more input devices, a user input selecting a first available control (e.g., an individual control, a group representation of a group of related controls, a page of controls, an application launcher control, or other types of controls) in the control library user interface (e.g., detecting the user input includes detecting a tap input on the first available control, an air tap gesture at the location of the first available control, an air pinch gesture detected while a gaze is on the first available control, a click input detected when a focus selector is on the first available control, an activation of a controller detected when the first available control has input focus, or another type of selection input that targets the first available control); and in response to detecting the user input selecting the first available control from the control library user interface, the computer system adds the first available control to the control user interface (e.g., adds the first available control to the page of the control user interface from which the control library user interface was launched, adds the first available control to a new page of the control user interface, adds the first available control to an available position in the control user interface, or adds the first available control to another location in the control user interface). For example, in some embodiments, as described with reference to FIGS. 5AE-5AG, the user selects the silence control 5228 in the search user interface 5224, and in response to the user selection, the selected silence control 5228 is added to the editing control user interface 5210-1. Enabling a user to add a control, selected from a library of controls, to be included in the control user interface, provides the user with additional options to customize the control user interface by selecting and adding desired controls that are available in the library of controls.

In some embodiments, adding the first available control to the control user interface includes (958) adding the first available control to an unoccupied location (e.g., a first unoccupied location that can accommodate the size of the first available control, a first unoccupied location (e.g., controls located after the unoccupied location can be pushed further down, to the next page, or to a new page) in the control user interface (e.g., in the page from which the control library user interface was launched (e.g., by the selection of the add control affordance), or any page of the control user interface). For example, in some embodiments, as described with reference to FIGS. 5AE-5AF, the added silence control 5228 is positioned at a first available slot (e.g., from top-to-bottom, left-to-right and/or another order of availability, as indicated by indications 5216) in the editing control user interface 5210-1. Automatically placing a control selected from a library of controls in the control user interface at a first available position reduces the time and number of inputs required to add a control to the control user interface, without requiring the user to manually identify and select an available position within the control user interface.

In some embodiments, adding the first available control to the control user interface includes (960) ceasing to display the control library user interface and displaying the first available control in the control user interface (e.g., in a previously unoccupied location in the control user interface, at the top of the last displayed page of the control user interface, in the last unoccupied location in the last displayed page of the control user interface, in the last page of the control user interface, or in a new page of the control user interface). For example, in some embodiments, as described with reference to FIGS. 5AE-5AF, in response to detecting a user input selecting a respective control in the controls search user interface 5224, the device 100 ceases display of the controls search user interface 5224 and redisplays the editing control user interface 5210-1 (e.g., including the selected respective control). Automatically ceasing display of a library of controls in response to detecting user selection of a control from the library of controls reduces the number of inputs required to navigate back to the control user interface after the use has selected the control from the library, without requiring the user to provide additional inputs to dismiss the display of the library of controls.

In some embodiments, while displaying the control library user interface, including the controls that are available to be added to the control user interface, the computer system detects (962), via the one or more input devices, a user input dragging a second available control (e.g., an individual control, a group representation of a group of related controls, a page of controls, an application launcher control, or other types of controls) in the control user interface relative to the control library user interface (e.g., detecting the user input includes detecting a tap-hold input on the second available control followed by a drag input with the same contact, an air tap and hold gesture at the location of the second available control followed by a drag input with the same hand, an air pinch gesture detected while a gaze is on the second available control followed by a drag input of the same hand while maintaining the pinch posture of the hand, a click and hold input detected when a focus selector is on the second available control followed by a drag input while maintaining the click and hold input, an activation of a controller detected when the second available control has input focus followed by a movement input of the controller, or another type of selection input that targets the second available control followed by a movement input that is a continuation of the selection input before detecting termination of the selection input); and in response to detecting the user input dragging the second available control relative to the control library user interface, the computer system: ceases to display the control library user interface; and displays, via the one or more display generation components, the control user interface. In some embodiments, while displaying the control user interface, the computer system detects via the one or more input devices, a termination of the user input dragging the second available control; and in response to detecting a termination of the user input dragging the second available control while the control user interface is displayed: in accordance with a determination that a termination location of the user input dragging the second available control corresponds to a first location in the control user interface, the computer system adds he second available control to the first location in the control user interface; and in accordance with a determination that the termination location of the user input dragging the second available control corresponds to a second location, different from the first location, in the control user interface, the computer system adds the second available control to the second location in the control user interface. For example, in some embodiments, as described with reference to FIG. 5AG, in response to detecting that the user input 5236-1 (e.g., in FIG. 5AG) is a drag user input, the device 100 ceases display of the controls search user interface 5224 and displays the editing control user interface 5210-1 to allow the user input 5236-1 to drag the control 5234 to a respective position in the editing control user interface 5210-1. Updating a position of a control in a control user interface in response to detecting the user dragging the control to the new position provides the user with additional control options for arranging the controls in the control user interface without cluttering the user interface by displaying additional control options and provides an efficient way to view where the control is moved within the control user interface, thereby providing real-time visual feedback to the user.

In some embodiments, displaying the control user interface includes (964): in accordance with a determination that the control user interface is in a mode (e.g., reconfiguration mode, or editing mode) in which one or more configuration options of a respective control are adjustable in accordance with user inputs, displaying, via the one or more display generation components, a visual indication that indicates availability (and respective positions) of one or more unoccupied locations for accommodating new controls in the control user interface; and in accordance with a determination that the control user interface is in a mode (e.g., normal mode) in which a respective control function of the computer system is accessible through a corresponding control of the respective control function in the control user interface, forgoing displaying the visual indication that indicates availability (and respective positions) of one or more unoccupied locations for accommodating new controls in the control user interface (e.g., the unoccupied locations are displayed as unoccupied space without visually outlining or highlighting the occupied locations relative to other unoccupied space that cannot accommodate controls (e.g., the gaps between rows and columns of controls)). For example, in some embodiments, as described with reference to FIG. 5AD, the device 100 displays indications 5216 that identify available positions within the grid layout of the editing control user interface 5210-1 in which controls may be placed. Automatically providing indications of available positions (e.g., in a grid layout) at which controls may be added in the control user interface while the user is editing the control user interface, increases the efficiency of the user editing the control user interface according to a preset layout, thereby reducing the number of inputs required for editing the control user interface without requiring the user to manually identify available positions for the controls.

In some embodiments, while displaying the control user interface in a normal mode of the control user interface, including displaying the plurality of controls overlaying a background of the control user interface, the computer system detects (966), via the one or more input devices, a user input that is directed to an unoccupied portion of the background; and in response to detecting the user input that is directed to an unoccupied portion of the background, in accordance with a determination that the user input meets reconfiguration criteria (e.g., a tap-hold input on the unoccupied portion of the background, a light press input on the unoccupied portion of the background, an air pinch and hold input detected when a gaze is on an unoccupied portion of the background, a click and hold input detected while the focus selector is on an unoccupied portion of the background, or another type of input that is targeting an unoccupied portion of the background and that meets a first input threshold (e.g., a duration threshold, an intensity threshold, or another type of input threshold)), the computer system transitions from displaying the control user interface in the normal mode to displaying, via the one or more display generation components, the control user interface in a reconfiguration mode of the control user interface, wherein one or more configuration options of a respective control of the plurality of controls are adjustable in accordance with user inputs in the reconfiguration mode of the control user interface (e.g., the controls are resizable in accordance with user inputs while the control user interface is continuously displayed in the reconfiguration mode). For example, in some embodiments, as described with reference to FIG. 5AC, in accordance with a determination that the user input 5206 satisfies a first set of criteria, such as maintaining the user input 5206 for at least a threshold amount of time (e.g., a long press, press and hold, or other type of input that satisfies the first set of criteria), the device 100 displays an editing control user interface 5210-1, as illustrated in FIG. 5AD. Enabling the user to provide an input within the control user interface that causes the computer system to display the editing control user interface, without requiring the user to navigate away from the control user interface, enables the user to quickly and efficiently enter an editing mode and reduces a number of inputs required to enter the editing mode.

In some embodiments, while displaying the control user interface in a normal mode of the control user interface, wherein the control user interface in the normal mode includes an affordance (e.g., an “edit” button, “customize” button, or “configure” button) for activating a reconfiguration mode of the control user interface, the computer system detects (968), via the one or more input devices, a user input selecting the affordance for activating the reconfiguration mode of the control user interface (e.g., a tap input on the affordance, an air tap gesture at a location of the affordance, an air pinch gesture detected when a gaze is on the affordance, a click input detected while the focus selector is on the affordance, or another type of selection input that targets the affordance); and in response to detecting the user input selecting the affordance for activating the reconfiguration mode of the control user interface, the computer system transitions from displaying the control user interface in the normal mode to displaying, via the one or more display generation components, the control user interface in the reconfiguration mode, wherein one or more configuration options of a respective control of the plurality of controls are adjustable in accordance with user inputs in the reconfiguration mode of the control user interface (e.g., the controls are resizable in accordance with user inputs while the control user interface is continuously displayed in the reconfiguration mode). Displaying a user-selectable option for displaying an editing control user interface within the control user interface provides additional control options in the control user interface and enables the user to quickly and efficiently enter an editing mode without requiring the user to navigate away from the control user interface, thereby reducing a number of inputs required to enter the editing mode.

In some embodiments, displaying the control user interface in the reconfiguration mode of the control user interface includes (970): animating (e.g., jiggling, pulsating, or otherwise animated in appearance and/or position) a first set of one or more controls (e.g., all the visible controls, or controls that are configurable in one or more aspects) in the plurality of controls, in the control user interface, to indicate that respective configuration options for the first set of one or more controls are adjustable in accordance with user inputs in the reconfiguration mode of the control user interface. In some embodiments, the computer system detects a user input that corresponds to a request to exit the reconfiguration mode and return to the normal mode of the control user interface, and in response, the computer system stops the animation of the first set of controls while maintaining display of the control user interface to indicate that the control user interface is now in the normal mode. For example, in some embodiments, as described with reference to FIGS. 5AC-5AD, in response to detecting a user input 5208 (e.g., in FIG. 5AC), such as a tap input or other selection input, directed to the edit control 5006, the device 100 displays the editing control user interface 5210-1 illustrated in FIG. 5AD. Automatically animating the controls while the controls are configurable in an editing control user interface provides the user with real-time visual feedback that the controls are configurable which increases the efficiency of customizing the control user interface.

In some embodiments, while displaying the control user interface in a reconfiguration mode of the control user interface (e.g., when one or more configuration options of a respective control, including a size of the respective control and optionally other configuration options, are adjustable in accordance with user inputs), the computer system detects (972), via the one or more input devices, a user input that is directed to a fifth control in the control user interface; and in response to detecting the user input that is directed to the fifth control in the control user interface displayed in the reconfiguration mode, in accordance with a determination that the user input that is directed to the fifth control meets selection criteria (e.g., a tap input on the fifth control, an air tap gesture at the location of the fifth control, an air pinch gesture detected when a gaze is on the fifth control, a click input detected when a focus selector is on the fifth control, an activation of a controller when the fifth control has input focus, or another type of selection input targeting the fifth control), the computer system displays, via the one or more display generation components, a plurality of selectable options corresponding to a plurality of configuration options associated with the fifth control. In some embodiments, in response to a user input that is directed to the fifth control when the control user interface is displayed in the normal mode, the computer system, in accordance with a determination that the user input meets the selection criteria, displays status information and/or performing a control function corresponding to the fifth control (e.g., without displaying the plurality of configuration options associated with the fifth control). In some embodiments, in response to detecting a user input directed a respective option of the plurality of selectable options, the computer system updates the fifth controls based on the respective option. For example, the fifth control is updated to have a different size, be associated with a different scene, be associated with a different vehicle and/or home device, and/or is otherwise updated based on the selected respective option of the plurality of selectable options. For example, in some embodiments, as described with reference to FIGS. 5AY-5AZ, in response to detecting a user input 5328 directed to scene control 5326, the device 100 displays a user interface 5333 that includes a plurality of options to change the scene control 5326 from a first scene (e.g., “leave home”) to a different scene (e.g., “arrive home,” “wake up,” or another scene), as illustrated in FIG. 5AZ. In another example, as described with reference to FIG. 5AM, the user configures options for the timer control 5026′ by selecting, via user input 5260 the timer control 5026′, using the platter 5262 that includes options for different configurations of the timer control 5026′. Enabling the user to configure one or more properties of a respective control that is displayed in the control user interface, for example to set one or more default operations and/or to modify operations associated with the respective control, provides additional control options for the user thereby providing the user with greater control for customizing the control user interface.

In some embodiments, while displaying the control user interface, including displaying a respective page of controls that was added to the control user interface in accordance with the prior user input (e.g., by selecting a representation for the respective page of controls in the control library user interface, or dragging and dropping the representation of the respective page of controls from the control library user interface to the control user interface), the computer system detects (974), via the one or more input devices, a drag input directed to the respective page of controls; and in response to detecting the drag input directed to the respective page of controls: in accordance with a determination that the control user interface was in a reconfiguration mode when the drag input was detected, the computer system moves the respective page of controls relative to other pages of the control user interface (e.g., repositions the respective page of controls in the sequence of pages of the control user interface at the termination of the drag input). In some embodiments, in response to detecting the drag input directed to the respective page of controls, in accordance with a determination that the control user interface was in a normal mode when the drag input was detected, the computer system scrolls controls in the respective page of controls and/or scrolls the control user interface (e.g., navigating to the next page of the control user interface), without moving the respective page relative to other pages of the control user interface. For example, in some embodiments, as described with reference to FIGS. 5AQ-5AS, the user reorders the preset page 5270 via user input 5272-1, such as a drag user input that continues as user input 5272-2, to drag the preset page 5270 past the now playing page of the editing control user interface 5210-4. Navigating to a next page of the control user interface while the user is editing the control user interface in response to detecting that a preset page or group of controls is dragged to an edge of the current page, reduces the number of inputs required to change between a current page and a next page of the control user interface and makes the reordering of pages of the control user interface more efficient.

It should be understood that the particular order in which the operations in FIGS. 9A-9J have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600, 700 and 800) are also applicable in an analogous manner to method 900 described above with respect to FIGS. 9A-9J. For example, the controls, user interfaces, and user inputs described above with reference to method 900 optionally have one or more of the characteristics of the controls, user interfaces, and user inputs described herein with reference to other methods described herein (e.g., methods 600, 700 and 800). For brevity, these details are not repeated here.

The operations described above with reference to FIGS. 6A-6J, 7A-7I, 8A-8H and 9A-9J are, optionally, implemented by components depicted in FIGS. 1A-1B. For example, displaying operation 602, detecting operation 714, modifying operation 828, and/or generating operation 923, are optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. M any modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a computer system that is in communication with one or more display generation components and one or more input devices:
displaying, via the one or more display generation components, a first user interface;
while displaying the first user interface, detecting, via the one or more input devices, a first input that includes first movement relative to the first user interface;
in response to detecting the first input, displaying a control user interface, including:
in accordance with a determination that the first movement meets first criteria that correspond to display of a first set of two or more controls that corresponds to a first set of two or more control functions of the computer system, without meeting second criteria that correspond to display of a second set of two or more controls that is different from the first set of two or more controls, wherein the first criteria require that the first movement meets a first input threshold in order for the first criteria to be met by the first movement, displaying, via the one or more display generation components, after detecting an end of the first input, the first set of two or more controls that corresponds to the first set of two or more control functions of the computer system; and
in accordance with a determination that the first movement meets the second criteria, wherein the second criteria require that the first movement meets a second input threshold that is greater than the first input threshold, in order for the second criteria to be met by the first movement, displaying, via the one or more display generation components, after detecting the end of the first input, the second set of two or more controls that corresponds to a second set of two or more control functions of the computer system, wherein the second set of two or more control functions are different from the first set of two or more control functions.

2. The method of claim 1, wherein:
the first criteria require that the first movement includes more than a first threshold amount of movement in a first direction in order for the first movement to meet the first criteria,
the second criteria require that the first movement includes more than a second threshold amount of movement in the first direction in order for the first movement to meet the second criteria, and
the second threshold amount of movement is larger than the first threshold amount of movement.

3. The method of claim 1, wherein the first criteria require that at least a portion of the first movement is made with more than a first threshold speed in order for the first movement to meet the first criteria, and wherein the second criteria require that at least a portion of the first movement is made with more than a second threshold speed greater than the first threshold speed in order for the first movement to meet the second criteria.

4. The method of claim 1, wherein the first set of two or more controls includes fewer controls than the second set of two or more controls.

5. The method of claim 1, wherein the first set of two or more controls are controls selected from a first category of controls, and the second set of two or more controls are controls selected from a second category of controls different from the first category of controls.

6. The method of claim 1, wherein the first set of two or more controls includes one or more controls that are automatically selected by the computer system in accordance with a current context of the computer system, and wherein:
in accordance with a determination that the current context of the computer system meets first contextual conditions, the one or more automatically selected controls include a first control without including a second control; and
in accordance with a determination that the current context of the computer system meets second contextual conditions different from the first contextual conditions, the one or more automatically selected controls include the second control without including the first control.

7. The method of claim 1, including:
while displaying the first set of two or more controls in response to detecting the first input that includes the first movement, detecting, via the one or more input devices, a second input that is directed to the control user interface; and
in response to detecting the second input that is directed to the control user interface:
in accordance with a determination that the second input meets switching criteria, wherein the switching criteria require that the second input does not correspond to a request to activate a respective control in the first set of two or more controls in order for the switching criteria to be met, displaying the second set of two or more controls.

8. The method of claim 7, wherein the second input that meets the switching criteria includes second movement that meets third criteria, wherein the third criteria require that the second movement is along a first edge of the computer system in order for the second movement to meet the third criteria.

9. The method of claim 7, including:
in response to detecting the first input:
in accordance with the determination that the first movement meets the first criteria without meeting the second criteria, displaying, after detecting the end of the first input and concurrently with display of the first set of two or more controls, a first set of indications corresponding to the first set of two or more controls, and one or more additional sets of controls that are available to be displayed, in the control user interface; and
in accordance with the determination that the first movement meets the second criteria, displaying, after detecting the end of the first input and concurrently with display of the second set of two or more controls, a second set of indications corresponding to the second set of two or more controls, and one or more additional sets of controls that are available to be displayed, in the control user interface.

10. The method of claim 9, including:
while displaying, concurrently with display of the first set of two or more controls, the first set of indications corresponding to the first set of two or more controls and the one or more additional sets of controls, in the control user interface, detecting a third input that includes third movement; and
in response to detecting the third input that includes the third movement:
in accordance with a determination that a current portion of the third movement has a location corresponding to a first indication of the first set of indications, displaying a first additional set of controls in the control user interface; and
in accordance with a determination that the current portion of the third movement has a location corresponding to a second indication of the first set of indications different from the first indication, displaying a second additional set of controls, different from the first additional set of controls, in the control user interface.

11. The method of claim 9, including:
while displaying, concurrently with display of the second set of two or more controls, the second set of indications corresponding to the second set of two or more controls and the one or more additional sets of controls, in the control user interface, detecting a fourth input that is directed to a respective location in the control user interface; and
in response to detecting the fourth input that is directed to the respective location in the control user interface:
in accordance with a determination that the respective location corresponds to a third indication of the second set of indications and that the fourth input meets selection criteria, displaying a third additional set of controls in the control user interface; and
in accordance with a determination that the respective location corresponds to a fourth indication of the second set of indications different from the third indication, displaying a fourth additional set of controls, different from the third additional set of controls, in the control user interface.

12. The method of claim 9, wherein the first set of indications includes a first icon corresponding to the first set of two or more controls, and the second set of indications includes a second icon corresponding to the second set of two or more controls, and the method includes:
while displaying the first set of two or more controls or the second set of two or more controls, detecting a fifth input that corresponds to a request to display a third set of controls different from the first set of two or more controls and the second set of two or more controls; and
in response to detecting the fifth input, displaying, in the control user interface, the third set of controls, wherein the third set of controls corresponds to a third set of control functions of the computer system different from the first set of two or more control functions and the second set of two or more control functions of the computer system, and displaying a third icon corresponding to the third set of controls, different from the first icon and the second icon.

13. The method of claim 1, including:
in accordance with a determination that media display criteria are met, displaying, in the control user interface, a set of two or more media controls that corresponds to two or more media playback functions of the computer system;
while displaying the set of two or more media controls that corresponds to the two or more media playback functions of the computer system, detecting a respective user input that includes movement in a respective direction that is different from a direction of the first movement of the first input; and
in response to detecting the respective user input, switching from controlling a first set of one or more output devices for media playback using the set of two or more media controls to controlling a second media set of one or more playback device different from the first set of one or more output devices for media playback.

14. The method of claim 13, including:
in response to detecting the respective user input, switching from displaying a current status of a first output device for media playback to displaying a current status of a second output device for media playback.

15. The method of claim 1, including:
in accordance with a determination that media display criteria are met, displaying, in the control user interface, representations of a plurality of output devices for media playback, including concurrently displaying:
a first set of two or more media controls that corresponds to two or more media playback functions of a first set of one or more output devices for media playback of the plurality of sets of output devices for media playback, and
a selectable option for switching to displaying a second set of two or more media controls that corresponds to a second set of one or more output devices for media playback of the plurality of sets of output devices for media playback;
while displaying the first set of two or more media controls that corresponds to the first set of one or more output devices for media playback, detecting, via the one or more input devices, an input corresponding to selection of the selectable option for switching to displaying the second set of two or more media controls; and
in response to detecting the input corresponding to the selection of the selectable option for switching to displaying the second set of two or more media controls, displaying the second set of two or more media controls that corresponds to two or more media playback functions of the second set of one or more output devices for media playback.

16. The method of claim 1, including:
in accordance with a determination that smart-home display criteria are met, displaying, in the control user interface, a set of two or more home controls, including at least a first subset of home controls that corresponds to two or more home control profiles of the computer system and a second subset of home controls that correspond to two or more home control locations associated with the computer system.

17. The method of claim 1, including:
while the control user interface is not displayed, detecting a first event; and
in response to detecting the first event, in accordance with a determination that control display criteria are met as a result of the first event, displaying the control user interface including a respective set of two or more controls that correspond to a respective set of two or more control functions of the computer system, wherein displaying the control user interface in response to detecting the first event includes:
in accordance with a determination that a third set of contextual conditions are met, displaying the control user interface with a first layout; and
in accordance with a determination that a fourth set of contextual conditions, different from the third set of contextual conditions, are met, displaying the control user interface with a second layout different from the first layout, wherein the first layout and the second layout are different in at least one of spatial arrangement of controls and included collections of controls in the control user interface.

18. The method of claim 17, wherein:
displaying the control user interface with the first layout includes displaying a first control at a first location in the control user interface, and
displaying the control user interface with the second layout includes displaying the first control at a second location, different from the first location, in the control user interface.

19. The method of claim 17, wherein:
displaying the control user interface with the first layout includes displaying a second control in a first state in the control user interface, and
displaying the control user interface with the second layout includes displaying the second control in a second state, in the control user interface, wherein the second control displayed in the second state provides additional functionality related to the respective control function, that is not provided when the second control is displayed in the first state.

20. The method of claim 17, wherein:
the fourth set of contextual conditions requires that the computer system is performing a first set of operations, in order for the fourth set of contextual conditions to be met.

21. The method of claim 20, wherein:
the second control includes a media playback control module that includes a play/pause control,
the third set of contextual conditions requires that media playback is not ongoing in order for the third set of contextual conditions to be met and in order for the media playback control module to be displayed in a first state of the media playback control module, and
the fourth set of contextual conditions requires that the media playback is ongoing in order for the fourth set of contextual conditions to be met and in order for the media playback control module to be displayed in a second state of the media playback control module, wherein the media playback control module displayed in the second state of the media playback control module provides additional functionality that is not provided when the media playback control module displayed in the first state of the media playback control module.

22. The method of claim 17, wherein displaying the control user interface with the first layout includes:
displaying a media recording control that includes one or more controls for changing values for one or more parameters of media recording, in the control user interface, in accordance a determination that media recording is ongoing, and
displaying the control user interface with the second layout includes forgoing displaying the media recording control in the control user interface, in accordance with a determination that media recording is not ongoing.

23. The method of claim 1, wherein displaying the control user interface includes:
in accordance with a determination that a current context of the computer system meets a fifth set of contextual conditions, displaying a first set of status information associated with a current status of the computer system; and
in accordance with a determination that the current context of the computer system meets a sixth set of contextual conditions different from the fifth set of contextual conditions, displaying a second set of status information associated with the current status of the computer system.

24. The method of claim 23, including:
while displaying a respective set of status information of the first set of status information and the second set of status information, detecting a user input selecting the respective set of status information; and
in response to detecting the user input selecting the respective set of status information, displaying additional details related to the respective set of status information, wherein the additional details are not displayed before the respective set of status information is selected.

25. The method of claim 23, including:
while displaying a respective set of status information of the first set of status information and the second set of status information, detecting a user input selecting the respective set of status information; and
in response to detecting the user input selecting the respective set of status information, displaying one or more controls for controlling one or more parameters of a respective device feature represented in the respective set of status information.

26. The method of claim 25, wherein displaying the one or more controls for controlling the one or more parameters of the respective device feature represented in the respective set of status information includes:
in accordance with a determination that the respective set of status information includes first status information corresponding to a visual media recording device, displaying a first set of controls for controlling a first set of parameters of the visual media recording device.

27. The method of claim 26, including:
while the first set of controls for controlling the first set of parameters of the visual media recording device, detecting a user input that is directed to a third control in the first set of controls; and
in response to detecting the user input that is directed to the third control in the first set of controls:
in accordance with a determination that the user input that is directed to the third control is of a first input type, changing a respective state of a parameter controlled by the third control from a first state to a second state; and
in accordance with a determination that the user input that is directed to the third control is of a second input type that is different from the first input type, displaying a plurality of selectable states for the parameter controlled by the third control, including the first state, the second state, and one or more additional states different from the first state and the second state.

28. The method of claim 25, wherein displaying the one or more controls for controlling the one or more parameters of the respective device feature represented in the respective set of status information includes:
in accordance with a determination that the respective set of status information includes second status information corresponding to an audio media recording device, displaying a second set of controls for controlling a second set of parameters of the audio media recording device.

29. The method of claim 25, including:
in response to detecting the user input selecting the respective set of status information, displaying a graphical indication of a current output of a respective device feature represented in the respective set of status information.

30. The method of claim 25, including:
in accordance with a determination that the respective set of status information includes third status information corresponding to a file transfer function of the computer system, displaying a third set of controls for controlling a third set of parameters of the file transfer function of the computer system.

31. The method of claim 25, wherein displaying the one or more controls for controlling the one or more parameters of the respective device feature represented in the respective set of status information includes:
in accordance with a determination that the respective set of status information includes fourth status information corresponding to a gaming function associated with the computer system, displaying a fourth set of controls for controlling a fourth set of parameters of the gaming function.

32. The method of claim 1, wherein displaying the control user interface includes:
displaying a power control in the control user interface, concurrently with a respective set of controls that corresponds to a set of control functions of the computer system included in the control user interface;
while displaying the power control, detecting a user input that is directed to the power control in the control user interface; and
in response to detecting the user input that is directed to the power control in the control user interface:
in accordance with a determination that the user input that is directed to the power control meet activation criteria, initiating a process for powering down the computer system.

33. The method of claim 1, wherein:
displaying the control user interface includes displaying a first adjustable control that corresponds to a first adjustable parameter of a first device feature of the computer system, and
the method includes:
while displaying the control user interface including the first adjustable control, detecting a first user input that is directed to the first adjustable control;
in response to detecting the first user input:
in accordance with a determination that the first user input meets adjustment criteria, wherein the adjustment criteria require that the first user input includes a first movement input that is directed to the first adjustable control in order for the adjustment criteria to be met by the first user input, adjusting the first adjustable parameter of the first device feature in accordance with the first movement input; and
in accordance with a determination that the first user input meets control expansion criteria, wherein the control expansion criteria require that the first user input includes less than a threshold amount of movement in order for the control expansion criteria to be met by the first user input, displaying an expanded version of the first adjustable control.

34. The method of claim 33, including:
while displaying the expanded version of the first adjustable control, detecting a second user input that is directed to the expanded version of the first adjustable control or a region proximate to the expanded version of the first adjustable control; and
in response to detecting the second user input:
in accordance with a determination that the second user input meets modified adjustment criteria, wherein the modified adjustment criteria require that the second user input includes a second movement input with a starting portion of the second movement input directed to a location within the expanded version of the first adjustable control, in order for the modified adjustment criteria to be met by the second user input, adjusting the first adjustable parameter of the first device feature in accordance with the second movement input; and
in accordance with a determination that the second user input meets control collapsing criteria, wherein the control collapsing criteria require that the second user input is started with a location outside the expanded version of the first adjustable control, in order for the control collapsing criteria to be met by the second user input, ceasing to display the expanded version of the first adjustable control.

35. The method of claim 34, including:
in response to detecting the second user input:
in accordance with a determination that the second user input meets the modified adjustment criteria, and that a subsequent portion of the second movement input following the starting portion of the second movement input corresponds to a movement of outside the expanded version of the first adjustable control, changing at least a shape and a position of the expanded version of the first adjustable control in accordance with the subsequent portion of the second movement input.

36. A computer system, comprising:
one or more display generation components;
one or more input devices;
one or more processors; and
memory storing one or more programs, wherein the one or more programs are configured to be executed by the one or more processors, the one or more programs including instructions for:
displaying, via the one or more display generation components, a first user interface;
while displaying the first user interface, detecting, via the one or more input devices, a first input that includes first movement relative to the first user interface;
in response to detecting the first input, displaying a control user interface, including:
in accordance with a determination that the first movement meets first criteria that correspond to display of a first set of two or more controls that corresponds to a first set of two or more control functions of the computer system, without meeting second criteria that correspond to display of a second set of two or more controls that is different from the first set of two or more controls, wherein the first criteria require that the first movement meets a first input threshold in order for the first criteria to be met by the first movement, displaying, via the one or more display generation components, after detecting an end of the first input, the first set of two or more controls that corresponds to the first set of two or more control functions of the computer system; and
in accordance with a determination that the first movement meets the second criteria, wherein the second criteria require that the first movement meets a second input threshold that is greater than the first input threshold, in order for the second criteria to be met by the first movement, displaying, via the one or more display generation components, after detecting the end of the first input, the second set of two or more controls that corresponds to a second set of two or more control functions of the computer system, wherein the second set of two or more control functions are different from the first set of two or more control functions.

37. A computer readable storage medium storing one or more programs, the one or more programs comprising instructions that, when executed by a computer system in communication with one or more display generation components and one or more input devices, cause the computer system to perform operations including:
displaying, via the one or more display generation components, a first user interface;
while displaying the first user interface, detecting, via the one or more input devices, a first input that includes first movement relative to the first user interface;
in response to detecting the first input, displaying a control user interface, including:
in accordance with a determination that the first movement meets first criteria that correspond to display of a first set of two or more controls that corresponds to a first set of two or more control functions of the computer system, without meeting second criteria that correspond to display of a second set of two or more controls that is different from the first set of two or more controls, wherein the first criteria require that the first movement meets a first input threshold in order for the first criteria to be met by the first movement, displaying, via the one or more display generation components, after detecting an end of the first input, the first set of two or more controls that corresponds to the first set of two or more control functions of the computer system; and
in accordance with a determination that the first movement meets the second criteria, wherein the second criteria require that the first movement meets a second input threshold that is greater than the first input threshold, in order for the second criteria to be met by the first movement, displaying, via the one or more display generation components, after detecting the end of the first input, the second set of two or more controls that corresponds to a second set of two or more control functions of the computer system, wherein the second set of two or more control functions are different from the first set of two or more control functions.
